(19) United States
(12) Patent Application Publication
(10) Pub. No.: US 2013/0097093 A1
(43) Pub. Date: Apr. 18, 2013

(54) Systems and Methods for Quantifying Job Candidates

(71) Applicants: George Kolber, Locust, NJ (US); Solito Reyes, Hoboken, NJ (US); Richard Kolber, Locust, NJ (US); Robert D. Pearson, Seaside Park, NJ (US)

(72) Inventors: George Kolber, Locust, NJ (US); Solito Reyes, Hoboken, NJ (US); Richard Kolber, Locust, NJ (US); Robert D. Pearson, Seaside Park, NJ (US)

(21) Appl. No.: 13/628,830

(22) Filed: Sep. 27, 2012

Related U.S. Application Data
(60) Provisional application No. 61/546,265, filed on Oct. 12, 2011.

(51) Int. Cl. G06Q 10/10

(52) U.S. Cl. CPC G06Q 10/1053
USPC 705/321

(57) ABSTRACT

Systems and methods of matching candidates and employers are described. The system can be a web based server that provides processors that implement all of the methods described herein. In accordance with one method described herein, a processor displays a video of the candidate during the interview on a display, the processor displays a scorecard that shows a score of the candidate on the display, the processor displays a candidate profile on the display. An interviewer enters scoring and comment information on the display and the processor updates the scorecard based on the scoring information and displaying an updated scorecard on the display.

### STATEMENT OF RELATED CASES

The present application claims priority to and the benefit of U.S. Provisional Patent Application Ser. No. 61/546,265 filed on Oct. 12, 2011, which is fully incorporated herein by reference.

### BACKGROUND

In a very important sense, the world revolves around the economy. Jobs are at the heart of every economy. In today's economic environment, this fact has been highlighted and there are great political, legal and economic efforts to resolve job issues. People cannot find jobs. Companies are afraid to hire the wrong person because of the cost involved with hiring someone.

Existing web sites do not adequately assist individuals in the job search process for a number of reasons. For example, they do not provide adequate information about the potential employer, they do not provide information or tools to help the person become more presentable or more employable, they do not provide an individual with an adequate way of presenting themselves to a potential employer, they do not provide adequate assistance in matching an individual to a potential job, the redundancies involved with responding to each seemingly relevant employment listing in a site and the burden of follow up thereafter.

On the employer's side, existing web sites also fail. They do not adequately measure a potential candidate's suitability for an employment position. They also do not allow an employer to adequately analyze a potential candidate's suitability for an employment position efficiently and cost effectively.

In view of these and other inadequacies, new and improved systems and methods for introducing employment opportunities to individuals, for finding suitable candidates for employers and for matching individuals with companies are needed.

### SUMMARY OF THE INVENTION

Systems and methods for introducing employment opportunities to individuals, for finding suitable candidates for employers and for matching individuals with companies are provided. In accordance with one aspect of the present invention, a method of interviewing a candidate for a position is provided. In accordance with aspects of the invention, a processor displays a video of the candidate during the interview on a display, the processor displays a scorecard that shows a score of the candidate on the display and the processor displays a candidate profile on the display. During an interview process, an interviewer enters scoring and comment information on the display. The processor updates the scorecard based on the scoring information and displaying an updated scorecard on the display.

In accordance with other aspects of the present invention, the processor can display a search order for the position. The search order can include the requirements for position and a salary range for the position.

In accordance with a further aspect of the present invention, the processor can selectively cause the recording and storing the video of the candidate during the interview. Alternatively or additionally, an audio stream of an interview during the interview can be recorded and stored.

The scorecard can include entries related to the appearance of the candidate, a first impression by the candidate, a last impression by the candidate, communication skills, work experience, work relevance, academic achievement, and combinations thereof. In accordance with one aspect of the present invention, the processor can total all of the scores from individual interviewers and either store or display or store and display the total scores. The processor can thus accumulate scores from a number of interviewers and make those accumulated scores available as soon as new information becomes available.

In accordance with a further aspect of the present invention, an interviewer can enter comments related to the interview in a note taking area displayed on the display and the processor storing the notes in a memory.

In accordance with a further aspect of the present invention, the processor can display a video of one or more interviewers on the display.

During the interview or before the interview starts, the processor can retrieve and display information from one or more social network sites on the display. For example, information can be retrieved from Facebook, LinkedIn, Twitter, Google+, Yahoo and other sources.

In accordance with another aspect of the present invention, a plurality of interviewers can participate in the interview and the plurality of interviewers can enter comments in a comment box the processor displays on the display. These comments can be stored by the processor in memory.

At the conclusion of the interview, the processor can cause an interview summary report to be displayed to one or more interviewers. The interview summary reports are completed by the one or more interviewers and stored by the processor in memory.

In accordance with a further aspect of the present invention, the processor can access candidate endorsements by a third party that are stored in memory and displaying the candidate endorsements on the display.

In accordance with a further aspect of the present invention, multiple interviewers at different locations can participate in the interview process.

In accordance with yet further aspects of the present invention, information relating to the display can be shown to an employment candidate during the interview on another display. For example, a video of an interviewer can be displayed to the candidate on a second display. Further, a video of a second interviewer can be displayed to the candidate on the second display. Additionally, the candidate's notes regarding the interview can be displayed to the candidate on the second display. Further, the method can include displaying on the second display to the candidate information about the company, information about the available employment position and information about interviewer's company background.

### DESCRIPTION OF THE DRAWINGS

FIG. 1 illustrates a system block diagram used in a system in accordance with an aspect of the present invention.

FIG. 2 illustrates a computing system used in the system in accordance with an aspect of the present invention.

FIGS. 3 to 34 illustrate various procedures used in the system in accordance with various aspects of the present invention.

FIGS. 35 to 48 illustrate methods used to quantify an individual's qualification for a position in accordance with various aspects of the present invention.

FIGS. 49 to 124 illustrate screen shots used in accordance with various aspects of the present invention.

### DESCRIPTION

Network based job seeking systems and methods for individuals are disclosed. At the same time, network based job recruiting systems and methods for organizations are disclosed. Also disclosed are systems and methods for matching job seekers with job recruiters, along with other innovative systems and methods. While specific embodiments are disclosed of these systems and methods, the invention is intended to extend to its broadest aspects. Thus, if limiting language is used when describing an embodiment, that language is not intended to limit the broad aspects of the various inventions described herein.

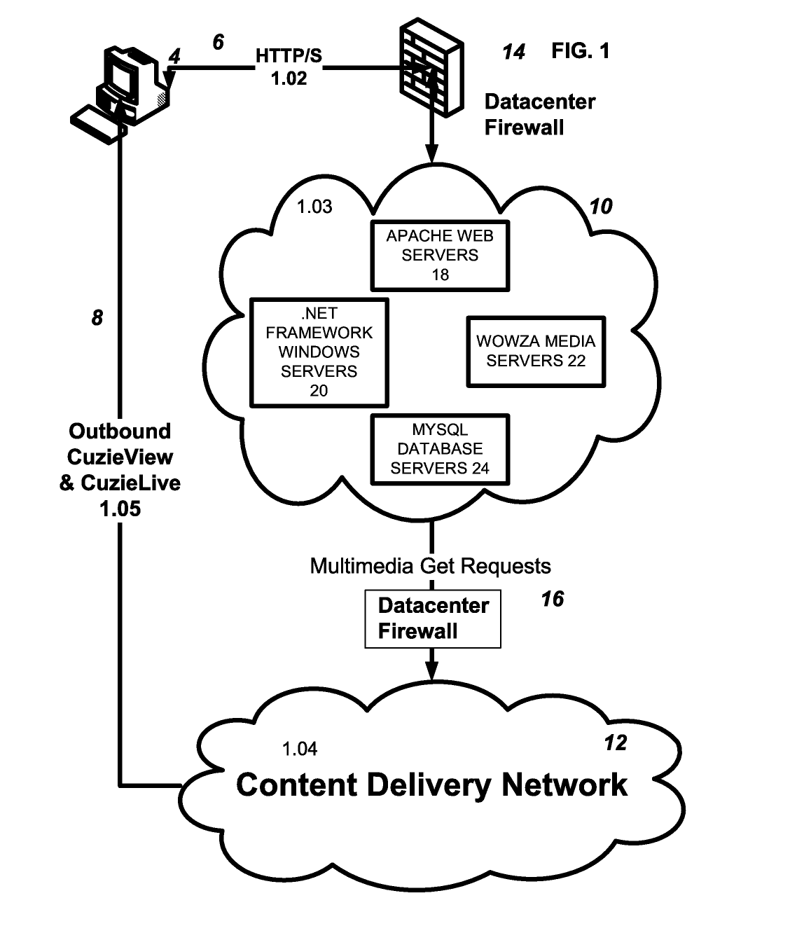

FIG. 1 illustrates a system in accordance with an aspect of the present invention. A remote computing terminal 4 communicates over internet or intranet connections 6 and 8 with servers 10 and 12 through firewall connections 14 and 16. It is to be understood that there are a plurality of remote computing terminals 4 communicating with the servers of the present invention, even though only one is shown. Similarly, it is to be understood that one or more servers can be used to implement the various aspects of the present invention. For example, server 10 may be implemented using an Apache server 18, a NET framework server 20, a WOWZA multimedia server 22 and a MySQL server 24. The server 12 can be a content delivery network. Any number of web architectures can be used to implement the system of the present invention. As described herein, all of the following methods and procedures are implemented by the processing through the server architecture of FIG. 1. Any processor or any server in FIG. 1, and any database associated with the server or processor, can be used to implement the methods and processes described herein.

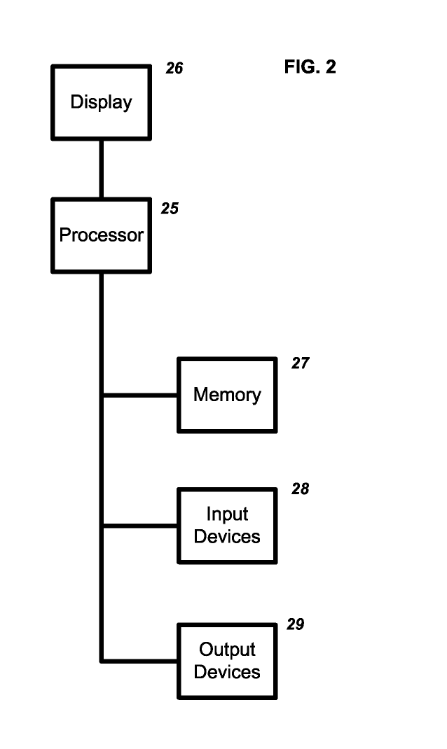

FIG. 2 illustrates a computing system useful in the present invention. The servers and the remote computing stations include a processor 25, a display 26, memory 27, input devices 28 and output ports 29. Each of the processes and steps described herein are implemented using the processor 25 and the ancillary devices 26-29 that form the responsible part of the computing systems of the present invention. Any number and any arrangement of computing systems can be used to implement the present system. Any of the methods and steps described herein can be implemented using the computing system of FIG. 2. Additionally, any of the methods and steps described herein can be implemented on any of the processors in any of the servers illustrated in FIG. 1, or on any remote processor found on the Internet.

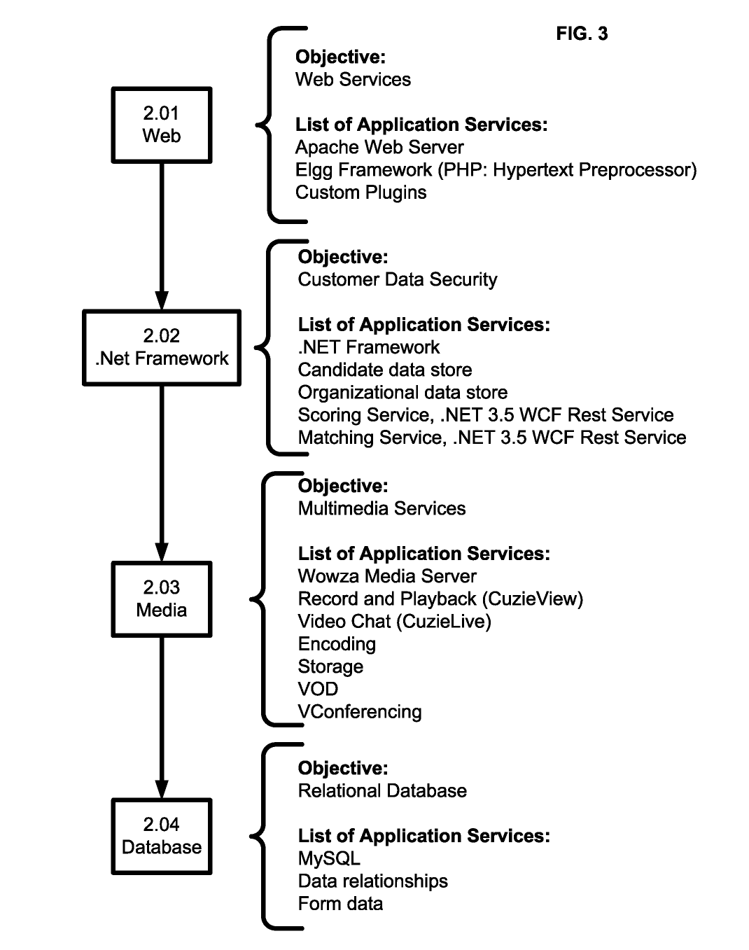

FIG. 3 depicts an application architecture diagram that provides a high-to-low level view of the major services running within each system tier involved in the operation of the website, as well as the servers 10. Views of the web, the .NET framework, the media and the database are provided. Of course other architectures can be used as well.

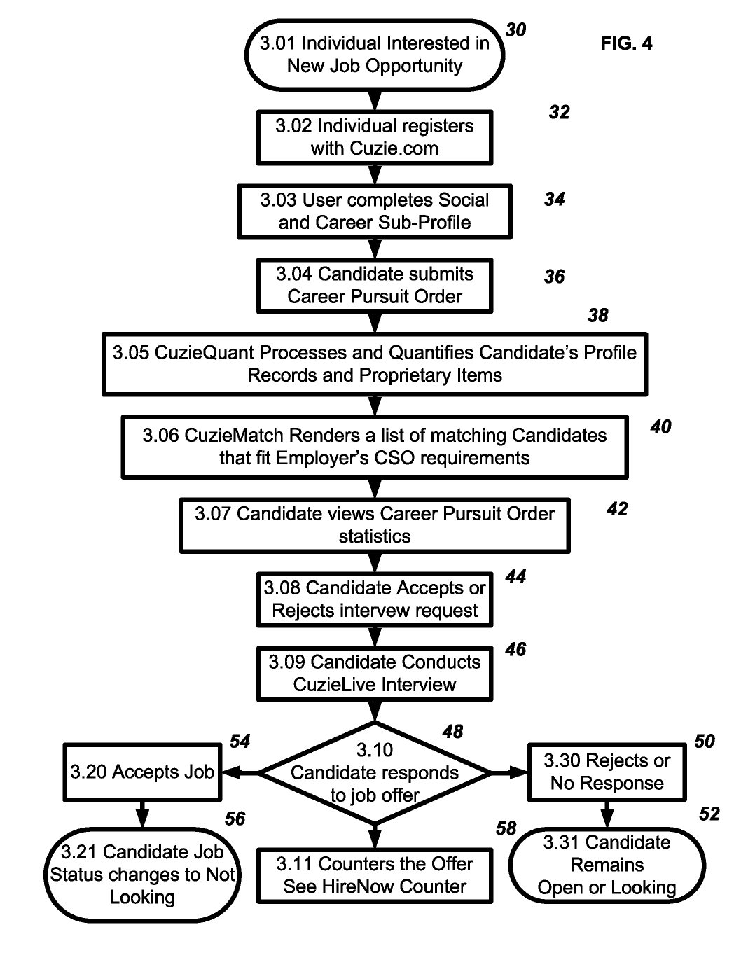

FIG. 4 depicts a workflow diagram of one embodiment of a method for the major steps involved when a user registers, pursues a new employment opportunity, is matched, views statistics, responds to interview requests and job offers. The method starts at step 30, in accordance with an aspect of the present invention, when a person seeking career advancement or new employment opportunities becomes interested in using the Cuzie approach for finding new employment opportunities. If the individual is not registered, the method proceeds from step 30 to step 32. At step 32, the individual registers for an account and receives credentials to enable the individual to sign-in to the system. The individual signs-in to the system and the method proceeds to step 34. If the individual is a registered user, the individual signs-in to the system and the method proceeds to step 34. Once the credentials are verified by the system, the method proceeds to step 34.

At step 34, the user is directed to complete an Individual Profile which is divided into two subprofiles encompassing different objectives: a Social SubProfile and a Career SubProfile. After completing the Social SubProfile and the Career SubProfile 34, or if they were already completed, the method proceeds to step 36. The user should complete the Career SubProfile to be allowed to proceed to step 36 to pursue career advancement or seek new employment opportunities.

At step 36, in accordance with an aspect of the invention, the user completes a Career Pursuit Order (CPO). In this step, the user seeking employment in a selected career, fills out forms requesting details about work experience and education as well as forms requesting information related to the “Job Role” the user seeks. “Job Role” is a term of art that represents the main selection criteria for matching up Candidates and Employers. Matchup relevancy is determined by background information as well as other criteria and proprietary considerations. By default, the system does not include the Candidate into any Employer search results until the user explicitly executes the <submit> command, which initiates his Career Pursuit Order into the system. Once the Candidate submits the CPO, the system makes the Candidate eligible against all Candidate Search Orders that are relevant. The method then proceeds to step 38.

At step 38, the system utilizes a method, in accordance with another aspect of the present invention that quantifies and evaluates the Candidate's objective background and qualifications against competing Candidates. Essentially, the algorithm quantifies object criteria in the Candidate's work history, education and other proprietary features and uses these values in formulas to render a numerical score about the Candidate. This implied score is compared against other Candidates vying for similar Job Roles. Candidates who are included in Candidate Search Orders are sorted by these Implied Scores, essentially ranking relevant Candidates against others. There are many components that are factored into rendering an implied score, and many features are dynamic, providing a Candidate the opportunity to raise his implied score and possibly his overall ranking in search results.

The system uses a novel method to match the most qualified Candidates to Employers seeking workers. As mentioned in step 38, the system quantifies and sorts Candidates. There is also a complimentary process for matching Candidates to Employers through the CPO and CSO request systems. CSO refers to a Candidate Search Order. Once the Candidate completes and submits the Career Profile, as in step 36, the Candidate is processed in step 38 and made eligible to be included in CSO search results. At step 40, the system compares criteria filled out in an Employer's CSO and matches it up with parallel criteria filled out in a Candidate's CPO (Career Pursuit Order). Each order is comprised of very detailed forms and questions about employment requirements desired by each side. The more matches, the more relevant the search results become. The system processes the CSO and accumulates a ranked list of relevant Candidates for the Employer. This list appears in the dashboard of the Organizer managing the company's Org profile. All the matched up Candidates are sorted by rank mentioned in step 38.

In one embodiment of the present invention, the Candidate is limited to submit up to 5 (five) different CPOs in step 36, thus pursue 5 (five) different Job Roles, some may just be variants of the same Job or a totally different field that the user sees as a dream job. In light of recent economic times, this allows Candidates to pursue a diverse range of careers. In step 42, the candidate views CPO statistics. If a Candidate is engaged in pursuing multiple CPOs, he can keep track of how well each order is being received by gleaming insight from statistics we provide about the CPOs; for example, the number of views each feature in his Career Profile received, general information about the companies that viewed his profile, x the total number of those in the same Job Role he would be competing against.

After the Candidate submits a CPO in step 36, he may receive a request by electronic message to interview by prospective Employers in step 44. The Interview request process in step 44 is managed by the Employer in the ScheduleNow application, which handles interview scheduling and requests at the same time. The Employer schedules one of two kinds of interviews with the candidate in step 44: (a) a CuzieLive video conference session which (1)is a proprietary video conferencing application with integrated recruiting tools and (2) is used by the Employer and Candidate to meet without having to be in-person; or (b) an In-Person meeting at the business location. Step 44 could happen very quickly after a CPO is submitted in step 36. The electronic message request for an interview provides a link for the Candidate to respond. The link brings Candidate to his dashboard where he can respond to the Interview request. The Candidate can accept the interview requests by first clicking on the link provided in the message for <Accept the Interview Request>, which takes him to his dashboard. In his dashboard, the candidate should respond by selecting a convenient time slot from those made available by clicking on the appropriate button or link that represents that particular time slot. Once the Candidate selects a time slot, the interview is scheduled in the calendar of the Organizer, the Interviewer(s) and Candidate. All parties receive electronic messages that an event has been scheduled in all relevant party's CuzieCalendars (a calendar provided on a user's webpage on the system of the present invention). Each person is provided a means for saving the event into another major calendar, such as Google, Yahoo, Hotmail and/or Outlook. The candidate can also reject the interview request, either by clicking on the <Reject> button or link provided in the electronic message or by rejecting it with no response and letting the interview request expire on its own as the candidate is informed that the request expires in 24 hours.

If the Candidate accepts a CuzieLive interview request in step 44, he should make himself available for the Video conference session by logging into his account during that time. Notification of the scheduled CuzieLive interview event appears in the Candidate's dashboard. In step 46, once the schedule time for the interview arrives, the Employer is able to see if the Candidate is available; thereafter, the Employer should initiate the Video conference session. In regards to the financial transaction, as long as the Candidate is signed on to his Cuzie account during the scheduled time of the event, the call is considered complete, regardless of whether the Employer actually initiated the call or not. Thus, the Employer is billed for the session even if he fails to attend, initiate or complete the session. However, if the Candidate fails to make himself available for the video conferencing session, by not logging into his account 5 minutes after the scheduled time or fails to accept the call request altogether, the call is then considered incomplete; and the Employer is not charged for the call. The Candidate may face reprimands by the system for failing to attend or complete the call. These reprimands may come in the form of a temporary CPO suspension, Profile suspension, full Account suspension altogether or blocked from ever being eligible for search for that particular Employer again. Upon reprimand, the system sends an automated message that he missed the called, and informs the Candidate of the type of reprimand, and the Candidate needs to provide a reason. The Candidate's response is reviewed by Cuzie's in-house staff and decides upon any further actions. The CuzieLive session in step 46 is limited to 30 minutes in accordance with one embodiment of the present invention. Other lengths of time can be used also.

After the interview process, the Employer may deem the Candidate appropriate for filling its available employment position. In step 48, the Employer may extend a Job Offer to the Candidate using Cuzie's HireNow application. In step 48, the Candidate receives notification that a Job Offer has been extended to him. The Candidate then clicks on a link provided in the message body of this message that transfers him to his dashboard. The Candidate should respond to the Job Offer in one of the following ways (a) Accept Job Offer, (b) Reject or No Response, or (c) Counter the Offer for better terms. The system proceeds to step 54 if the Candidate accepts the job offer, then all pertinent parties are informed, and the Candidate's response is considered an action of agreement. The system then initiates some cleanup for both parties by either (a) employer closing the CSO by clicking on <hired>, or (b) Candidate accepting the Job Offer. The system then goes into a cleanup routine disabling messages, updating profile statuses and display notifications, and other functionality tied to the originating CPO and CSO orders. Thereafter, the Candidate receives more information in subsequent messages that provide Orientation and start date information.

After the system completes its cleanup routine in step 54, the system proceeds to step 56 where the Candidate's Job Status automatically changes to <Not Looking> in his dashboard profile. The Candidate is notified that all his current CPOs are discontinued. If the Candidate prefers to keep his additional CPOs running, he needs to manually change his Job Status to <Open> or <Looking> for the CPOs to be eligible for CSO search results by Employers.

If the Candidate rejects the job offer in step 48, the system proceeds to step 50. In step 50, the Candidate can also reject the Job Offer in by either: (a) explicitly rejecting the offer by clicking on the appropriate button provided; or (b) by not responding at all and allowing the time limit set in the Job Offer to expire. The Employer can choose to have the Job Offer expire in either: (a) 24 hours (default); (b) 48 hours; or (c) 72 hours.

If the Candidate rejects the Job Offer in step 50, the system proceeds to step 52 where the Candidate's Career Profile, Job Status remains <Open> or <Looking> depending on which particular one he selects.

If the Candidate chooses to counter the offer in step 48 in order to demand better terms the system proceeds to step 58. In step 58, the Candidate selects to counter the offer by clicking on the <Counter> button within the job offer message. In step 58, the Candidate is able to respond to the Employer with his counter offer, but the Candidate risks the Employer rescinding the Job Offer. The process of FIG. 4 is illustrative only. Other workflows can be implemented. Further, in other embodiments of the present invention, any number of counteroffers are permitted—the system and methods of the present invention are not necessarily limited to a single counteroffer.

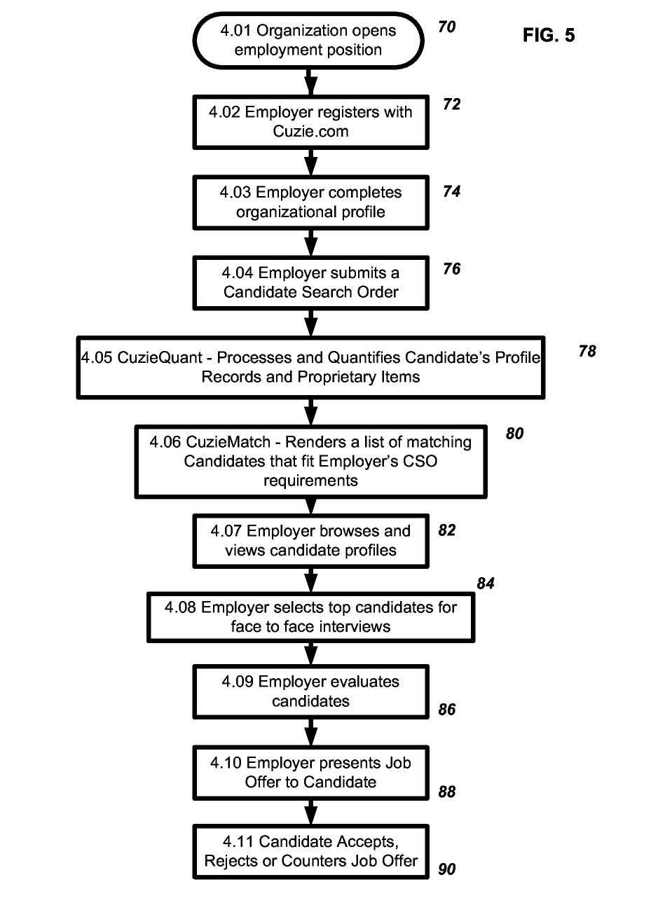

FIG. 5 depicts a workflow diagram to illustrate how an organization registers and utilizes recruiting services. This illustrates the workflow that an Organizer follows when seeking candidates to fill an open employment position from how an organization is registered, searches for new employees, finds well matched Candidates, views statistics, extends interview requests and job offers.

At step 70, any Employer with an available employment position can utilize Cuzie's services and applications to find the most qualified Candidates to fill these open positions.

At step 72, when an Organization, such as a company business or educational institution arrives at Cuzie, in order to use any of the services and applications herein, the organization should register in order to receive credentials for signing in. The person who fills out the Organization's profile and continues to manage the account is called the Organizer. The Organizer is one of 4 roles in the Organization Account: (a) Organizers—Administrative account of the Organization with the most permissions and access to services; (b) Managers—Administrative account like the Organizer with no user management or financial permissions; (c) Interviewers—Users with permissions that allow them to participate in the recruiting process and access recruiting applications and services; and (d) Employee Users—users with the fewest permissions, and can communicate with anybody else in the organizational domain through communicational applications. The Organizer is the person most entrusted by the company to manage the financial sources, human resource responsibilities and the day to day operation of the Cuzie account for the company. The Organizational domain is flexible and dynamically designed to accommodate, large enterprise companies as well as the smallest firms. The Organization may have multiple people overlapping different roles in the account, or may have a single person administering the entire account and conducting all the interview processes within the system all by himself. It is the company's prerogative to determine the level of complexity of how they wish to exist in Cuzie. A large Organization may have multiple business units existing as independent user accounts with numerous financial sources managed by various individuals across the company. Another large Organization may realize that achieving scale through organized structure is the most optimal strategy, and decide to exist under one single account with one single financial source, making use of all the advanced structural features in the account, and finding benefit in the added collaboration across its business units, better messaging reach, and financial savings from promotions related to usage and bulk credit prepayments. A small company can utilize either structure, or in the simplest way, a single individual from the company serves as the Organizer, account manager and main interviewer.

At step 74, the Organizer should complete the company profile by filling in all the required fields in its account. After completing the profile, the Organizer saves his inputs by clicking on the <Save> button.

Once step 74 is complete, the Employer can search and hire new employees in Cuzie by submitting a CSO (Candidate Search Order) in step 76. The CSO is a form that requests information about the available Employment position. All the questions that we request and the way that we ask it is specifically designed to get the most relevant information so that we can match up the most qualified Candidates by matching up the most relevant CPOs to an Employer CSO.

The method then proceeds to step 78 where Candidates are processed and evaluated by an internal algorithm called CuzieQuant.

At step 80, Employer CSOs are matched up to relevant Candidate CPOs by an internal process and algorithm called CuzieMatch. CuzieMatch renders a search results list for each CSO an Employer submits. The CSO list is based on criteria and requirements the Employer included in each specific CSO.

At step 82, the Employer browses through the CuzieMatch list of search results of available Candidates that were matched up to each specific CSO in step 80. Cuzie provides a feature that allows the Employer to select Candidates that then can be saved to a “favorites” list. This list can then be rendered into a comparison grid amongst the competing Candidates, in another application called CandidateComp.

The Employer selects the best Candidates for face to face interviews in step 84. The Employer can schedule the Candidate using ScheduleNow.

In step 86, the Employer evaluates Candidates through the use of the ScoreCard application, which is integrated into the CuzieLive video conferencing interface. ScoreCard is made available to the Interviewer on his side of the CuzieLive screen, the following features are integrated into the CuzieLive interface: (a) Preview box of the Candidate's work history, this view can be expanded through the use of +/− controls; the current employer is listed by default; (b) Preview box of Candidate's education, this view can be expanded through the use of +/− controls, the latest school attended is listed by default; (c) Summary of the Candidate's Respects; (d) Summary of the Candidate's Referrals, the ability to view the actual Referral requires approved release by the Candidate after his is extended a Job Offer; and (e) Summary of Candidate's CPO requirements: Salary, Career level, Previous Job, Previous Job Title, previous industry, previous responsibilities etc.

After the interview and evaluation process in step 86, Cuzie provide the Employer the functionality to extend a job offer to one of the Candidates through the use of the HireNow application in step 88. The HireNow application manages the Job Offer process, the responses and exchange of relevant information between the parties thereof.

In step 90, the recruiting process (CSO) terminates once a Job Offer has been accepted by a Candidate, or the Employer manually discontinues the CSO. An Employer may have numerous CSOs running at the same time, with each CSO running its own course. Once a CSO concludes, numerous automated cleanup routines are executed to discontinue running services and open applications related to that particular CSO. The process of FIG. 5 is illustrative only—other workflows within the teachings of the present invention can also be used.

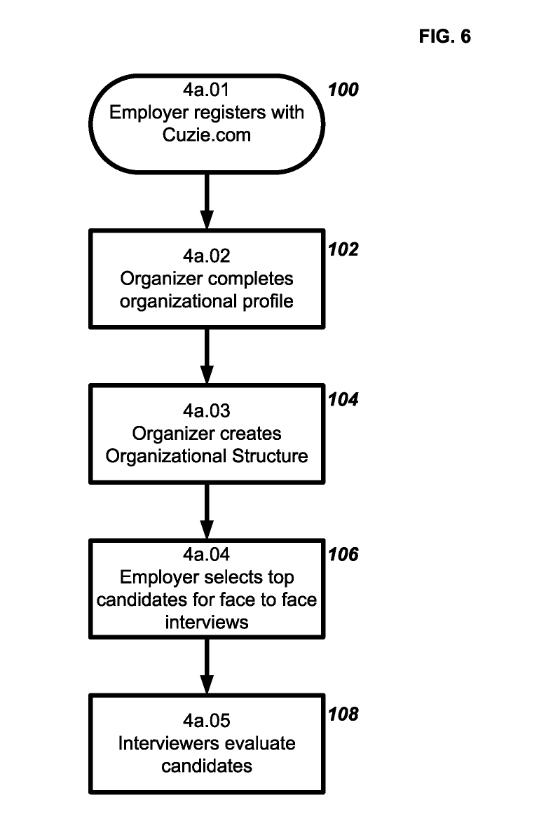

FIG. 6 depicts a workflow diagram to illustrate how an Organizer creates the Organizational Structure by adding users and assigning roles in the Organizational domain account. For advanced Organizers of large companies, Cuzie provides an Organization the functionality of being able to create an Organizational Structure for having multiple users with different roles. The company can benefit from a consolidated account: one company profile, one financial account, multiple employees for better collaboration and communication and control. FIG. 6 illustrates the steps and processes involved with how an Organizer creates and Organizational Structure by including additional users and assigning roles to them.

Step 100 begins when an Organization, such as a company business or educational institution arrives at Cuzie, in order to use any of the services and applications herein, the organization should register in order to receive credentials for signing in. The person who fills out the Organization's profile, receives and manages the credentials, and continues to manage the entire Organization account is called the Organizer. The Organizer is one of 4 roles in the Organization Account. See step 104. The Organizer is the person most entrusted by the company to manage the financial sources, human resource responsibilities and the day to day operation of the Cuzie account for the company. The Organizational domain is flexible and dynamically designed to accommodate, large enterprise companies as well as the smallest firms. The Organization may have multiple people overlapping different roles in the account, or may have a single person administering the entire account and conducting all the interview processes within the system all by himself. It is the company's prerogative to determine the level of complexity of how they wish to exist in Cuzie. A large Organization may have multiple business units existing as isolated user accounts with independent financial sources managed by numerous individuals across the company. Another large Organization may realize that achieving scale is the most optimal strategy, and decide to exist under one single account with one single financial source, making use of all the advanced structural features in the account, and finding benefit in the added collaboration across its business units, better messaging reach, and financial savings from promotions related to usage and bulk credit prepayments. A small company can utilize either structure, or in the simplest way, a single individual from the company serves as the Organizer, account manager and main interviewer.

At step 102, the Organizer should complete the company profile by filling in all the required fields in its account. After completing the profile, the Organizer saves his inputs by clicking on the <Save> button.

At step 104, the Organizer creates the Organizational Structure. The Organization can encompass many “users.” This Organizational structure is designed for large companies with an Organizer who is very technically proficient in terms of managing administrative functionalities found in many enterprise application systems. Large organizations that have experience using enterprise systems understand the benefits of implementing an Organizational Structure feature in a software application as sophisticated as this. Each user is assigned a “role.” Each role carries a set of “permissions” related to its purpose where the predefined permissions control what a user can do and access within the organizational domain. All the roles are hierarchical: Organizer—has the most rights and permissions; Managers—enough permissions to manage the Organization Account; Interviewers—participate in interview apps; and Users—regular employees, can communicate with other Users only. The Organizer sits at the top of the hierarchy, possesses the most privileges and permissions (the person that ideally should undertake this role is the top Personnel agent or IT person at the company, for example: HR Director, General Manager, Director of IT, etc.). There should only be two Organizers (a main one and backup), but the company can structure their account any way it pleases: Organizers—Administrative account of the Organization with the most permissions and access to services; Managers—Administrative account like the Organizer with no user management or financial permissions; Interviewers—Users with permissions that allow them to participate in the recruiting process and access recruiting applications and services; and Users—users with the fewest permissions, and can communicate with anybody else in the organizational domain through communicational applications. Permissions are broken down as follows.

Organizer—(1) Manages Org structure: Invites users to join Organization; Block users from the Organizational Domain; Assigns user to any role and can promote a user to Organizer status and can demote an Organizer to lower status. (2) Manages Organization Account with Total access to every application in Org Domain; can add, remove, edit Company Profile information; can add, remove, edit all content; and can manage credits, financial account. (3) Manages Recruiting Tools when it submits CSO, views Analytics, reads Respects, manages CuzieScreener, browses CuzieMatch, browses Candidate Career Profiles, manages CandidateComp, manages ScheduleNow, manages ScoreCards, manages ScoreBoard, manages CuzieLive, manages ApplyNow, manages HireNow, reads Referrals. (4) There will always be at least one Organizer in each Organizational domain. Managers—(1) Manages Org structure when it invites users to join Organization; Blocks users from the Organizational Domain; and Assigns user to any role except Organizer, promote or demote, but cannot promote a user to Organizer status and cannot demote an Organizer to lower status. (2) Manages Organization Account: total access to every application in Org Domain; can add, remove, edit Company Profile information; can add, remove, edit all content; and can manage credits, financial account. (3) Manages Recruiting Tools: submits CSO; views Analytics; reads Respects; manages CuzieScreener; browse CuzieMatch; browse Candidate Career Profiles; manages CandidateComp; manages ScheduleNow; manages ScoreCards; manages ScoreBoard; manages CuzieLive; manages ApplyNow; manages HireNow; reads Referrals. (4) There may not be a need for Managers, in a small company. Interviewer—(1) Can participate in the Interview applications: view Analytics; read Respects; browse CuzieMatch; browse Candidate Career Profiles; manages CandidateComp; ScoreCards; ScoreBoard; and CuzieLive. (2) Can post content. (3) Can browse candidates. Users (Employees)—(1) Can post content. (2) Can communicate with other users in the organization. (3) No recruiting application participation.

Managing Role Conflicts: If a user is placed in two different Roles, the user has overlapping roles, thus, possibly conflicting permission sets. The highest Group Permissions win. In other words: when permission conflicts occur because a user has been added to two different Groups: the LEAST restrictive permissions overrule the MOST restrictive permissions. For example, if a user is contained both in the Managers group and in the Users (Employees) group, his “Manager” rights prevail by overriding the conflicting User permissions.

The Organizer is provided tools to manage this in the Org Structure Manager. He can add users by clicking on <Add users>. A prompt appears for the Organizer to accept those on a “confirmation list” a list of users that made a “request” to join and he can Approve or Reject. Another prompt is provided for the Organizer to type in email addresses of those he wants to invite to join the Organization and those that accept, should then be confirmed, these users end up on the “confirmation list.” After adding users, he assigns them Roles: <User> by default, all new users start off in the User role, until promoted by the Organizer; <Organizer>; <Manager>; <Interviewer> assign CSO (by pull down choice); or <User>. When the Organizer is finished he clicks on <Save> to save and submit his changes.

At step 106, the Employer selects the best Candidates for face to face interviews. The Employer can schedule the Candidate using ScheduleNow.

At step 108, the Employer evaluates Candidates through the use of the ScoreCard application, which is integrated into the CuzieLive video conferencing interface. ScoreCard is made available to the Interviewer on his side of the CuzieLive screen, the following features are integrated into the CuzieLive interface: a preview box of the Candidate's work history, this view can be expanded through the use of +/− controls, where the current employer is listed by default; a preview box of Candidate's education, this view can be expanded through the use of +/− controls, the latest school attended is listed by default; a Summary of the Candidate's Respects; a Summary of the Candidate's Referrals, the ability to view the actual Referral requires approved release by the Candidate after his is extended a Job Offer; a Summary of Candidate's CPO requirements—Salary, Career level, Previous Job, Previous Job Title, previous industry, previous responsibilities, etc. The workflow of FIG. 6 is exemplary only.

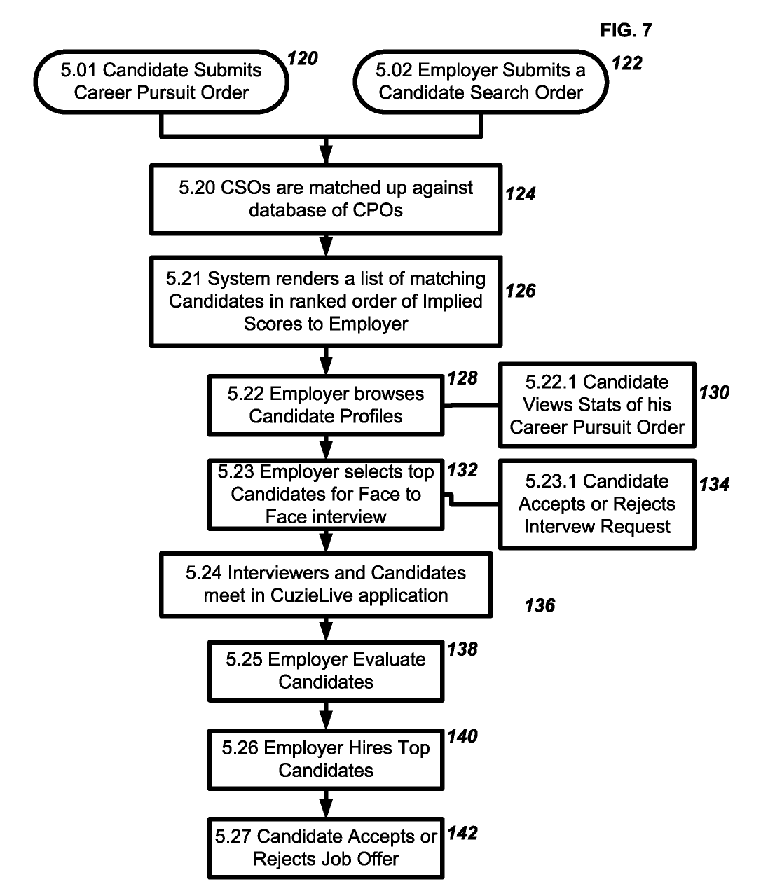

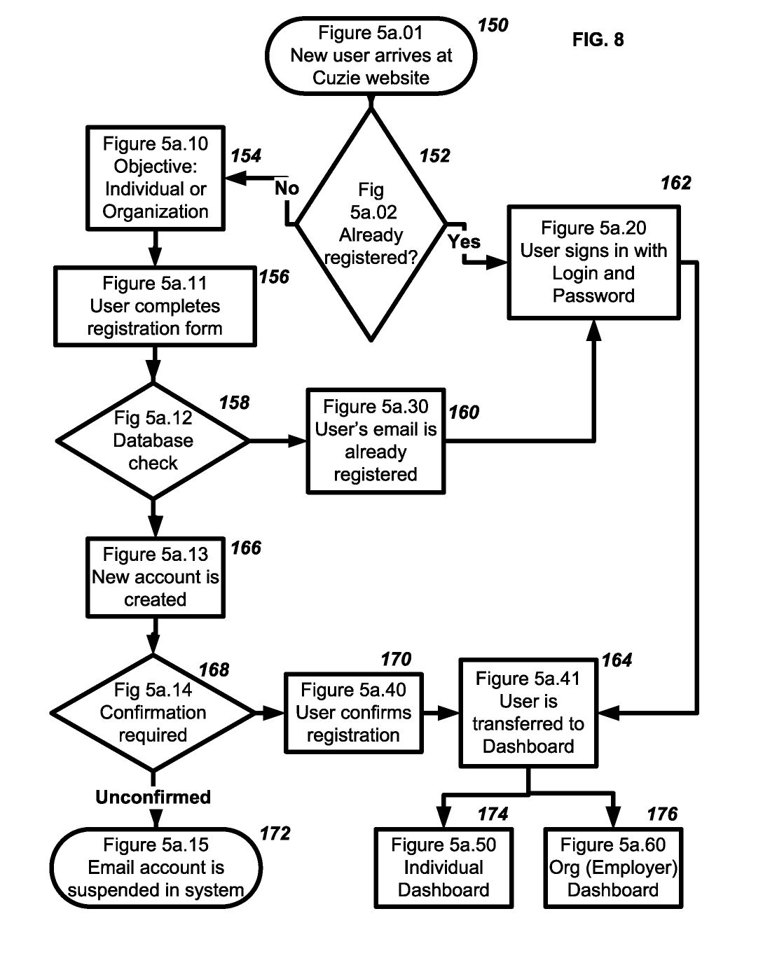

FIG. 7 depicts a workflow diagram that illustrates where Individual and Organization steps and processes interact and overlap. This workflow diagram illustrates how Employer and Candidate processes overlap in the Cuzie Virtual Recruiting system. FIG. 6 illustrates the major connection points between the individual Candidate CPOs and organization Employer CSOs. There are redundancies here taken from FIG. 5 and FIG. 6.

After completing the Career Profile (which is processed and quantified by CuzieQuant) the Candidate fills out the CPO form. The CPO form requests all the information required to ensure criteria matches within an Employer's CSO in the CuzieMatch process. At step 120, the Candidate submits the CPO.

After completing the Organization Profile, the Organizer fills out the CSO form. The CSO form requests all the information required to ensure criteria matches within relevant Candidate CPOs in the CuzieMatch Process. At step 122, the Employer submits a CSO.

At step 124, CuzieMatch searches all Candidate CPOs that matched up well with the Employer CSO based on Job Role, Salary, Career Level and other criteria.

At step 126, CuzieMatch renders a search results list for each CSO an Employer submits. The CSO list is based on criteria and requirements the Employer included in each specific CSO.

At step 128, the Employer browses through the CuzieMatch list of search results of available Candidates that were matched up to each specific CSO. Cuzie provides a feature that allows the Employer to select Candidates that then can be saved to a “favorites” list. This list can then be rendered into a comparison grid, in another application called CandidateComp.

If a Candidate is engaged in pursuing multiple CPOs, he can keep track of how well these orders are being received by gleaming insight from statistics we provide about the CPOs at step 130. For example, the number of views each feature in his profile received, general information about the companies that viewed his profile, the total number of those in the same Job Role he would be competing against and other records.

At step 128, the Employer browses through the CuzieMatch list of search results of available Candidates that were matched up to each specific CSO. Cuzie provides a feature that allows the Employer to select Candidates that then can be saved to a “favorites” list. This list can then be rendered into a comparison grid, in another application called CandidateComp. At step 132, the Employer selects the best Candidates for an interview. The Employer can schedule the Candidate using ScheduleNow. ScheduleNow sends the interview request and provides a means for scheduling the interview at the same time.

At step 134, the electronic message request for an interview provides a link in the message body for the Candidate to respond. The link brings the Candidate to his dashboard where he responds to the Interview request by one of the following. (1) Accept the Interview Request—The Candidate can accept the interview requests by first clicking on the link provided in the message, which takes him to his dashboard and responds by selecting a convenient time slot from those made available by clicking on the appropriate button or link. Once the Candidate selects a time slot, the interview is scheduled in the calendar of the Organizer, the Interviewer/s and Candidate. All parties receive electronic messages that an event has been scheduled in all relevant party's CuzieCalendars. Each person is provided a means for saving the event into external calendars, such as Google, Yahoo, Hotmail and/or Outlook. (2) Reject the Interview Request—by clicking <Reject> provided for this purpose. (3) Reject the Interview Request with No Response and letting the request expire on its own, Candidate is informed that the request expires in 24 hours by default, unless the Organize choose a longer duration.

At step 136, the Candidate and Organization Interviewer can meet face to face using CuzieLive. If the Candidate accepts a CuzieLive interview request, he should make himself available for the Video conference session by logging into his account during the scheduled time slot. Notification of the schedule CuzieLive interview event appears in the Candidate's dashboard. Once the scheduled time for the interview arrives, the Employer is able to see if the Candidate is available; thereafter, the Employer should initiate the Video conference session.

At step 138, the Employer evaluates Candidates through the use of CuzieLive, which integrates the following features: a preview of the Candidate's work history, this view can be expanded through the use of +/− controls; a preview of Candidate's education, this view can be expanded through the use of +/− controls; a summary of the Candidate's Respects; a summary of the Candidate's Referrals, the ability to view the actual Referral requires approved release by the Candidate; and a summary of Candidate's CPO requirements: Salary, Career level, Previous Job, Previous Job Title, previous industry, previous responsibilities, etc.

After the evaluation process in step 138, the Employer can extend a Job Offer to one of the Candidates using the HireNow application in step 140. The HireNow application manages the Job Offer process, the responses and exchange of relevant information between the parties thereof.

At step 142, the Candidate accepts or rejects the job offer. If the Candidate accepts, all pertinent parties are informed, and the Candidate's response is considered an action of agreement. The system initiates some cleanup for both parties either when the employer closes the CSO by clicking on <Hired> or when the Candidate accepts the Job Offer. The system then goes into a cleanup routine disabling messages, updating profile statuses and display notifications, and other functionality tied to CPO and CSO orders. Thereafter, the Candidate receives more information in subsequent messages that provide Orientation and start date information. The Candidate is then in possession of all pertinent information to start his new job. The workflow of FIG. 7 is exemplary only.

FIG. 8 depicts a diagram of a method of registering individuals in order to obtain user account credentials for signing in and being able to access applications and services within the Cuzie website. This method provides an intelligent and interrelated approach for structuring Social Networking and Recruiting services into a single construct without compromising tenets of each service. “Open” Social Networks that offer recruiting services are faced with a major challenge-recruiting (Employers searching the best employees and Candidates searching for the best employment opportunities) in of itself is a confidential activity requiring the utmost “discretion”, a tenet extolled by employed Candidates and by many competitive Employers. (This is a major flaw with LinkedIn.) With a single account, a Cuzie individual user can access services between his Social Networking Profile and Career Profile with utmost discretion because services applicable to each profile are isolated from the other. “Open” social networks are not conducive platforms for Candidates looking to pursue new employment opportunities, a private activity requiring a great deal of discretion from the current employer. Recruiting platforms are not conducive platforms for socializing and making social connections. Also, Employers looking for new employees do not care about Social Networking services. In an “Open” singularly dimensional social network environment, users are pestered by unwarranted solicitations by recruiters and salespeople. This diagram illustrates the steps and processes involved with how a new user registers with Cuzie.

At step 150, a user arrives at Cuzie. In order to access applications and services of Cuzie, he should sign-in with credentials linked to his user account.

As step 152, Logins and Passwords are provided to those already registered with Cuzie. To obtain a user account, new users should register with Cuzie. If a user is already registered, he should sign-in with his Login and Password, see step 162. If user in not registered, he should complete the registration process to obtain a user account and credentials, see step 154.

At step 154, new users initiate the registration process by clicking on <Register> provided for this purpose. Before the registration process begins, the individual is prompted to select his user type depending on his objectives, he should choose from the following. If the new user is an Individual, he should chose whether he is (1) Seeking Career Advancement or new employment opportunities or (2) Socializing (Social networking). If the new user is an Organization (being the Organizer herein), the user should choose whether it is (1) for recruiting new employees or (2) for Communicating with Co-workers (in a closed Organizational domain, i.e., Social Networking with other registered employees). After making the appropriate selection, the new user should click on <Get an Account> to submit his selection and initiate the registration process. Depending on the selection, an appropriate registration form appropriate to the user type of choice is rendered for the new user to complete at step 156.

At step 156, the new user should provide basic information for one of two kinds of forms: either a Registration for an Individual Account or a Registration for an Organization Account. A Registration form for an Individual Account asks for the following: First Name; Last Name; Suffix; Birth Date; Personal Email Address (non-work related email address) a question mark <?> provides an explanation and the relevance of this distinction; Company domain name—a question mark <?> provides an explanation and the relevance of this information; and Password choice. A Registration form for an Organization Account asks for two sets of information: Company/Organization Information and Organizer Information. The first set is the Company/Organization form that asks for the following information: Company Name; Company Domain; Address; Company Logo image and/or video—<Browse> is provided to locate the file from disk, <Upload> is provided to upload the file to the website; and Company Description—user can type in a description up to 500 characters. The Second set is the Organizer Information form that asks for the following information: First Name; Last Name; Birth Date; Work Email Address; User Id; and Password. The user then clicks on <Sign Up> to save and submit the information into the system. The user should type-in a Captcha message at the prompt provided for this purpose to ensure the registrant is not an automated registration bot.

At step 158, the system back-checks the user's email address from the database to ensure that it is not already registered.

If the user account does not yet exist, it is added into the system at step 166.

The system requires full confirmation before enabling the account. At step 168, the system sends an automated email message to the email address recipient provided in the registration form. After receiving the automated email message, the recipient clicks on the link provided in the body of the message to confirm his registration.

At step 172, if the message is not responded to in 24 hours, the account is saved and stored, but not enabled. It remains suspended until the user tries again and confirms.

If the user already has a user account, he simply signs into the system by typing in his Login and Password in the prompts provided for this purpose at step 162.

If the new user is trying to register with an email account that already exists, at step 160 he is immediately informed that an account with the same email address already exists as soon as he types it into the prompt provided for this purpose. He is prompted to Sign-in with his password. He can request a new password if he forgets it.

After the user receives his confirmation email at step 168, the user clicks on the link provided in the message body of the email message to confirm his registration at step 170.

At step 172, the user is transferred to his appropriate dashboard interface where he receives a notification that his account has been successfully registered and confirmed.

If the user registered as an individual, at step 174 he is sent to a specially designed dashboard for this purpose.

If the user registered as the Organizer to an Organization, at step 176 he is sent to a specially designed dashboard for this purpose. The workflow of FIG. 8 is exemplary only.

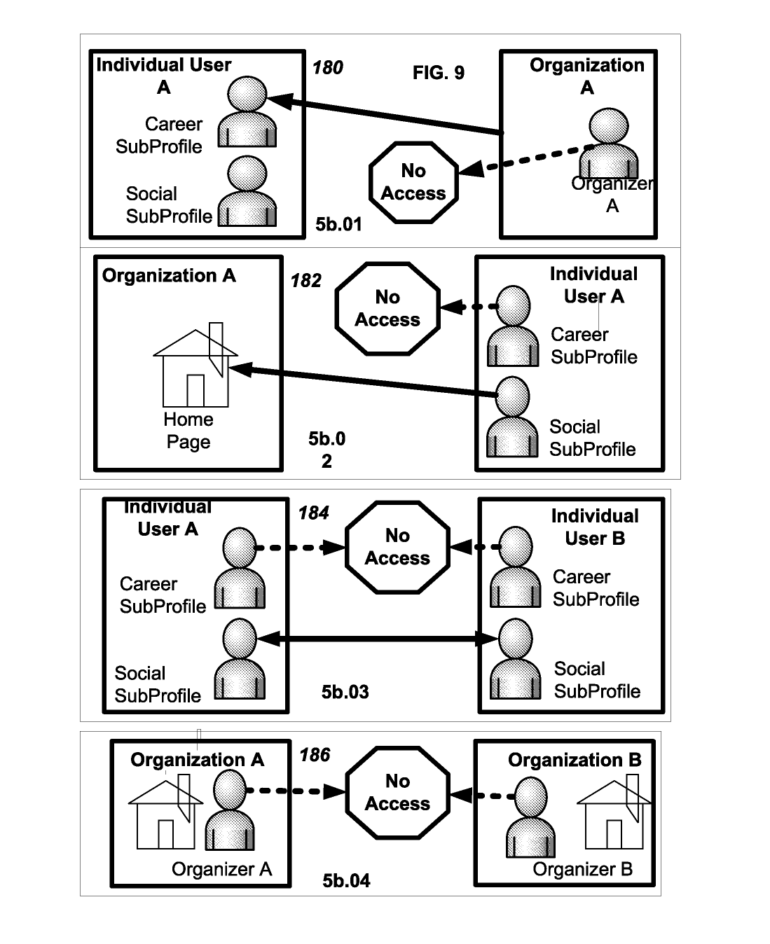

FIG. 9 depicts a method of predefined access rules that establishes lines of communication among various user types and subprofiles. A method of predefined access rules that establishes lines of communication among various user types and subprofiles. This policy method remedies the following shortcomings that pervade “open” Social Networks: (1) an employee's decision to leave his current employer for a new Employment opportunity elsewhere is a confidential decision and the activity thereof requires the utmost discretion; (2) “Open” Social Networks are not conducive platforms for maintaining or establishing discretion; (3) Nonetheless, Candidates not looking for new Employment are open targets, pestered by unwanted solicitations from recruiters and salespeople. One strategy for remedying these shortcomings is to develop a new Social Recruiting platform, a platform that combines Social Networking with smart Virtual Recruiting applications. To facilitate this strategy, individual user accounts are broken down into subprofiles. Each subprofile carries its own set of attributes and access rules. The access rules are based on the objectives of that subprofile. This strategy differs from open social network user accounts that implement uni-dimensional access policies that is a major tenet (Open); users conduct all their activities under the same umbrella of rules and policies that may ultimately conflict with each other, as is the shortcomings mentioned above. The ability to access and/or view other user profiles is determined by the rules of this User Interaction Policy.

There are two user types in Cuzie: Individuals and Organizations. Each user type and underlying subprofile carries its own default set of attributes, access policies and permissions. An Individual, user profile is composed of two core subprofiles: Social Profile and Career Profile. The first profile, a user's Social Profile, carries its own unique attributes and access policies for the purpose of existing and communicating within a defined Social Networking environment called CuzieConnect. The second profile, a user's Career Profile, carries other unique attributes and access policies for the purpose of pursuing Career advancement or new employment opportunities. An Organizational profile (Organization account) is a self contained organizational domain that carries its own unique attributes for the purpose of recruiting new employees and communicating internally with other employees. The Organization Account is managed by an Organizer. Organizers control: membership—addition and removal of employee users in the organizational domain; roles—the assignment of roles granted to users in the organization; permissions—the assignment of permissions to specific roles; and application management—the management of features within applications that the Organization are privy to use.

FIG. 9 illustrates the communicational lines between individuals (Career and Social subprofiles) and organizations (Organizers and organization's home page). With individuals, the user can toggle back and forth the between his Social Profile and Career Profile very quickly by simply clicking on the <Social Profile> or <Career Profile> tabs. The interface changes as he toggles back and forth for the purpose of the profile he selects.

At step 180, Organizers can access an Individual's Career Profile during the Candidate Search process. After a CSO search result is rendered, an Organizer can browse through many Candidate Career Profiles. Organizers cannot view the Social Profile of users. CuzieConnect is a self contained domain for the use of individual user accounts only. This keeps recruiters from soliciting users in a platform relegated to social use.

At step 182, Individual users, navigating through CuzieConnect, after having selected his Social profile can view an Organization's Home Page. Social profiles carry attributes specifically for the purpose of existing and communicating within the CuzieConnect domain. A user in his Career Profile cannot view the Organization's Home Page. The Home Page of an organization is only visible in the CuzieConnect domain, which a Career profile cannot access. Individuals can only access the CuzieConnect domain through the Social Profile created for social purposes. Career profiles include tools related to Career advancement and new employment search.

At step 184, Individual users cannot access each other's Career Profiles. However, individuals can access each other's Social Profiles. Obviously, this is the social networking domain, users can connect with users through their Social Profiles in CuzieConnect. Certain basic information in an individual's Career profile is displayed over to their Social profile, like their Job Title and current employer. To protect users from being solicited by organizations posing as individuals in CuzieConnect, we are providing a “flagging” system for users to flag users abusing Cuzie's Non-Solicitation policy that all users should abide by. Any type of solicitation for the purposes of recruiting should be conducted using Cuzie recruiting applications.

At step 186, Organizations cannot communicate with each other. Organizations cannot view each other's Home Pages. Since organizations cannot operate in CuzieConnect, they can't view each other the way individuals can communicate with each other socially. The methods of FIG. 9 are exemplary only.

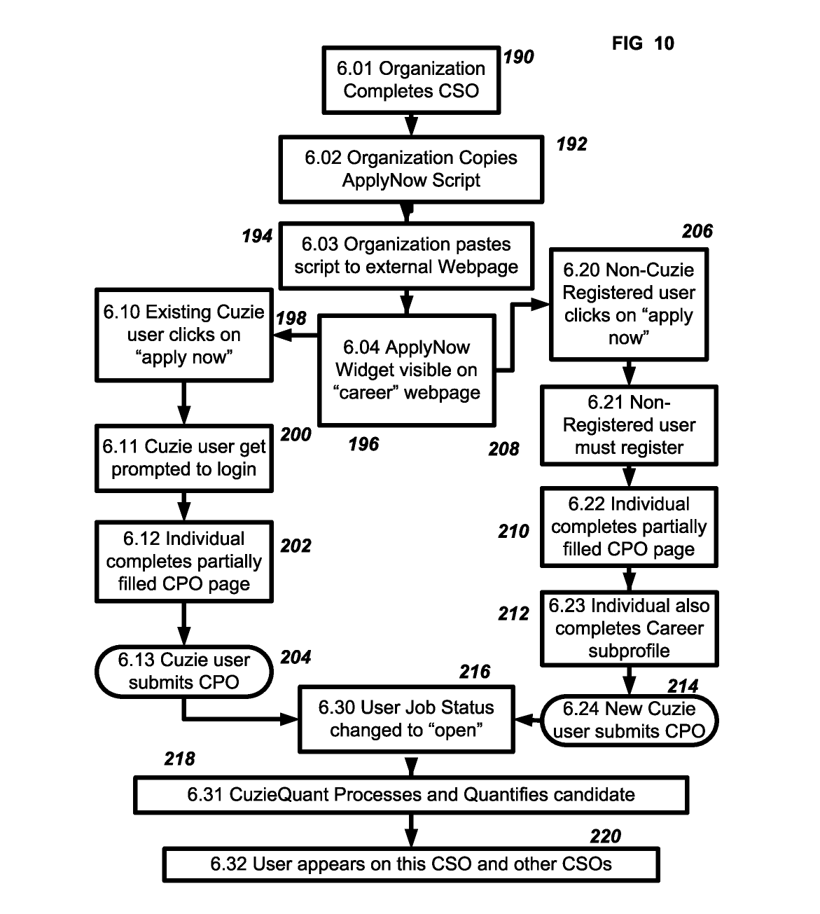

FIG. 10 depicts a method for displaying job openings (CSOs) that were generated and submitted in Cuzie, can be displayed on external websites enabling Job Seekers to apply (register and submit a CPO) directly to the job listing. This offloads career management from the external website to Cuzie, which allows Organizers to centrally manage the applicants within Cuzie. This method streamlines logistical issues for Employers that have an existing Career Website for advertising available Job positions and accelerates the process for having Candidates apply to specific Job postings and register with Cuzie quickly. For Employers—This application allows the Employer to maintain its existing career website and still benefit from using Cuzie's recruiting services by being able to advertise available positions submitted in Cuzie to display on its existing Career website. Subsequently, this offloads the recruiting aspect from the external website to Cuzie and allows the Employer to manage applicants centrally on Cuzie; while keeping Job Availabilities in sync between the external website and job listings submitted in Cuzie. For Candidates—This application decreases the number of steps a Candidate conducts on his computer to apply to a job listing on an external website. The Candidate no longer has to manually type in Cuzie.com and toggle back and forth from the job listing to Cuzie to complete the CPO as well as the registration process. For Marketing—this extends marketing efforts to customer's websites, and still provides them utility at the same time. The script is designed so that the Candidate is applying directly to the job listing; the system pre-fills relevant Job Role fields in the underlying form based on the requirements set in the originating CSO; this ensures that the Candidate is matched to this particular position at least accurately. This helps the Employer, knowing full well Candidates that are applying to the listing, fall in the CSO search results for this specific listing, are tallied in statistics and can be managed on Cuzie. After an Employer completes a Candidate Search Order, Cuzie provides a programming script that can be copied and pasted into the HTML code of an external web page.

FIG. 10 diagram illustrates the specifications of the steps and processes involved in the operation of the ApplyNow application. At step 190, the Employer can search and hire new employees in Cuzie by submitting a CSO (Candidate Search Order). The CSO is a form that requests information about the available Employment position. All the questions that we request and the way that we ask it is specifically designed to get the most relevant information so that we can match up the most qualified Candidates by matching up the most relevant criteria within CPOs to an Employer CSO.

After the CSO has been completed and submitted into Cuzie at step 190, Cuzie provides the Employer an advanced option at step 192 to post the available Job listing related to a specific CSO on an external website. By clicking on <generate script for external listing> provided for this purpose, we provide the Organizer a snippet of software code that can be copied and pasted into an HTML page. The script is automatically generated with certain required fields pre-filled to ensure that submissions to this Job listing are matched accurately to the underlying originating CSO. Existing Cuzie users go through the process quickly; new users need to propagate their entire profile before the CPO can be submitted into the system to match up properly.

At step 194, the Organizer copies the script into his computer's memory cache and goes to the HTML page where the script can be pasted into an appropriate section of an external website.

At step 196 when the script renders on the HTML page in a browser, the browser displays the Job Role, preview of basic requirements that can be expanded and <ApplyNow> that brings the user to the registration form at the Cuzie web site.

A Job Seeker already registered with Cuzie can apply to the job listing by clicking on the <Apply Now> button at step 198. After clicking on the <Apply Now> button, the Candidate is prompted to sign-in or register at step 200. After signing in with his credentials, the Candidate is brought to his dashboard. At his dashboard, he is brought to a new CPO form where he needs to complete all the remaining empty fields in the CPO at step 202. After completing the remaining fields in the CPO at step 202, the Candidate should submit the CPO into the system at step 204. The candidate can save it, review it and submit it later; the Candidate submits it immediately by clicking on the <Submit> button.

A Job Seeker not registered with Cuzie can apply to the job listing by clicking on the <Apply Now> button at step 206. After clicking on the <Apply Now> button at step 206, the user is prompted to sign-in or register at step 208. The unregistered user should choose <Register>. The Candidate is then brought to Cuzie, where he begins the entire registration process and fills out his Career Profile before he can apply to the listed position. Even if the user just provides Cuzie with his basic registration information and does not ultimately complete his profile and submit a CPO, Cuzie can market to the user later and urge him to do so. Usually, a new user seeking a new Employment position or Career advancement would fill out his basic profile and then his career profile before getting to the CPO to submit himself to be matched up for a new job. But since this person came in from the ApplyNow widget, he should first fill out the CPO at step 210 and is later prompted to complete his Career profile, this workflow inverse is a marketing strategy not a logistical approach. Hopefully the user feels he went far enough to go ahead and fill in his profile and not abort altogether. At step 210, the user fills out prompts requesting information related to the Employment position he seeks. All the information the user provides is relevant to the system logic involved with matching Employer demands with the available supply of Candidates. By default, the system does not include the Candidate into any Employer CSO search results until the user explicitly executes the command to submit the Career Pursuit Order into the system. The user can take the time to edit his CPO before ultimately submitting it. After completing his basic profile, the user should then complete his Career Profile by filling in all the required the fields in the Career Profile form at step 212. The Candidate fills out prompts requesting details about his work experience and education. Along the way, the user also sees that there are proprietary features that also needs to be filled out in his profile such as Respects and Referrals, features all designed to improve his chances in the recruiting process. The user realizes that the entire registration process is not a quick one, but the magnitude of why he is here becomes immediately obvious. Once the Candidate submits the CPO at step 214, the system processes his CPO and makes it eligible to be searched; not only is the Candidate matched up against the originating CSO that generated the Job listing that brought him to Cuzie, but also enjoys the added benefit of being eligible to be matched up against all Candidate Search Orders that are relevant to him in the entire Cuzie system.

As soon as the user submits a CPO at step 204 or 214, the user's Job Status automatically changes to <Open> at step 216. The user is prompted and informed of this change; he then has the option of setting his Job Status to <Looking> allowing all interested parties to view his profile without requesting his approval to view beforehand.

At step 218, CuzieQuant takes over. The system utilizes a method to evaluate the Candidate's qualifications against others. Essentially, the method quantifies object criteria in the Candidate's work history, education and other proprietary features and uses these values in formulas to render a numerical implied score about the Candidate. This implied score is compared against other Candidates vying for similar Job Roles. Candidates who are included in Candidate Search Orders are sorted by these Implied Scores, essentially ranking relevant Candidates from top to bottom. The implication being, the higher the score the more loyal an employee was at previous employment tenures, was deemed in high regard by many professional and social acquaintances and attended better ranked schools. There are other components that are factored into rendering an implied score, and many proprietary features are dynamic, providing a Candidate the opportunity to raise his implied score and possibly his overall ranking in search results.

After submitting the CPO, the Candidate appears in the search results of the underlying CSO that created the Job Listing that brought the user to Cuzie in step 220; the users also enjoy the added benefit of being matched up against all other CSOs running within Cuzie. The process of FIG. 10 is exemplary only.

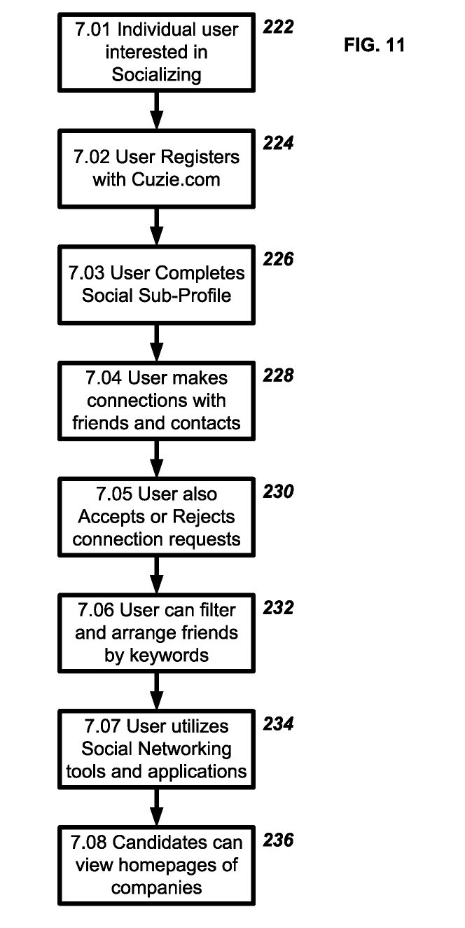

FIG. 11 depicts a diagram that illustrates an example of the workflow, operations and Social Networking features of CuzieConnect. The basic social networking features that allow individual users to connect and communicate with other friends registered with the system based on common interests will be provided such that comments, messages, photos, videos and other media are shared between connected users. At step 222, an individual can register with Cuzie for the sole objective of utilizing Social Networking features. At step 224 the individual needs to register with Cuzie in order to utilize any of its services. After registering, the Social Networking features are accessed through the user's Social SubProfile. An individual user has two subprofiles, the Social and Career SubProfile. For the purposes of this diagram, the Social subprofile is described herein.

At step 226, the user can make the most of the features provided to him by completing his Social SubProfile. There can be a section in the Social SubProfile for Basic Information such as the following: (a) Name; (b) Phone; (c) Personal Email addresses (which is propagated from Registration); (d) Position/Title (which is propagated from Career Profile if filled out); (e) High School; (f) College (which is propagated from Career Profile if filled out); (g) Sex; (h) Birthday; (i) About Me. There can also be a section in the Social SubProfile for Interests such as the following: (a) Television; (b) Movies; (c) Books; (d) Music; (e) Sports; (f) Hobbies; (g) Politics; (h) Heroes; (i) Favorite Quotes.

At step 228, the user can connect with friends and other users should be registered with Cuzie. Cuzie provides ancillary tools that enable the user to pull in address books from external sources like Yahoo, Gmail, Outlook and the like. Once the user has consolidated his contacts into Cuzie, he can then invite friends to also register and connect with him on Cuzie. This is one of many other viral mechanisms designed to get users to continually invite friends and colleagues to register with Cuzie.

As the user starts inviting friends to connect with him at step 228, the user can also receive requests to connect with other friends and users. Every user has the ability to accept or reject these connection requests as step 230 illustrates.

At step 232, the Social user is provided the ability to create interest groups, the ability to filter, sort and group his friends based on interests and keywords in their Social Profiles, where he can then group them together for future reference. For example, the user may want to group all his friends together who have an interest in Golf, so he would set up a filter to find everyone interested in Golf, once all the individuals are collected, the user could save this group as the “Golf Group.”

At step 234, the user can use social networking tools and applications provided in CuzieConnect, such as the following: (a) Photo application where the user can upload photos; (b) Video application where the user can upload videos; (c) Blogging application where the user can publish blogs; (d) Messaging application where user send messages to only to Cuzie users; (e) Commenting features where user can post comments; (f) Calendar application for scheduling events, Business events not viewable. The system can intelligently sort Social vs Business events based on which subprofile the event was created or by the user explicitly selecting its event type.

At step 236, Candidates can view homepages of companies. Organizations can appear in CuzieConnect with a very simple home page view. The most basic information propagates from the Organization's Org profile. Organizations may not have any Social Networking access, only individuals registered as CuzieConnect users may have this access. Cuzie can reprimand users who try to solicit other users in any way within the CuzieConnect domain that is not a Social activity. All individuals should register with their personal email accounts, and are considered no longer representing an organization or company, business or entity that employs them. The process of FIG. 11 is exemplary only.

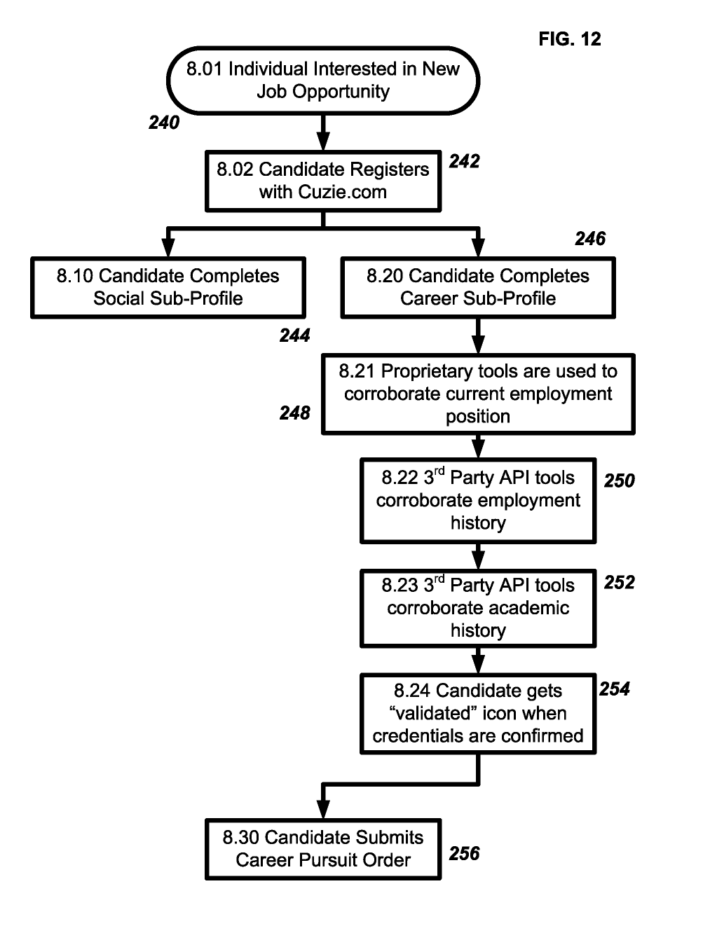

FIG. 12 depicts a diagram of one method of the CuzieValidator. The CuzieValidator is a software application for validating a person's identity and registration information and, thereafter, a special icon is displayed next to the person's name listed in a Candidate search result to indicate validation. At step 240, an individual is interested in a new job opportunity. At step 242, the individual (or candidate) registers with Cuzie.com. At step 244, the candidate completes his Social SubProfile. At step 246 the candidate completes his Career SubProfile. At step 248, tools are used to corroborate the candidate's current employment position. At step 250, third party API tools corroborate the candidate's employment history. At step 252, third party API tools corroborate the candidate's academic history. At step 254, the candidate gets a “validated” icon that appears next to his profile listing in CSO search results, once the candidate's credential's are confirmed. At step 256, the candidate submits a Career Pursuit Order (“CPO”). The process of FIG. 12 is exemplary only.

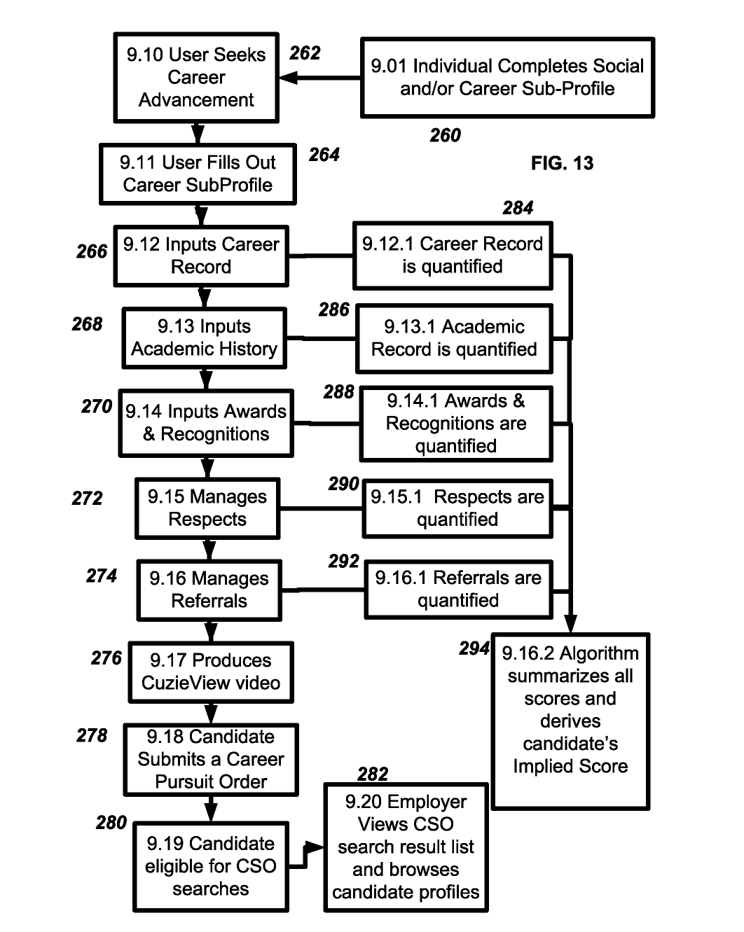

FIG. 13 depicts a diagram that illustrates a potential method where CuzieQuant quantifications and processes that take place in the overall workflow in the completion of a Candidate's profile. After the Candidate registers, he should continue on filling in more information to complete his profile at step 260. The user can complete either his Social SubProfile or Career SubProfile first. If the Candidate wants to advance his career or seek new employment opportunities, he should complete his Career Profile at step 262. To do so, the user clicks on the link provided to complete the profile in his dashboard. After clicking on the link provided that takes him to his Career Profile, the user fills out the Career SubProfile at step 264. The user should complete all the required fields in each profile section before he submits a CPO, if he wants the best chance of getting matched up for available job opportunities. At step 266, the Candidate should fill out his Career record. This Career record is a granular online resume that breaks down all its various parts so that it can be recorded in greater detail in the system, such as: (a) Start and End date at each job; (b) Company name at each job; (c) Job title at each job; and (d) Career description. After completing this section, the user clicks on <Save> to record all changes. The user can go back and edit this section later by clicking <Edit Career Record> provided for this purpose. After the Candidate fills out his Career Record at step 266, all the particular inputs that were saved are processed are quantified by CuzieQuant at step 284.

The Candidate then fills out his Academic Record at step 268. At step 268, the Candidate fills in details of his education, such as: (a) Degree Level; (b) Fields of Study; (c) Cumulative GPA; (d) Year Degree Achieved; (e) Activities and Societies; and (f) Notes (for adding comments about anything that may require clarification to the reader). After completing this section, the user clicks on <Save> to record all changes. The user can go back and edit this section later by clicking on <Edit Academic Record>. After the Candidate fills out his Academic Record, all the particular inputs that were saved are processed and quantified by CuzieQuant at step 286.

Candidate fills out his this section with any Awards & Recognitions he has ever received at step 270. The Candidate provides the following details of each Award: (a) Year award was received; (b) Name of the award; (c) Name of the authority that gave the award; (d) Type of award; (e) Description of the award or recognition; (f) Link to the award, or any media coverage of it; and (g) Any image related to the award. After completing this section, the user should click on <Save> to record all changes. The user can go back and edit this section later by clicking on <Edit Awards & Recognitions>. After the Candidate fills out his Awards & Recognitions, all the particular inputs that were saved are processed and quantified by CuzieQuant at step 288.

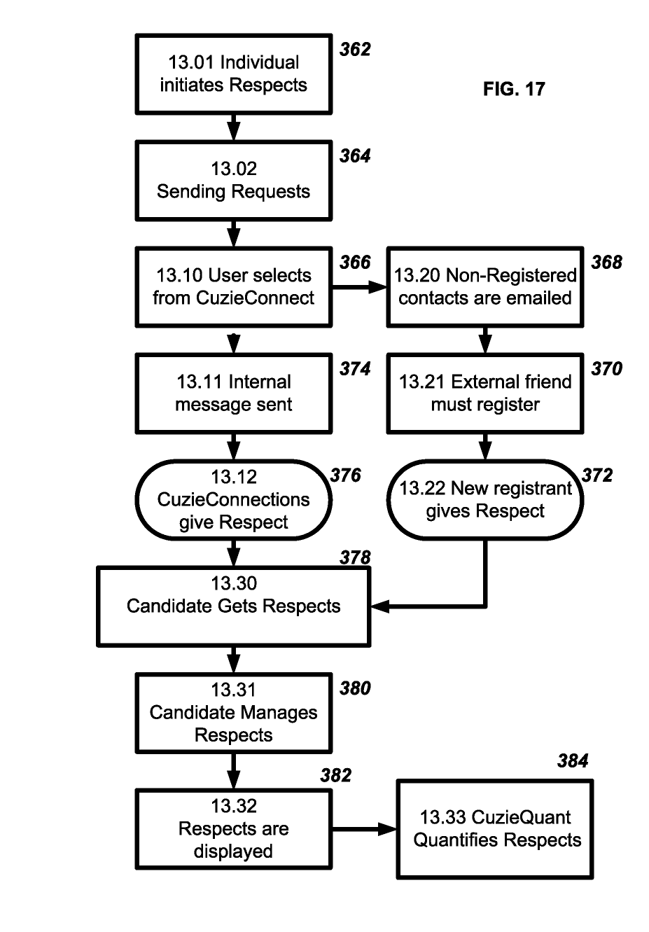

At step 272, the Candidate manages his Respects. The User can: (a) Request for Respects from (1) registered Cuzie users, or (2) non-registered Cuzie users by email; (b) Give out Respects voluntarily; (c) Give out Respects by Responding to requests; or (d) Give out Respects by reciprocating an unsolicited Respect left for him. In the management section at step 272, the user has the discretion to delete respects he does not want displayed and also block users who continually post Respects that are not favorable to the user. The user cannot edit respects. The user should then click <Save> to record all changes. The user can go back and edit these again by click on <Manage Respects>. See FIG. 17, for diagram that illustrates a potential method for Respects. After the Candidate completes the management of his Respects at step 272, the summary of his Respects is processed and quantified by CuzieQuant at step 290.

At step 274, the Candidate manages his Referrals. Referrals can be given in long form text or video. The user can manage Referrals through such means as the following actions: (a) Request for Referral from (1) registered Cuzie users, or (2) non-registered Cuzie users by email; (b) Give out Referrals voluntarily; (c) Give out Referrals by Responding to requests; or (d) Give out Referrals by reciprocating an unsolicited Referrals left for him. In the management section at step 274, the user has the discretion to delete Referrals he does not want displayed and also block users who continually post Referrals that are not favorable to the user. The user cannot edit Referrals. The user should then click <Save> to record all changes. The user can go back and edit these again by click on <Manage Referrals>. After the Candidate completes the management of his Referrals at step 274, the summary of his Referrals is processed and quantified by CuzieQuant at step 292.

At step 294, CuzieQuant summarizes all the quantifications and calculates an Implied Score for the Candidate. Candidate and Employer are not privy to this numerical score. The Candidate's Implied Score is used internally for sorting and ranking in CuzieMatch and is not displayed.

At step 276, the Candidate manages his CuzieView videos. The Candidate can submit CuzieView videos by: (a) Recording a video from his webcam using controls set in CuzieView; or (b) Upload a video from disk using the <Browse> and <Upload> controls. The user cannot link a video from an outside source like YouTube because these videos are deemed confidential. Linking such outside source videos promotes the use of open video systems and undermines the confidentiality of these videos. There can be a space limitation for CuzieViews, which can equate to about a 45-60 seconds time span for a video. The user can manage each CuzieView independently. The Candidate can manage his CuzieView videos by clicking on <Manage CuzieView>. The user can conduct the following actions in managing his CuzieView: (a) Record a new video from his webcam using controls set in CuzieView; (b) Upload a new video from disk using browse and upload controls; (c) Delete a video using the online controls. The user can create and save a predetermined number, for example 5 (five), CuzieViews altogether. However, he can only select one video to be displayed per CPO.

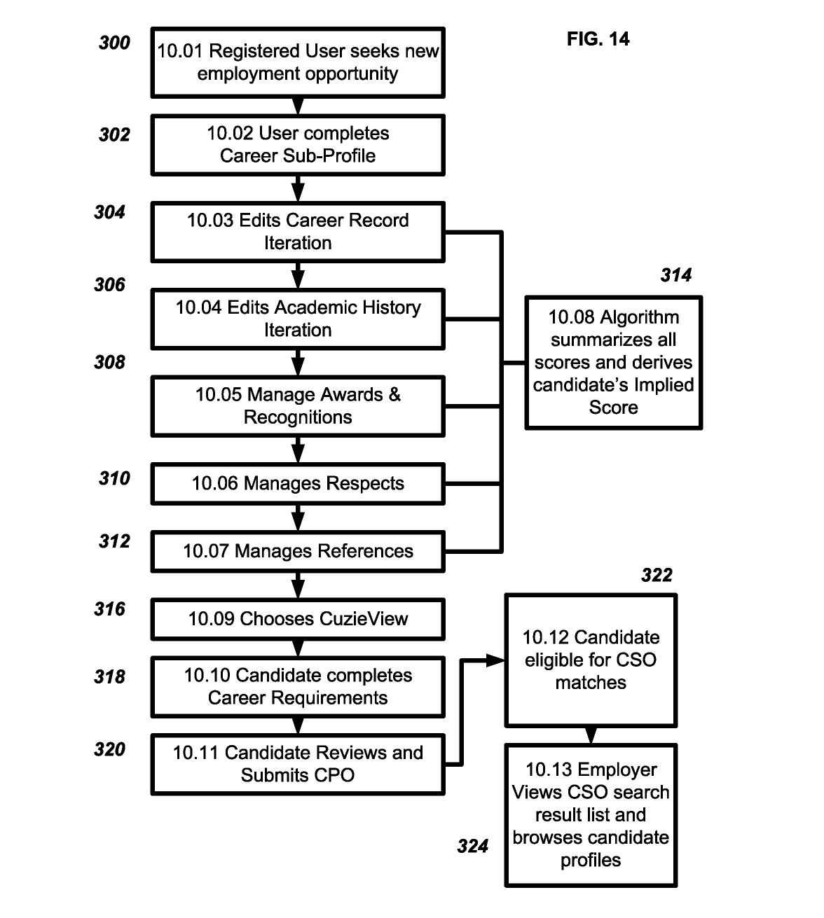

After the Candidate has completed filling out all the features in his Career profile, he can then submit a Career Pursuit Order (“CPO”) at step 278. The Career Pursuit Order is a collection of selected iterations and particular edited versions of items that make up his Career profile such as his Career Record, Academic Record, Awards & Recognitions, Respects, Referrals and CuzieView relevant to a particular Job Role cited therein. Cuzie provides the user the ability to pursue multiple CPOs at once, and each one could be entirely different from the others. A lawyer may still have that dream job of being a Chef, and this could be his way of secretly pursuing that dream. In each CPO, the user has the ability to customize profile features and save a uniquely edited iteration so that it becomes relevant to a particular Job Role cited therein. A video created for Accounting does not play well for Chef positions. See FIG. 14 for or diagram that illustrates a potential method for Career Pursuit Order.

Once the Candidate has completely filled out his Career Profile, and submits his CPO he is eligible to be matched up against Employer CSO searches at step 280. At step 282, all eligible Candidates appear in search results where an Employer's CSO matches up to the Candidate's CPO. The Employer browses the list of available Candidate rendered by CuzieMatch.

FIG. 14 illustrates a diagram of the steps and processes involved with how a Job Seeker initiates edits and submits a CPO. A CPO is an interactive form that Candidates complete in order to get matched up to open job positions. CPOs create an easy way to capture all the requirements a Candidate demands in a new employment opportunity. A Candidate fills out a CPO and provides very comprehensive information about demands in a new employment opportunity. A CPO serves as the instrument that determines whether a Candidate is a good match for an employment opportunity. Matches between the CPO and CSO help identify qualified Candidates for an open position. The processes of FIG. 14 are exemplary only.

Users should be registered with Cuzie to have access to its features and applications. Once a user is registered he can pursue a new employment opportunity by completing the Cuzie Candidate Pursuit Order form in step 300. This form is located in the user account Career Profile. At step 302, the user should complete his Career Profile by filling out all the required fields in the form. If the Candidate chooses to complete a CPO before he has completed his Career Profile, he is prompted to complete his Career Profile. There is a percentage counter that displays the user's progress in completing his Career Profile. It is to the user's advantage to fully complete his Career Profile by providing all relevant information that is requested of the user.

At step 304, the user completes or edits his Master Career Record. The Master Career Record serves as the default Career Record for all CPOs if no other iterations exist. The user can create multiple Career Record iterations. Each Career Record iteration can be assigned to different CPOs or multiple CPOs. The user can create and submit multiple CPOs; see step 320 below. If the user already has a Master Career Record saved, he has the ability to edit his Master Career Record and save an additional iteration of it for the purpose of assigning it to a different CPO. By creating an additional Career Record iteration, the user can mold the Career Record by omitting irrelevant information or including additional information in making the record more favorable to Job Role requirements in a particular CPO.

At step 306, the user completes or edits his Master Academic Record. The Master Academic Record serves as the default Academic Record for all CPOs if no other iterations exist. The user can create multiple Academic Career Record iterations. Each Academic Record iteration is assigned to different CPOs or multiple CPOs. User can create and submit multiple CPOs; see step 320 below. If the user already has a Master Academic Record saved, he has the ability to edit his Master Academic Record and save an additional iteration of it for the purpose of assigning it to a different CPO. By creating an additional Academic Record iteration, the user can mold the Academic Record by omitting irrelevant information or including additional information in making the record more favorable to Job Role requirements in a particular CPO. Regarding Academics, most of the iteration editing takes place in the Licenses and Certifications section.

At step 308, the user completes or edits his Master Awards & Recognitions record. The Master Awards & Recognitions record serves as the default Awards & Recognitions record for all CPOs if no other iterations exist. The user can create multiple Awards & Recognitions record iterations. Each Awards & Recognitions iteration is assigned to different CPOs or multiple CPOs. The user can create and submit multiple CPOs; see step 320 below. If the user already has a Master Awards & Recognitions record saved, he has the ability to edit his Master Awards & Recognitions record and save an additional iteration of it for the purpose of assigning it to a different CPO. By creating an additional Awards & Recognitions record iteration, the user can mold the Awards & Recognitions record by omitting irrelevant information or including additional information in making the record more favorable to Job Role requirements in a particular CPO.

At step 310, the user has the ability to manage his overall Respects record. However, unlike the Career, Academic or Awards & Recognitions records, he may not be able to edit or create an entire Respects record iteration. The entire Respects record as a whole is the default record assigned to every CPO. The user can manage the Respects record by: (a) Keeping particular Respect items; (b) Deleting particular Respect items; (c) Blocking specific users; (d) Users can not edit a particular Respect item. The user should obtain as many Respects as possible. The number of Respects that the user receives contributes to the CuzieQuant component that places a value for Respects in the calculation of the user's Implied Score. Increasing this Respect value may increase his overall Implied Score, thus, possibly raising his search ranking.

At step 312, the user has the ability to manage his overall Referrals record. However, unlike the Career, Academic or Awards & Recognitions records, he is not able to edit or create an entire Referrals record iteration. The entire Referrals record as a whole is the default record assigned to every CPO. The user can manage the Referrals record by: (a) Keeping particular Referrals items; (b) Deleting particular Referrals items; (c) Blocking specific users; (d) Users can not edit a particular Referrals item. The user should obtain as many quality Referrals as possible. The number of Referrals that the user receives contributes to the CuzieQuant component that places a value for Referrals in the calculation of the user's Implied Score. Increasing this Referrals value may increase his overall Implied Score, thus, possibly raising his search ranking.

Every time the user updates his Career Profile section, CuzieQuant makes an update to its calculations for that section in step 314. CuzieQuant summarizes each sectional value and derives a user's overall Implied Score. When a user submits a CPO, his Implied Score is carried with him into the CuzieMatch process where he is ranked against other Candidates vying for similar Job Roles.

At step 316, the user can store up to a predetermined number, for example Five (5), CuzieView videos by default. At step 316, the user selects one to serve as the default video in his Career Profile for that section. Allowing certain number, such as 5 CuzieView videos is determined because the Candidate can submit up to the same number, such as five (5) CPOs. Cuzie provides the user the ability to produce a unique video for each possibly unique CPO.

After completing the Career Profile sections, the Candidate initiates the CPO process at step 318. In his dashboard, the user initiates this process by clicking on <My Career Pursuits> tab and then clicking on <Create a Career Pursuit Order>.

At step 318, the candidate selects the Job Requirement Criteria: (a) Choose Career Type (one or more): (1) Full Time (W2); (2) Part Time (W2); (3) Contract (C2C or 1099); (4) Internship; or (5) Temporary. (b) The candidate also types in his single Career Role (Job Role) of choice in the field provided, “autosuggest” offers suggestions as he types (e.g., Nurse, Baker, etc.). (c) The candidate also chooses a Career Level (choose up to two): (1) Executive Management; (2) Licensed Professional; (3) Senior Management; (4) Management; (5) Experienced; (6) Junior Level; (7) Intern. (d) The Candidate chooses Industry preferences. Cuzie implements its own list (e.g., Healthcare, Food & Beverage, etc.). (e) The candidate types in minimum Annual Salary. (f) The Candidate types in minimum Base Rate per Hour (this form displays if choices other than, only Full Time is selected in the Career Type). The Candidate clicks on <Open to commission-based work> if applicable. (g) The Candidate types in number of Years of Experience. (h) The Candidate types in his relevant Skills and “autosuggest” offers suggestions to be selected as the user types. (i) The Candidate types in My Summary, a description of what he feels summarizes his work experience related to this CPO. There can be a character limit, such as 800 characters in My Summary. (j) The Candidate chooses how many miles he prefers to work from home or a future location, and then chooses country, City and zip code of his residence. (k) The Candidate answers “Yes” or “No,” to whether he is willing to travel.

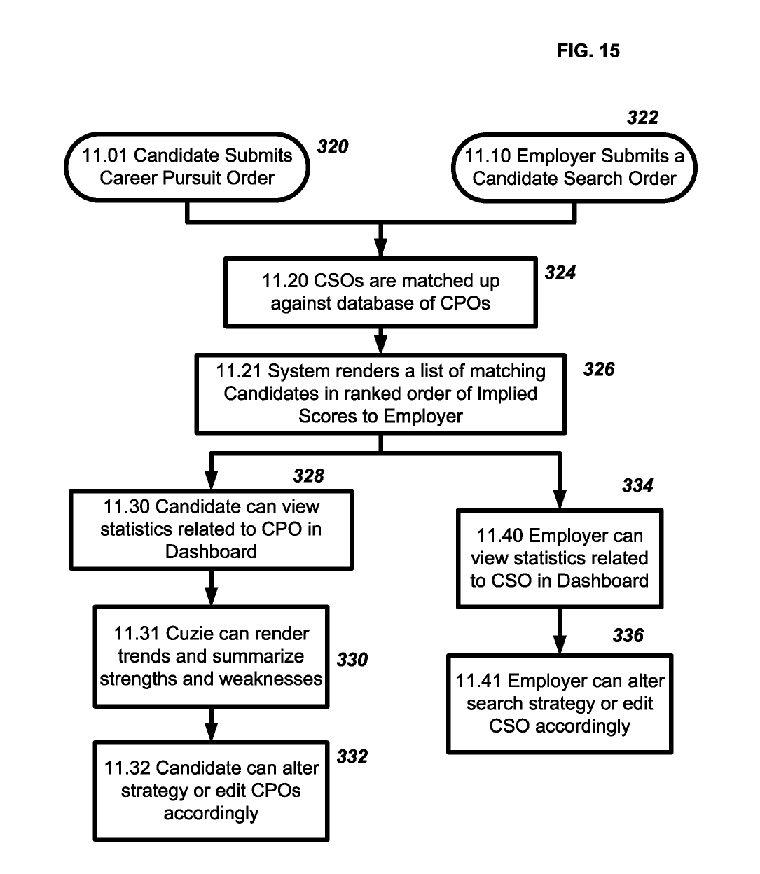

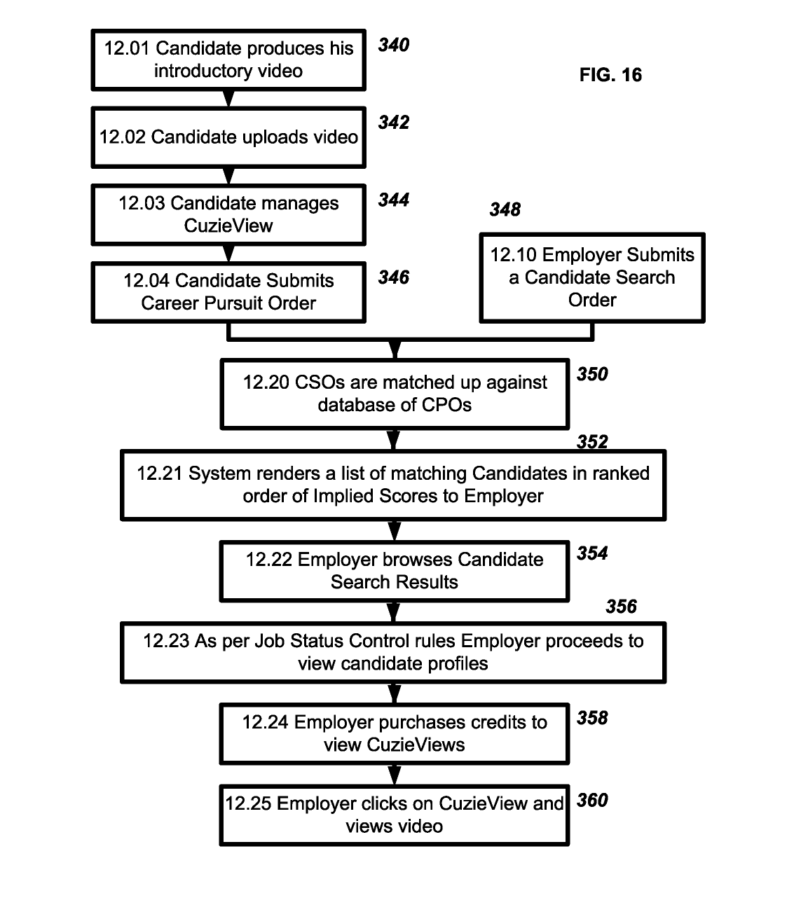

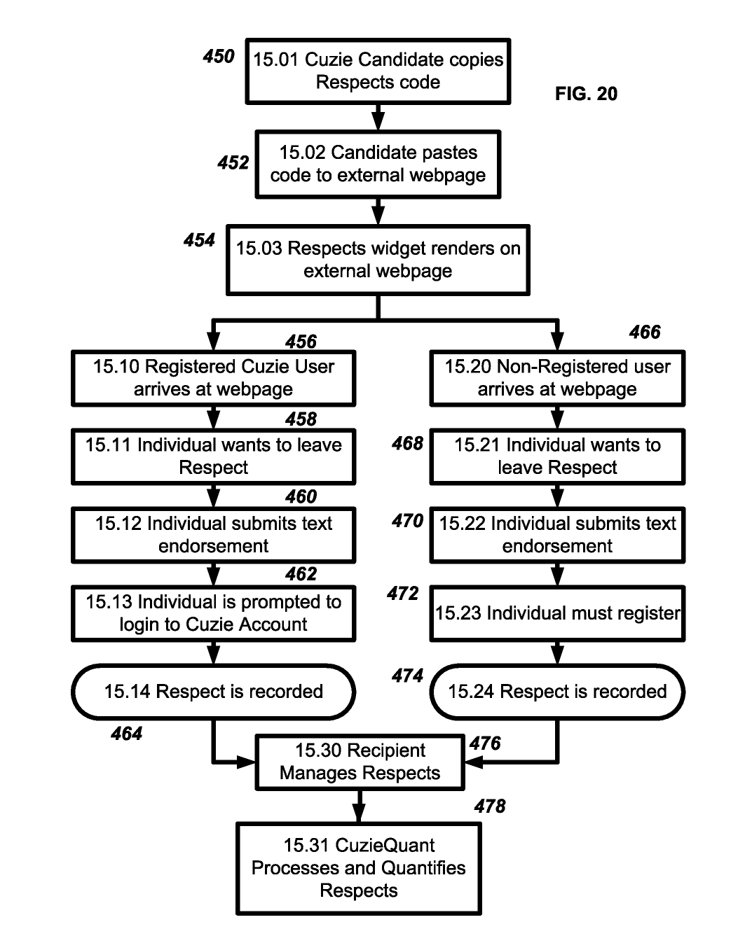

At step 318, the user can select which Profile Elements (Profile section iterations) are to be displayed to prospective Employers. (a) The user selects Career Record items to be displayed or omitted by clicking or unclicking the provided check boxes: (1) by default all specific Job Items are selected; (2) the user can uncheck items he prefers not to display for this CPO; (3) the user can edit a selected item, in order to rephrase it making it more relevant to the Job Role for this CPO; (4) see step 304. (b) The user can select Academic Record items to be displayed or omitted by clicking or unclicking the provided check boxes: (1) by default all specific School instances are selected; (2) the user can uncheck items he prefers not to display for this CPO; (3) the user can edit a selected item, in order to rephrase it making it more relevant to the Job Role for this CPO; (4) see step 306. (c) The user selects Awards & Recognitions items to be displayed or omitted by clicking or unclicking the provided check boxes: (1) by default all specific Award & Recognition instances are selected; (2) the user can uncheck items he prefers not to display for this CPO; (3) the user can edit a selected item, in order to rephrase it making it more relevant to the Job Role for this CPO; (4) see step 308. (d) The user selects Referrals items to be displayed or omitted by clicking or unclicking the provided check boxes: (1) by default all specific Referral videos or letters are selected; (2) the user can uncheck items he prefers not to display for this CPO; (3) the user can not edit any Referral items; (4) see 312 and FIG. 20. (e) The user selects Respects items to be displayed or omitted by clicking or unclicking the provided check boxes: (1) by default all specific Respects endorsements are selected; (2) the user can uncheck items he prefers not to display for this CPO; (3) the user can not edit any Respects items; (4) see step 310 and FIG. 16. (f) The user selects CuzieView video to be displayed by clicking the provided check box: (1) by default latest CuzieView video are selected; (2) the user should return to CuzieView section of profile to manage videos; (3) see step 316 and FIG. 15.

At step 320, the user Reviews Summary of all his selections and information provided and then submits a CPO. (a) The user can go back and make edits to items by clicking on the edit link for that particular section where item exists. (b) The user should provide a name for this CPO for his own reference. (c) The user can either: (1) save this search CPO; go back later and continue to edit it, or submit later; or (2) submit this search CPO. The Candidate can manage all his specific CPOs by clicking on <My Career Pursuits> tab in the main navigation. All of the Candidate's CPOs can be displayed in grid form.

Once CPO is submitted, the Candidate is immediately eligible to be matched up against relevant Employer CSO searches in the entire system at step 322. At step 324, the Candidate appears in Employer CSO search results list where he is ranked against every other Candidate competing for the very same Job Role with similar requirements.

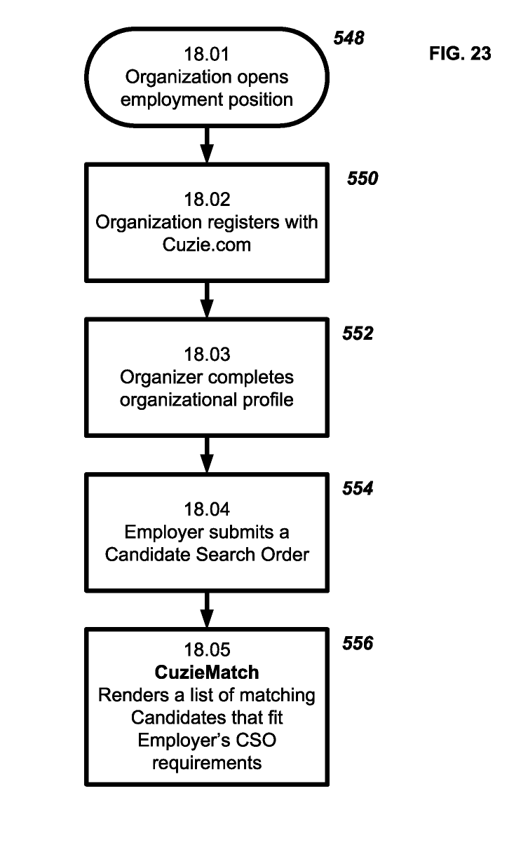

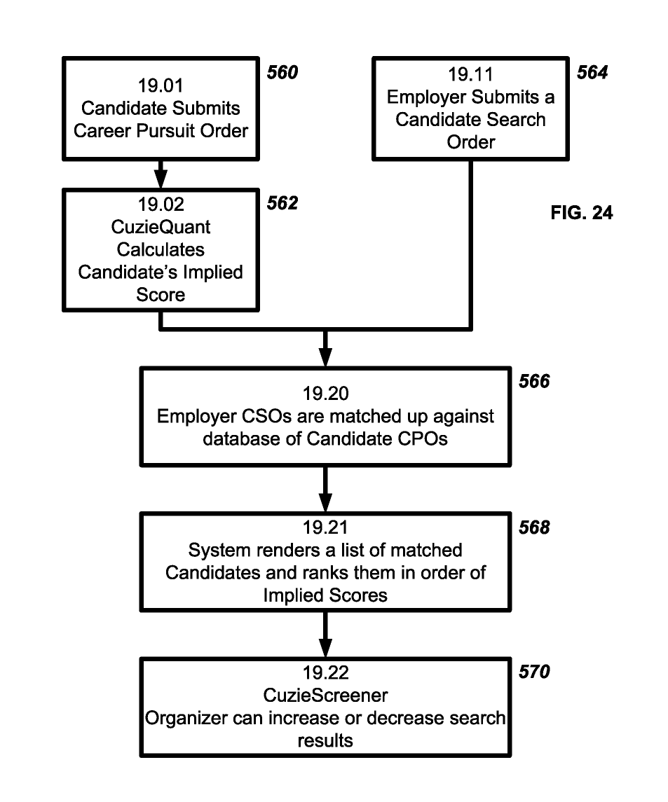

FIG. 15 illustrates a diagram of one method for the steps and processes involved with CuzieAnalytics, how data is recorded, processed and displayed in order to provide Employers and Candidates insight on their active searches in accordance with an embodiment of the present invention. At step 320, a Candidate completes and submits a CPO. See FIG. 14. At step 322, an Employer completes and submits a CSO. See FIG. 23. At step 324, CuzieMatch matches up Employer's CSOs by searching the databases of CPOs. Each match is based on inputs typed-in and selected in the Career Requirements section that exist in parallel in the CSO and CPO forms. See FIG. 24. At step 326, CuzieMatch looks at Job Role, Salary, Career Level and other criteria. CuzieMatch identifies matches among Candidate CPOs with criteria on an Employer's CSO and renders a search results list. A search results list is rendered for each CSO an Employer submits. See FIG. 23. At step 328, the Candidate is provided statistics displayed in his dashboard regarding the number of profile views his CPO attracted. Since the Candidate could submit up to a certain number of CPOs, for example, 5 (five) CPOs; he would at the most 5 (five) unique sets of statistics related to each particular CPO.

At step 330, CuzieAnalytics records and renders statistics for Candidates for various categories, such as the following. (a) CPO Stats: (1) total number of Career Profile views received—(i) total number of Career Record views, (ii) total number of Academic Record views, (iii) total number of Respect views, (iv) total number of CuzieView views (if <Open> Job Status, the number of View Requests); (2) total number of In-Person interview Requests; (3) total number of CuzieLive Requests; (4) total number of Job Offers. (b) About Employers that Viewed Profile: (1) description Summary of the CSOs that matched up; (2) average Size of each company whose CSO matched up; (3) zip code of each company whose CSO matched up; (4) number of CSOs submitted by each company that is cited. (c) Competitive Stats: (1) total number of CSOs submitted related to same Job Role; (2) total number of Candidates competing for similar Job Role; (3) average salary demand of competing Candidates—(i) tier where Candidate falls against competition, (ii) tier based on tenths; (4) average academic degree level of competing Candidates—(i) tier where Candidate falls against competition, (ii) tier based on number of degree levels; (5) median number Years of Experience of competing Candidates—(i) tier where Candidate falls against competition, (ii) tier based on tenths; (6) median number of Respects of competing Candidates (above or below the median by percentage); (7) top 3 Industries, most competing Candidates for same Job Role; (8) top 3 Industries, lowest number of competing Candidates for same Job Role.

At step 332, the Candidate can make his own conclusions about the CuzieAnalytics that is provided to him in the dashboard. He can then adjust his employment pursuit accordingly by either adjusting his employment demands, raising his educational level or getting more endorsements.

At step 334, CuzieAnalytics records and renders statistics related to CSOs for Employers that can be viewed in the Dashboard. For example, Employers can view the Candidate Search Stats: (1) total number of matched, available Candidates—(i) total number of <Open> Candidates, and (ii) total number of <Looking> Candidates; (2) total number Candidates with Graduate Degrees or higher; (3) total number Candidate with Four Year College Degrees or higher; (4) total number Candidates with High School Education or higher; (5) total number of Candidates with five or more years of Work Experience in Job Role; (6) total number of Candidate with ten or more years of Work Experience in Job Role; (7) highest Salary Demand amongst all matched Candidates for Job Role; (8) median Salary Demand amongst all matched Candidates for Job Role; (9) lowest Salary Demand amongst all matched Candidates for Job Role.

At step 336, the Employer can make his own conclusions about the CuzieAnalytics data that is provided to the Organizer in the dashboard. The Organizer can then adjust his Candidate search order filters accordingly by adjusting the requirements in CuzieScreener. The processes of FIG. 15 are exemplary only.

FIG. 16 illustrates a diagram of one method of the steps and processes involved with CuzieView videos, and how CuzieViews are produced, uploaded and displayed.

At step 340, the Candidate produces his introductory video. There are a number of ways a Candidate can produce a video that complies with CuzieView rules: (a) user can produce a well edited video using multimedia equipment and saving the video as a digital file onto disk; (b) user can hire a professional producer and be provided a digital file onto disk; (c) the user can also utilize Cuzie software within the website to manage the user's web cam in recording a video, which is saved as a digital file to disk.

Once a video has been produced and is saved to disk, the user should upload the video file to his Career Profile at step 342. The user should be in the CuzieView section of his Career Profile. The user then clicks on <Manage CuzieView>. The user scrolls down to the Upload Video section of the page and completes the following: (a) types in a title for the Video for his own reference in the provided form; (b) clicks on <Browse> and locates the file from his disk; (c) once file is located he selects it; (d) after selecting it, the file is highlighted, and the path to the file is propagated in the location prompt next to <Browse>; (e) the user should click on <Upload> to initiate the transfer of the file from disk to the website—; (f) video can be previewed by clicking on <Play> after transmission has completed; (g) the user should click on <Submit> to save it in his Career Profile. By default, the last video uploaded serves as the video of choice for any CPO where a video selection has not been explicitly set by the user. Candidate may upload multiple videos, but only one serves as the displayed CuzieView for a particular CPO. The Candidate can upload up to one video for each possible CPO, which can be limited to 5 (five) in accordance with an embodiment of the present invention.

At step 344, the Candidate can then manage CuzieViews by clicking on <Manage CuzieViews> provided in that section. The user sees in grid form all his videos. Each video appears in its own row and the user can preview all videos from this page. Each row overlaps columns citing additional information and functions: (a) titles for each video—the name of the title the user gave during upload; (b) assignment to CPOs—the user selects which particular CPO this particular video should display as the CuzieView. All CPOs propagate as choices; (c) delete. From this section, the user can also create a new video using Cuzie by clicking on <Create New CuzieView>: (a) an interface with multimedia controls appears; (b) the multimedia controls manage his connected web cam; (c) the user should see a preview of himself in the preview pane provided in an interface next to the recording controls; (d) Cuzie can provide the user a script to help assist him in what to say; (e) there is also a timer to inform him of the length of his video. As he gets closer to the time limit, he is informed by seeing a countdown; (f) to record, the user clicks on <Record>; (g) as the system is recording, he sees himself in real time in the preview screen; (h) the user can terminate the recording by clicking on <Stop>; (i) the user can review the video by clicking on <Play> provided for this purpose; (j) the video is saved in Cuzie or to his default disk location set in his computer; (k) after reviewing it locally, the user can edit it some more locally and upload the file (see step 342). At step 346, the Candidate submits a CPO. The user assigns a video to a CPO in the Manage CuzieView section or by doing so in the CPO process. See FIG. 14.

At step 348, the Employer submits a CSO (Candidate Search Order). The CSO is a form that requests information about the available Employment position. All the questions that we request and the way that we ask it is specifically designed to get the most relevant information so that we can match up the most qualified Candidates by matching up the most relevant CPOs to an Employer CSO. See FIG. 23.

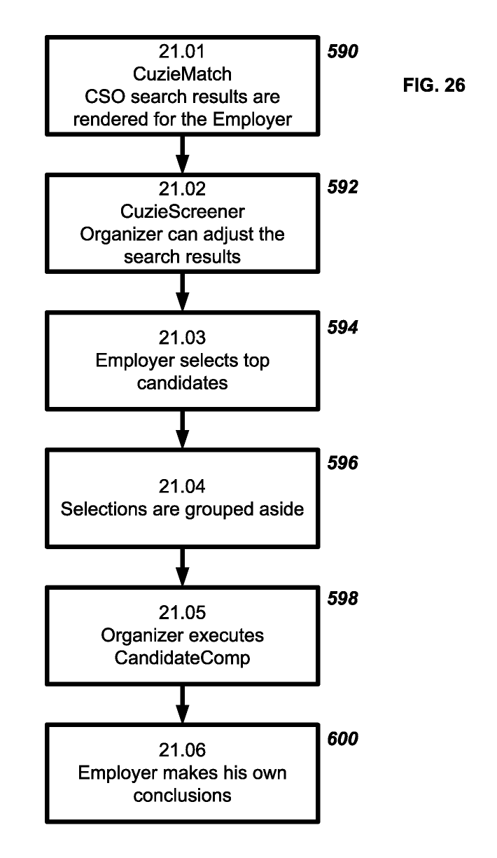

At step 350, CSOs are matched up against a database of CPOs. See FIG. 24. At step 352, the Employer is provided search results of matched up Candidates ranked in order of Implied Scores. See FIG. 24. At step 354, the Employer browses through the CuzieMatch list of search results of available Candidates that were matched up to each specific CSO. Cuzie provides a feature that allows the Employer to select Candidates that then can be saved to a “favorites” list. This list can then be rendered into a comparison grid, in another application called CandidateComp. See FIG. 26.

At step 356, the Employer can view each section of a Candidate's Career Profile. However, the ability to view a CuzieView depends on the Job Status Control set by each Candidate. The Job Status Control provides Candidates an optional screening step: (a) Not Looking—the Candidate is not pursuing any new employment opportunities, any CPOs the Candidate has submitted is suspended, and the Candidate is not eligible for any further CSO searches; (b) Open—Particular Candidates, maybe those currently employed or those that are very particular about who view their profile may prefer that all Employers make a request first. Once the Candidate grants explicit permission, the Employer can proceed to view the CuzieView video and Respects; (c) Looking—a Candidate's Career Profile is wide open for viewing, Employers are not required to request permission to view the Candidate's Career Profile.

At step 358, the Employer purchases credits to view CuzieViews. In order to View a Candidate's CuzieView, the Employer should have enough credits in his account to cover the cost of each CuzieView. If the Employer's account does not have enough credits to proceed with viewing a CuzieView, he at least should purchase enough credits to cover the price of the one he seeks to view. Bulk purchases provide the Employer discounts. The Employer can view as many CuzieViews as his credit balance affords at step 360. The processes of FIG. 16 are exemplary only.

FIG. 17 illustrates a diagram of one method for the steps and processes involved with how a Candidate requests and receives Respects in accordance with an embodiment of the present invention. To initiate the Respects process at step 362, the Candidate should be in the Respects section of his Career Profile in order to access the application. In the Respects section, the user clicks on <Manage Respects> where he is brought to the Manage Respects administrative page for managing the application. The Candidate starts the process by first sending out requests for Respects at step 364. Requests are sent using an internal and external method: (a) Internal Message Inbox—for registered and connected Cuzie users (registered users should be connected to the requesting user in CuzieConnect); (b)Email—for External, non-registered users (requests sent to external, non-registered users are sent over email). The Candidate initiates the request process for Respects by clicking on <Request a New Respect> provided in the Manage Respects section of this Career Profile. After the user clicks on <Request a New Respect>, all his contacts in CuzieConnect appear in a grid where he should select contacts for sending a request at step 366. The Candidate selects users by clicking on a checkbox next to the contact's name and thumbnail photo. More connections allows for more Respects. The Candidate is provided tools for inviting friends from other online services, such as Gmail, Yahoo, Hotmail or Outlook.

After completing all his selections, requester can edit the default title and message text in the form before sending the message at step 374. (There is also a field for sending to external recipients via email, see step 368). The user should click on <Submit> to transmit message. Registered Cuzie recipients receive two notifications by default regarding this request: (a) Internally—notification message sent to his Cuzie messaging inbox; (b) Externally—notification message sent to his Personal Email account. At step 376, the recipient can give Respect by responding to one of the two notification methods. Recipient clicks on the link provided in the message body in either method.

At step 368, the Candidate is provided a means for sending a message request for those that are not yet registered with Cuzie. After completing all his selections, as per step 366 and step 374, the requester can edit the default title and message text in the editable fields before sending the message. There is also a “Request by Email” field provided for sending to external recipients via email to non-registered users. The Candidate can type in email addresses into the “Request by Email” field. As per step 366, the user clicks on <Submit> to transmit the message request to external individuals over email. The messages are transmitted via email to each recipient. After receiving the Request for Respect message, the recipient of the email initiates the process of giving Respect by clicking on the link provided in the body of the email. After clicking on the link, the non-registered user arrives at the website where he should register to proceed. At step 370, external users should register with Cuzie in order to give Respect by clicking on <Register>. For this purpose, the user only needs to provide his full name, email address, and password to register. After completing the registration process, the user can proceed to give Respect. After registration, the system remembers that the newly registered user's email address was a recipient of a request message. Now that he is a new user, he is notified as per the default method for registered users. He receives an internal and external notification message as shown in step 374. At step 372, the recipient can give Respect by responding to one of the two notification methods. Recipient clicks on the link provided in the message body in either method.

At step 378, after the Respect message is submitted, the recipient of the Respect message sees the entry in his Respect table. At step 380, the Candidate can manage his Respects by going to the Manage Respects subsection of the Respects page of his Career Profile. Candidate has the following management controls: (a) Keep a Respect entry by doing nothing; (b) Delete a Respect entry by clicking on <Delete> provided in the function column for a particular Respect entry; (c) Block a particular user which blocks the user altogether from being able to connect with the Candidate by clicking on <Block User>; or (d) Reciprocate after receiving a Respect from someone by clicking on <Reciprocate> in the function column for a particular Respect entry. At step 382, all Respect messages are recorded and displayed automatically in the Candidate's Career Profile and summarized in CuzieAnalytics. At step 384, the Candidate's respects are quantified and CuzieQuant recalculates the Candidate's Implied Score. See FIG. 13. The processes of FIG. 17 are exemplary only.

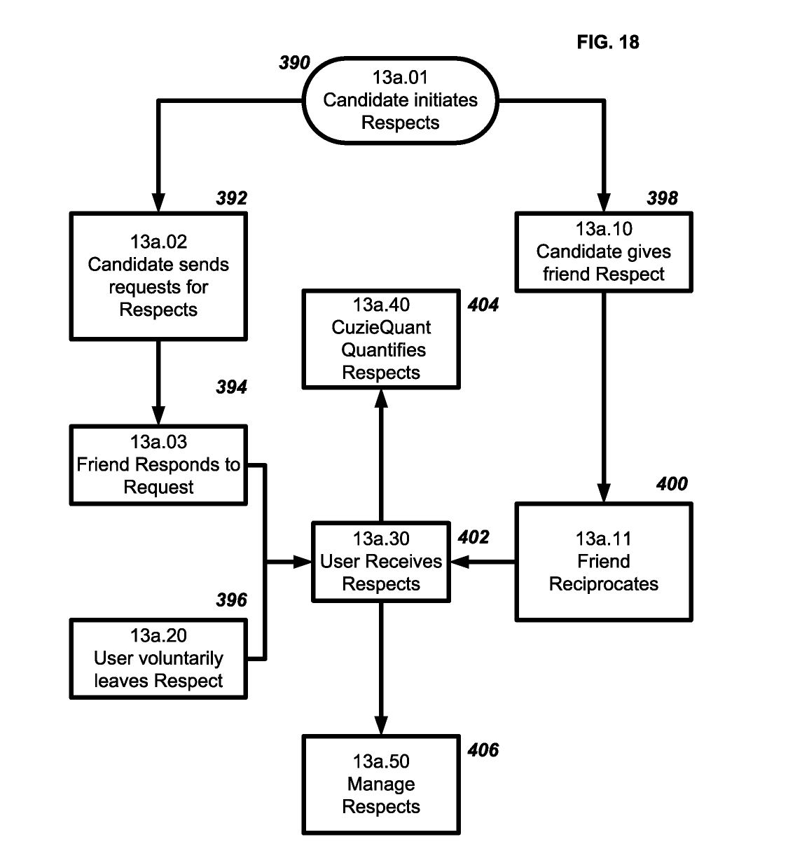

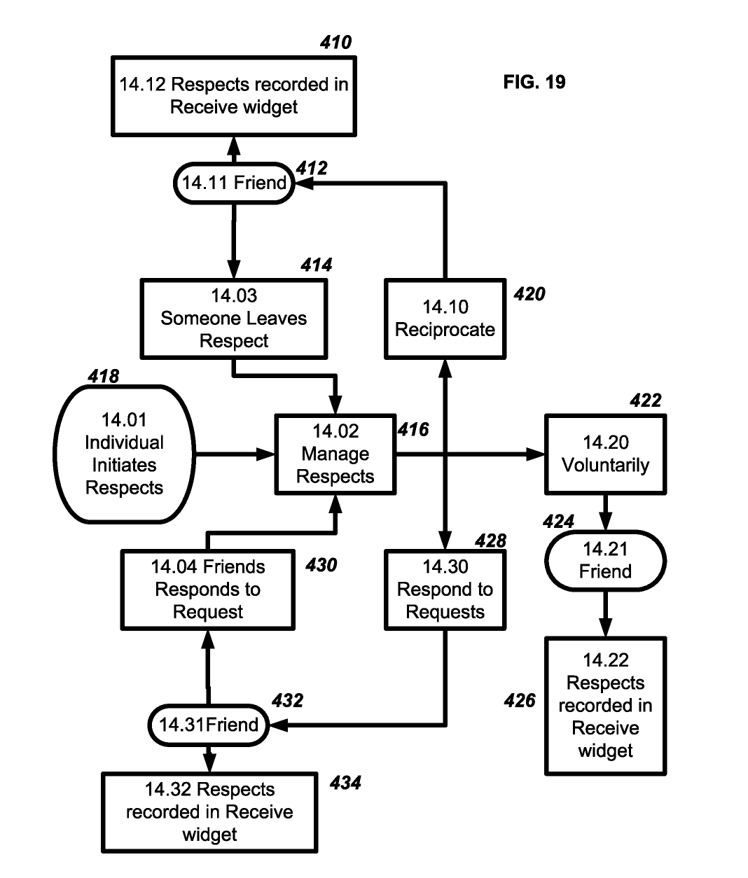

FIG. 18 illustrates a diagram of one method of the steps and processes involved with how a Candidate receives Respects in accordance with an embodiment of the present invention. To see the diagram and specification for how a Candidate requests for Respects, see FIG. 17. At step 390 the Candidate initiates Respects as in step 362. At step 392, the Candidate sends requests for Respects as shown in FIG. 17. At step 394, a Friend responds to the Candidate's request for Respects as shown in step 376 and step 372. At step 398, the Candidate gives out Respect as shown in FIG. 19. At step 400, the Friend can reciprocate the Candidate's giving the Friend Respects. The Candidate benefits from another user reciprocating his initial Respect. After leaving a voluntary Respect message for someone else, the recipient responds by giving another Respect back. The user just needs to click on <Reciprocate>, provided in the function column in the Manage Respects table for a particular Respects entry. At step 396, the user voluntarily leaves Respects. The Candidate benefits from another user leaving Respect voluntarily. A user may have come across the user's profile, or have known the user for a while and decides to leave him Respect (see FIG. 19). At step 402, the user receives Respects. The user receives respects in three ways: (a) Voluntarily—Someone voluntarily leaves Respect via Social Profile home page (see step 392); (b) Reciprocation—Someone gives back Respect after receiving one (see step 400); (c) Request Response—Someone responds to a Candidate's request for Respect (see step 396). At step 404, the Candidate's Respects are quantified and CuzieQuant recalculates the Candidate's Implied Score (see FIG. 13). At step 406, the Candidate can manage his Respects (see step 380). The processes of FIG. 18 are exemplary only.

FIG. 19 illustrates a diagram of one method for the steps and processes involved with how a Candidate gives Respects in accordance with an embodiment of the present invention. To see the diagram and specification for how a Candidate requests for Respects, see FIG. 17. At step 418, the Candidate initiates Respects (see step 362). At step 416, the Candidate can manage his Respects (see step 380). At step 414, a user voluntarily decides to leave the Candidate a respect endorsement. Candidate receives notification of the Respect message left. After reading the comment, the Candidate may decide to reciprocate and give back the user Respect himself (see step 420). At step 430, a user leaves the Candidate Respect after responding to his initial Request (see step 376 and step 372 for how internal and external individuals can give Respect to the Candidate).

One way that a Candidate gives Respect is by reciprocation at step 420. The Candidate can automatically give Respect back to someone who left him an initial Respect comment. After receiving Respect and seeing a notification, the Candidate can reciprocate by clicking on <Reciprocate>, which is provided in the function column on every Respect entry listed in the Manage Respect table. After clicking on <Reciprocate>, the Candidate is prompted to leave a Respect endorsement. The User can also go to the requesting user's Social Profile page where a <Give Respect> link is provided for this same purpose. After typing in a comment, the user just needs to click on <Submit> to save and submit the Respect comment into the system. At step 412, the recipient of the reciprocated Respect receives notification in his message inbox and personal email account. He can click on the link provided in the message to review the comments. Upon receiving the “Request for Respect” notification, the recipient clicks on the automatically generated link provided in the body of either message. The recipient can: (a) Respond via the email message—the link takes the user to the Cuzie website where he should log in. After signing in he is brought to a prompt to give Respect; or (b) Respond via the Cuzie Message Inbox—the link takes the user directly to his dashboard he is brought to a prompt to give Respect. Either way, user should click on <Submit> to save and leave the Respect message. If the recipient decides to keep the Respect entry, it is recorded and displayed in his Career Profile immediately and made available for Employers to review at step 410.

At step 422, the Candidate can also give Respect endorsements voluntarily. The Candidate can leave Respect endorsements by visiting a user's SocialConnect home page profile. On the user's home page, the visitor just clicks on <Leave Respect> this brings up the Respect prompt. In the Respect prompt, the user needs to type in his comments (limited to, for example, 150 characters) in the comment field provided and click on <Submit> to save and submit the comments in the system. At step 424, the recipient of the reciprocated Respect receives notification in his message inbox and personal email account. He can click on the link provided in the message to review the comments. Upon receiving the “Request for Respect” notification, the recipient clicks on the automatically generated link provided in the body of either message. The recipient can: (a) Respond via the email message—the link takes the user to the Cuzie website where he should sign-in. After signing in he is brought to a prompt to give Respect; or (b) Respond via the Cuzie Message Inbox—the link takes the user directly to his dashboard he is brought to a prompt to give Respect. Either way, user should click on <Submit> to save and leave the Respect message. If the recipient keeps the Respect entry, it is recorded and displayed in his Career Profile immediately and made available for Employers to review at step 426.

At step 428, the Candidate can also give Respect by responding to a Request message he received from a friend. If the user is already registered with Cuzie, notification is sent to his internal message inbox. If the user is not registered with Cuzie, notification is sent to him over email. The recipient of the reciprocated Respect receives notification in his message inbox and personal email account at step 432. He can click on the link provided in the message to review the comments. Upon receiving the “Request for Respect” notification, the recipient clicks on the automatically generated link provided in the body of either message. The recipient can: (a) Respond via the email message—the link takes the user to the Cuzie website where he should log in and, after logging in, he is brought to a prompt to give Respect; or (b) Respond via the Cuzie Message Inbox—the link takes the user directly to his dashboard he is brought to a prompt to give Respect. Either way, user should click on <Submit> to save and leave the Respect message. If the recipient decides to keep the Respect entry, it is recorded and displayed in his Career Profile immediately and made available for Employers to review at step 434. The processes of FIG. 19 are exemplary only.

FIG. 20 illustrates a diagram of one method for the specifications for the external Respects widget in accordance with an embodiment of the present invention. This is a variation of the internal Respects application, which the submission interface is rendered on an external website but still served and managed on Cuzie. To access the software code generator, the user should navigate to the Manage Respects administrative page within the Respects subsection of the user's Career Profile. There, user generates the code by clicking on <Generate code>. The application generates the software code and presents it in a prompt provided for this purpose; the user can copy and paste the software code into memory by clicking on <Copy code> at step 450. After saving the code to memory, the user can paste the code into the appropriate section of an HTML webpage at step 452. The user should save the updated HTML with the Respects page to the server. After saving the code to the page, the external Respects widget fully renders and operates automatically like the internal Respects application except it exists on an external web page at step 454.

At step 456, registered Cuzie users can leave a message in the Respects application. There is also a process for non-registered users to leave Respects (see step 466). At step 458, an individual wants to leave Respect. The process is simple and self explanatory, for users that want to leave a Respect message for someone. At step 460, an individual submits a text endorsement. The user can leave Respect by typing in comments into the field provided for this purpose within the application widget (e.g., 150) character limit. The user clicks on <Submit> to save and submit the comments into the system for the recipient of the endorsement to receive the Respect. After clicking on <Submit> the user should validate his Cuzie account by signing into his Cuzie profile in the sign-in prompt that appears for this purpose at step 462. Once the system validates the user's credentials, the Respects message proceeds to get recorded, processed and displayed at step 464. Recipient is notified of the new Respect endorsement.

Step 466 is a process for non-registered users to leave Respect messages. If a non-registered user wants to leave Respect for someone using the external Respects widget at step 468, he can follow the same procedure as the registered Cuzie user. At step 470, a user can leave Respect by typing in comments into the field provided for this purpose within the application widget (e.g., 150) character limit. The user clicks on <Submit> to save and submit the comments into the system for the recipient of the endorsement to receive the Respect. After clicking on <Submit>, the user should validate his Cuzie credentials by logging into this Cuzie account in the log-in prompt that appears for this purpose. The non-registered user has no account for logging in. External users should register with Cuzie in order to give Respect by clicking on <Register> at step 472. For this purpose, the user only needs to provide his full name, email address, and password to register. After completing the registration process, the user can proceed to give Respect. Once the system validates the user's log in credentials, the Respects message proceeds to get recorded, processed and displayed at step 474. Recipient is notified of the new Respect endorsement.

At step 476, the Candidate can manage his Respects (see step 380). At step 478, the Candidate's respects are quantified and CuzieQuant recalculates the Candidate's Implied Score (see FIG. 13). The processes of FIG. 20 are exemplary only.

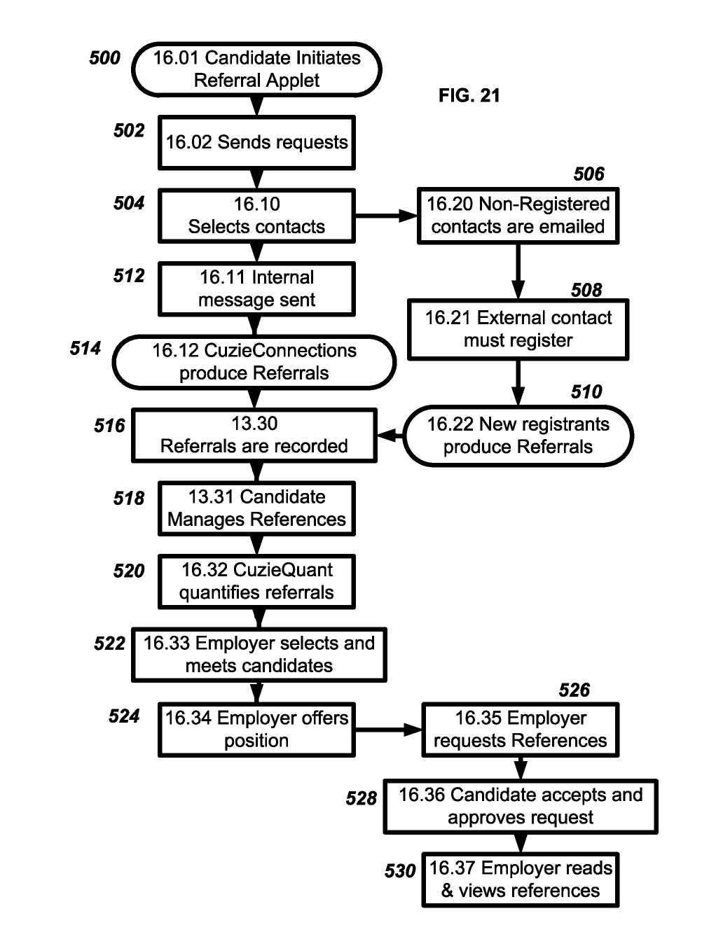

FIG. 21 illustrates a diagram of one method for the steps and processes involved with CuzieReferral, a multimedia update to the traditional referral format used in the hiring process in accordance with an embodiment of the present invention. This is a method of submitting (using an intuitive submission form), saving (storing the comments or video files to a database) and streaming a video (playing the video retrieved from the server to the desktop of the viewer) or submitting, saving and displaying (retrieving the text files and displaying it on a web page) formally written endorsements about a worthy Candidate produced by someone with a previous professional relationship; which the videos are recorded by the endorsers web cam, or uploaded from a file from his computer to be saved on a web server and can be retrieved for prospecting Employers thereafter to view; whereas the formally typed in comments are submitted by the endorser to be saved on a web server and can be retrieved for prospecting Employers thereafter to view. These particular referrals are approved by the Candidate to be release for viewing by the Employer.

To initiate the CuzieReferral process at step 500, the Candidate should be in the Referral section of his Career Profile in order to access the application. In the Referral section, the user clicks <Manage Referrals> where he is transferred to the Manage Referral administrative page for managing the application. Candidate starts the process at step 502 by first sending out requests for Referrals. The Candidate starts the request process for Referrals by clicking on <Request a New Referral> provided in the Manage Referral section of this Career Profile. Requests are sent using an internal and external method: (a) Internal Messaging system—for registered users connected to the requestor (Registered users should be connected to the requesting user in CuzieConnect, see FIG. 11); and (b) Email—for External, non-registered users (Requests to external, non-registered users are sent over email).

After the user clicks on <Request a New Referral> at step 502, all his contacts in CuzieConnect appear in a grid where he should select contacts as target recipients of these requests at step 504. The Candidate selects recipients by clicking on a checkbox next to the contact's name and thumbnail photo. Having more connections allows for more Referral requests. The Candidate is provided tools for inviting friends from such internet services as Gmail, Yahoo, Hotmail or Outlook. After completing all his selections, requester can edit the default title and message text in the form provided before sending the message in step 512. (There is also a field for sending to external recipients via email, see step 506). The user should click on <Submit> to transmit message. Recipients receive notifications after completed delivery of the request message. Cuzie recipients receive two notifications by default regarding this request: (a) Internally—notification message sent to his Cuzie messaging inbox; (b) Externally—notification message sent to his Personal Email account.

At step 514, CuzieConnections produce Referrals. The recipient receives the request. The Recipient of the Referral request receives notification in his message inbox and personal email account (by default, user can edit these notification methods). He can click on the link provided in the message to review the comments. Upon receiving the “Request for Referral” notification, the recipient clicks on the automatically generated link provided in the body of either message. The Recipient can: (a) Respond via the email message—the link takes the user to the Cuzie website where he should log in and after logging in he is brought to a prompt to give a Referral; or (b) Respond via the Cuzie Message Inbox—the link takes the user directly to his dashboard he is brought to a prompt to give a Referral. Either way, user should click on <Submit> to save and leave a Referral.

At step 506, the Candidate is provided a means for sending a message request for those that are not yet registered with Cuzie. After completing all his selections, as in step 512, the requester can edit the default title and message text in the form before sending the message. There is also a field provided for sending to external recipients via email to non-registered users. The Candidate can type in email addresses of those not yet registered with Cuzie into the “Request by Email” field provided for this purpose. As in step 504, the user clicks on <Submit> to transmit the message request to external individuals over email. The messages are transmitted via email to each recipient. After delivery of the requests is completed, the recipient of the email initiates the process of giving Respect by clicking on the link provided in the body of the email. After clicking on the link, the non-registered user arrives at the website where he should register. At step 508, the external user should register with Cuzie in order to give a Referral by clicking on <Register>. For this purpose, the user only needs to provide his full name, email address, and password to register. After completing the registration process, the user can proceed to give a Referral. After registration, the system remembers that the newly registered user's email address was a recipient of a recent request message. As a Cuzie user, notifications are sent to inform him that new messages arrived. By default, the new registrant receives an internal and external notification message and the new registrant can now produce referrals at step 510. The recipient can give referrals by responding to one of the two notification methods. Recipient clicks on the link provided in the message body in either method.

The recipient at both step 514 and step 510 is transferred to the “Give a Referral” page, with the name of the requesting user already propagated in the appropriate fields. The user can give two types of referrals: (a) type written online; and (b) video. To leave a type written online referral: (a) the user just types in his comments in the comment field provided for this purpose; (b) after completing his comments, he simply clicks on <Submit> to save and submit the referral into the system. To leave a video referral, there are a number of ways that a referrer can produce a video referral: (a) produce a well edited video and save the video as a digital file onto disk; (b) hire a professional producer and be provided a digital file onto disk; and (c) utilize built-in Cuzie features to control the referrer user's web cam for recording a video, which is saved in Cuzie or can output the video to be saved as a digital file onto disk. Once a video has been produced and is saved to disk, the referrer uploads the video file to the Candidate's Career Profile by doing the following: (1) the user should be in the Referrals section of the Candidate's Career Profile; (2) the referrer clicks on <Give Referral>; and (3) the referrer scrolls down to the Upload Video section of the page and completes the following—(a) types in a headline for the Video, (b) clicks on <Browse> and then locates the file from his disk, (c) once file is located he selects it by clicking on it, (d) after selecting it, the file is highlighted, and the path to the file is propagated in the location prompt provided for this purpose next to <Browse>. The user should click on <Upload> to initiate the transfer of the file from disk to the website. There is a (e.g., 100 MB) size limit for video referrals. The Video can be previewed by clicking on <Play> after transmission has completed. The referrer should click on <Submit> to save and submit it into the candidate's profile in the system.

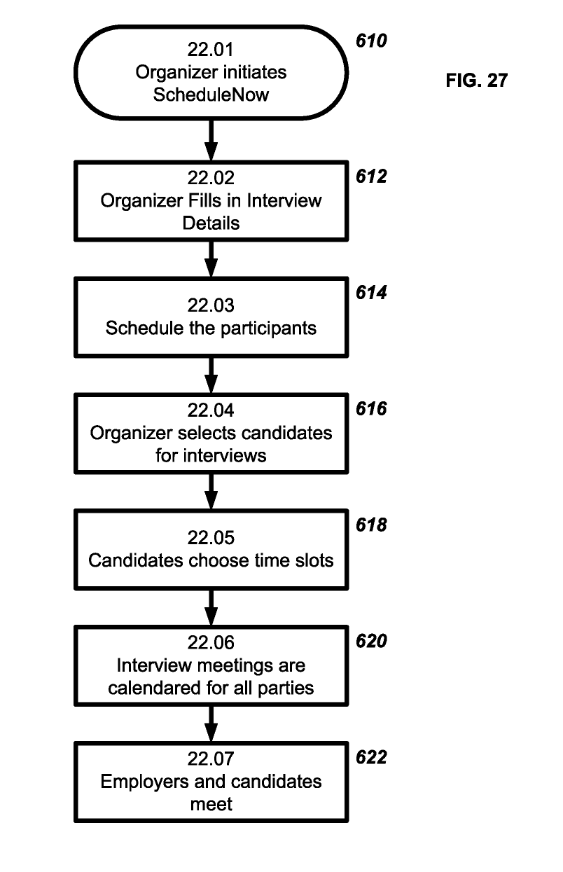

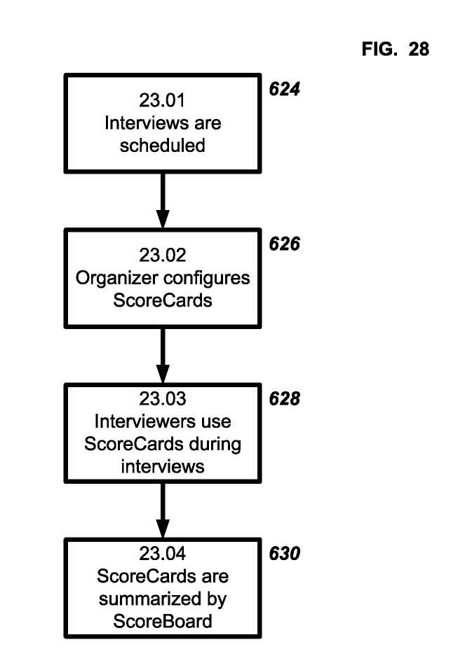

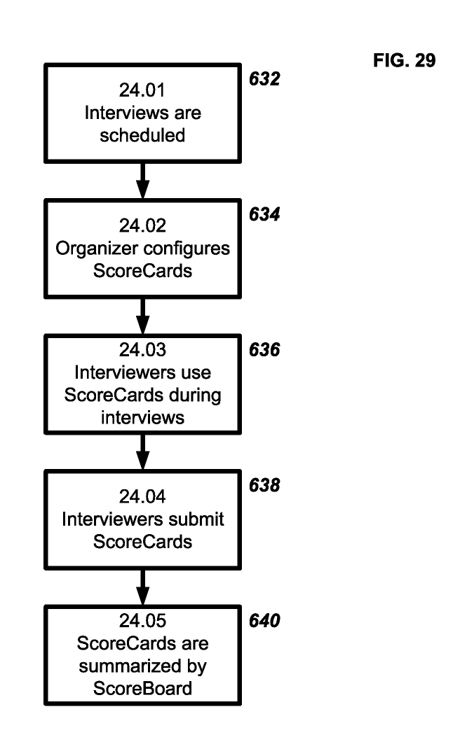

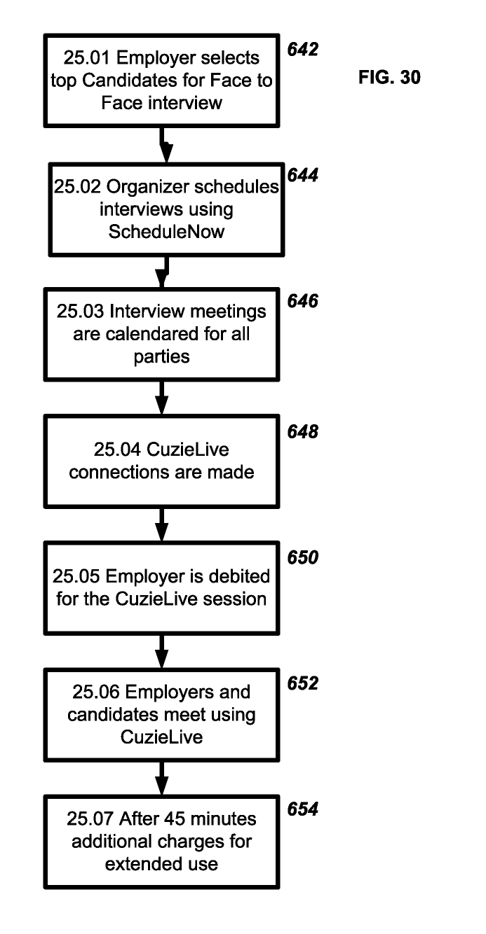

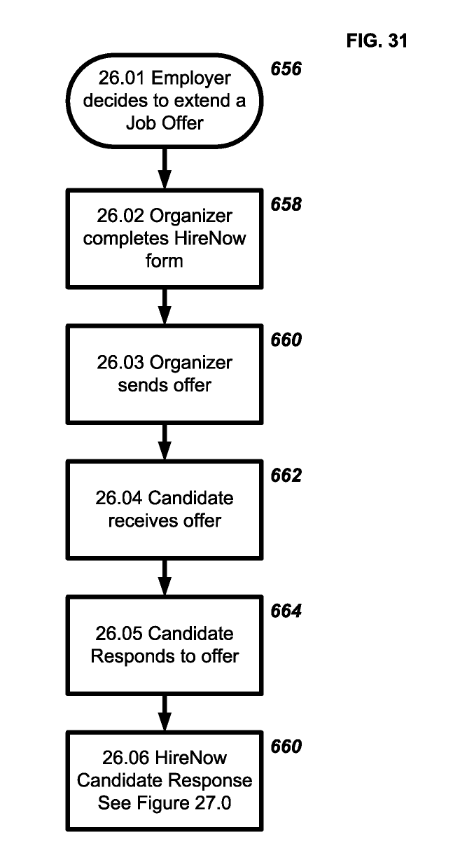

After the referral is submitted, the Referral is recorded at step 516 and the recipient of the referral message sees the entry in his Referral table. At step 518, the Candidate is notified of his new Referral endorsement, see step 362. The Candidate can manage his Referrals by going to the Manage Referrals subsection of the Referrals page of his Career Profile. Candidate has the following management controls: (a) keep a Referral entry by doing nothing; (b) delete a Referral entry by clicking on <Delete> provided in the function column for a particular Referral entry; or (c) block a particular user which blocks the user altogether from being able to connect with the Candidate by clicking on <Block User>. At step 520, the Candidate's referrals are quantified and CuzieQuant recalculates the Candidate's Implied Score. See FIG. 13. At step 522, the Employer selects the best Candidates for face to face interviews. The Employer can schedule the Candidate using ScheduleNow. See FIG. 27. The Candidate goes through the process of picking a time slot and meeting the Employer, either in-person or using the CuzieLive video conferencing system. After interviewing and thoroughly evaluating the most qualified Candidates (Cuzie provides an evaluation system, see FIG. 28 and FIG. 29), the Employer should narrow down the Candidate choices and offer the available position to a single Candidate at step 524. The Employer can extend a Job offer using Cuzie's Job offer application called HireNow for this purpose. See FIG. 31. In the HireNow form, the Employer is asked if he wants to view the Candidate's Referral. Employer is informed that a request to view the Referral is requested in the Job Offer message to the Candidate of choice at step 526. At step 528, the Candidate responds to the Job Offer. The Candidate, by accepting the Job Offer automatically authorizes his Referral to be viewed by the Employer. See FIG. 30. After accepting the Job Offer, the Employer can access and view the Candidate's Referral in his Career Profile at step 530. The processes of FIG. 21 are exemplary only.

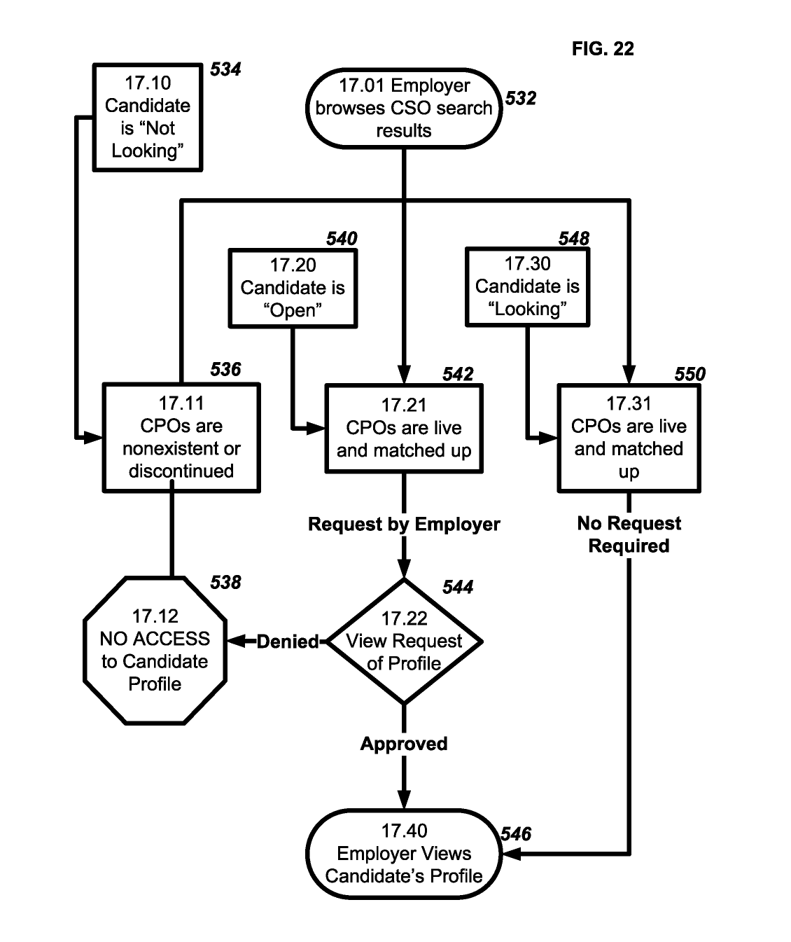

FIG. 22 illustrates a diagram of one method for the policies, steps and processes involved with the Job Status Control feature in accordance with an embodiment of the present invention. This is a method of controlling (user chooses a predefined policy in the software application) the exposure (access for viewing a career profile) a Candidate's profile (features that provide insight about a user) receives from prospecting Employers or individuals. There are three major settings, each setting encompasses predefined access policies that dictate viewing logistics: (1) Not Looking—Candidate profile is withheld from any Candidate searches; (2) Open—Candidate is eligible for searches, but should approve required requests from Employers to view Career Profile; and (3) Looking—Candidate is eligible for searches and freely allows any prospecting Employer to view his full Career Profile without request. After submitting a CSO (see FIG. 13), an Employer is provided a ranked search results list (see FIG. 23). At step 532, the Employer can browse through the CuzieMatch list of search results of available Candidates that were matched up to the CSO. However, the Employer's ability to fully view a Candidate's Career Profile is determined by the Job Status Control (“Job Status Control” and “Career Status Control” are used synonymously) applied to it, selected by the Candidate.

As previously stated, there are three major settings the Candidate can select: (1) Not Looking, see step 534; (2) Open, see step 540; and (3) Looking, see step 548. At step 534, a Candidate can choose <Not Looking> by clicking on the pull down menu under My Career Status in the Career Profile section of his profile. Candidate should choose between <Not Looking>, <Open> or <Looking>. The user navigates to his Career Profile by clicking on the [Career Profile] tab (user can toggle between Social and Career profile). At step 536, if a Candidate submits a CPO, his Job Status automatically changes to <Open>. The system informs the user of this change after submitting his CPO. If the Candidate prefers, he can also choose a more liberal status called <Looking>, see step 548. Job Control Status becomes very important after the Candidate has taken himself off the employment market, either by choice, or because the Candidate accepted a new job. <Not Looking> has the following impact: (a) The Candidate can quickly suspend any running CPOs that he submitted into the system by changing his Job Status Control to <Not Looking>. (b) If the Candidate accepted a new employment position through our website process, the system automatically sets his Job Control Status to <Not Looking> and suspends any running CPOs the Candidate has submitting into the system. At step 538, if a Candidate chooses <Not Looking>, the Candidate's Career Profile is withheld from any Candidate searches and running CPOs are suspended. By default, all Profiles are set to <Not Looking>. Obviously, if a Candidate has not submitted a Career Pursuit Order, the Candidate is not looking for a new employment opportunity; therefore the proper Job Status in this case is <Not Looking>.

At step 540, a Candidate can choose <Open> by clicking on the pull down menu under My Career Status in the Career Profile section of his profile. Candidate should choose between <Not Looking>, <Open> or <Looking>. The user navigates to his Career Profile by clicking on the [Career Profile] tab (user can toggle between Social and Career profile). At step 542, once a Candidate submits a CPO, his Job Status automatically changes to <Open>. The system informs the user of this change after clicking on <Submit> for the CPO. If the Candidate prefers, he can also choose a more liberal status called <Looking>, see step 548. The <Open> Job Status makes the Candidate eligible for matchups in CSO searches by Employers. At step 544, with the Job Status Control set to <Open> Candidate is eligible for searches, but should approve requests by Employers to view his Career Profile. The <Open> Job Status provides the Candidate the ability to screen Employers that want to view his profile. Candidates may want to screen Employers for the following reasons: (a) Selectivity—The Candidate may prefer that only particular types of companies view his profile: whether by size, prestige, political affiliation, philosophy, and consideration of competitors or non-competitors of his current Employer or some other personal preference. (b) Market Research—A Candidate may not yet be sure or confident enough that he wants to fully engage in a new employment search, so he may submit a CPO to see what type of response he gets and adjust his strategy and/or CPO accordingly. (c) Contractual Constraints—Because of Employment Agreement limitations, the Candidate may not be allowed to meet with certain companies. (d) New Employment safety net—Candidate may accept a new job, but wants to keep his current CPOs running. To protect himself from his new Employer, he may choose to screen Employers that are related to his new and former Employer looking to view his profile. (e) Current Employment discretion—Candidate may want to ensure that his current Employer does not stumble upon his Career Profile. Even though there are built in protections for automatically keeping a Candidate hidden from his current Employer, such as blocking by Domain Name, Business Name, Business Address, Names of People (if the user knows all the typical HR people who conduct recruiting at his company) criteria, Cuzie offers the Candidate peace of mind by providing him total control of this screening method. Cuzie lists the Candidate's Job Status control in the CuzieMatch list. If the Employer chooses to view a Candidate's profile and the Job Status control is set to <Open>, the Employer is prompted if he wants to send the request to view the profile. If yes, the request is sent to the Candidate immediately. How quickly a Candidate responds to a View Request is entirely up to the Candidate. By default, all registered users of Cuzie receive notifications in their internal Message Box and receive a notification message in their personal email boxes as well. Candidates are also provided the option of receiving SMS text alerts. Most people receive email alerts on their phones already, and Cuzie provides a mobile phone application for this situation as well. The Candidate can approve the request by click on <Approve> in the request that he receives in his internal messaging system and/or notification in his personal email account. If he clicks on the link provided in his email account, he is brought to his dashboard, where he responds to the View request in the same way.

At step 548, a Candidate can choose <Looking> by clicking on the pull down menu under My Career Status in the Career Profile section of his account. Candidate should choose between <Not Looking>, <Open> or <Looking>. The user navigates to his Career Profile by clicking on the [Career Profile] tab (user can toggle between Social and Career profile). At step 550, once a Candidate submits a CPO, his Job Status automatically changes to <Open>. The system informs the user of this change after clicking on <Submit> for the CPO. If the Candidate prefers, he can also choose a more liberal status called <Looking>, see step 548. The <Looking> Job Status makes the Candidate eligible for matchups in CSO searches and provides Employers unrestricted access to all the sections of a Candidate's Career Profile. At step 546, once an Employer receives approval from the <Open> Candidate the ability to view the Candidate's Career Profile is very easy and intuitive. <Looking> Candidates make it easy for the Employer to view his career profile quickly. However, one of the reasons, someone may choose the <Looking> Job Status, is because they have no current employer to worry about. Either they are unemployed or self employed. The ability for an Employer to navigate the Career Profile is managed by clicking on links provided on the side for getting to the following features: (a) Career Record; (b) Academic Record; (c) Awards & Recognitions; (d) Respects; (e) CuzieView; (f) Referrals. The processes of FIG. 22 are exemplary only.

FIG. 23 illustrates a diagram of one method for the steps and processes involved with creating, editing, submitting and managing CSOs (Candidate Search Orders) in accordance with an embodiment of the present invention. Cuzie matches up Employers and Candidates by matching up Employer's CSOs with Candidate CPOs. At step 548, an employment organization opens up an employment position at their location of business. The organization wants the most cost effective solution for finding the most qualified Candidates. The organization decides to use Cuzie. At step 550, the organization registers with Cuzie. At Cuzie, the person in charge of managing the profile for the company is the one who undertakes the responsibility of registering the Organization and managing the day to day operation of the website as its Administrator. In Cuzie, this Administrator is called the Organizer. The Organizer is a specific user account in the Organizational domain, which possesses the most permissions, the most access and has totally authority over other users, content and finances of the Organization Account. At the Cuzie home page, the Organizer initiates the registration process by clicking on <Register> and choosing his account type: (a) Individual; or (b) Organization. See FIG. 8. For the purposes of FIG. 22, the company representative responsible for completing the registration process chooses <Organization>. At this point, the representative takes on the role as Organizer of this Organization in Cuzie. The Organizer submits his choice by clicking on <Get an account>. The registration process for the Organization continues.

At step 552, the Organizer should complete the Organization Account form by providing basic information about the company. The Organizer completes the Company/Organization and the Organizer Info sections. The Organizer should complete the form by filling in the fields provided for this purpose with the appropriate information. In the Company/Organization section, the Organizer should provide the following information: (a) Company Name; (b) Company Domain name (more than one domain name can be submitted by clicking on <Add another domain> and submitting another domain name); (c) Company Address; (d) Company Address 2; (e) City; (f) State; (g) Zip Code; (h) Country (user selects clicks on the pull down menu and selects the appropriate country); (i) Upload Company Logo and/or video—(1) user clicks on <Browse> and locates the file on disk, (2) after locating file on disk, user clicks on <Upload> to upload file to Cuzie and into the Organization's profile; (j) Company Description (user types in a description about the company and this comment field can be limited to, for example, 600 characters. In the Organizer Info section, the Organizer should provide the following information about him/herself: (a) First Name; (b) Last Name; (c) Suffix (user selects suffix in pull down menu); (d) Birth Date (user selects month, day, year in pull down mean for each choice); (e) Organizer's email address; (user should confirm by typing in the same email address again in the repeating field provided for this purpose); (f) User ID, which serves as the Vanity URL (www.cuzie.com/(USER ID)); (g) Password—(1) User creates a password, and submits it, (2) User confirms by typing in the same password in the repeating field provided for this purpose, (3) User can click on <Password rules> to read password conformity rules that the user should follow for the password to be submitted. Organizer clicks on <Sign Up> to save and submit this registration form into Cuzie. Organizer receives a message in his email that informs him that his account has been created, and in order to complete the registration process, the Organizer should confirm the registration by clicking on the link provided in the email message body. The link transfers the user to the confirmation page to confirm the Registration of the Organization in Cuzie. There the Organizer may be asked to sign-in again manually, if he wants to continue filling out the Organization profile. For advanced Organizers, those with administrative experience managing enterprise software applications, Cuzie provides advanced functionality for adding other users such as Organizers, Managers, Interviewers, other employee users, assigning roles to these users, editing permissions of these roles, and providing financial scale. For simpler Organizers, they can simply proceed to the Recruiting applications for finding Candidates immediately.

At step 554, to find Candidates, the Organizer should submit a CSO, which stands for Candidate Search Order. A CSO encompasses all the criteria an Employer requires that a Candidate should meet in order to be matched up for hiring considerations. An Organizer creates a new CSO by: (a) clicking on <Create a new Candidate Search Order> in the CSO management section; (b) after clicking on this link, the Organizer is transferred to the CSO form. An Organizer should provide the following information in the CSO form: (a) Career Type—(1)

User should choose between Full Time (W2), Part Time (W2), Contract (C2C or 1099), Temp, or Internship; (b) Career Role—User should start typing in, and the system searches its Career Role database and autosuggests choices for this purpose, the user should then click on a selection; (c) Job Title—User should type in an arbitrary name for this position and this is also used as a point of reference for the Employer when managing the company's CSO; (d) Maximum Annual Salary; (e) Maximum Rate (if Employer chose an hourly position, then he should put in an hourly rate); (f) Career Level should be chosen from the following—(1) Executive Management, (2) Licensed Professional, (3) Senior Management, (4) Management, (5) Experienced, (6) Junior Level (Associate), (7) Intern; (g) Minimum Years Experience; (h) Minimum Academic Certification; (i) Office Location—(1) Country, (2) State, (3) Zip; (j) Travel Preference—(1) Yes, (2) No. The use should click on <Submit> to save, preview and submit the CSO into Cuzie. An Organizer can manage the CSOs by clicking on [Our Candidate Searches] tab in the top level navigation. In the CSO management section, the Organizer sees a grid of all the CSOs the organization has submitted. The grid displays the following information about the CSO: (1) Date Submitted; (2) Title; (3) Favorite Candidates; (4) Scheduled Interviews; (5) Delete—(a) The Organizer has the ability to delete CSO from this screen, (b) CSOs cannot be edited; (6) Create a new Candidate Search Order. CSOs cannot be edited or changed once they have been submitted. Organizers are provided post-filtering tools, which essentially alters the CSO criteria on the fly and provides results thereof on the fly. This also reduces the redundancy of editing the CSO and then having to constantly save and view the altered results.

At step 556, the CSO is then matched up against all available Candidate CPOs vying for the same Job Role. See FIG. 24. The processes of FIG. 23 are exemplary only.

FIG. 24 illustrates a diagram of one method for the steps and processes involved in the CuzieMatch algorithm in accordance with an embodiment of the present invention. After completing his Career Profile, the Candidate completes the CPO form, and submits it into Cuzie at step 560. For the full specification of a CPO, see FIG. 14. Once the Candidate submits a CPO, his entire Career Profile is quantified by the CuzieQuant algorithm and an Implied Score is calculated at step 562. Anytime a feature in his Career Profile that contributes to his Implied Score changes, CuzieQuant recalculates the Candidate's Implied Score. See FIG. 13. At step 564, after completing the Organization's profile, the Organizer can quickly search for Candidates on Cuzie. The Organizer completes the CSO form and submits it into Cuzie. For the full specification of a CSO, see FIG. 23.

At step 566, Cuzie matches up Employers with Candidates by comparing CSOs and CPOs. Cuzie looks at the criteria provided by Employers and Candidates in their CSOs and CPOs and finds identical inputs and requirements between them. CuzieMatch compares inputs provided in Step One: Designate Career Requirements section of the CSO and CPO. CuzieMatch compares choices, information, requirements and identifies granular matches between CSOs and CPOs criteria in the following. (a) Career Type: (1) Employers should choose one per CSO, Candidates can make multiple choices—(a) Full Time (W2), (b) Part Time (W2), (c) Contract (C2C or 1099), (d) Temp., (e) Internship; (2) Similar choices are rendered a match for these criteria. (b) Career Role: (1) Career Role choice, made here, is the main criterion for matching CSOs and CPOs (i) Either user should start typing in a word, and the system searches its Career Role database and “autosuggests” choices for this purpose, the user should then select one by clicking on it and (ii) Cuzie implements a variation of the Standard Occupational Classification system Job Roles used by the Federal statistical agencies for this purpose; (2) Similar Career Role choice renders a match for these criteria. (c) Salary (annual and/or hourly): (1) Employers type in the Maximum number they are willing to pay for a position; (2) Candidates put in the Minimum number they require for compensation for that position—if the Candidate minimum fits under the maximum Candidate renders a match for this criterion. (d) Career Level: (1) Employers should choose one per CSO, Candidates can make multiple choices—(a) Executive Management, (b) Licensed Professional, (c) Senior Management, (d) Management, (e) Experienced, (f) Junior Level (Associate), (g) Intern; (2) Similar choices are rendered a match for these criteria. (e) Minimum Years Experience: (1) Employers type in the Minimum number they require for an employment position; (2) Number years of experience for that employment position is automatically calculated for the Candidate from the Career Record—if the number of years experience is the same or above the Employer's minimum requirement Candidate renders a match for this criteria. (f) Minimum Academic Certification: (1) Employers type in the Minimum academic level they require for an employment position; (2) Cuzie compares the Candidate's Academic Level against Employer's requirement—if the academic level is the same or above the Employer's minimum requirement Candidate renders a match for this criteria. (g) Office Location: (1) The Employer provides the location where the open position is available; (2) Candidate provides the preferred location for work—if the Candidate's preferred location for work is in the same location as the Employer, a match is rendered for this criteria. (h) Travel Preference: (1) The Employer cites whether there is travel involved, and percentage of travel; (2) The Candidate cites if he is willing to travel (if travel is required and the Candidate is willing to travel, a match is rendered for this criteria).

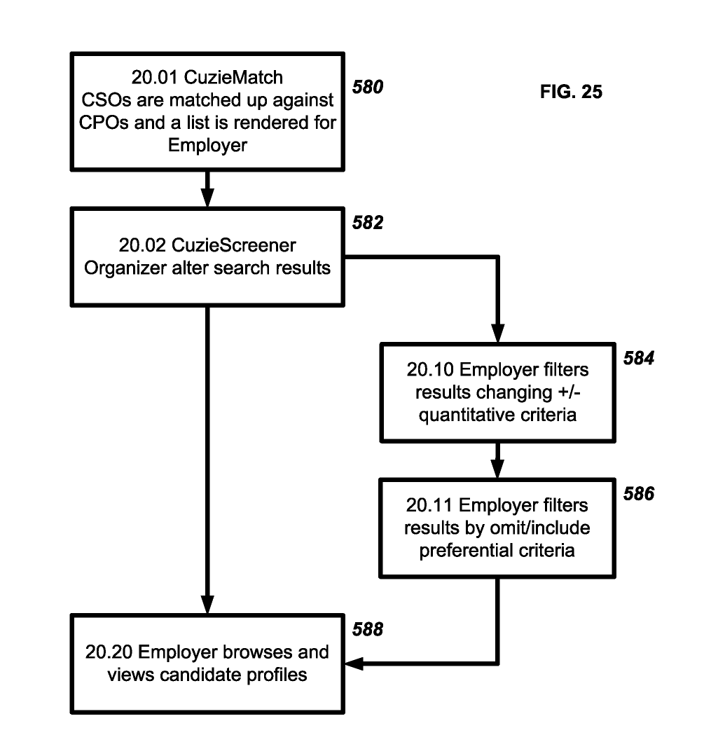

At step 568, the system renders a list of matched Candidates and ranks them in order of Implied Scores. Candidates can be sorted by the following criteria in the following sequence: (a) Career Role—system identifies all Candidates that match the Career Role criterion in the CSO. (b) Criteria Relevancy—Of those Candidates vying for the same Job Role criterion, the Candidates are then sorted by the number of matches amongst the 8 criteria mentioned above in descending order; those with the most matches of the 8 appear at the top of the list. (c) Implied Scores—After Step A and B are conducted; the remaining Candidates are then sorted by the strength of their Implied Scores in descending order, highest scoring Candidates appearing at the top. The Organizer may want to alter this search results and realize the impact of those changes in real time to give him a better sense of the marketplace for a particular Job Role, which is where CuzieScreener comes in. At step 570, CuzieScreener Organizer can increase or decrease search results. The CSOs cannot be edited after it is submitted into the system, it can only be deactivated or deleted. If for some reason, the Organizer wants to adjust the sorting of the search results, he can use post filtering applications for this purpose. CuzieScreener is provided for this purpose of adjusting CSO search results. (“Career Role” and “Job Role” are synonymous) See FIG. 25. The processes of FIG. 24 are exemplary only.

FIG. 25 illustrates a diagram of one method for the steps and processes involved with the CuzieScreener post filtering feature in accordance with an embodiment of the present invention. Cuziescreener is software application controls that filter Candidate search results using graphical dials and gauges to increase or decrease quantity increments in hiring criteria. At step 580, CSOs are matched up against CPOs and a list is rendered for the Employer. An Employer submits a CSO seeking the most qualified Candidate to fill an open position at his organization. CuzieMatch conducts this process, it matches up Employers with Candidates by comparing CSOs and CPOs looking for relevant matches. Cuzie looks at the criteria provided by Employers and Candidates in their CSOs and CPOs and counts the number of identical inputs and requirements between them. There are eight major criteria that CuzieMatch uses to identify and tier Candidates, thereafter the Candidates are sorted by their Implied Scores. See FIG. 24. At step 582, CuzieScreener Organizer can alter search results. The CSOs cannot be edited. If for some reason, the Organizer wants to adjust the sorting of the search results, he can use post filtering applications for this purpose. CuzieScreener is provided for the purpose of adjusting CSO search results. At step 584, an Employer can adjust the following quantities using graphical interface controls in adjusting the CSO search results: (a) Maximum Salary: (1) A graphical dial is used to go from 0-$500,000; (2) dial is set at the CSO requirement by default. (b) Rate: (1) A graphical dial is used to go from 0-$500/hour; (2) dial is set at the CSO requirement by default. (c) Required Years of Experience: (1) A graphical dial is used to go from 0-50 years; (2) Dial is set at the CSO requirement by default. (d) Relevancy Factor: (1) A graphical dial is used to go from 0-100%, in increments of 12.5%; (2) In this embodiement of the invention, this relates to the 8 matching criteria in CuzieMatch. Thus, if Employer wants to see Candidates that match all 8 criteria, he chooses 100%. Technically, this increment never goes less than 12.5% because the Job Role is one criteria that has to always match. So ⅛ is the lowest Relevancy Factor. By choosing 12.5%, pretty much everyone that matches the Job Role criterion is included. Cuzie administrators can adjust the matching criteria involved in the Relevancy Factor, thus increasing or decreasing the quantity of matching criteria. The dial gauge percentages would adjust automatically.

At step 586, an Employer can adjust the following non-quantitative criteria in adjusting the CSO search results: (a) Skills—an Employer can refine his search by adding another matching relevancy factor for Skills—(i) The Employer types in all the required skills required for the Job Role; (ii) This particular relevancy factor is not applicable to the Relevancy Factor filter in step 584. (b) Schools: an Employer can refine his search by adding another matching relevancy factor for schools (colleges)—(i) The Employer can filter Candidates by including or excluding the schools they attended; (ii) This particular relevancy factor is not applicable to the Relevancy Factor filter in step 584. (c) Academic Level: an Employer can refine his search by adding another matching relevancy factor for Academic Level—(i) The Employer can require that all Candidates have graduated with minimum academic level achieved; (ii) A graphical dial is used designate that level, which moves vertically from: (1) Doctorate up top, (2) Masters Degree, (3) Bachelors Degree, (4) Associates Degree, (5) Technical Certification, (6) High School being at the bottom; (iii) This particular relevancy factor is not applicable to the Relevancy Factor filter in Step 584. (d) Previous Company: an Employer can refine his search by adding another matching relevancy factor for Previous Employers—(i) The Employer can filter Candidates by including or excluding Previous Employers of the Candidate; (ii) This particular relevancy factor is not applicable to the Relevancy Factor filter in step 584. The Employer can apply these filters by clicking on <Apply These Additional Filters>. Every time a filter is added or adjusted, so are the CSO search results. The Employer can make as many CuzieScreener changes as he wants. At step 580, the Employer browses and views Candidate profiles. The Employer browses through the CuzieMatch list of search results of available Candidates that were matched up to each specific CSO. Cuzie provides a feature that allows the Employer to select Candidates that then can be saved to a “favorites” list. This list can then be rendered into a comparison grid, in another application called CandidateComp. See FIG. 26. The processes of FIG. 25 are exemplary only.

FIG. 26 illustrates a diagram of one method for the steps and processes involved with the CandidateComp application, which is a software application that allows an Employer to compare competing Candidates' attributes by displaying these attributes in a side by side comparison chart in accordance with an embodiment of the present invention. At step 590, the Employer submits a CSO seeking the most qualified Candidate to fill an open position at his organization. CuzieMatch conducts this process, it matches up Employers with Candidates by comparing CSOs and CPOs looking for relevant matches. CuzieMatch looks at the criteria provided by Employers and Candidates in their CSOs and CPOs and counts the number of identical choices and requirements between them. There are 8 major criteria that CuzieMatch uses to identify Candidates, thereafter the Candidates are sorted by their Implied Scores. See FIG. 24. At step 592, CuzieScreener Organizer can adjust the search results. The CSOs cannot be edited. If for some reason, the Organizer wants to adjust the sorting of the search results, he can use post filtering applications for this purpose. CuzieScreener is provided for the purpose of adjusting CSO search results. See FIG. 25. At step 594, the Employer selects its top Candidates. At some point, the Organizer should select the top Candidates among those that were matched up and filtered. In the search results display, the Candidate is provided with two tabs: (a) <All>; (b) <Favorites>. In the <All> tab display, CSO search results appear and every matched Candidate is listed and ranked. Each row encompasses a Candidate and his attributes and demands. Each row lays across a column that specifies an attribute or Career demand about a Candidate. The rows display the following Candidate information assigned to a column: (1) Checkbox for Favorites Selection; (2) Candidate's Thumbnail Photo; (3) User ID; (4) Career Type choices; (5) Last school attended; (6) Years of Experience; (7) Desired Salary or Rate; (8) Desired Location for work. The Employer selects “favorite” Candidates by clicking on the appropriate checkbox and then clicking on <Apply> or by clicking on <Add to Favorites> provided for this purpose at the end of the row entry.

After the Employer has completed all his selections, all the Candidates that were selected from the <All> tab list now appear under the <Favorites> tab list at step 596. All the Candidates are rendered in the same grid format as in the <All> tab, except that these Candidates that appear are explicitly selected as “favorites” in this list. At step 598, the Employer is provided another feature to expand on this summary grid view, by utilizing the CandidateComp application. CandidateComp expands the summary grid view to include additional information about the Candidate by including more columns with more information. In CandidateComp the following information is displayed: (a) The default columns: (1) Candidate's Thumbnail Photo, (2) User ID, (3) Career Type choices, (4) Last school attended, (5) Years of Experience, (6) Salary or Rate, (7) Desired Location for work; (b) Additional Columns and Quick Links are added in CandidateComp: (1) CuzieView with <Play> button, (2) Respects Summary, (3) Career Level, (4) Minimum Academic Certification, (5) Awards & Recognitions Summary, (6) Travel Preference, (7) <ScheduleNow>, (8) <HireNow>. Candidate in this “favorites” section are sorted by their ranked order by Implied Score. At step 600, CandidateComp provides a comprehensive comparison chart for displaying all the top Candidates side by side, which provides the Employer with another robust tool in helping make a conclusion about who to hire. The processes of FIG. 26 are exemplary only.

FIG. 27 illustrates a diagram of one method for the steps and processes involved with operating the ScheduleNow application, which is a software application for scheduling and managing interviews across multiple participants for each Job opening, in accordance with an aspect of the present invention. At step 610, the Organizer initiates ScheduleNow. Once an Organizer selects a qualified Candidate to meet for an interview, he can use ScheduleNow. The Organizer can initiate the ScheduleNow application by: (a) Clicking on <ScheduleNow> in the Candidate's Career Profile Page, in the CuzieMatch or CuzieScreener application page; (b) Navigating to the calendar section, by clicking on <Our Calendar> in the top navigation. After clicking on <ScheduleNow> the user is transferred to the <Our Calendar> page where the ScheduleNow form is automatically initiated for this purpose.

At step 612, the Organizer fills in Interview Details. The Organizer should provide meeting information into the ScheduleNow form. This information becomes relevant if a Candidate confirms a meeting. All the information inputted here is provided to the Candidate after Time Slots are confirmed between both parties. The Organizer should choose and fill in the following information into the forms provided for this purpose. (a) Choose Interview Type: (1) CuzieLive video conference (default choice); or (2) In-Person. (b) Interview Address (appears if in-person is chosen). (c) Interview Address 2 (appears if in-person is chosen). (d) City (appears if in-person is chosen). (e) State (appears if in-person is chosen). (f) Zip (appears if in-person is chosen). (g) Country (appears if in-person is chosen). (h) Suggestions for Transportation (appears if in-person is chosen). (i) Suggestions for Parking (appears if in-person is chosen). (j) Name of Representative greeting Candidate (appears if in-person is chosen). (k) Representative Contact Phone Number (appears if in-person is chosen). (1) Exact Meeting Location (appears if in-person is chosen). (m) Instructions for asking for the representative (appears if in-person is chosen). (n) Location of Rest Rooms (appears if in-person is chosen). (o) Name of Interviewer (selects from menu of available users). (p) Background info about Interviewer. If CuzieLive is selected as the Interview Type of choice, all the relevant information is automatically sent to both parties involved in the Interview Meeting: (a) Time of Interview; (b) Instructions for initiating the CuzieLive session; (c) Reminders are sent a day before, 1 hour and then 15 minutes before the interview time slot to both parties. For the Interviewer, each reminder message provides a link that transfers the Interviewer to the CuzieLive interface. For the Candidate, each reminder message provides a link that transfers the Candidate to the CuzieLive interface. The CuzieLive interface appears and operates differently for the Interviewer and Candidate. The Organizer clicks on <Next> to proceed to the next section of the ScheduleNow application form.

At step 614, the Organizer schedules the participants for the interview. The Organizer should now manage the scheduling process for both parties. It is the Organizer's responsibility to figure out time availabilities among its interviewers, the Organizer is assisted in breaking up the blocks of time into 30 minute increments allocated for the Organization's interviewers. The Organizer is provided a graphical calendar program that allows him to block out time: (a) Time slots are blocked out by simply clicking on time blocks, which get highlighted; (b) Time slots are blocked in 30 minute increments; (c) The Organizer should allow more than enough time slots required for the number of Candidate competing for Time Slots; (d) In the end, it's first come, first serve for the Candidates. All the Candidates are sent interview requests and a message to select Time Slots at the same time.

At step 616, the Organizer should select Candidates for this round of interview meetings with the company. The Organizer should select Candidates who are deemed qualified enough for a face to face interview. If the Organizer got to ScheduleNow from clicking on <ScheduleNow> from a Candidate's Career Profile, CuzieMatch or CuzieScreener application, then all the Candidates that were selected in that screen appear pre-selected here when the Organizer gets to this step. In this step, all of the Candidates from the [Favorites] tab page appear in a grid layout without all of the information that appears in the CuzieScreener page, just the following: (1) Thumbnail photo, (2) User Id, (3) <Review> Career Profile link if the Organizer wants to review the Candidate's profile one more time. A new web page pops up so that the Organizer is not knocked out of this session. The Organizer then selects Candidates by clicking on the checkbox provided next to each Candidate. The Organizer clicks on <Next> and is transferred to the next page for step 618.

At step 618, the Candidate selects his preferred Time Slot for conducting the interview. All the Candidates selected for this Employment Position are sent the Interview Request messages at the same time. There are numerous factors that impact when each Candidate actually receives the message. Regardless, the Candidate is provided the control in his administrative settings to configure the type of notifications that are the most expedient for the Candidate. By default, Cuzie provides internal messaging and email notifications. The Candidate may choose SMS notifications that go straight to mobile phones. Once the Candidate receives the Interview Request message, he can quickly select his preferred Time Slot. To select a Time Slot: (a) Candidate clicks on link provided in the message body of his notification; (b) Clicking on the link takes him to the website, and to this dashboard where he should respond to the request; (c) Candidate clicks on <Select Time Slot>; (d) An applet pops up with all the available Time Slots lined up from top to bottom, with each day, the Candidate just clicks on a Time Slot to select it, and then click on submit. The available Time Slots are displayed in real time, selected Time Slots are removed as Candidate selections are confirmed. Once a Candidate selects a Time Slot, the system alerts the counter parties. The Organizer can then confirm, or the interviewer can confirm the selection. Neither party can reject a selected time slot because it is assumed that available time has been finalized.

At step 620, Interview meetings are calendared for all parties. Once the Time Slot is confirmed, the interview meeting is recorded in all relevant parties' calendar. The Organizer can view all the scheduled interviews in the Manage CSO section of his account. At step 622, Employers and Candidates meet. Interviewers and Candidate can meet face to face during the scheduled Time Slot. For In-Person Interviews: (a) Candidate receives all the information filled out in Step One, after his Time Slot selection has been confirmed; (b) The Organization expects his prompt arrival at the scheduled Time Slot for interview. For CuzieLive (video conference) Interviews: (a) Candidate just needs to be logged in Cuzie during their schedule interview Time Slot; (b) The Employer should initiate the CuzieLive session; (c) The Candidate just needs to answer the CuzieLive session call; (d) For illustration on how CuzieLive sessions are executed, see FIG. 29. The processes of FIG. 27 are exemplary only.

FIG. 28 illustrates a diagram of one method for the steps and processes involved with operating the ScoreCard application, which is a software application provided to Employers for scoring Candidates during interviews, in accordance with an aspect of the present invention. Once Candidate Time Slot preferences are confirmed, the interview meeting is scheduled and displayed in every relevant user's calendar at step 624. Employers can utilize the ScoreCard system for evaluating Candidates during interviews. At step 626, the Organizer configures ScoreCards. First, the Organizer should configure the ScoreCard to the Organization's liking. The Organizer can navigate to this by clicking on <Manage ScoreCards> under <Tools> in the main navigation tabs. After clicking on <Manage ScoreCards> the Organizer is transferred to the Manage ScoreCards administrative page. The Organizer clicks on <Create New ScoreCard Configuration> provided for this purpose. The Organizer should configure the default configuration and following settings: (a) Provide a Name for referencing this ScoreCard configuration set; (b) Edit the Criteria used for this ScoreCard configuration set; (c) Choose a Scale used for this ScoreCard configuration set. Next, the controls for configuring the ScoreCards are provided: (a) Name—the Organizer should type in a name for this ScoreCard configuration set. This name makes it easy to reference this configuration set later. If this configuration set needs to apply to other CSOs, it can be easily identified. For example: Legal Position ScoreCard, Head of Marketing ScoreCard, etc. (b) Criteria—the Organizer should define the underlying ScoreCard criteria that interviewers consider in evaluating the Candidate. By default Cuzie provides the following criteria that an Organizer can edit, or delete by clicking on the control next to it: (i) First Impression (<Edit>, <Delete>), (ii) Communication (<Edit>, <Delete>), (iii) Preparation (<Edit>, <Delete>), (iv) Work Experience Relevance (<Edit>, <Delete>), (v) Skills Relevance (<Edit>, <Delete>), (vi) Role Fit (<Edit>, <Delete>), (vii) Willingness to Learn (<Edit>, <Delete>), (viii) Attitude (<Edit>, <Delete>), (ix) Work Ethic (<Edit>, <Delete>), (x) Competitive Nature (<Edit>, <Delete>), (xi) Respect for Company (<Edit>, <Delete>), (xii) Culture Fit (<Edit>, <Delete>), (xiii) Professionalism (<Edit>, <Delete>), (xiv) Overall Impression (<Edit>, <Delete>), (xv) <Add More>—the Organizer can add more by clicking on this Add More link. (c) Scale—Organizer should select a numerical scoring scale to be used in this ScoreCard configuration set. Cuzie provides three choices for the scale: (i) 1-3, (ii) 1-5, (iii) 1-9. 1 is the lowest score in the scale and the lowest score possible, and/or most negative rating that an interviewer can give. The highest number in the scale is the highest score possible, and/or the best rating that an interviewer can give. Interviewers can choose any number in the scale by clicking on the pull down menu and selecting the number by clicking on it. The number represents the interviewer's perception impressed upon him about particular criterion as it relates to the Candidate. For example, if an Interviewer perceives that a Candidate's Work Ethic is strong, he may choose a score of 9 to reflect that strong impression determined for that particular criterion. After completing this configuration set, the Organizer clicks on <Save> to save it. This new configuration set appears in the Organizer's ScoreCard management page that lists all the configuration sets.

At step 628, Interviewers use ScoreCards during Interviews. The ScoreCard can be used during (a) In-person interviews; (b) CuzieLive video conferencing interviews. ScoreCard runs as a standalone application during in-person interviews. ScoreCard can be used within video conferencing interviews, where the true power of this application shines. ScoreCard is carefully integrated with CuzieLive. See FIG. 29. During in-person interviews, the Interviewers run ScoreCard by doing the following: (1) Interviewers have access to the scorecard by clicking on the <Get ScoreCard> link in their calendar event; (2) Go to their [Tools] tab page, go to the ScoreCard section, and click on Interviews; (3) Interviewer clicks on <Run ScoreCard> to execute the ScoreCard setup for this particular interview. During in-person interviews, the Interviewers use ScoreCard by doing the following: (1) After the application loads in a new window, the Interviewer can use it; (2) As he interviews the Candidate, he chooses a number to represent the score he wants to give the Candidate for particular criterion—(a) Interviewer clicks on the pull down menu and selects a number from the scale (lowest numbers being the worst, highest numbers being the best scores), (b) Interviewer can also leave a comment related directly to this criterion by clicking on <comment>, a prompt appears for the Interviewer to type in his comments. After completing the in-person interview, and completing the ScoreCard, the interviewer can submit his scores by doing the following: (a) Interviewer clicks on <Submit> to save and submit his scores into the system; (b) The Organizer is notified that an Interviewer submitted a ScoreCard for this interview. During CuzieLive interviews, the Interviewer runs ScoreCard by doing the following: ScoreCard runs differently in the CuzieLive application than in-person interviews. When a CuzieLive session initiates, the ScoreCard application initiates as well because it is integrated in the CuzieLive interface. Unlike in-person interviews, the Interviewer should manually initiate the CuzieLive session. To see full specification of ScoreCard within CuzieLive, see FIG. 30. During CuzieLive interviews, the Interviewer uses ScoreCard by doing the following: After the ScoreCard application loads, the Interviewer can use it. As he interviews the Candidate, he chooses a number to represent the score he wants to give the Candidate for a particular criterion. The Interviewer clicks on the pull down menu and selects a number from the scale (lowest numbers being the worst, highest numbers being the best scores). The Interviewer can also leave a comment related directly to this criteria by clicking on <comment>, a prompt appears for the Interviewer to type in his comments. After completing the interview, and completing the ScoreCard, the interviewer can submit his scores by doing the following: (a) Interviewer clicks on <Submit> to save and submit his scores into the system; (b) The Organizer is notified that an Interviewer submitted a ScoreCard for this interview.

At step 630, ScoreCards are summarized by ScoreBoard. The ScoreCards from this interviewer and other interviewers in the company are recorded and displayed in the ScoreBoard application, where all the interview participants can see the cumulative scores of every Candidate summarized in a grid display. See FIG. 29. These scores and comments are then utilized later on in CuzieFeedback, a feedback application to help the Candidate realize his strengths and weaknesses during previous interviews. See FIG. 33. The processes of FIG. 28 are exemplary only.

FIG. 29 illustrates a diagram of one method for the steps and processes involved in the operation of the ScoreBoard application, which is an application that summarizes cumulative scores recorded in ScoreCards from multiple interviewers evaluating multiple Candidates and aggregating those scores in a single display, in accordance with an aspect of the present invention. At step 632, Interviews are scheduled. Once Candidate Time Slot preferences are confirmed, the interview meeting is scheduled and displayed in every relevant user's calendar. Employers can utilize the ScoreCard system for scoring all the Candidates during interviews. At step 634, the Organizer configures ScoreCards. The Organizer should create a configuration set by providing a name, editing the criteria and selecting a scale. For details on configuring a ScoreCard, see FIG. 28. At step 636, Interviewers use the ScoreCard application for evaluating Candidates during interviews. For details on using a ScoreCard, see FIG. 28. At step 638, after completing the interview, and completing his scores in ScoreCard, the interviewer submits his scores. The Interviewer clicks on <Submit> to save and submit his scores into the system. The Organizer is notified immediately of all Interviewers that submit a ScoreCard after an interview completes.

At step 640, ScoreCards are summarized by ScoreBoard. Every time a ScoreCard is submitted, the data is processed and recorded for that particular CSO instance. All the scores are aggregated, summarized, and displayed by ScoreBoard in real time. The ScoreCard(s) are aggregated, summarized and displayed in grid form: (1) Each ScoreCard represents one particular Candidate's scores received from interviewers; (2) Each ScoreCard holds every Interviewer's criteria scores and comments that were given to a Candidate; (3) In the grid, each Row encompasses scores given by an interviewer—(a) The interviewers name appears in the first column, (b) There may be numerous interviewers, thus as many rows provided and displayed; (4) In the grid, each Column represents the specific Criterion being evaluated as it applies to the Candidate—(a) There are numerous criteria, thus as many columns provided and displayed, (b) For example, Work Ethic, Professionalism, Culture Fit; (5) Each square that represents where a Row overlaps a Column, appears a number, this number represents the score determined by the Interviewer for that particular criterion—for example, a score of “9” for the criterion of “professionalism”; (6) The last column represents the total, a summary of each score given by a particular Interviewer; (7) The last column of scores are all added up and summarized in the last row by a number; (8) Cuzie can provide additional Statistics, such as—(a) The cumulative score for each Candidate, (b) The average cumulative score for each Candidate per interviewer, (c) The cumulative score by criterion for each Candidate per interviewer, (d) The average cumulative score by criterion for each Candidate per interviewer, (e) Candidate Standings—Candidates listed in descending order by cumulative scores, (ii) Candidates listed in descending order by average criterion scores. The processes of FIG. 29 are exemplary only.

FIG. 30 illustrates a diagram of one method for the steps and processes involved in operating the CuzieLive video conferencing application, which is a web based software application for conducting interviews through video conferencing technology, in accordance with an aspect of the present invention. At step 642, the Employer selects top Candidates for Face-to-Face Interviews. Once the Organizer selects a qualified Candidate to meet for an interview, he can use the ScheduleNow application to schedule the meeting. At step 644, the Organizer should complete the ScheduleNow process to schedule an interview event between Candidates and Interviewers. The Organizer should provide information, manage the scheduling, select Candidates and confirm Time Slot selections. See FIG. 27. The Organizer should provide meeting information into the ScheduleNow form. This information becomes relevant if a Candidate confirms a meeting. All the information provided is provided to the Candidate after Time Slots are confirmed. If CuzieLive is selected as the Interview Type of choice, all the relevant information is automatically sent to both parties involved in the Interview Meeting: (a) Time of Interview; (b) Instructions for initiating the CuzieLive session; (c) Reminders are sent a day before, 1 hour and 15 minutes before the interview time slot to both parties. For the Interviewer, each reminder message provides a link that transfers the Interviewer to the CuzieLive interface (which is part of the ScoreBoard application). For the Candidate, each reminder message provides a link that transfers the Candidate to the CuzieLive interface. The CuzieLive interface appears and operates differently for the Interviewer and Candidate. The Organizer clicks on <Next> to proceed to the next section of the ScheduleNow application form. The Organizer should then manage the scheduling process for both parties. It is the Organizer's responsibility to figure out time availabilities, the Organizer is assisted in breaking up the blocks of time into 30 minute increments allocated for the Organization's interviewers. The Organizer is provided a graphical calendar program that allows him to block out time: (a) Time slots are blocked out by simply clicking on time blocks, which get highlighted; (b) Time slots are blocked in 30 minute increments; (c) The Organizer should allow more than enough time slots required for the number of Candidate competing for Time Slots; (d) In the end, it's first come, first serve for the Candidates. All the Candidates receive the message to select Time Slots at the same time. Next, the Organizer should select Candidates for this round of interview meetings with the company. The Organizer should select Candidates who are deemed qualified enough for a face to face interview. If the Organizer got to ScheduleNow from clicking on ScheduleNow from a Candidate's Career Profile, CuzieMatch or CuzieScreener application, then all the Candidates that were selected in that screen appear pre-selected here when the Organizer gets to this step. At this point, all the Candidates from the <Favorites> tab page appear in a grid layout without all the information that appears in the CuzieScreener page, just the following: (1) Thumbnail photo; (2) User Id; (3) <Review> Career Profile link if the Organizer wants to review the Candidate's profile one more time. A new web page launches so that the Organizer is not knocked out of this session. The Organizer selects Candidates by clicking on the checkbox provided next to each Candidate. The Organizer then clicks on <Next> and is transferred to the next page. At this point, the Candidate should select his preferred Time Slot for conducting the interview. All the Candidates selected for this Employment Position are sent the Interview Request messages at the same time. There are numerous factors that impact when each Candidate actually receives the message. Regardless, the Candidate is provided the control in his administrative settings to configure the type of notifications that are the most expedient for the Candidate. By default, Cuzie provides internal messaging and email notifications. The Candidate may choose SMS notifications that go straight to this mobile phone. Once the Candidate receives the Interview Request message, he can quickly select his preferred Time Slot. To select a Time Slot: (a) Candidate clicks on link provided in the message body of his notification; (b) Link takes him to the website, and to this dashboard where he should respond to the request; (c) Candidate clicks on <Select Time Slot>; (d) An applet pops up with all the available Time Slots lined up from top to bottom, with each day, the Candidate just clicks on a Time Slot to select it, and then click on <submit>. The Time Slots are displayed in real time. Available Time Slots are removed, as Candidates select Time Slots. Once a Candidate selects a Time Slot, the system alerts the counter parties. The Organizer can then confirm, or the interviewer can confirm the selection. Once the Time Slot is confirmed, the interview meeting is recorded in all relevant parties' calendar at step 646. The Organizer can view all the scheduled interviews in the Manage CSO section of his account.

At step 648, CuzieLive connections are made. Interviewers should initiate the CuzieLive session. The Employer initiates the CuzieLive session call by clicking on <Start CuzieLive Session>. The Candidate should be signed into his account once the scheduled interview Time Slot has passed. When the Employer initiates the call, the Candidate just needs to answer the CuzieLive call request that appears on his screen to complete the video conference connection. Once the CuzieLive connection is complete: (1) The video transmission of the Employer appears in the video screen for the Candidate; (2) The video transmission of the Candidate appears in the video screen for the Employer. Either party can terminate the video call by clicking on <End CuzieLive>. If either party is cut off, by technical difficulties, either side can reinitiate the call at any time by clicking on the <Reconnect CuzieLive>. For the Employer to be a No Show, two conditions should apply: (1) Scheduled Candidate is signed into his account assumed waiting for connection request; (2) Interviewer has failed to initiate the CuzieLive session within 10 minutes after the scheduled time of the CuzieLive session. After the missed connection is deemed a No Show, the Candidate is informed with a prompt on his screen that the Employer has failed to initiate the call, the opening for the CuzieLive session is terminated and the Candidate is suggested to contact the Organizer and reschedule. Candidates are considered a No Show if one of the following conditions apply: (1) Failure to Accept—Candidate fails to accept the CuzieLive connection request within 10 minutes after the schedule interview time has passed (either the Candidate signed out of his account or the Candidate is signed in but never clicks on <Accept Call> after the Interviewer sends the request); (2) Refused Call—Candidate clicks on <Refuse Call> on the CuzieLive connection request; (3) Premature Termination—Candidate prematurely terminates the CuzieLive session barring technical issues or reasonable cause. There can be penalties for No Shows. No Show penalties for Employers can include: (1) Employers are fiscally responsible for No Shows; (2) Employers are charged for the call, and their account is debited. No Show penalties for Candidates can include: (1) Candidate accounts are flagged after the first No Show; (2) After three No Shows, the Candidate's account is suspended—(a) the Candidate should contact Cuzie customer support to enable the account, (b) or wait 3 days for the account to automatically enable, (c) after every suspension, the suspension period doubles, (d) the Candidate can enable the account before the time has passed by paying the price of the CuzieLive session, (e) if the Candidate has an advanced account, has a credit card on file, or has a positive credit balance in his account, the Candidate's account is debited a Now Show penalty charge.

At step 650, the Employer is debited for the CuzieLive session. A CuzieLive video conferencing session is considered complete if the following conditions apply: (a) Employer initiates the CuzieLive session within 10 minutes passed the scheduled interview time; (b) Candidate accepts the call within 10 minutes passed the schedule interview time; (c) The CuzieLive session terminated by the Interviewer. If a CuzieLive video conferencing session is considered complete, the Employer is charged for the call, and the Employer's account is debited for the CuzieLive Session. Additional charges for extended use may apply and added to the charge accordingly. At step 652, the Employer and Candidate talk over CuzieLive. The Employer evaluates the Candidate using ScoreCard, see FIG. 28. At step 654, if the CuzieLive conversation exceeds the 45 minute limit, additional charges may be assessed for extended use. The processes of FIG. 30 are exemplary only.

FIG. 31 illustrates a diagram of one method for the steps and processes involved with operating the HireNow application, which is a software application for managing job offers, in accordance with an aspect of the present invention. After a thorough vetting of available Candidates using every possible application for identifying the most qualified Candidates, the Employer is confident in extending a Job Offer to one or more of the Favorites, see “Favorites” in FIG. 26. At step 656, the Employer can extend a Job Offer to the select Candidates using HireNow. At step 658, the Organizer can initiate the HireNow application by clicking on <HireNow> from: (a) The CandidateComp Candidate comparison grid, there is a<HireNow> link provided for this; (b) <Our Job Offers> tab page, also known as the HireNow Manager administrative page (where the Organizer can click on <Extend a Job Offer> link provided for this purpose). After clicking on either <HireNow> or <Extend a Job Offer>, the Organizer is brought to the Job Offer form. In the form, the Organizer should fill out information and input some choices: (a) Select Candidate's name from a pull down menu. (b) The Organizer links CSO to this offer, necessary for system cleanup. By linking the CSO, system knows to pre-fill the following information—Job Title, Address of Employment, Number of positions open, Start Date, Salary or Rate Offer, Benefits (form for cut and paste from pre-existing text document and <browse> for attaching PDF document), Deadline for Response (12 hour minimum time allocation starting at 5 PM of deadline date chosen), Negotiation Contact, Secondary Docs to provide to Candidate (provided after Candidate accepts offer) (<browse> for attaching PDF document), Starting Day Contacts (provided after Candidate accepts offer), Transportation and Parking information (provided after Candidate accepts offer), Training Information (provided after Candidate accepts offer) (form for cut and paste and <browse> for attaching PDF document). Organizer can make final adjustments after review it.

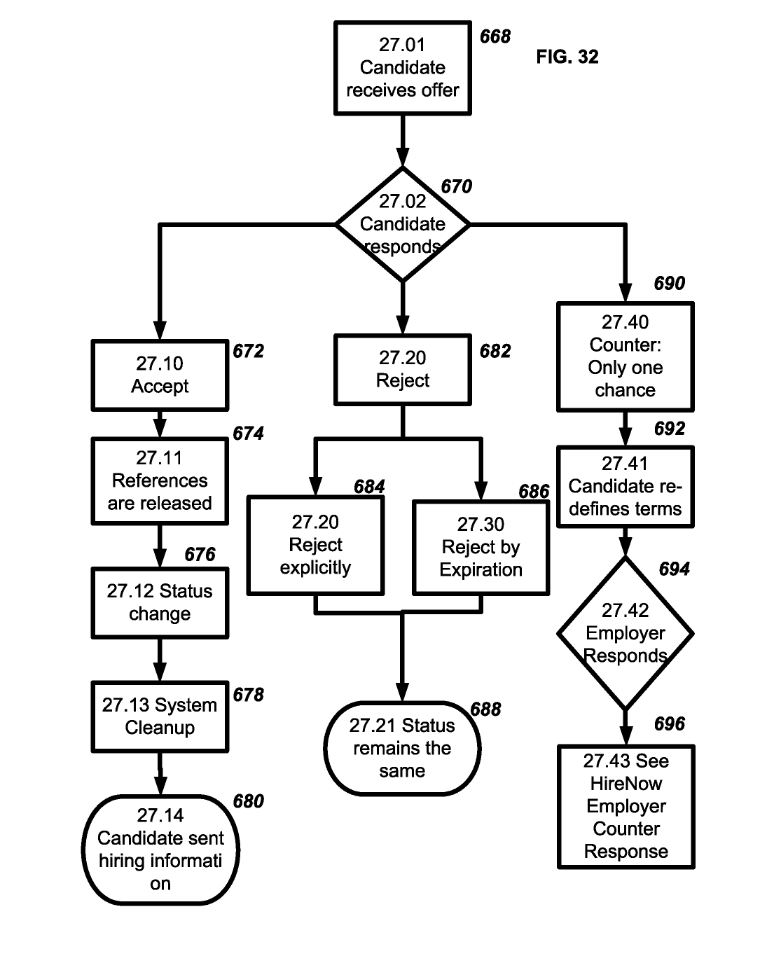

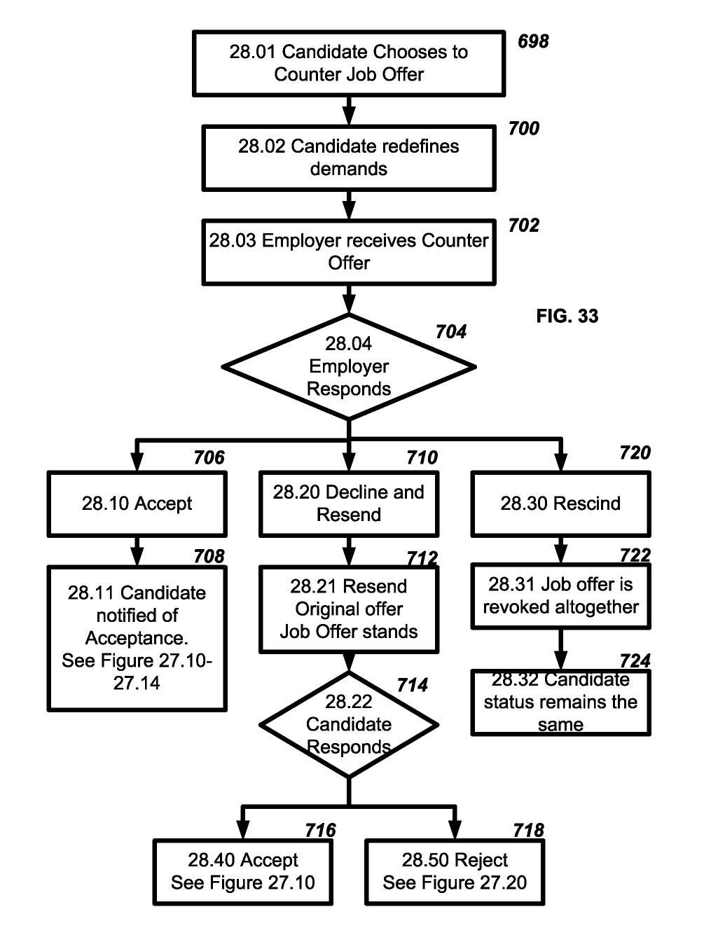

At step 660, the Organizer sends the Offer to the Candidate finalists. After completing the HireNow form, the Organizer can send the Job Offer message by clicking on <Send> provided at the end of the form for this purpose. After clicking on <send> the Job Offer is transmitted and delivered to the Candidate finalists. At step 662, the Candidate finalist receives the Job Offer message immediately. There are numerous external factors that impact when each Candidate actually receives the message. The Candidate is provided the control in his administrative settings to configure the type of notifications that are the most expedient for the Candidate. The Candidate may choose SMS notifications that go straight to this mobile phone, which may incur extra charges of course. By default, Cuzie provides internal messaging and email notifications. The Candidate clicks on link provided in the message body of either message. By clicking on the link, Candidate is transferred to his dashboard where he sees the Job Offer message can respond to the Job Offer. To see the full illustration of how a Candidate can respond to the HireNow job offer, see FIG. 31. At step 664, the Candidate responds to the Offer. At step 666, the Candidate responds using the HireNow application, see FIG.32. The processes of FIG. 31 are exemplary only.

FIG. 32 illustrates a diagram of one method for the steps and processes involved with using the HireNow application after an Employer extends a Job Offer to a Candidate finalist in accordance with an aspect of the present invention. HireNow is a software application for managing the Candidate's response after receiving notice that a Job Offer has been extended to him. At step 668, the Candidate finalist receives the Job Offer message immediately. By default, Cuzie provides internal messaging and email notifications. To see the full illustration of how a Candidate receives Job Offers, see step 662. At step 670, the Candidate can respond by clicking on the link provided in the message body of either message notification. He is then brought to his dashboard where he is notified again of the Job Offer message. He clicks on <Review> to initiate the Review process. The Candidate then can review all the details of the Job Offer. After reviewing the Job Offer details, he is prompted at the end to respond to the offer. The Candidate can see here that there is a timer at the end of the message that coincides with the deadline set by the Organizer to notify the user when the Job Offer expires. The Timer deadline clock initiates as soon as the Organizer sends the message. The Candidate should respond before the Job Offer expires. To respond, the Candidate has three choices: (a) Accept; (b) Reject—(1) Explicitly or (2) By Expiration; or (c) Counter.

The Candidate chooses to respond and Accept the Offer at step 672. If the Candidate chooses to Accept all the Terms and Conditions of the Job Offer, he can accept the job offer. The Candidate accepts the Job Offer by clicking on <Accept Job Offer> provided for this purpose. At step 674, once the Candidate clicks on <Accept Job Offer>, his Referrals are released, and the Candidate is notified of this step. If the Candidate has no Referral listed, he is prompted to provide them immediately. The Candidate cannot bypass this screen until his Referrals are provided. Thus, the Acceptance is in limbo, and the deadline clock continues until he completes the listing of his Referrals. Once the Candidate completes his Referral, his acceptance is delivered immediately and submitted into the system. The Employer is then notified of his acceptance and several more automatic steps are initiated. At step 676, the Candidate is notified that his Job Status changed to <Not Looking>. The Job Status change does the following: (a) Discontinues any running CPOs the Candidate has submitted—the CPOs are saved but are taken out of search eligibility and notifications about Job Searches are discontinued. (b) Removes his name from any CSO search list results—thus the reference to the Candidate is removed from any statistics and statistics related to the Candidate's appearance are updated upon his removal. (c) Bars the Candidate from any CSO searches conducted by Employers. The Candidate can manually change his Job Status back to <Open> or <Looking> and then the Candidate can reinitiate his CPOs by simply re-submitting them and his CPOs are then eligible for CSO search again. At step 678, automatic system cleanup occurs. Once the Candidate clicks on <Accept Job Offer>, the system conducts some automatic clean up of the following: (a) the CSO is discontinued, if one available position was listed for this Job Role in the CSO, the CSO is grayed out in the CSO manager. (b) If more than one position is available for this Job Role, the number displayed is reduced by one. (c) Any active Statistics related to the CSO are discontinued and wiped clean. (d) The “favorites” list remains for 30 days in the case the first choice Candidate rejects, or does not work out, the Employer can reference back to the favorites list as a backup. At step 680, the Candidate is sent hiring information. Once the Candidate clicks on <Accept Job Offer>, a message is sent to the Candidate that includes all the post-acceptance information and documents included in the HireNow application that the Organizer completed previously. The Candidate receives (a) Hiring information that was cut and pasted or attached as a document; (b) All of the contact information of those related to the Candidate's training and first day on the job; (c) Traveling information; (d) Location information; (e) Background information about the Candidate's first day.

At step 682, the Candidate chooses to respond and Reject the Offer. The Candidate can Reject the Job Offer in two ways: (a) By clicking on <Reject Job Offer> at step 684; (b) By ignoring the Job Offer and letting it expire at step 686. At step 686, the Candidate ignores the Job Offer and lets it expire. By letting it expire, the Employer is simply informed that the Job Offer expired, when the deadline passes. No additional information is exchanged between both parties. By rejecting the offer, Candidate's existing controls and status remains the same as shown at step 688 where: (a) the Candidate's Job Status control remains the same; (b) the Candidate remains eligible for CSO searches; (c) the Candidate's current CPOs continue running.

At step 690, the Candidate chooses to respond and Counter the Offer. If the Candidate does not accept all the Terms and Conditions set in the HireNow Job Offer, but wants the position, he can choose to Counter the Offer. The Candidate Counters the offer by clicking on <Counter Job Offer> provided for this purpose. The Candidate is immediately notified of the rules and steps involved in the Counter process such as the following: (a) the Candidate only has one chance to make a counter; (b) the Candidate can counter the following—(1) Salary, (2) Benefits, (3) Other; (c) the Employer can respond to the Candidate's Counter by—(1) Accepting the Counter, (2) Rejecting it, but keeping original offer, only once, (3) Rejecting it, and rescinding the offer altogether. At step 692, the Candidate can counter the Terms of the Offer through the following application process The Candidate selects which term he wants to counter—(1) Salary, (2) Benefits, (3) Other. The Candidate clicks on checkbox provided next to the term for this purpose. After clicking on the checkbox, a prompt appears next to the term for the Candidate to type in his counter comment. The Candidate can type in his offer for: (a) Salary, where only a number is allowed to be entered; (b) Benefits, where a free form type in prompt is provided with, for example, a 500 character limit; (c) Location, where a free from type in prompt is provide with, for example, a 300 character limit. At the end of the Counter form, another commentary prompt is provided where the Candidate can type in an explanation of his counter with, for example, a 1,000 character limit. The Candidate can save the Counter to preview it. After previewing it, the Candidate can save it. The Candidate can send the Counter message by clicking on <Send Counter Offer>. At step 694, the Employer responds to the Candidate's Counter. The Employer receives the Counter immediately. The Job Offer deadline clock is suspended until the Employer responds. At step 696, the Employer uses the HireNow application to make a Counter Response, see FIG. 33. The processes of FIG. 32 are exemplary only.

FIG. 33 illustrates a diagram of one method for the steps and processes involved with the HireNow application with how an Employer responds to Candidate's Job Offer Counters in accordance with an aspect of the present invention. HireNow is a software application for managing the Candidate's response after receiving notice that a Job Offer has been extended to him. At step 698, the Candidate chooses to Counter the Offer by the Employer. If the Candidate does not accept all the Terms and Conditions set forth in the Offer, but wants the position, he can choose to Counter the Offer. The Candidate counters the offer by clicking on <Counter Job Offer> provided for this purpose. The Candidate is immediately notified of the rules and steps involved in the Counter process. The Candidate only has one chance to make a counter. For a more detailed description of the Candidate Job Offer counter see FIG. 32 and step 690. At step 700, the Candidate can redefine its demands and Counter the following Terms: (1) Salary; (2) Benefits; (3) Other. The Candidate sends the Counter message by clicking on <Send Counter Offer>. The Job Offer deadline clock is suspended until the Employer responds. For a more detailed description of the Candidate Job Offer counter see FIG. 32 and step 690. At step, 702, the Employer receives the Counter. The Employer receives the Counter notification immediately. At step 704, the Employer responds to the Counter. The Employer can respond in three ways: (a) Accept; (b) Decline the Counter, resend Job Offer; (c) Reject altogether, decline counter and rescind Job Offer.

If the Employer agrees with the Candidate's Counter of Terms, he can accept the counter request and adjust his Job Offer at step 706. Once the Organizer selects <Accept Job Offer Counter> to accept the Candidate's Term adjustment request in the Counter. The system goes through its clean up routine for the Candidate and Employer and the CSOs and CPOs are discontinued related to this Job Role. The Organizer clicks on <Accept Job Offer Counter> to accept the Candidate's Job Offer counter. The Organizer is then brought to the HireNow application where adjustments can be made to the original offer. The form highlights where changes need to be made and provide thought balloons which displays the Candidate's counter comments to help remind the Organizer which adjustments to make. Once the HireNow form amendments have been implemented, the Organizer clicks on <Resend Job Offer>. After receiving the amended offer, once the Candidate clicks on <Accept> to accept the amended terms, the CSO is considered filled. No additional Counter option is provided. Not Even Accept or Reject are provided because the Employer already accepted the counter, thus an agreement has been reached between both parties. When the Candidate receives the Adjusted Job Offer, he can review the amendments in the adjusted offer for mistakes. If corrections are needed, he clicks on <Corrections Needed> and a prompt appears for this purpose for the Candidate to request clarification or request the Employer to fix a typo or to make an adjustment that has been missed. At step 708, the Candidate is notified that the Employer accepted the Counter. Once the Employer clicks on <Accept Job Counter Offer> the Candidate is notified of the Employer's acceptance. The same process for when a Candidate Accepts a Job Offer then occurs. See steps 672 through 680.

At step 710, the Employer declines the Counter and resends the original Offer. If the Employer disagrees with the Candidate's Counter of Terms, but deems the Candidate worthy of the position based on his original terms, the Organizer may choose to Decline and Resend. At step 712, with Decline and Resend, the Organizer declines Candidate's Term Counters and is only willing to offer the original terms. Thus, Organizer resends the original Job Offer terms back to the Candidate. At step 714, the Candidate receives the Decline and Resend message. The Candidate only has two response choices: (a) Accept; (b) Reject. At step 716, the Candidate can Accept the original Job Offer Terms by clicking on <Accept> provided for this purpose. At step 718, the Candidate can Reject the original Job Offer Terms by (a) clicking on <Reject Job Offer> provided for this purpose, or (b) expiration where the Candidate ignores the Offer and lets the Job Offer expire. Once a rejection is realized by the system, Candidate is removed and barred from the current CSO and removed from the search results.

At step 720, the Employer decides to not to accept the Candidate's Counter and rescinds the Offer. If the Employer disagrees with the Candidate's Counter of Terms, and deems that Candidate is no longer worthy of the position based on the Candidates Counter, the Organizer may choose to Rescind. At step 722, the Offer is revoked. By clicking on <Rescind> the Organizer not only declines the Counters but decides to retract the original Job Offer altogether; thus rescinding the entire Job Offer from the Candidate. At step 724, the Candidate receives the Rescind message, the candidate's Job Status remains the same and no response is required or provided for this purpose. Candidate is removed and barred from the current CSO and removed from the search results. Appropriate entries are made in a database maintained by the server of FIG. 1 to track that the Candidate is barred. Prior to all offers, the server checks the database to insure that the Candidate is currently eligible for the CSO. In other embodiments of the present invention, any number of counteroffers can be made and tracked, and the number of counteroffers can be unlimited. The processes of FIG. 33 are exemplary only.

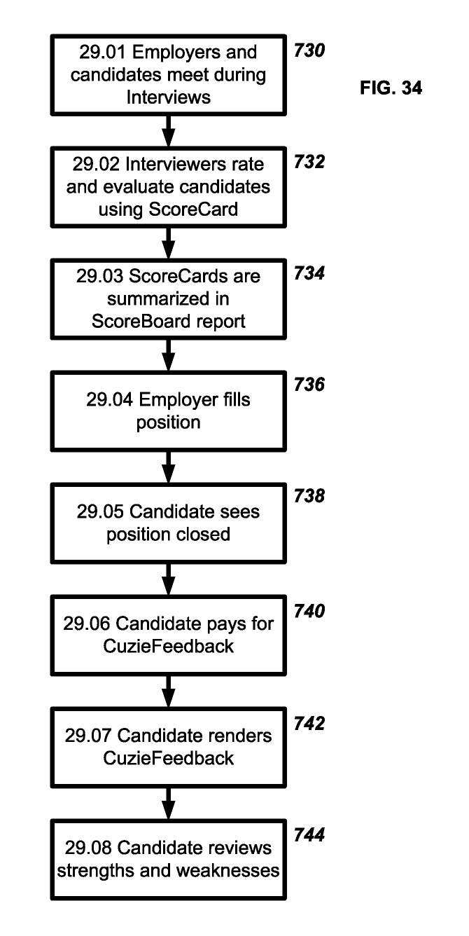

FIG. 34 illustrates a diagram of one method for the steps and processes involved in operating the CuzieFeedback application, which is a software application that provides Candidate's summary insight from their interview performances, if the Candidate was not hired. At step 730, Employers and Candidate meet during interviews. CuzieFeedback only applies to interviews when the Employer utilizes ScoreCard in evaluating the Candidate during the interviews. By using CuzieLive, ScoreCard is prominently integrated into the CuzieLive interface. At step 732, Interviewers utilize the ScoreCard system in evaluating the Candidates during interviews. For a more detailed description of the operation of ScoreCards, see FIG. 28. At step 734, all the ScoreCards by Interviewers about Candidates related to a CSO are aggregated and summarized by the ScoreBoard application. For a more detailed description of the operation of ScoreBoard, see FIG. 29. At step 736, when an Employer fills a position, the CSO is discontinued. At step 738, the Candidates can see in their statistics that the number of availabilities for the Job Role at an Employer that interviewed them has gone to 0 (zero) and has been discontinued. At step 740, the Candidate may choose to utilize CuzieFeedback application. This system provides the Candidate insight into their strengths and weaknesses. The system provides an automated summary of strengths and weaknesses of the Candidate as perceived by Interviewers. All the information is taken from data and comments provided by interviewers in ScoreCards. None of the conclusions provided to the Candidate can be attributed back to a particular interviewer. This service is available only after a Candidate has been through at least 5 different organizations for interviews.

At step 742, the Candidate is provided the following conclusions: (a) Strongest Attributes—(1) List 3 criteria that rendered the highest Average score, (2) List 3 criteria that rendered the highest Total score, (3) Comments from the 3 highest scores altogether for a particular criterion, if provided by interviewer; (b) Weakest Attributes—(1) List 3 criteria that rendered the lowest Average score, (2) List 3 criteria that rendered the lowest Total score; (c) Career Profile Suggestions—(1) Improve Education degree level where the system compares the Candidate's degree level with average degree level of competitors, if there were competitors interviewing for same CSO (Job Role), (2) Get more Respects where the system compares the Candidate's number of Respects with the average number of Respects by competitors, (3) Get more Referrals where the system informs the Candidate that it is always better to accumulate more Referrals, (4) Get more skills where the system compares the Candidate's number of skills with that of his competitors and provides a list of skills that his competitors had that the Candidate did not have listed. At step 744, the Candidate can render his own conclusions and make the proper adjustments to his profile or search strategy.

Each of these steps are performed, as appropriate, by the servers or the remote terminals shown in FIG. 1. The processes of FIG. 34 are exemplary only.

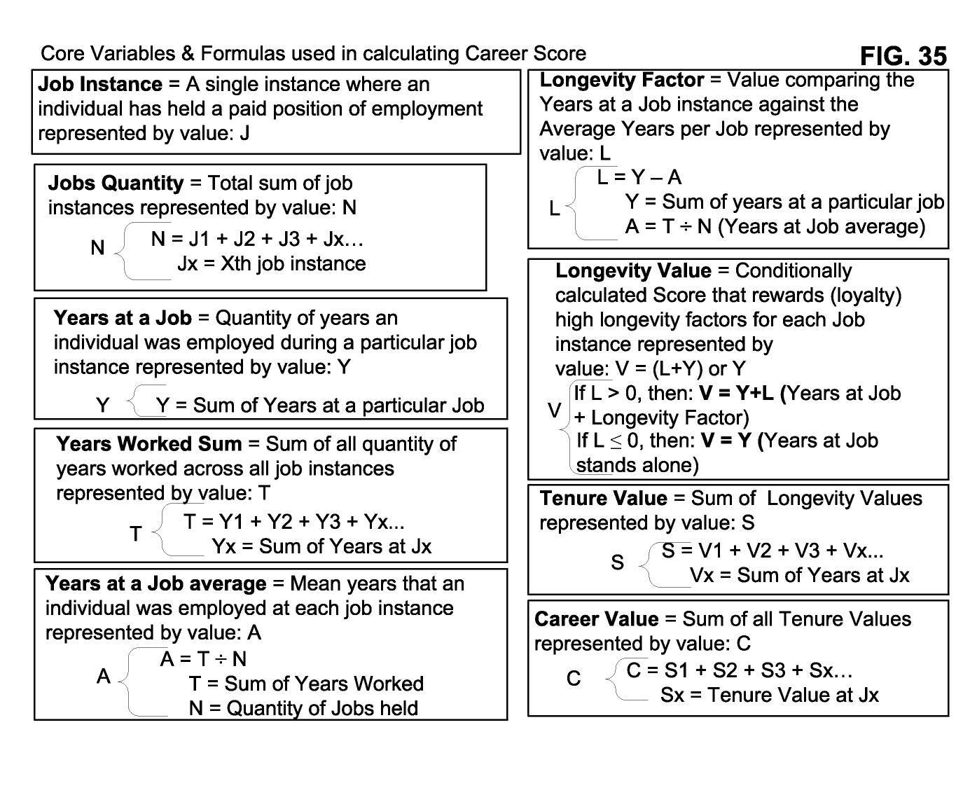

FIGS. 35 to 48 illustrate a method of quantifying an applicant for an opportunity. In general, the quantifying step can depend on a number of factors, including any combination of a career score, an education score, a respects score, a referrals score, an awards score.

FIG. 35 illustrates variables and equations used in calculating a career score in accordance with an aspect of the present invention. A Job Instance, value J is a single instance where an individual has held a position of employment. A Jobs Quantity value N is the total sum of job instances an individual has held. So for example, if N=J1+J2+J3+Jx . . . , then, J1 is the first job instance, J2 is the second job instance, J3 is the third job instance, J(x) is the (x)th job instance, and so on.

Total years of work experience can also be determined. This is the sum of all years worked represented by T. Thus, T=Y1+Y2+Y3+Y(x) . . . , where Y1 is the sum of years at job 1 (J1), Y2 is the sum of years at job 2 (J2), Y3 is the sum of years at job 3 (J3), and Y(x) is the sum of years at Job xth (Jx).

The average years per job, value A, can also determined. Mean years that an individual was employed at each job instance is represented by value: A. A can be determined as T divided by N, where T is the sum of years worked and N is the quantity of Jobs held.

A Longevity Factor can also be determined. The Longevity Factor is a Value comparing the Years at a Job instance against the Average Years per Job represented by value: L. L can be represented as L=Y−A, where Y equals the sum of years at a particular job and A (Average Years per Job) equals T (Years Worked Sum) divided by N (Jobs Quantity).

A Longevity Value can also be determined. The Longevity Value is a Conditionally calculated Score that rewards (loyalty) high longevity factors for each Job instance represented by value: V. V can be determined as V equals (L+Y) or Y. In accordance with n aspect of the present invention, if L>0, then: V=Y+L (Years at Job+Longevity Factor) and if L≦0, then: V=Y (Years at Job) standing alone.

A Tenure Value can also be determined. Tenure Value can be determined as the Sum of Longevity Values represented by value: S, where S=V1+V2+V3+Vx . . . and V1=Sum of Years at J1, V2=Sum of Years at J2, V3=Sum of Years at J3 and Vx=Sum of Years at Jx.

A Career Score can also be determined. The Career Score can be determined as the sum of all Tenure Values represented by value: C where C=S1+S2+S3+Sx, where S1=Tenure Value at J1, S2=Tenure Value at J2, S3=Tenure Value at J3, Sx=Tenure Value at Jx. The processes of FIG. 35 are exemplary only.

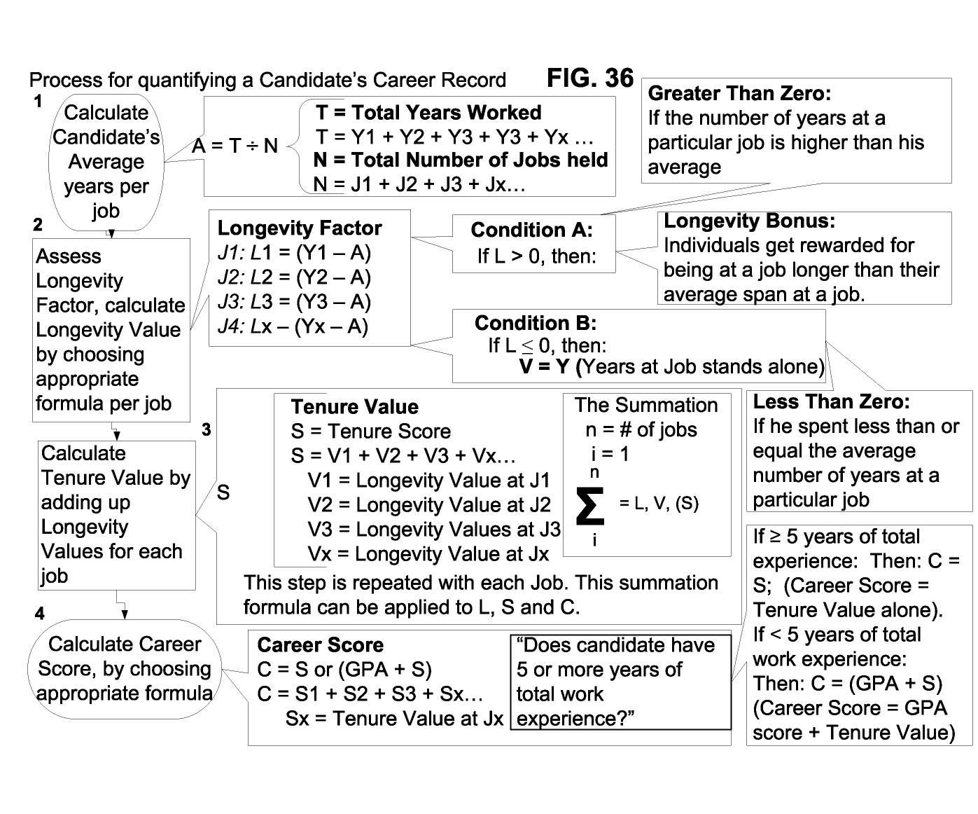

Referring to FIG. 36, a calculation of a career score is illustrated in accordance with an aspect of the present invention. First, a processor in a server of the invention calculates for the average years per job based on information entered by the applicant. This can be calculated in the manner described above and illustrated in FIG. 36. Then, then processor determines to assess Longevity Factor and calculates the Longevity Value by choosing appropriate formula per job. This is done in the manner described above and illustrated in FIG. 36. Then the processor calculates Tenure Value by adding up Longevity Values for each job.

The S is calculated by the processor in the servers illustrated in FIG. 1. The calculation is performed as

$${\sum }_{i}^{n} = L , V , ( S ) ,$$

a summation where n being the number of instances, in this case 4, i being the starting point, in this case 1, L being the Longevity factor calculation being repeated as per number of job instances, in this example 4, V being the Longevity values per job instance, S being the final resulting value by the summary of all V values, as illustrated in FIG. 36.

Finally, the processor calculates a Career Score, by choosing an appropriate formula. Either C=S or C=(GPA+S). The Candidate's GPA Value is represented by value “GPA”. If candidate has 5 or more years of total work experience, then: C=S (i.e. the Career Score=Tenure Value stands alone) However, if a candidate has less than 5 years of total work experience, then: C=(GPA+S) (i.e. Career Score=Candidate's GPA score value+Tenure Value). The processes of FIG. 36 are exemplary only.

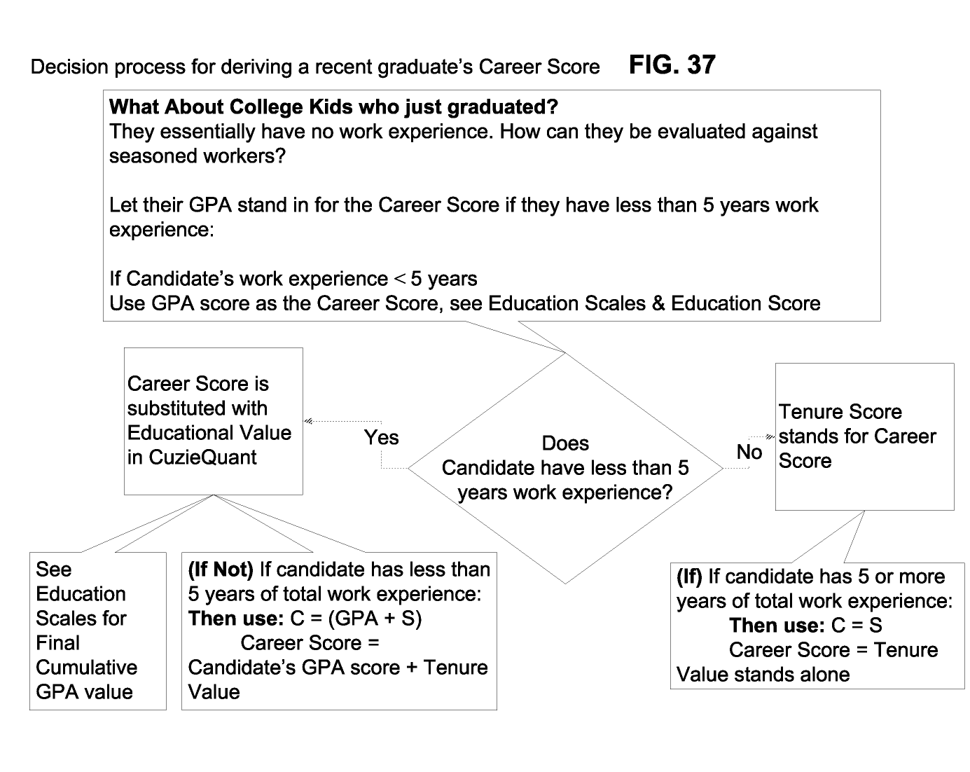

In FIG. 37, the situation where a job applicant is a recent college graduated is illustrated. In this case, the applicant has essentially no work experience. The question is how can they be evaluated against seasoned workers? In accordance with an aspect of the present invention, the systems and methods of the present invention allows the applicant's GPA value, as further explained, stands in for the Career Score if they have less than 5 years work experience. On the other hand, if the Candidate's work experience is greater than 5 years, then the tenure score explained above stands.

Thus, in accordance with an aspect of the present invention, if the Candidate has less than 5 years work, an Educational Value is used in place of the Career Store. Then C=GPA+S. The processes of FIG. 37 are exemplary only.

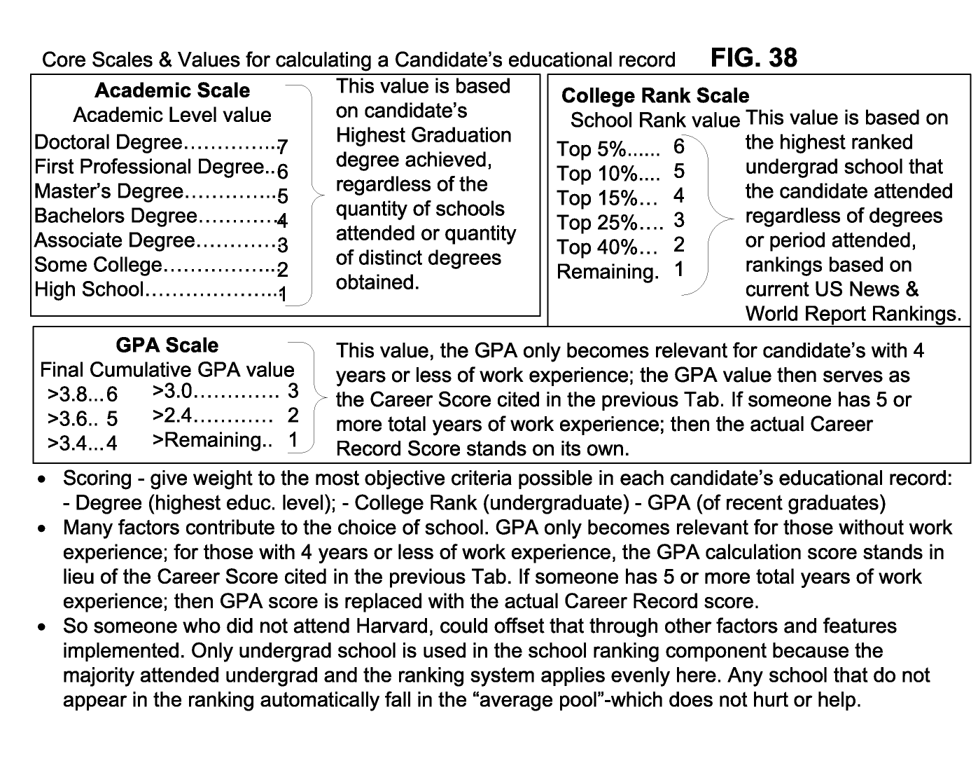

FIG. 38 illustrates one method of calculating the Educational Value in accordance with an aspect of the present invention. The basic premise is to give weight to the most objective criteria possible in each candidate's educational record, including the Degree (highest educational level); the College Rank (undergraduate) and the GPA (of recent graduates). Many factors contribute to the choice of school. In the end, everyone chooses the best school that they can afford. GPA only becomes relevant for those without work experience; for those with 4 years or less of work experience, the GPA calculation score value stands in lieu of the Career Score cited in the previous Tab. If someone has 5 or more total years of work experience; then GPA score is replaced with the actual Career Record score. So someone who did not attend Harvard, could still offset that competitive shortcoming through other factors and features implemented in CuzieQuant. Only undergraduate school is used in the school ranking component because the significant percentage of working class individuals attended undergrad and the ranking system applies evenly here. Any school that does not appear in the ranking automatically falls in the “average pool”—which does not hurt or help the individual.

In accordance with an aspect of the present invention, an academic scale as follows can be used: Doctor's degree is 7 points, First Professional Degree is 6 points, Master's Degree is 5 points, Bachelor's Degree is 4 points, an Associate's Degree is 3 points, some college is 2 points and high school is 1 point. This value, in accordance with an aspect of the present invention, is based on a Candidate's Highest Graduation degree achieved, regardless of the quantity of schools attended or quantity of distinct degrees obtained.

Also, in accordance with an aspect of the present invention, a college rank scale is used. If the candidate graduated from a top 5% school 6 points is given. If the Candidate graduated from a top 10% school, then 5 points is give. If the candidate graduated from a top 15% school 4 points is given. If the Candidate graduated from a top 25% school, then 3 points is given. If the candidate graduated from a top 40% school then 2 points is given. In all other cases, 1 point is given.

In accordance with another aspect of the present invention, this value is based on the highest ranked school that the candidate attended regardless of degree or period attended, rankings are based on current US News & World Report Rankings, annual report.

A GPA scale also contributes to the Educational Value in accordance with another aspect of the present invention. As shown in FIG. 38, if the Candidate got better than a 3.8, 6 points are given. If the Candidate got better than a 3.6, 5 points are given. If the Candidate got better than a 3.4, 4 points are given. If the Candidate got better than a 3.0, 3 points are given. If the Candidate got better than a 2.4, 2 points are given. In other cases, 1 point is given. The processes of FIG. 38 are exemplary only.

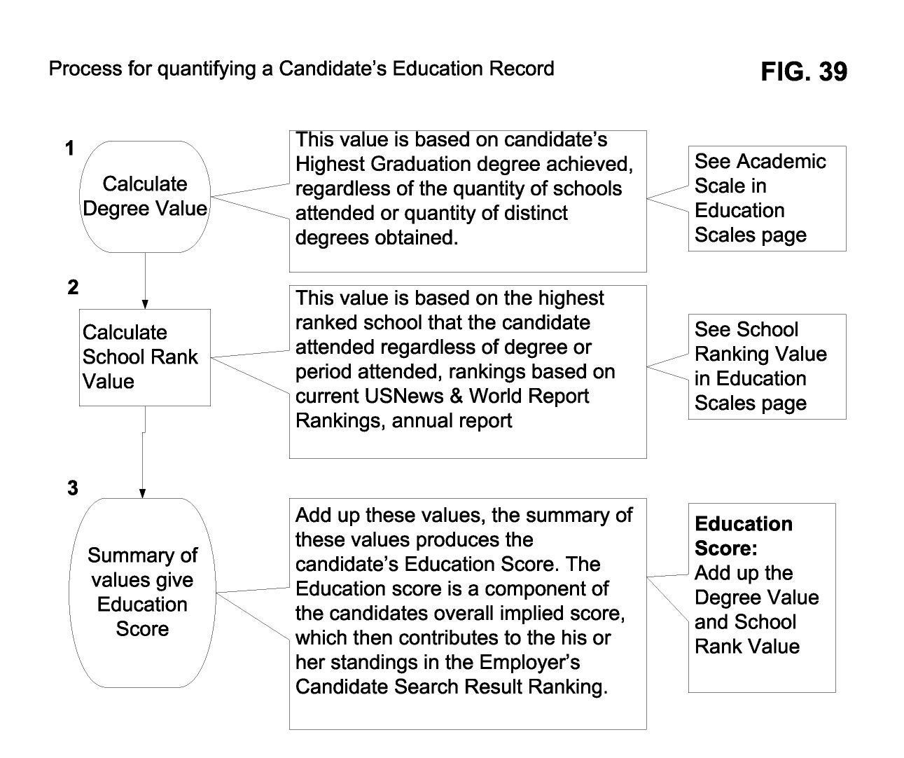

Referring to FIG. 39, the calculation of the Educational Value is described in accordance with an aspect of the invention. First, the degree value is determined as described above and as described in FIG. 39. Then, the school rank is determined as described above and as described in FIG. 39. Then the GPA scale is calculated as described above and as described in FIG. 39. The Educational Value, in accordance with one aspect of the invention, is determined by summing these scores. These components (school, degree and GPA) can be used in any manner or scale and the values can be determined with many different formulas. The processes of FIG. 39 are exemplary only.

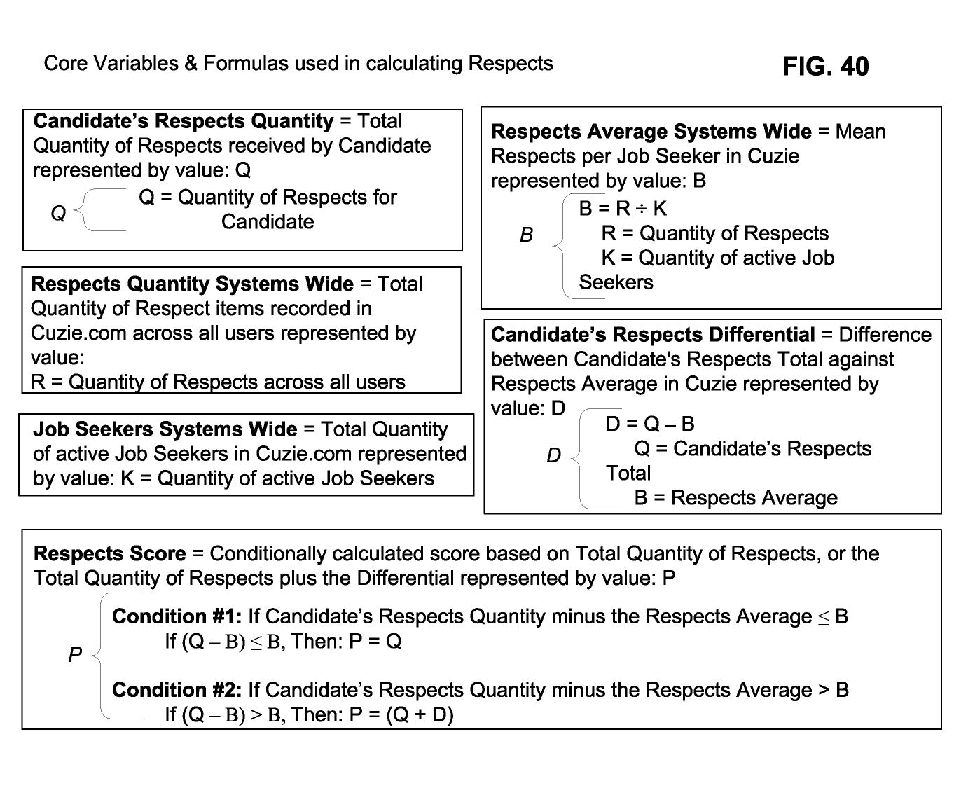

FIG. 40 illustrates a determination of another component of the quant score assigned to Candidates in accordance with an aspect of the present invention. This component is a Respects component. It measures how many respects other members of the system have given to the Candidate. The following parameters are determined in accordance with an aspect of the invention.

A Candidate's Respects Total is the Total Quantity of Respects received by Candidate represented by value: Q. The Respects Quantity Systems Wide is the Total Quantity of Respect items recorded in Cuzie.com across all users shown in FIG. 1 and is represented by value: R. The Job Seekers Systems Wide quantity is the Total Quantity of active Job Seekers in Cuzie.com in FIG. 1 and is represented by value: K. K, in accordance with an embodiment of the present invention is the number of job seekers in the registration database of the system of FIG. 1 that have actually submitted a Job Pursuit Order. The Respects Average Systems Wide is determined as the Mean Respects per Job Seeker in Cuzie represented by value: B. B is determined as B=R divided by K.

The processor also determines a Candidate's Respects Differential. Difference between Candidate's Respects Total against Respects Average per Candidate in Cuzie represented by value: D. The processor determines it as D=Q minus B.

The processor determines a Respects Score as Conditionally calculated score based on Total Quantity of Respects, or the Total Quantity of Respects plus the Differential represented by value: P. Thus, there are two conditions. Condition 1 is if the Candidate's Respects Total minus the Respects Average≦B (if D≦B). In that case, P=Q. Condition 2 is if the Candidate's Respects Total minus the Respects Average>B (if D>B). In that case, P=(Q+D).

All of these calculations and determinations are performed by the processor or processors illustrated in FIGS. 1 and 2. The processes of FIG. 40 are exemplary only.

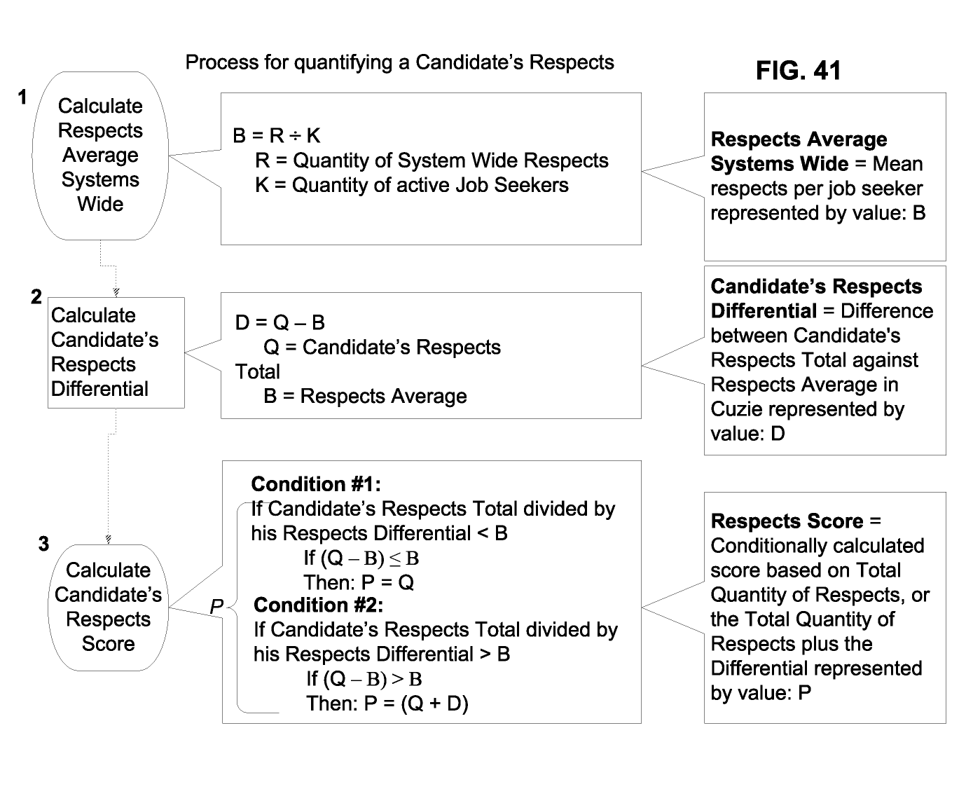

FIG. 41 further illustrates the calculation of the Respects Score. First, the Respects Average systems wide is determined as described above and as described in FIG. 40. Then, the Candidate's Respects Differential is determined as described above and as described in FIG. 40. The Respects Score is then determined as indicated and as described. The processes of FIG. 41 are exemplary only.

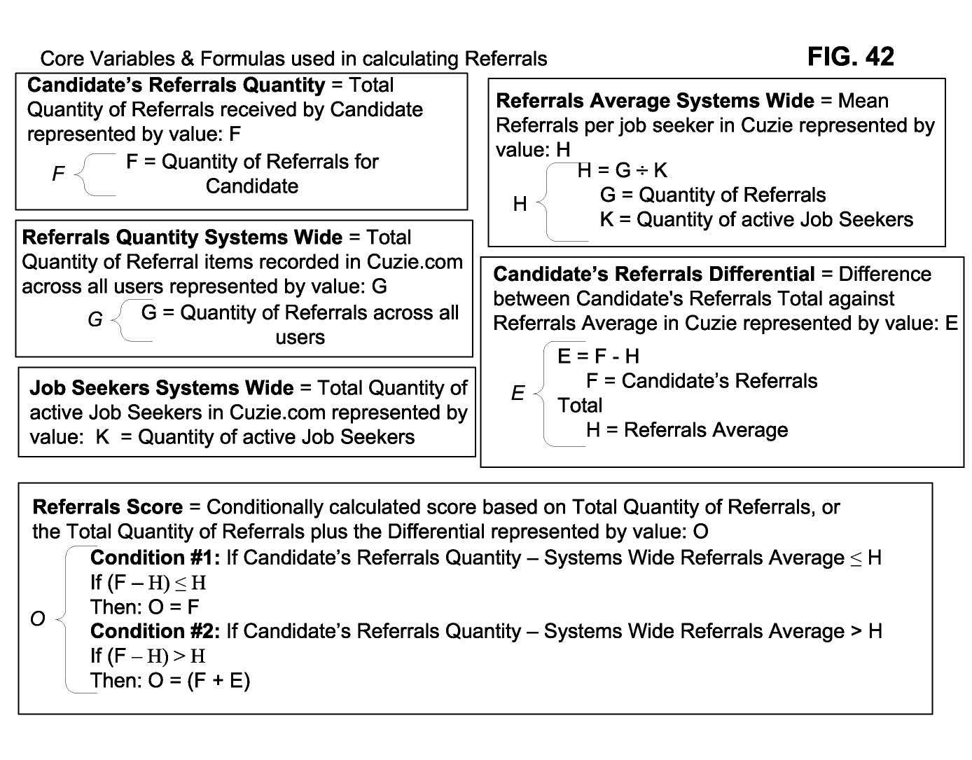

FIG. 42 illustrates a determination of another component of the quant score assigned to Candidates in accordance with an aspect of the present invention. This component is a Referrals component. It measures how many referrals have been given to the Candidate. The following parameters are determined in accordance with an aspect of the invention.

A processor determines a Candidate's Referrals Quantity. It is determined as the Total Quantity of Referrals received by Candidate represented by value: F. The processor also determines a Referrals Quantity Systems Wide as the Total Quantity of Referral items recorded in Cuzie.com across all users of FIG. 1 and is represented by value: G. Thus G is equal to the quantity of referrals across all users. The processor also determines the Job Seekers Systems Wide as the total quantity of active job seekers in the system of FIG. 1 and is represented by the value K. In accordance with an aspect of the present invention, job seekers are registered users that have submitted a CPO. The processor then determines a Referrals Average Systems Wide as the Average (mean) Referrals per job seeker in the system, which is represented by value: H. Thus, H=G+K, where G=Quantity of Referrals and K=Quantity of active Job Seekers (those that submitted a CPO). The processor also determines a Candidate's Referrals Differential as the Referrals Average in Cuzie represented by value: E.

Thus, E=F−H, where F=Candidate's Referrals Total and H is defined above.

The processor then determines a Referrals Score as a conditionally calculated score based on Total Quantity of Referrals, or the Total Quantity of Referrals plus the Differential represented by value: 0. Thus, the Referrals Score is conditional in accordance with one aspect of the present invention. In Condition 1, if Candidate's Referrals Total−Systems Wide Referrals Average≦H (if E≦H), then: O=F. In Condition 2, if Candidate's Referrals Total−Systems Wide Referrals Average>H (if E>H), then O=(F+E). The processes of FIG. 42 are exemplary only.

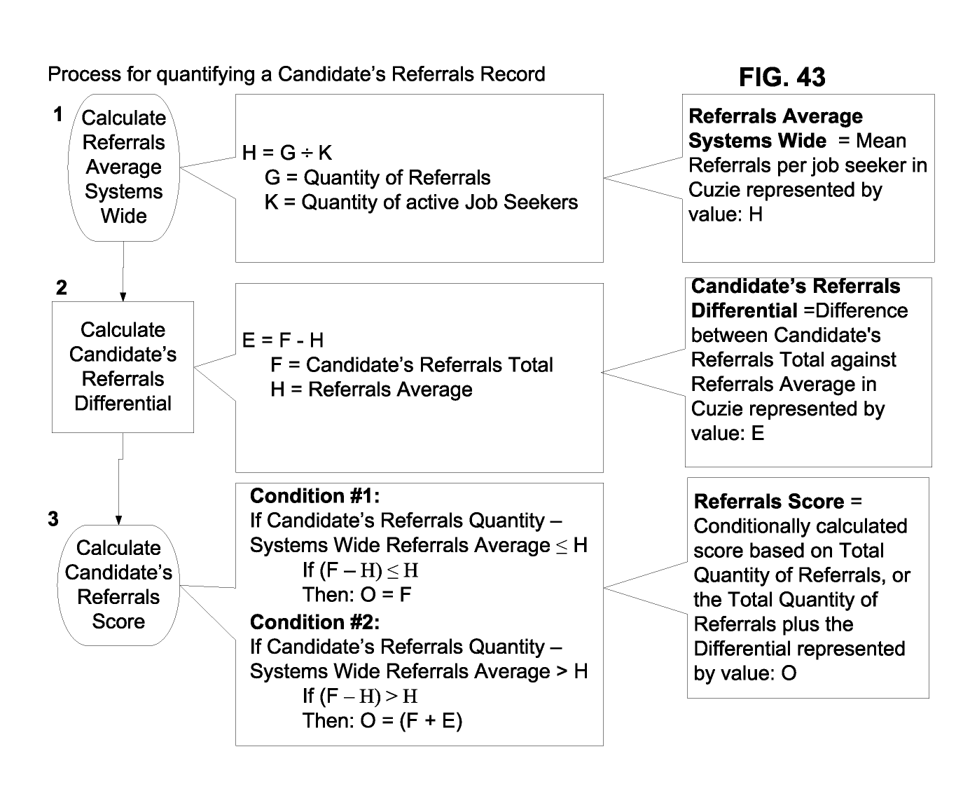

FIG. 43 further illustrates the calculation of the Referrals Score. First, the Referrals Average Systems Wide is determined as described above and as described in FIG. 42. Then, the Candidate's Referrals Differential is determined as described above and as described in FIG. 42. Then the Referrals Score is then determined as indicated and as described. The processes of FIG. 43 are exemplary only.

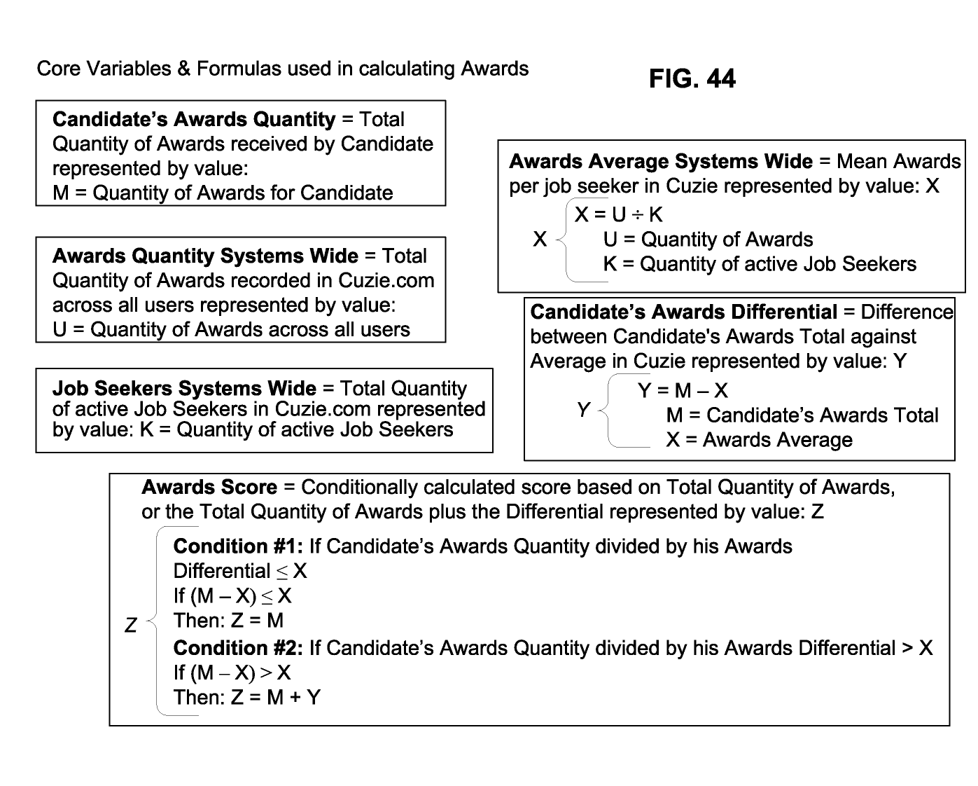

FIG. 44 illustrates a determination of another component of the quant score assigned to Candidates in accordance with an aspect of the present invention. This component is an Awards Score component. It measures how many awards (and thus recognition) have been given to the Candidate. The following parameters are determined in accordance with an aspect of the invention.

To determine this component in accordance with an aspect of the present invention, the following parameters are determined by a processor in the system of FIG. 1. A Candidate's Awards Quantity is determined as the Total Quantity of Awards received by Candidate of FIG. 1 for then Candidate and is represented by value: M. Thus M=Quantity of Awards for Candidate. The processor also determines a Awards Quantity Systems Wide Total Quantity of Awards recorded in Cuzie.com across all users of FIG. 1 and is represented by value: U. Thus, U=Quantity of Awards across all users. The processor also determines Job Seekers Systems Wide as the total quantity of active job seekers in the system of FIG. 1 and is represented by value: K. Again, Job Seekers are those in the registration database maintained in the system of FIG. 1 that have actually submitted a CPO. The processor also determines a Awards Average Systems Wide as the mean awards per job seeker in the system represented by value: X. Thus, X=U divided by K, where U=Quantity of Awards and K=Quantity of Job Seekers (that submitted a CPO). The processor also determines a Candidate's Awards Differential as the Difference between Candidate's Awards Total against Average in Cuzie represented by value: Y. Thus, Y=M−X, where M=Candidate's Awards Quantity and X=Awards Average Systems Wide. The processor then determines an Awards Score as the conditionally calculated score based on Total Quantity of Awards, or the Total Quantity of Awards plus the Differential represented by value: Z. The determination of the Awards Score is therefore conditional in accordance with an aspect of the present invention. In Condition 1, if a Candidate's Awards Quantity divided by his Awards Differential≦X (if Y≦X), then: Z=M. In Condition 2, if a Candidate's Awards Quantity divided by his Awards Differential>X (if Y>X) then Z=M+Y. The processes of FIG. 44 are exemplary only.

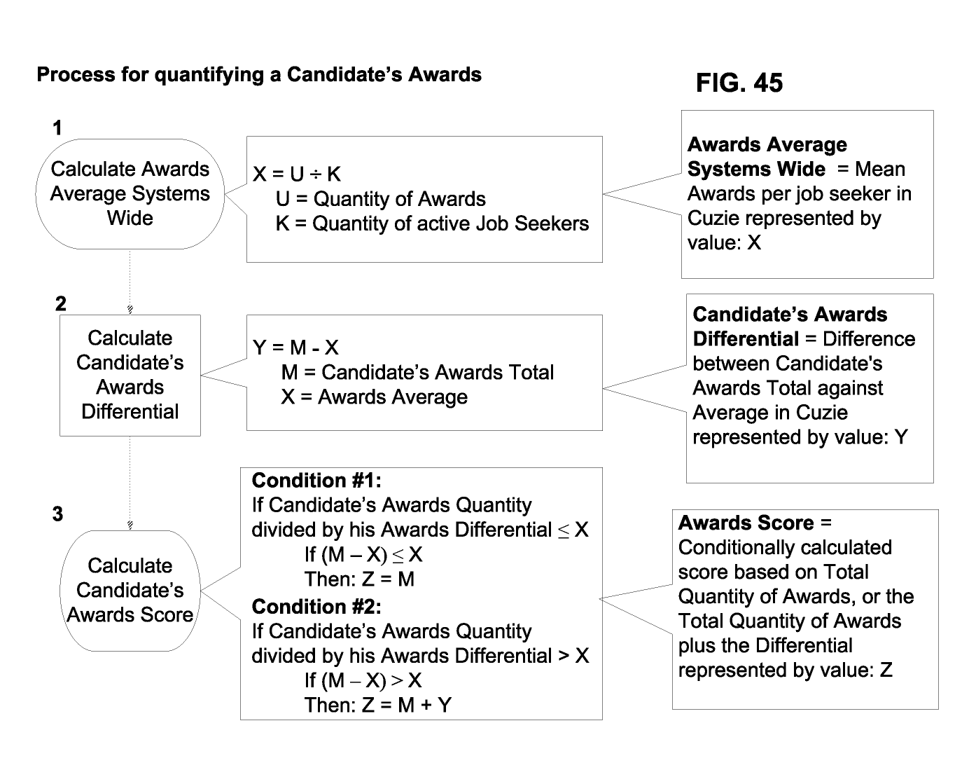

FIG. 45 further illustrates the calculation of the Referrals Score. First, the Awards Average Systems Wide is determined as described above and as described in FIG. 44. Then, the Candidate's Awards Differential is determined as described above and as described in FIG. 44. Then the Awards Score is then determined as indicated and as described.

In accordance with an aspect of the present invention, these components of a candidate's score are weighted. While difference values can be used, in accordance with an aspect of the present invention, the career weighting is 30%, the education ranking weighting is 15%, the education level weighting is 15%, the respects weighting is 15%, the referrals weighting is 13% and the awards (recognitions) weighting is 12%. The processor applies these weightings to each score described before to determine a total score for each Candidate. The processes of FIG. 45 are exemplary only.

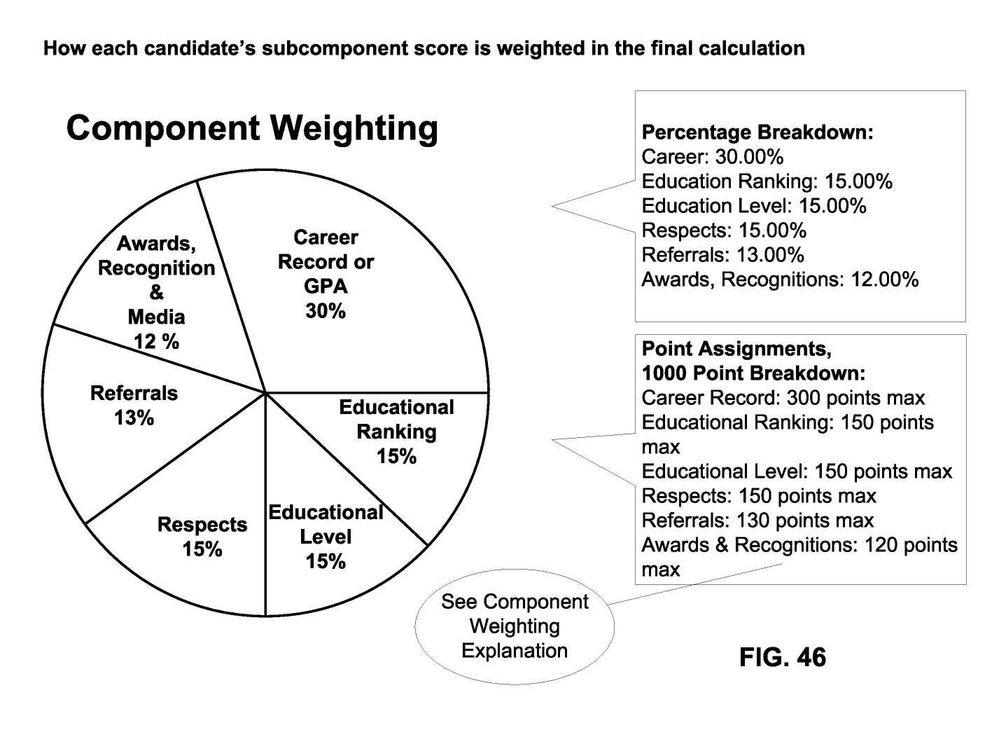

In accordance with an aspect of the invention, a total of 1000 possible points can be assigned to a Candidate. These point breakdowns are assigned in accordance with the weightings, as shown in FIG. 46. In accordance with another aspect of the present invention, a company can select the weightings it desires. Other weightings can be used.

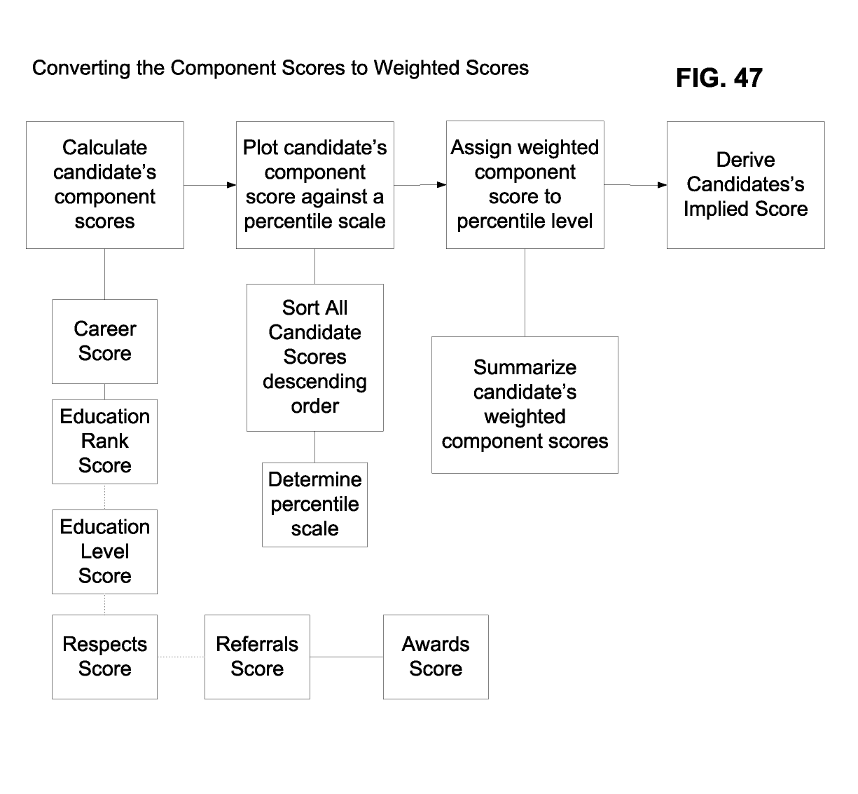

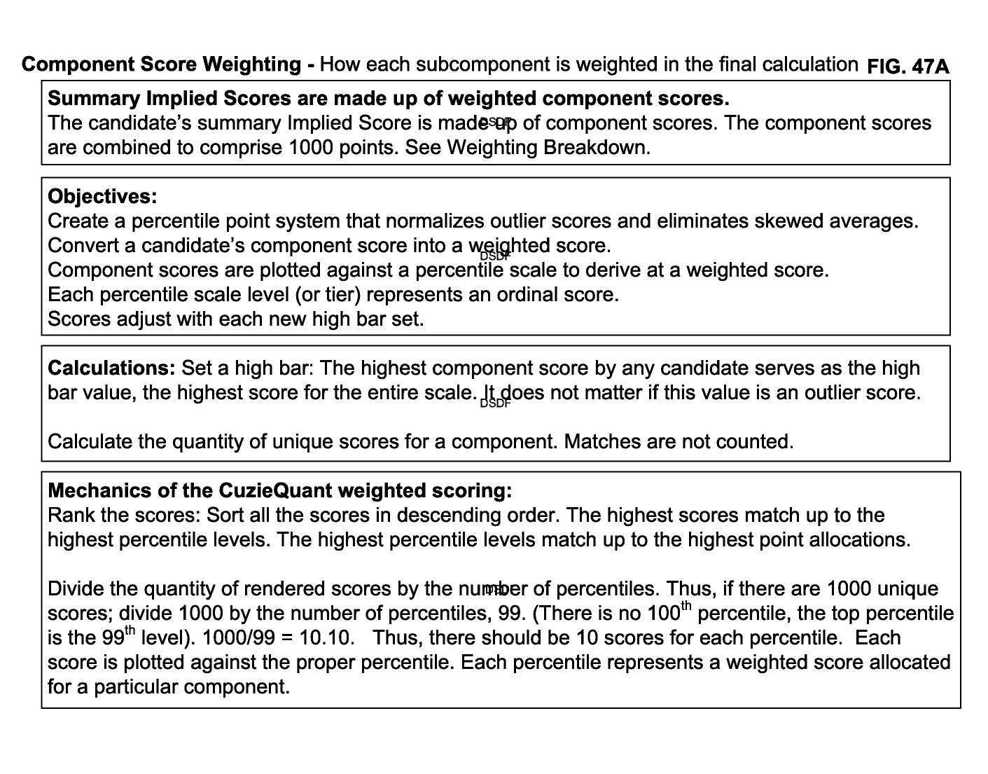

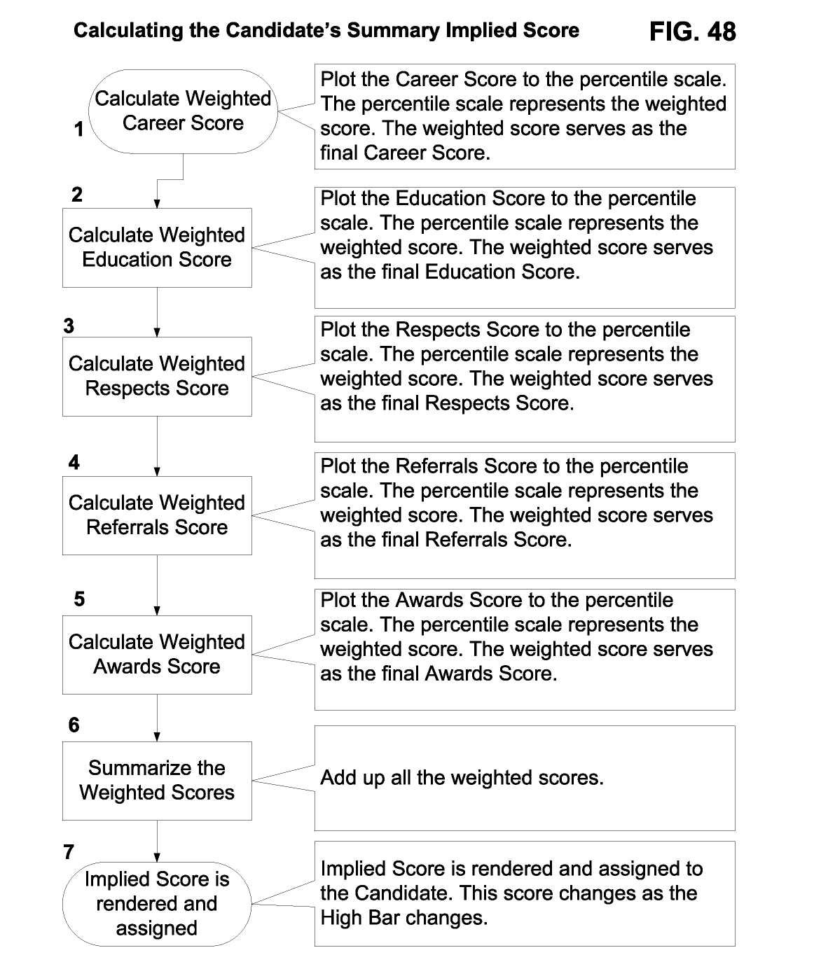

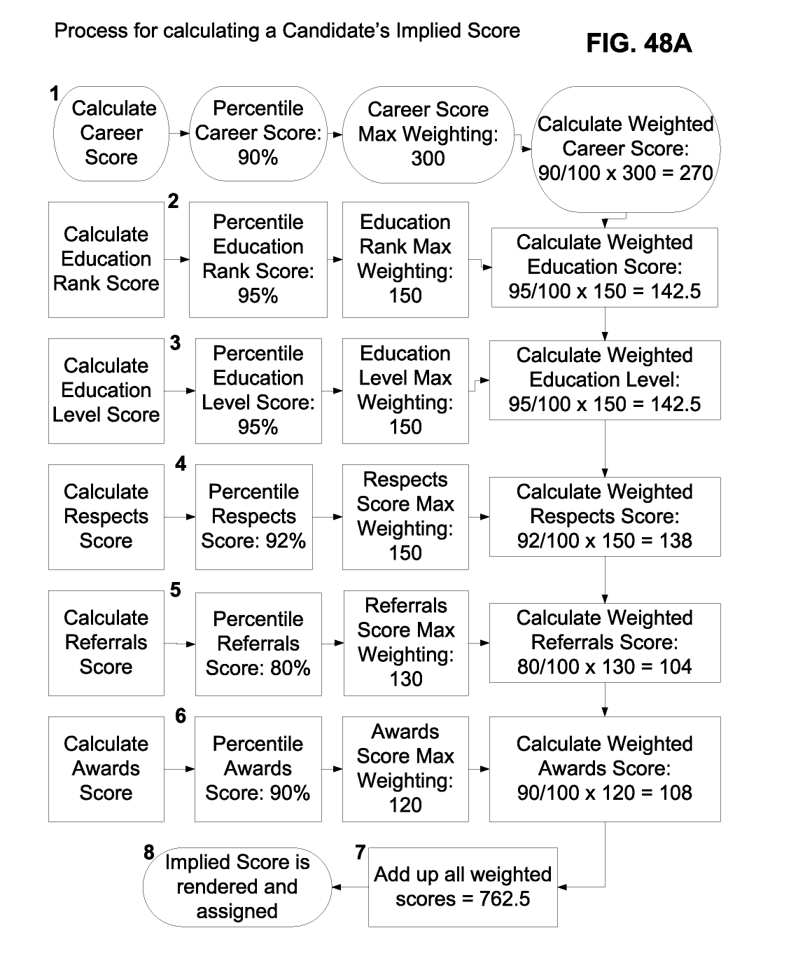

FIGS. 47 and 48 illustrate a calculation of a Candidate's final score in accordance with an aspect of the present invention. First, the Candidate's component scores are determined. These include the Career Score, the Education Rank Score, the Education Level Score, the Respects Score, the Referrals Score, and the Awards Score, as described above.

Then the candidate's component score is plotted against the percentile scale by the processor. The processor sorts all candidate scores systems wide in descending order. The processor divides scores into percentiles creating a scale. The processor plots the candidate's scores against this percentile scale. The processor relates percentiles to weighted scores. The processor allocates the correlated weighted score to the percentile level for each component. The processor adds up candidate's weighted scores and then derives a final implied score. An example of one embodiment of this process is illustrated in FIG. 48A. In accordance with an aspect of the present invention, Individual scores can be determined as a function of any of the following parameters, either alone or in any combination: career score, an education score, a respects score, a referrals score, an awards score. Additionally, these parameters can be weighted in any desired manner. Further, the parameters making up the Individual scores can be selected by Organizations in accordance with an aspect of the present invention. The weighting of the different parameters can also be selected by Organizations in accordance with an aspect of the present invention. Thus, different Organizations may have different scores for the same Individuals, depending on their selected parameters and weighting coefficients.

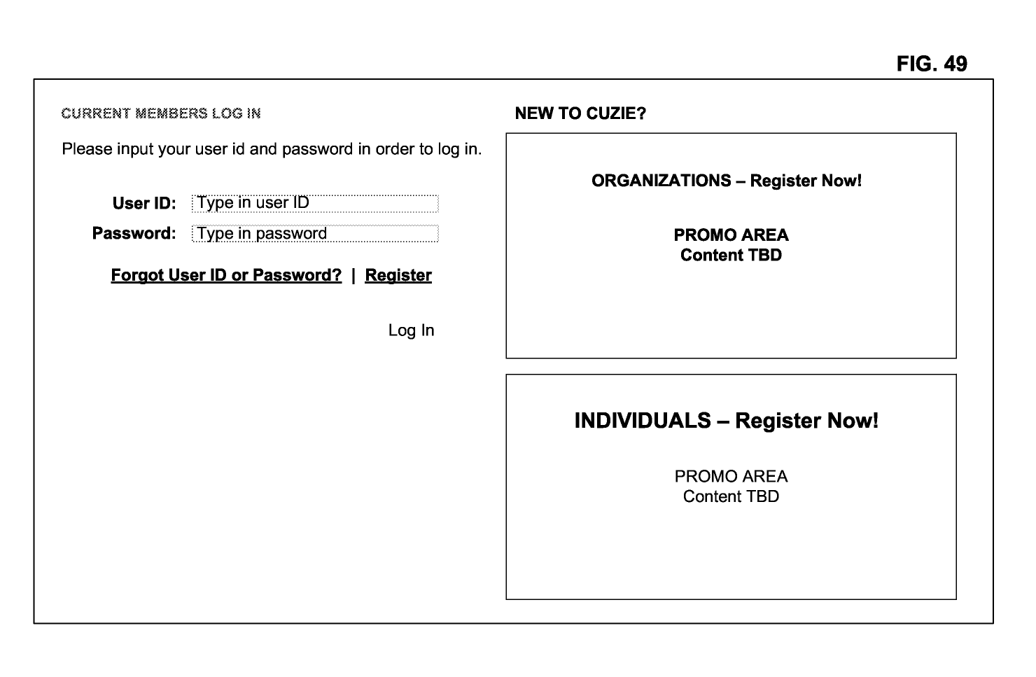

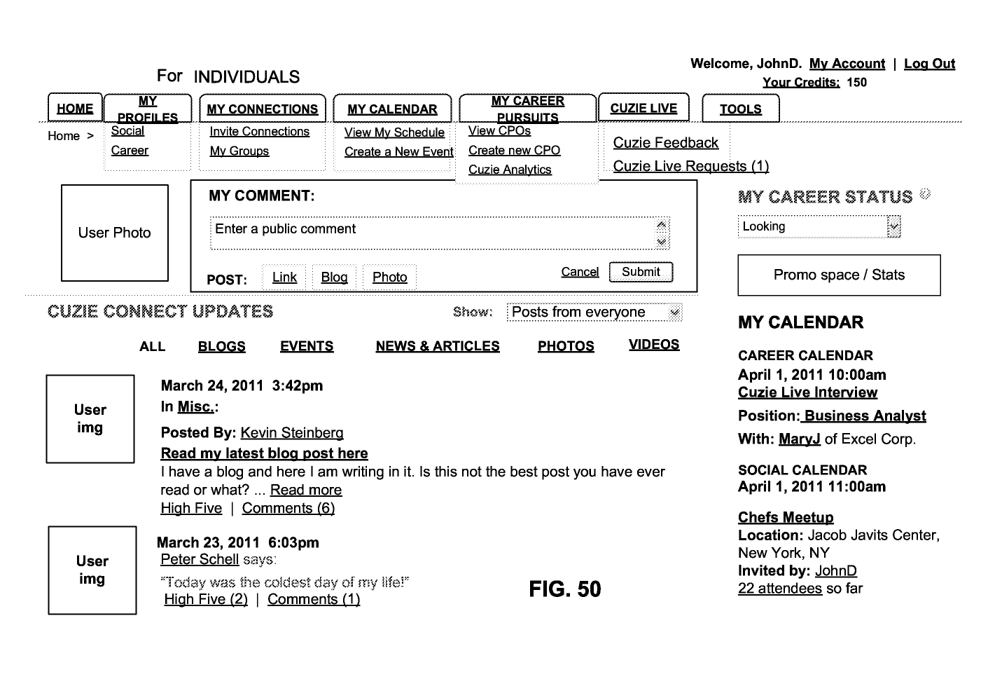

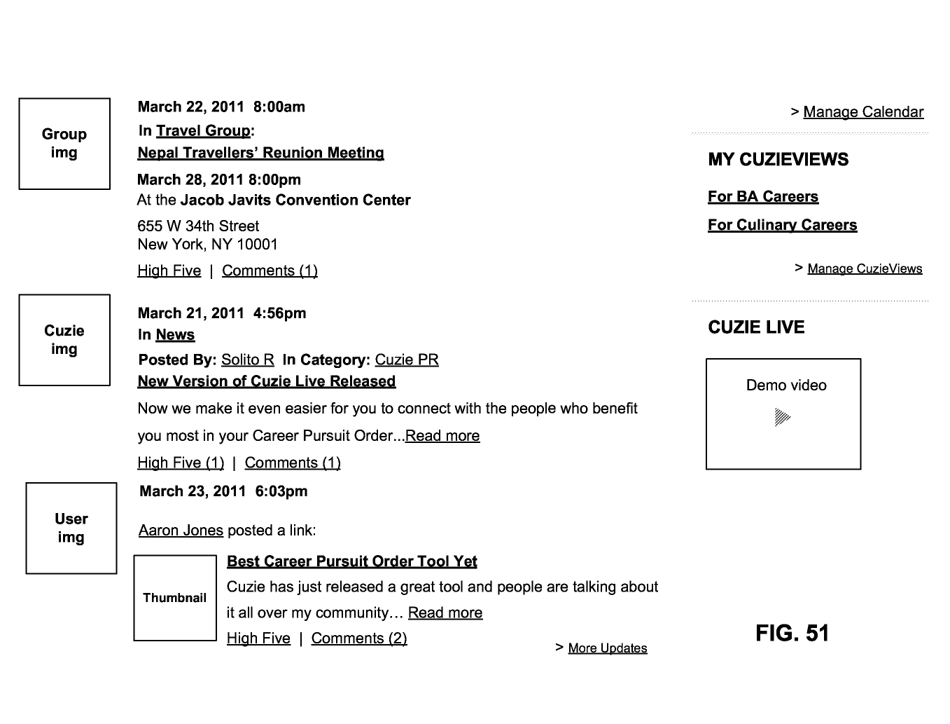

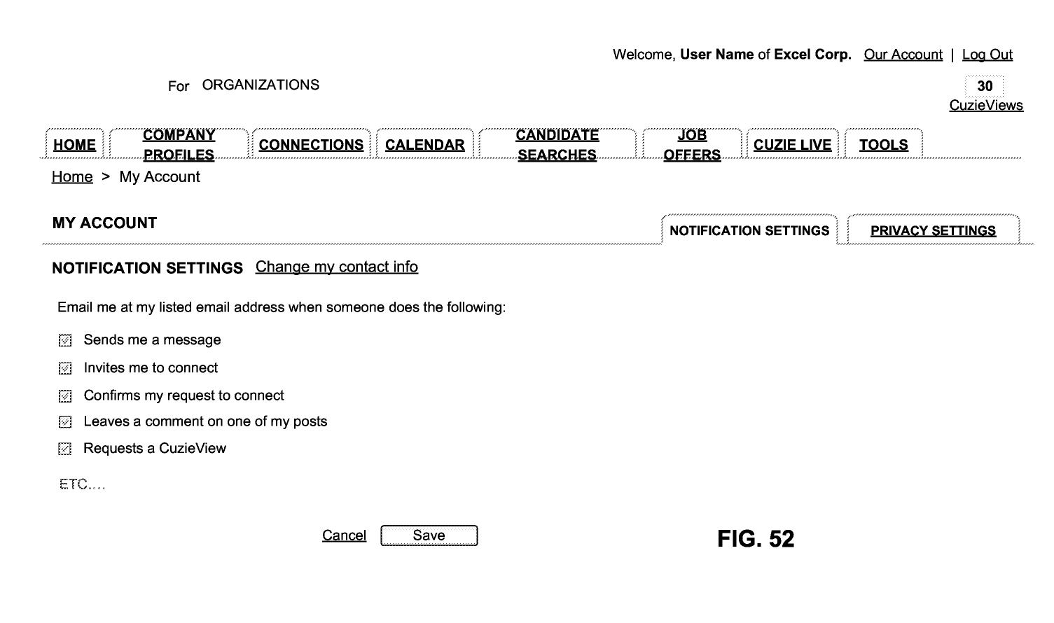

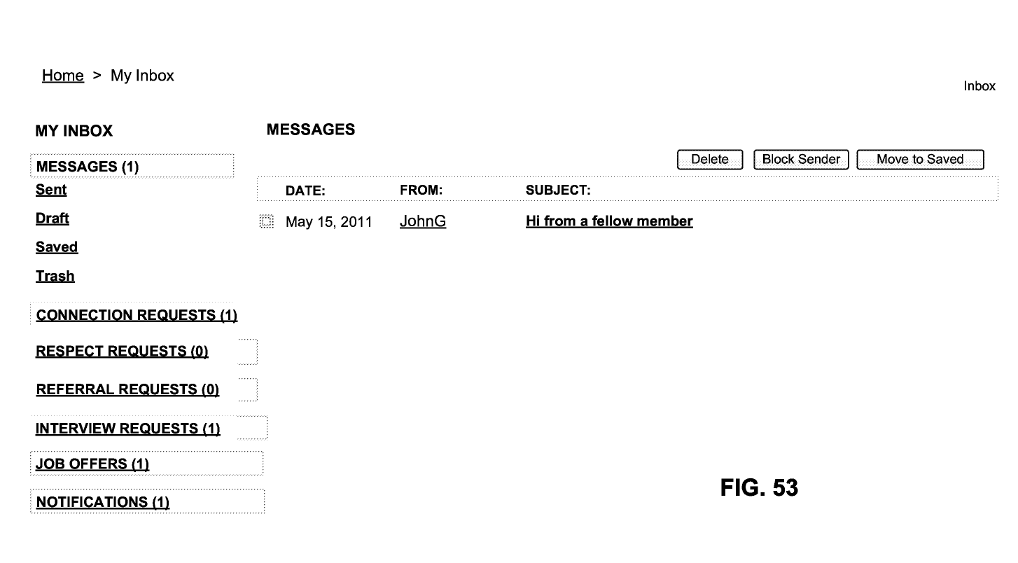

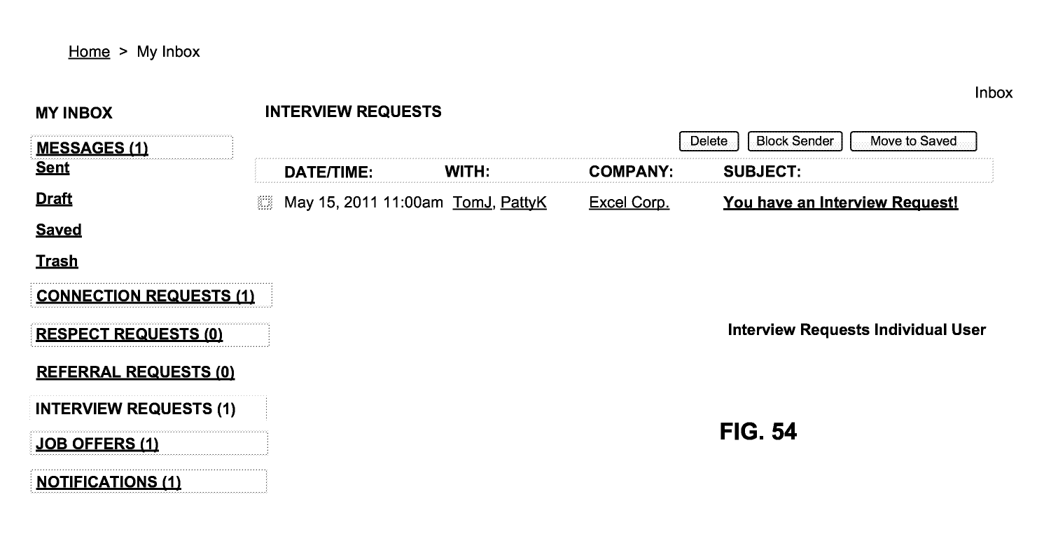

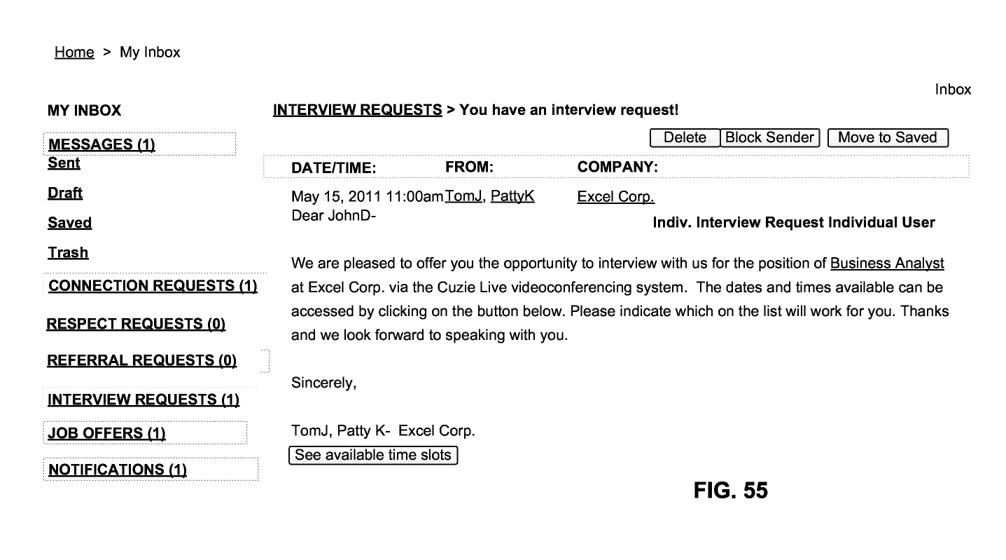

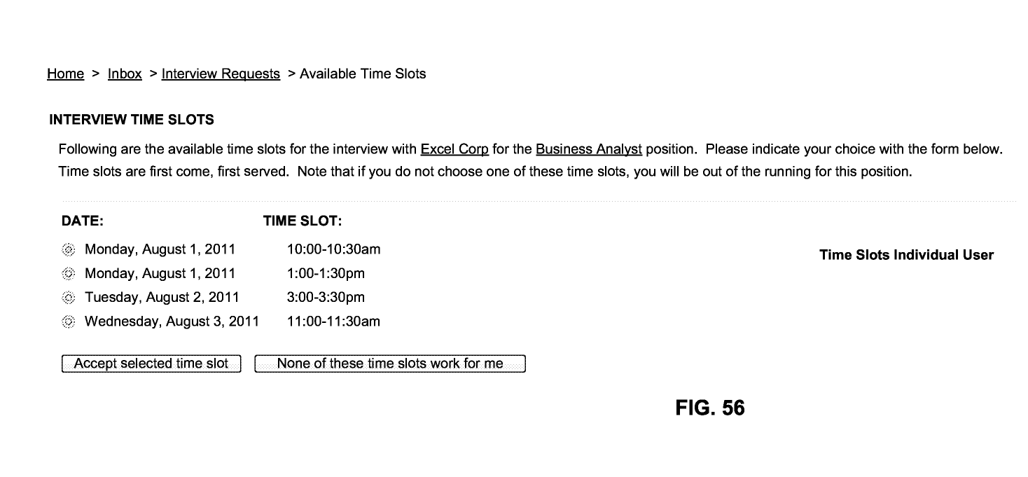

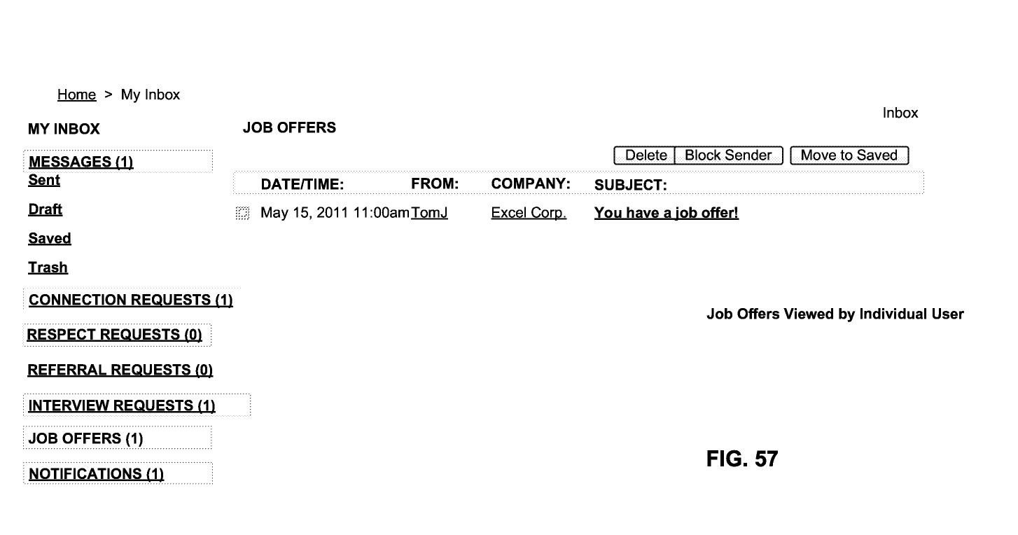

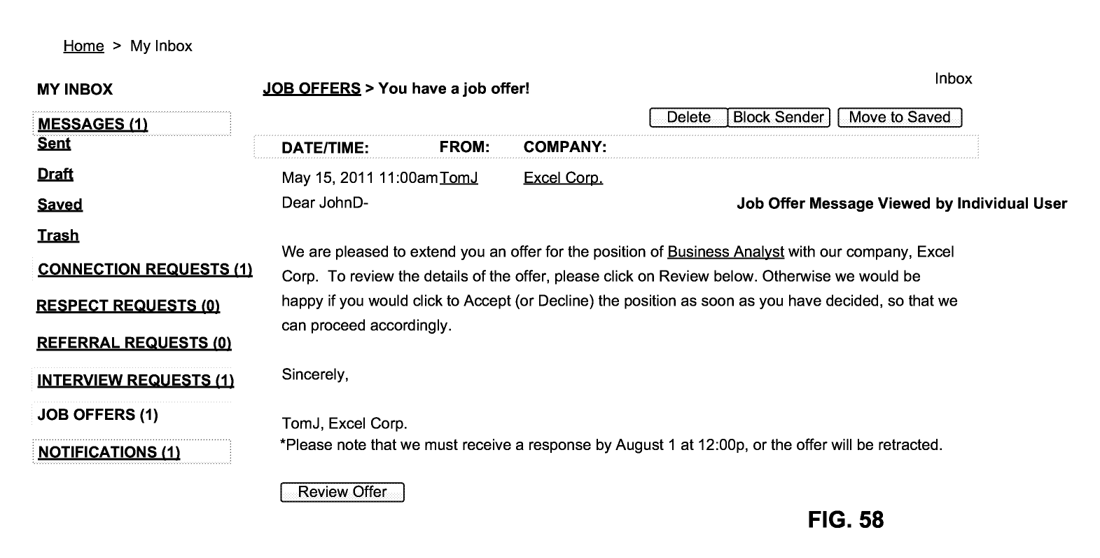

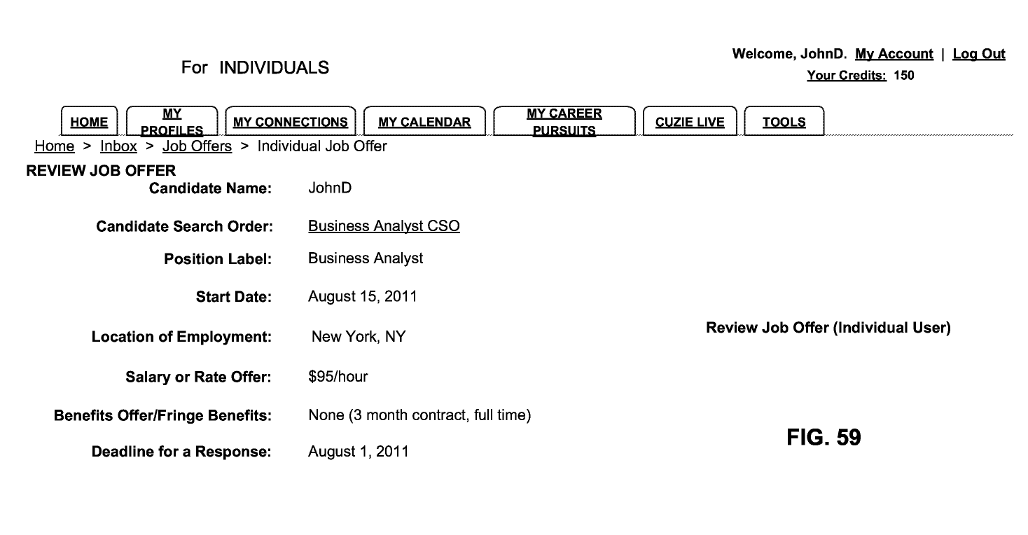

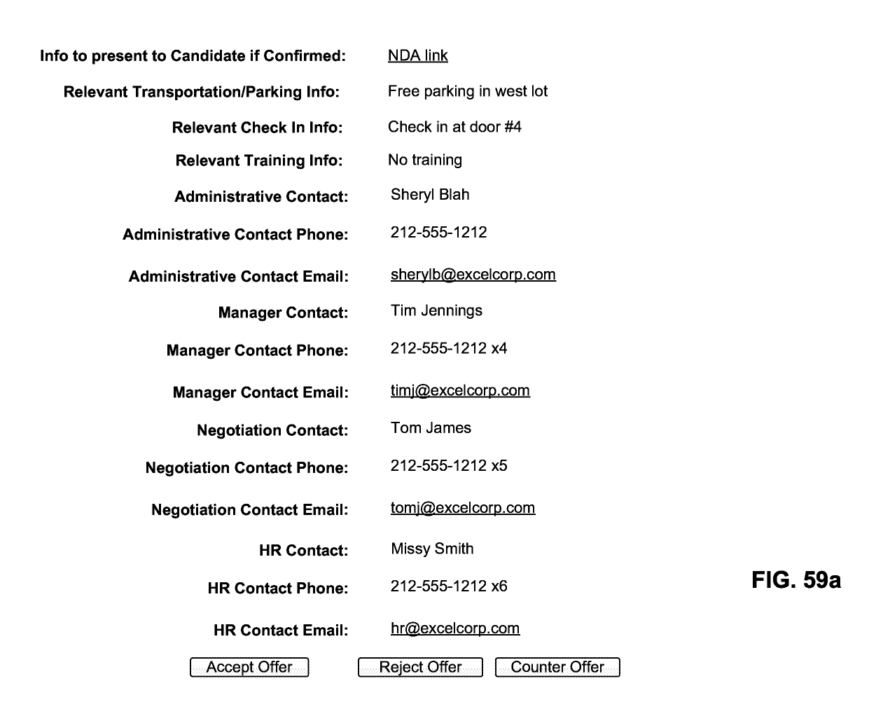

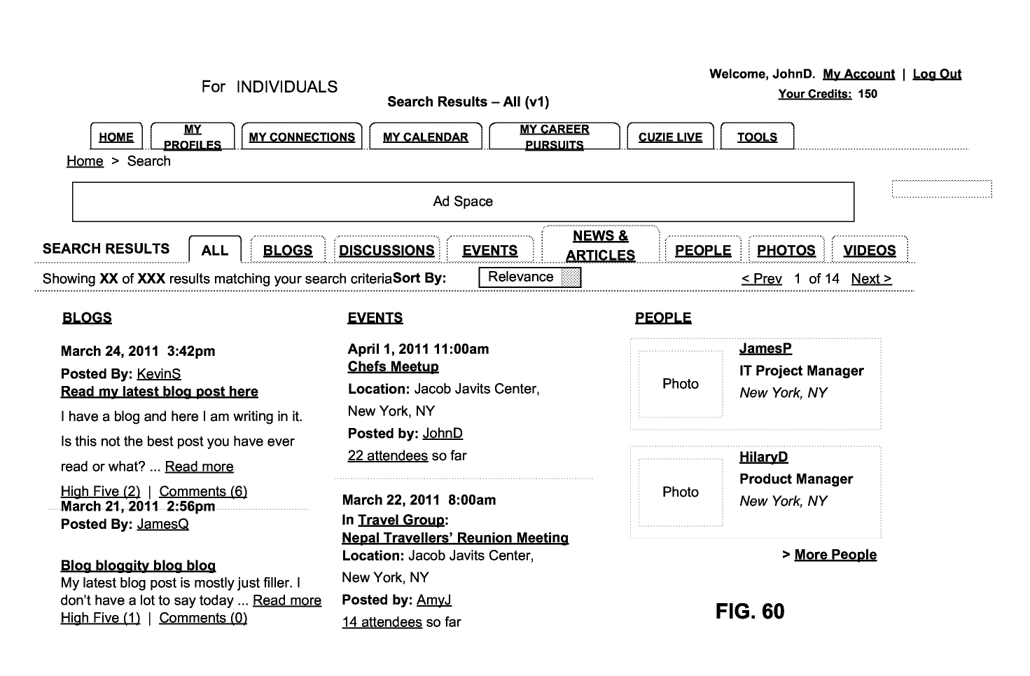

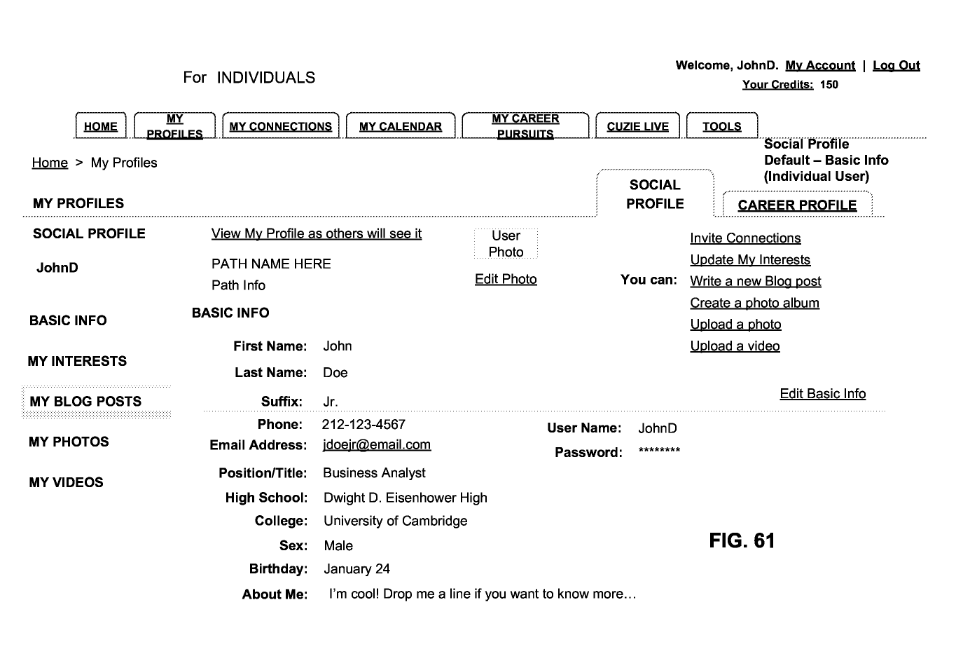

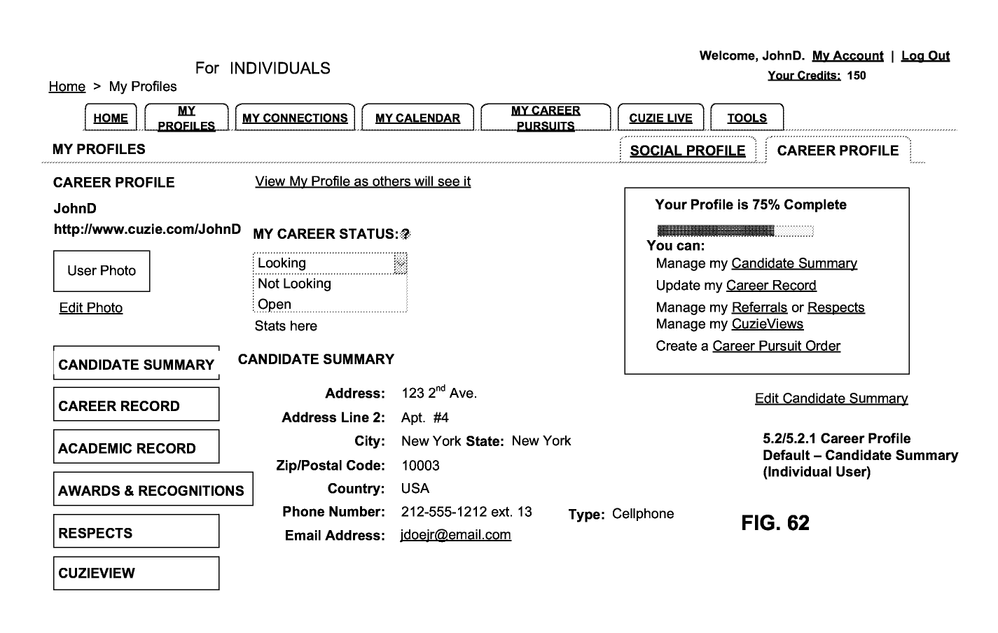

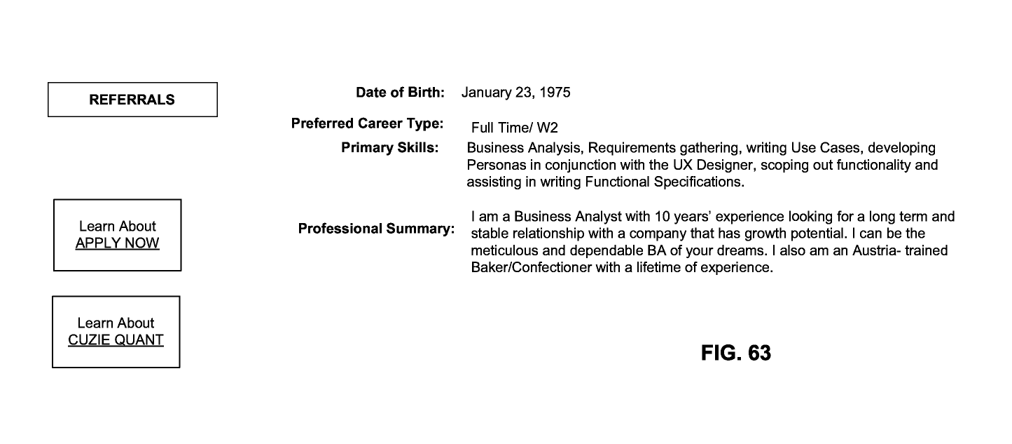

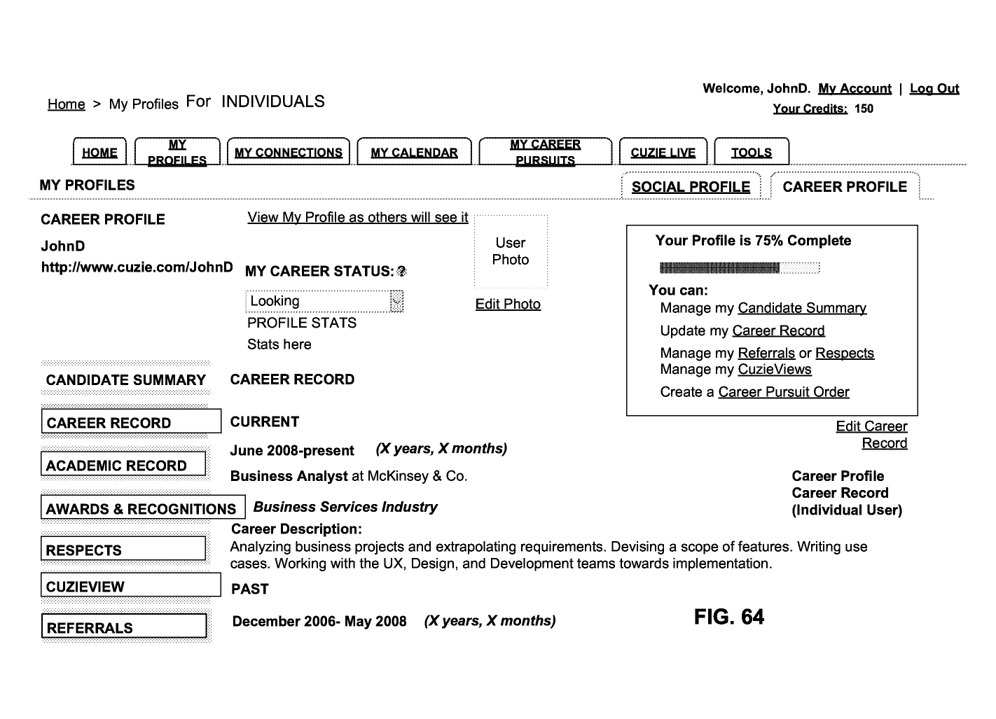

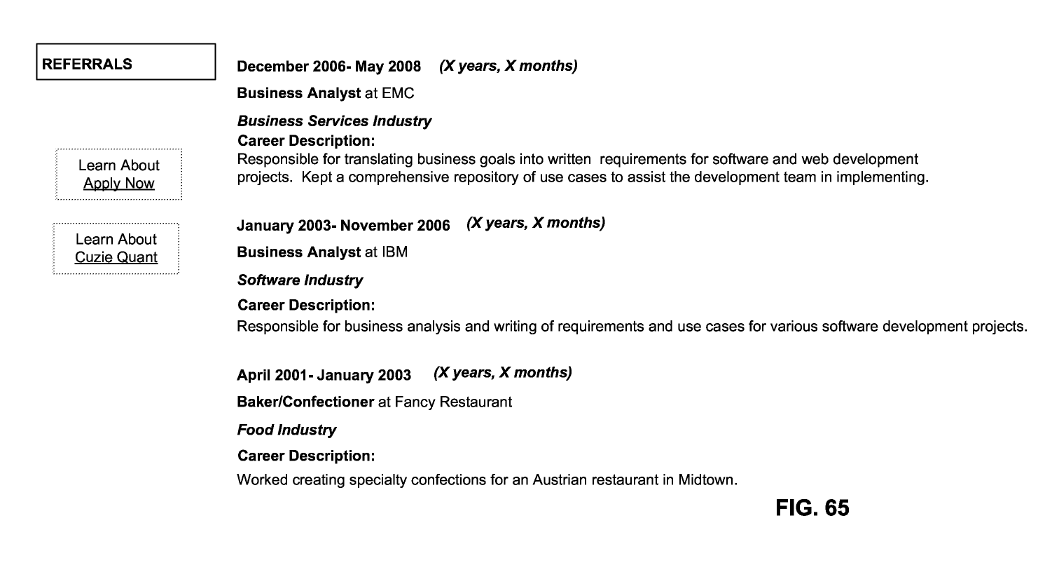

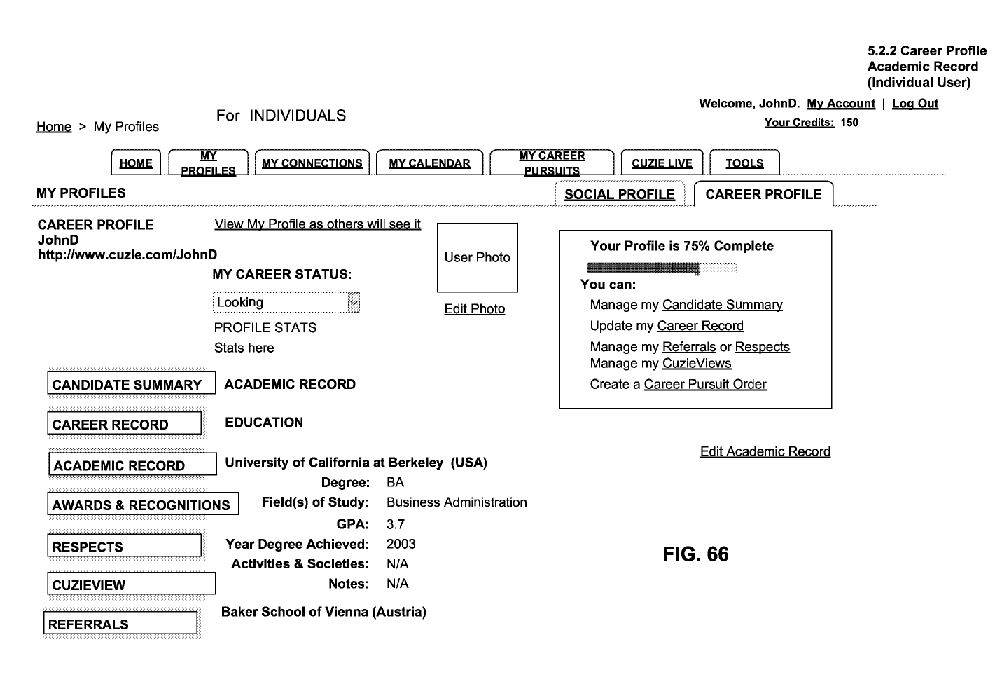

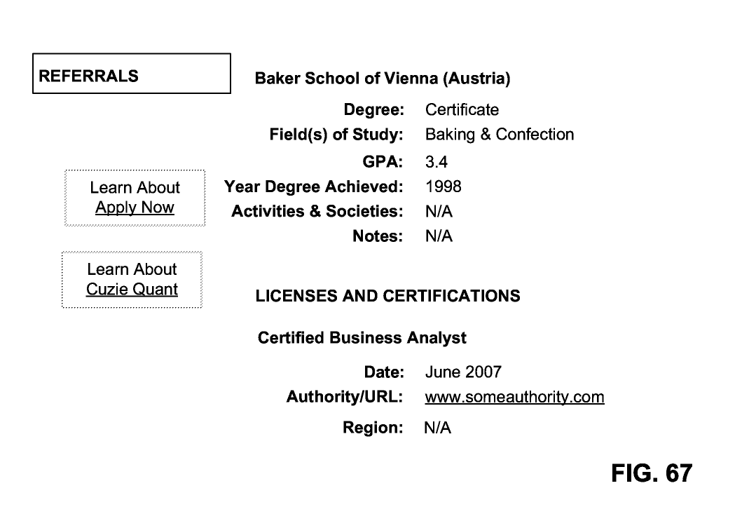

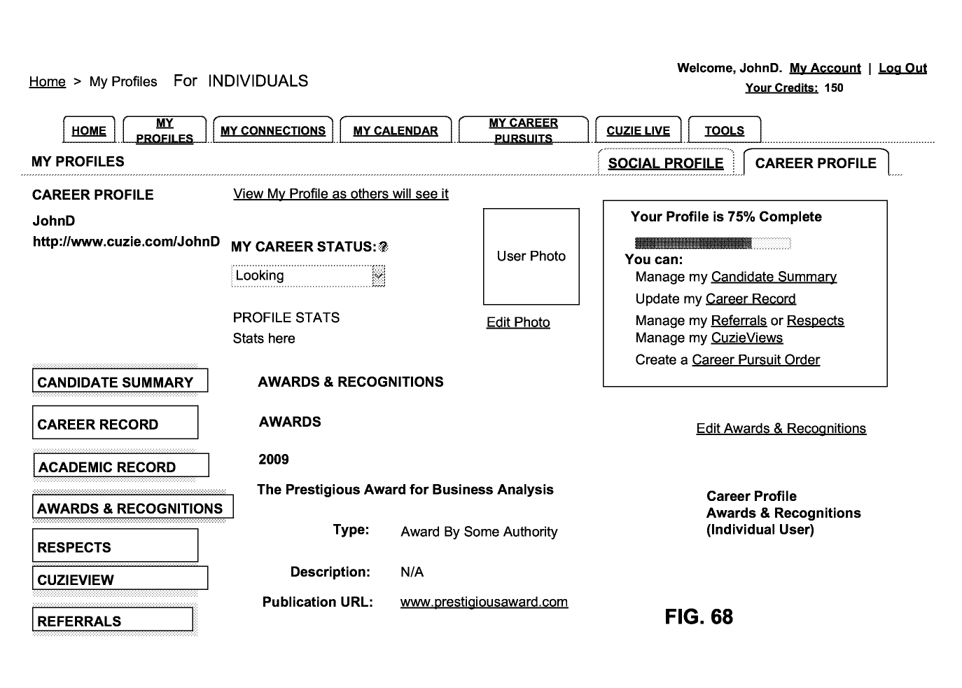

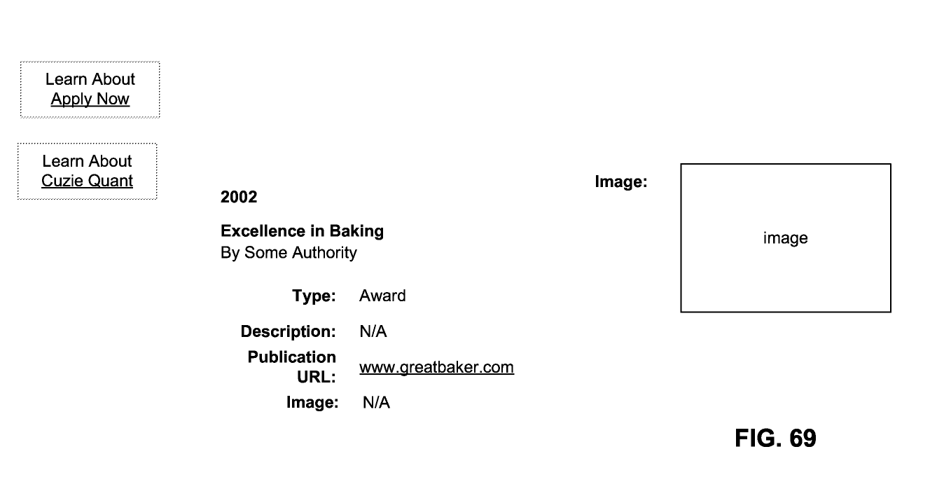

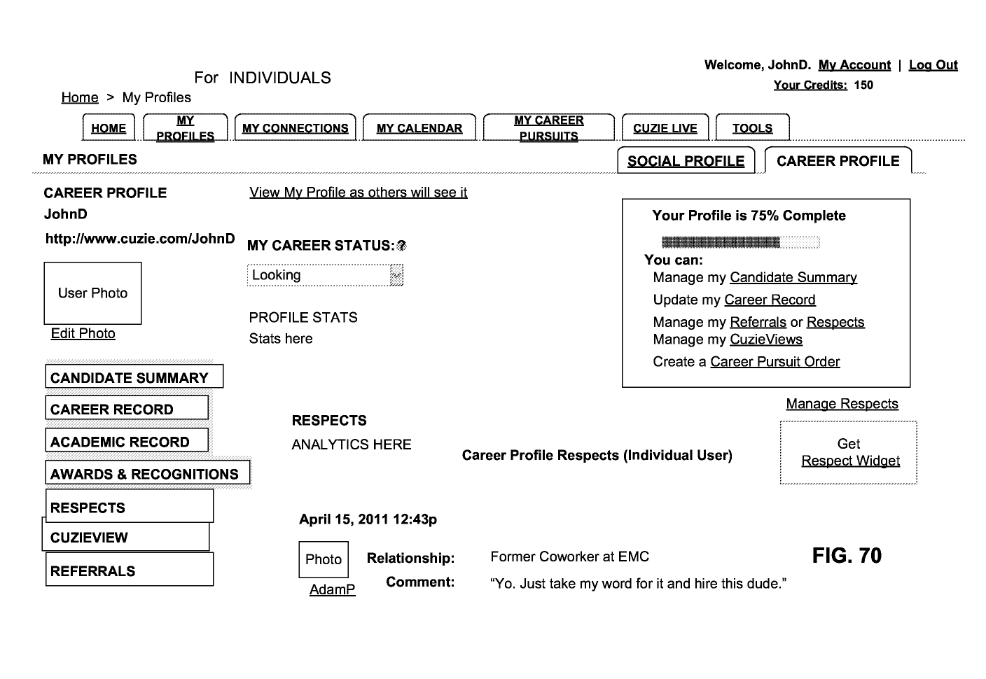

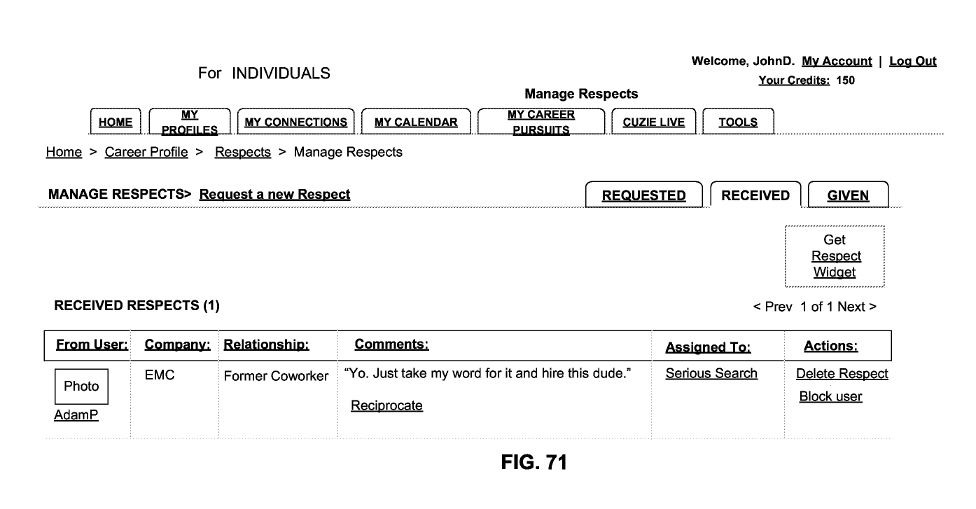

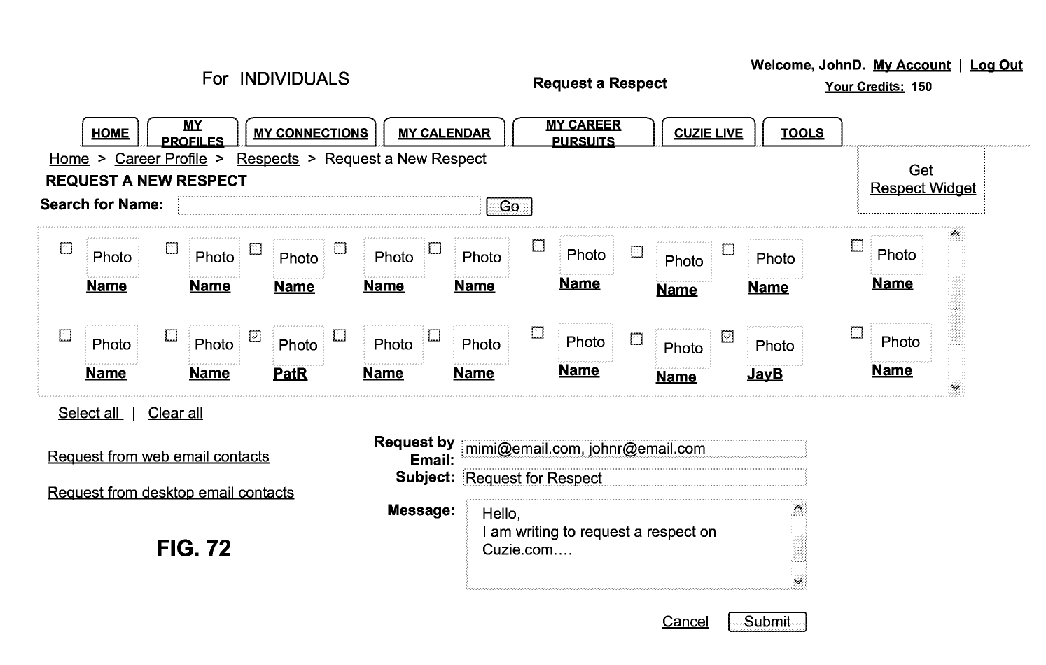

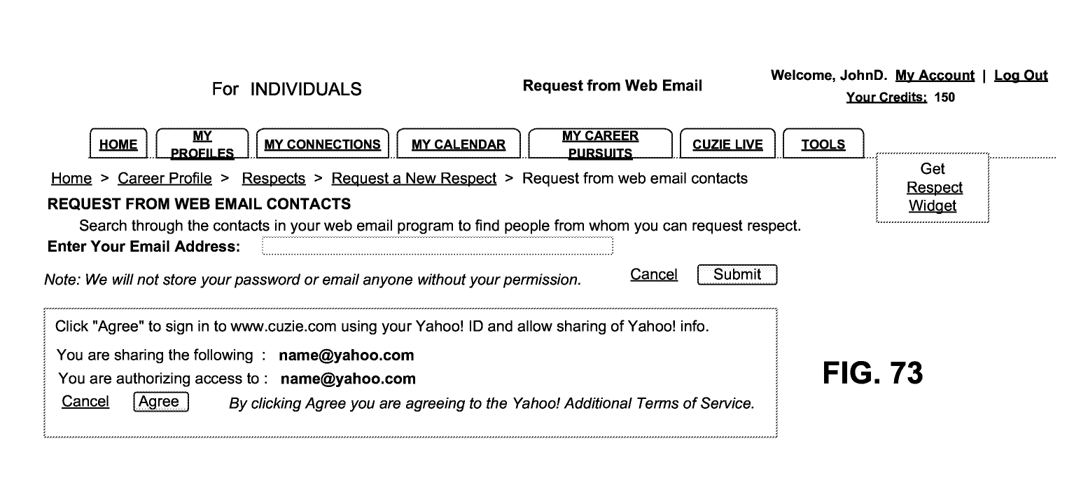

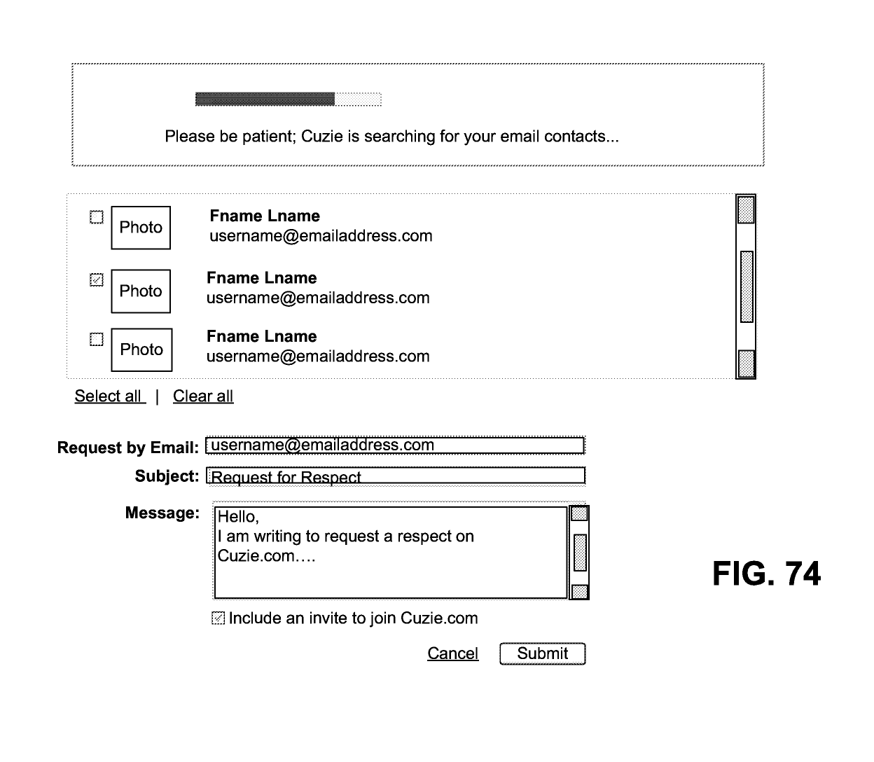

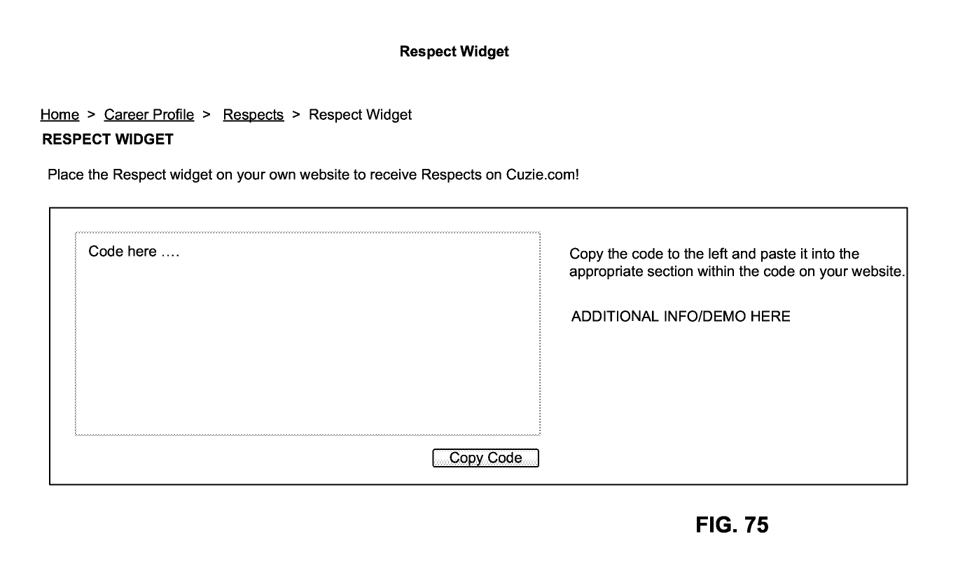

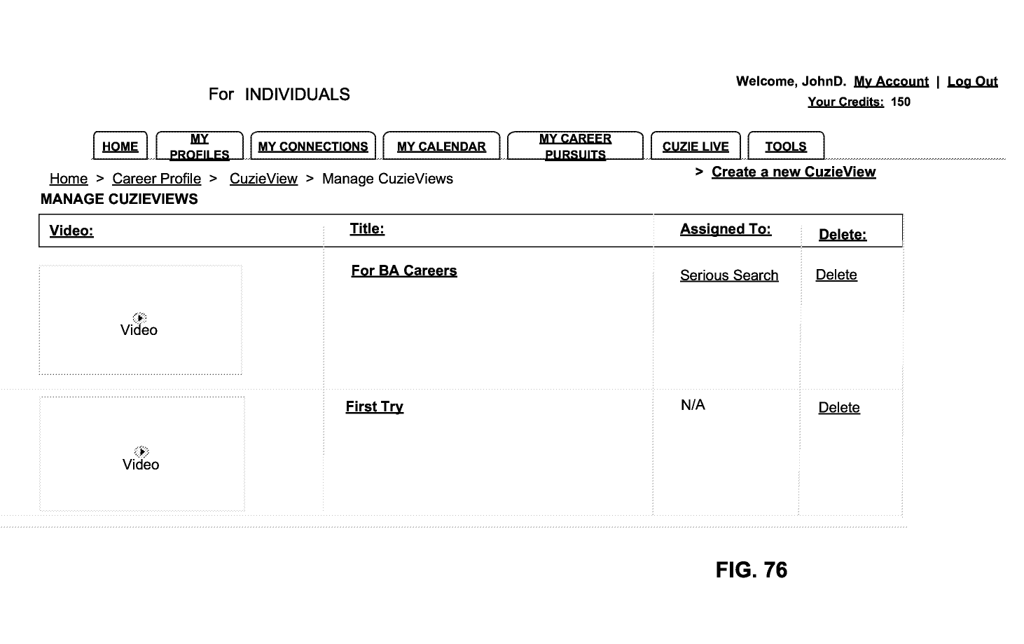

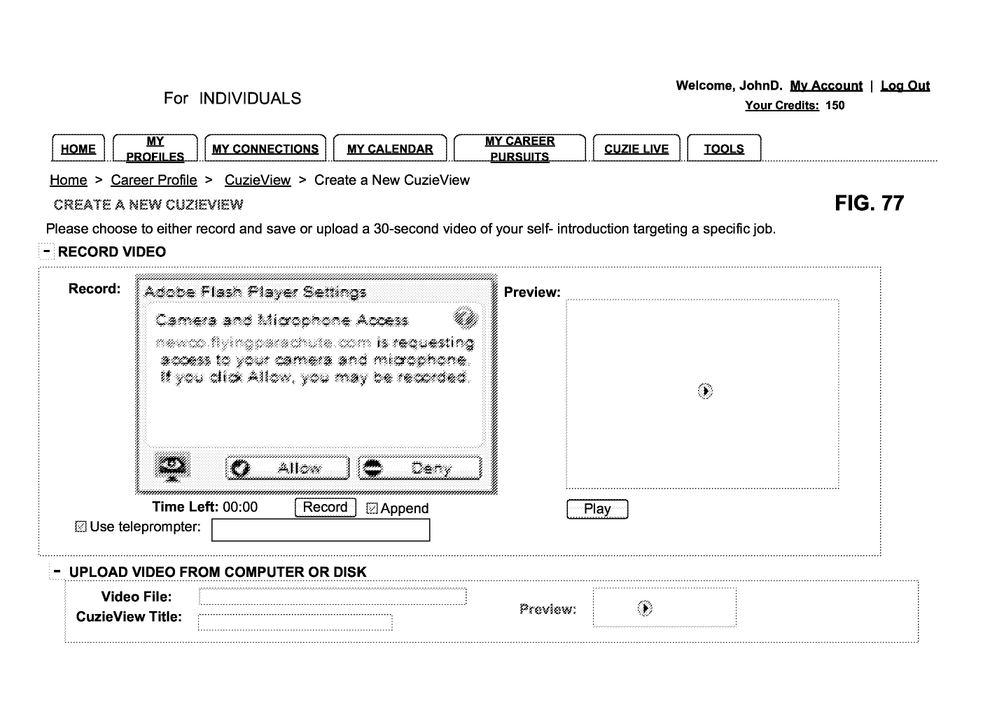

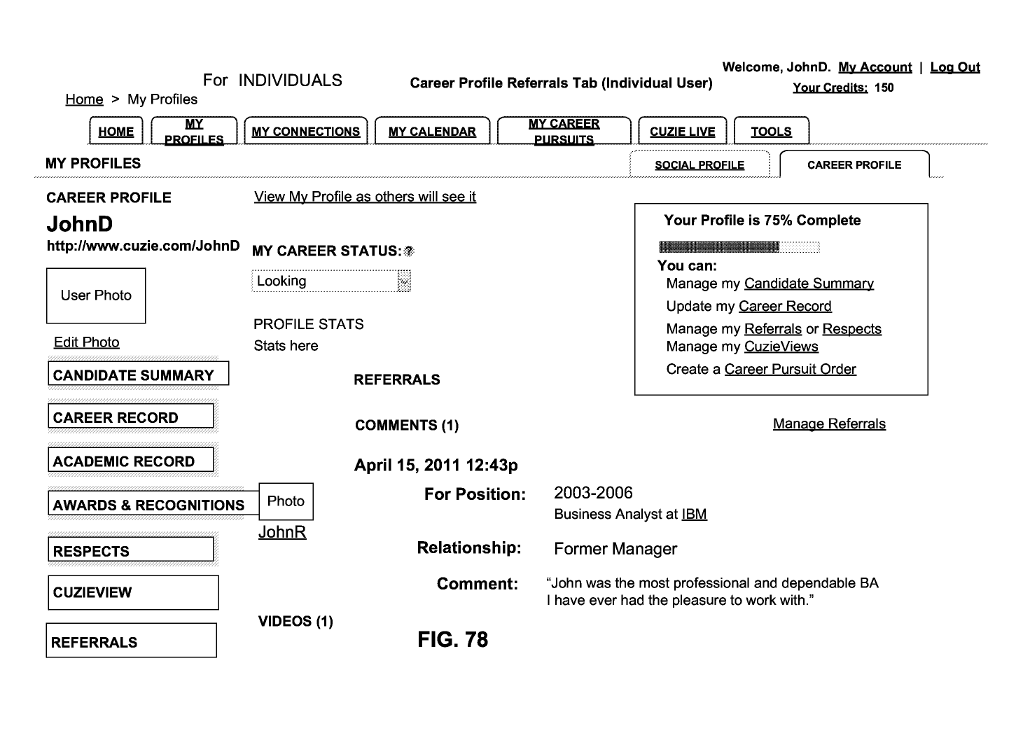

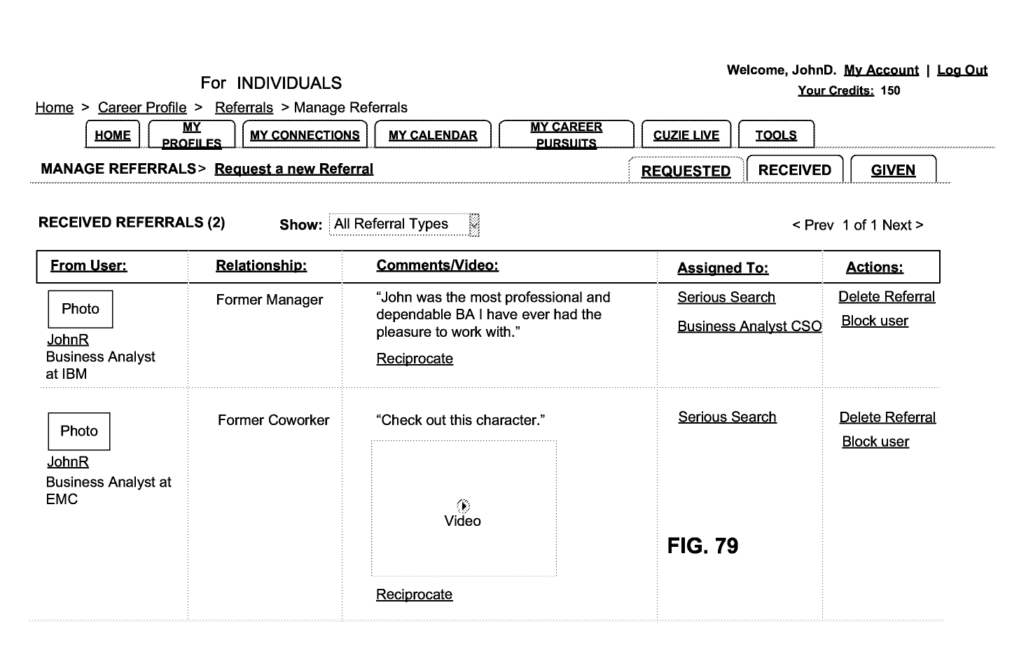

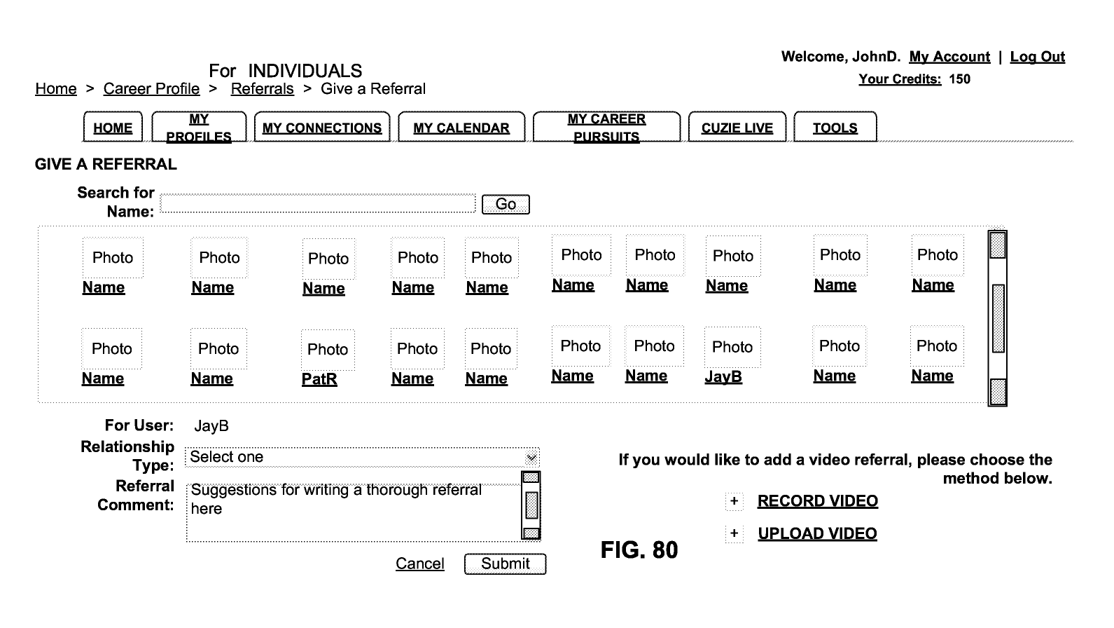

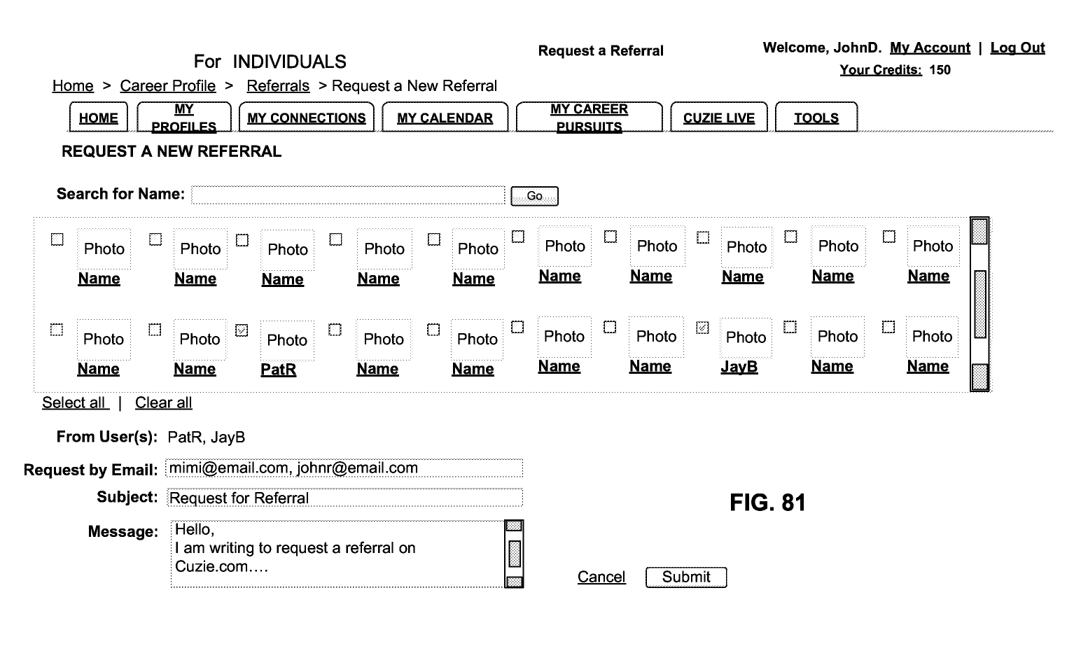

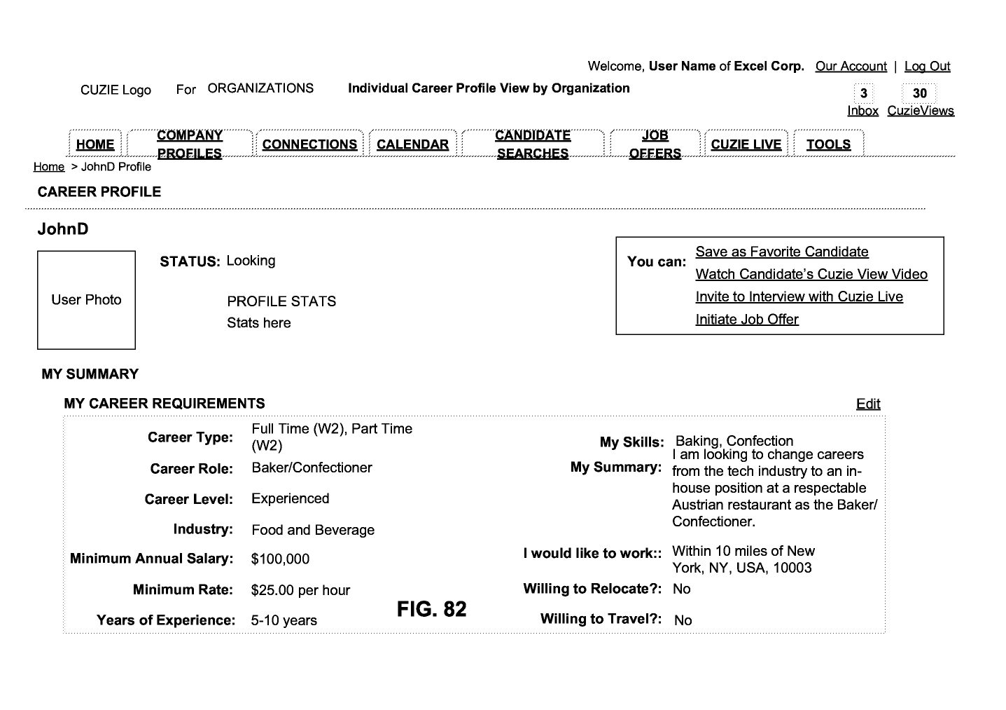

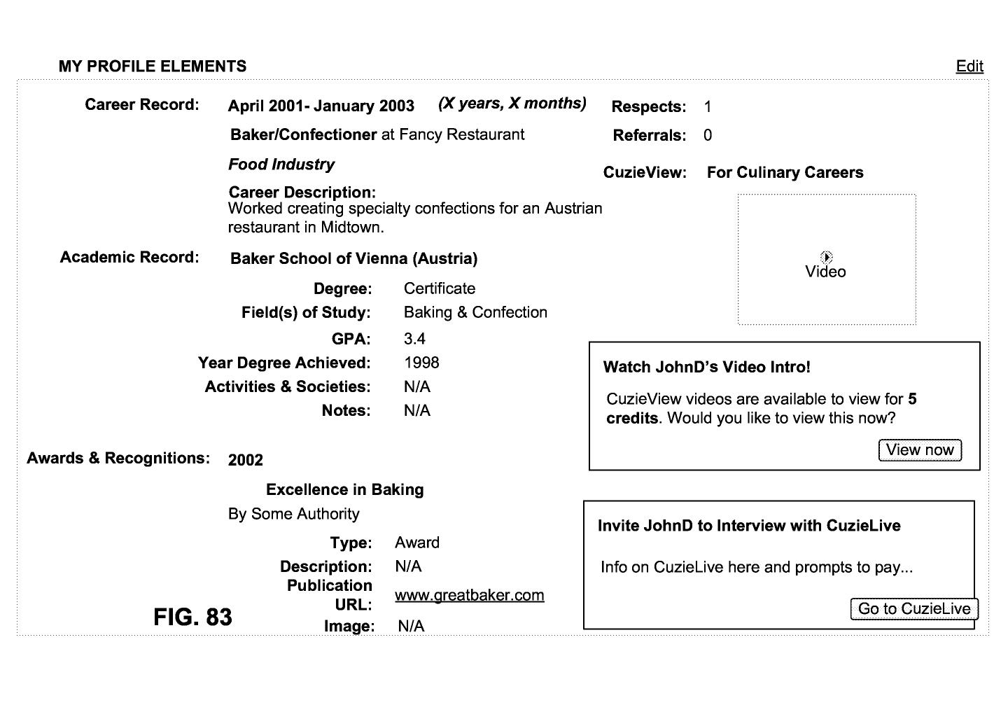

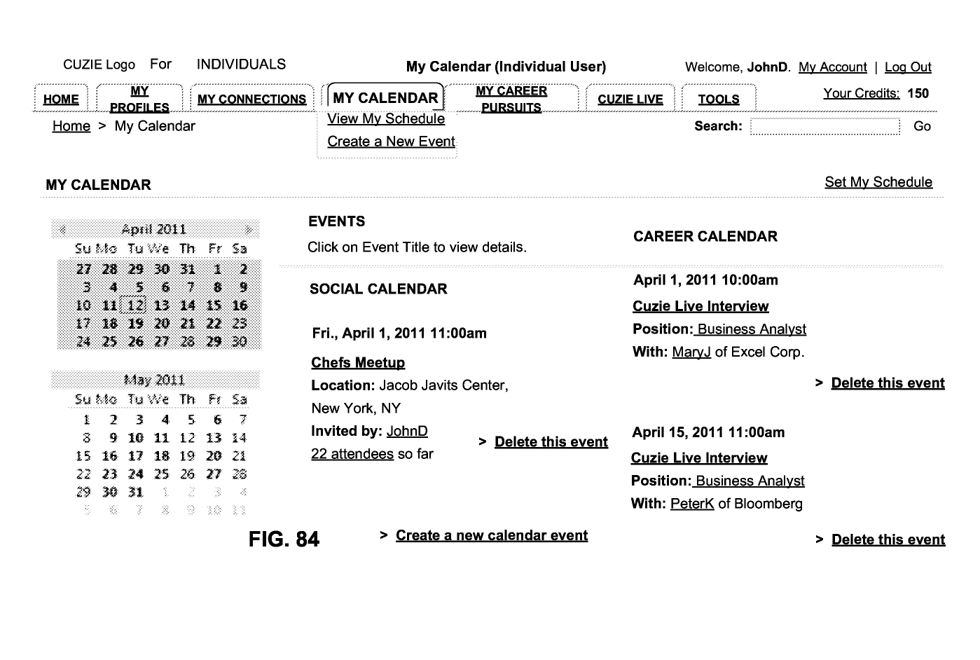

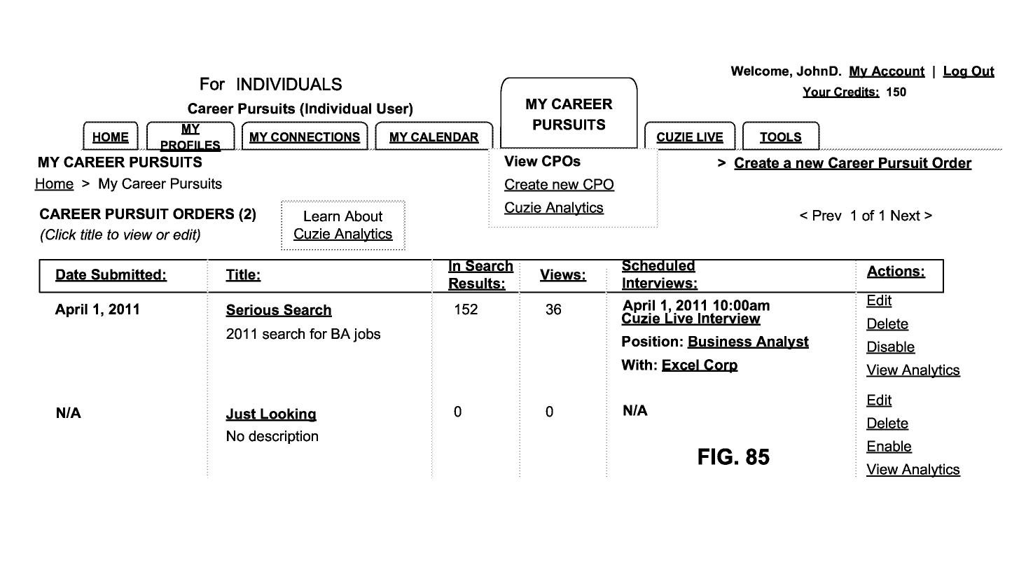

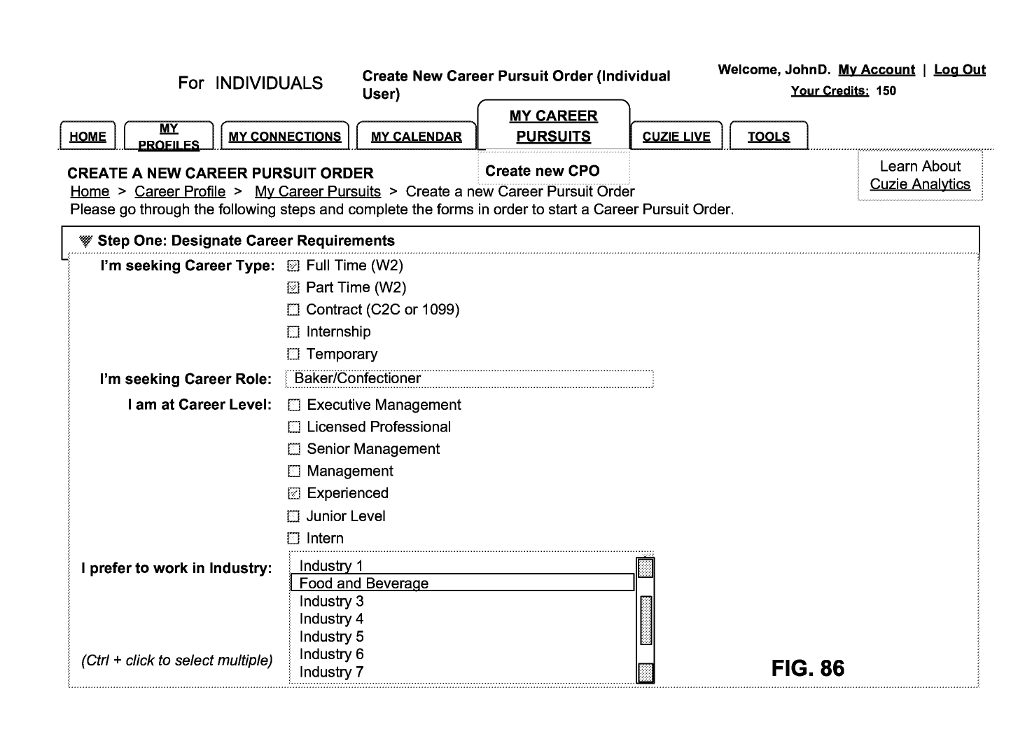

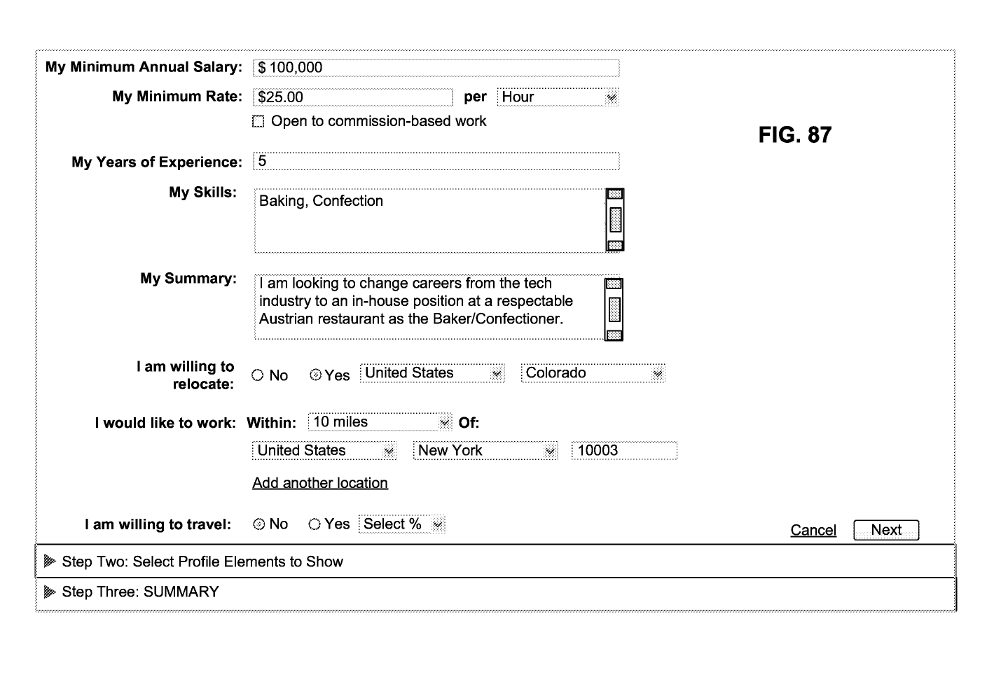

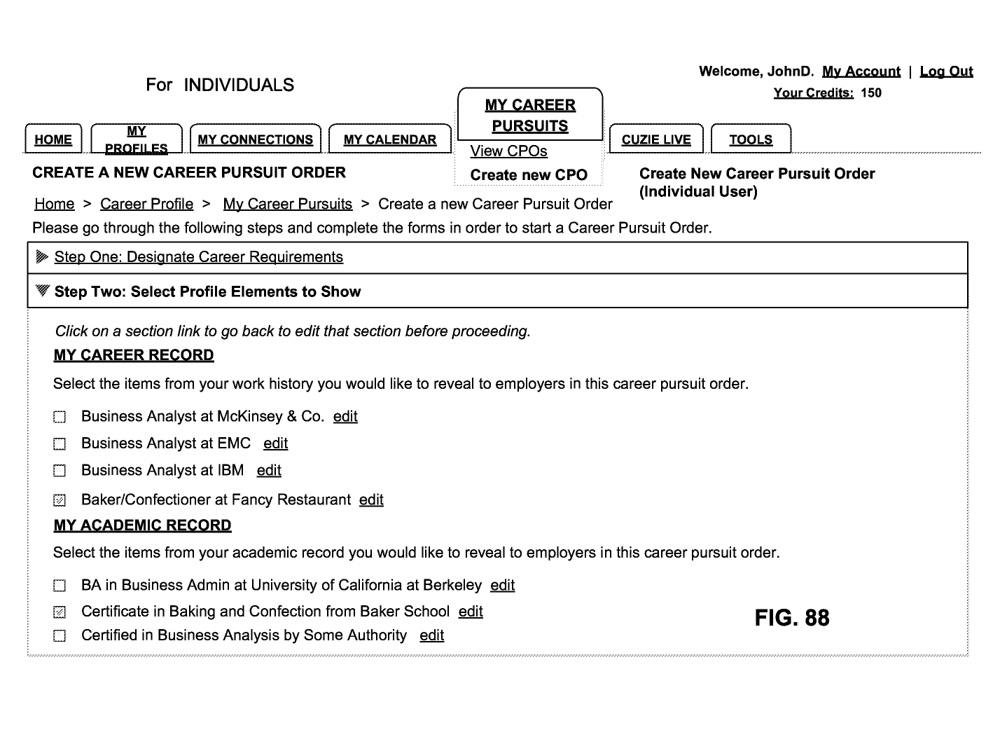

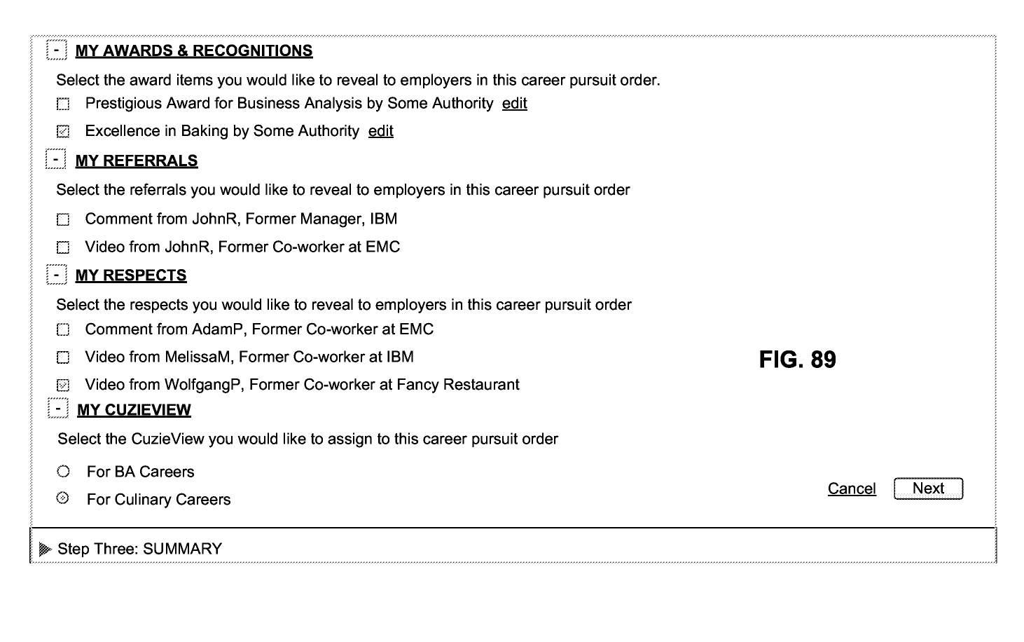

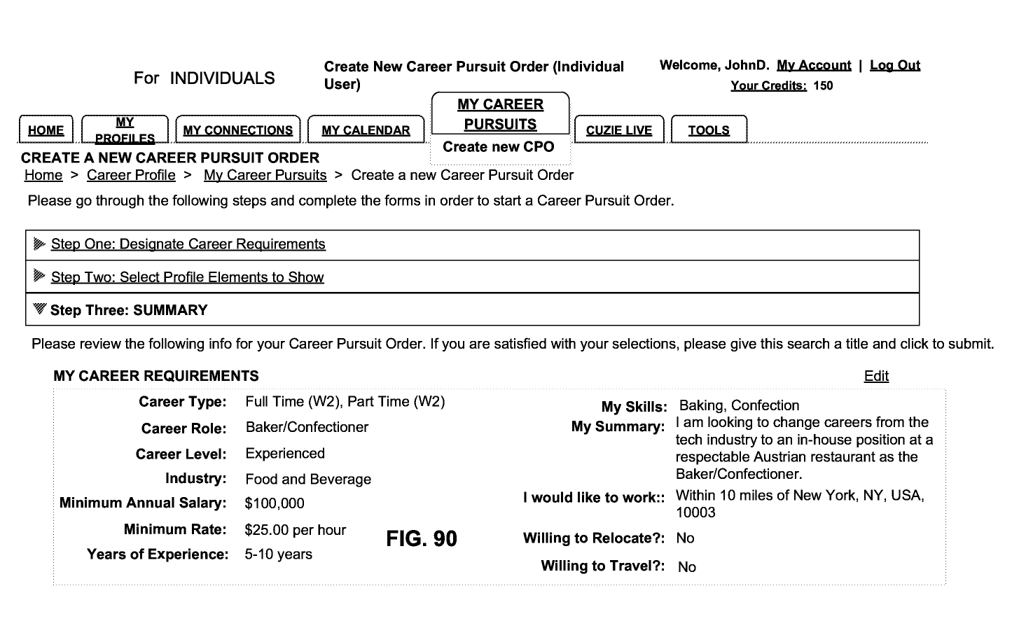

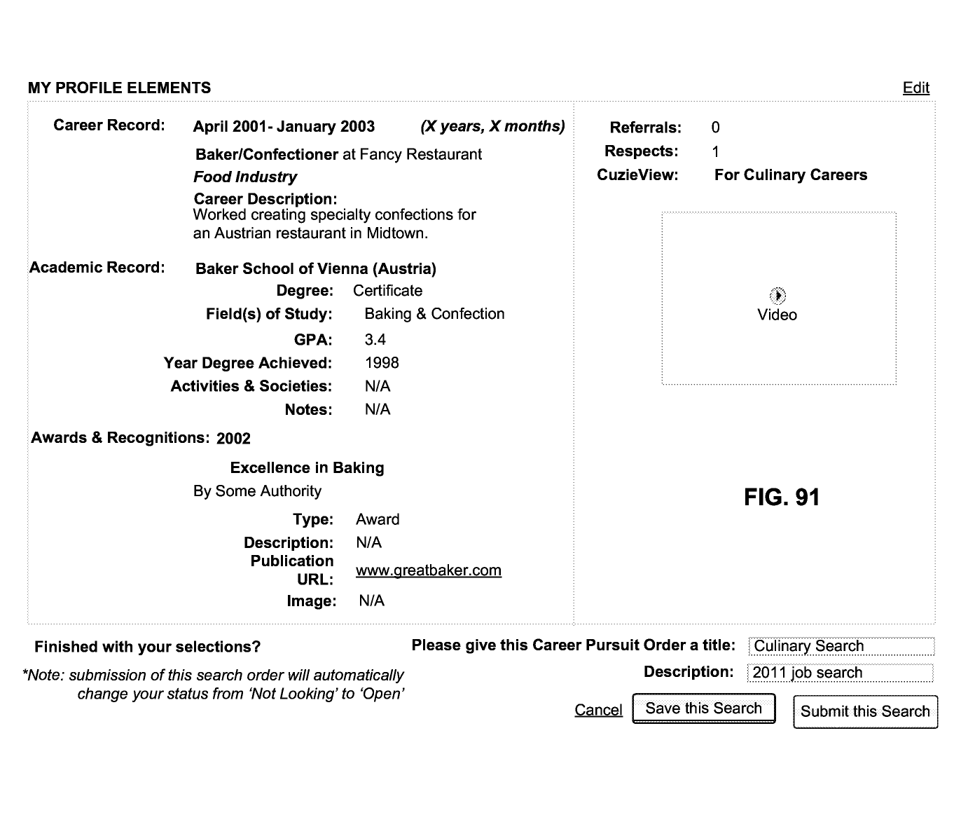

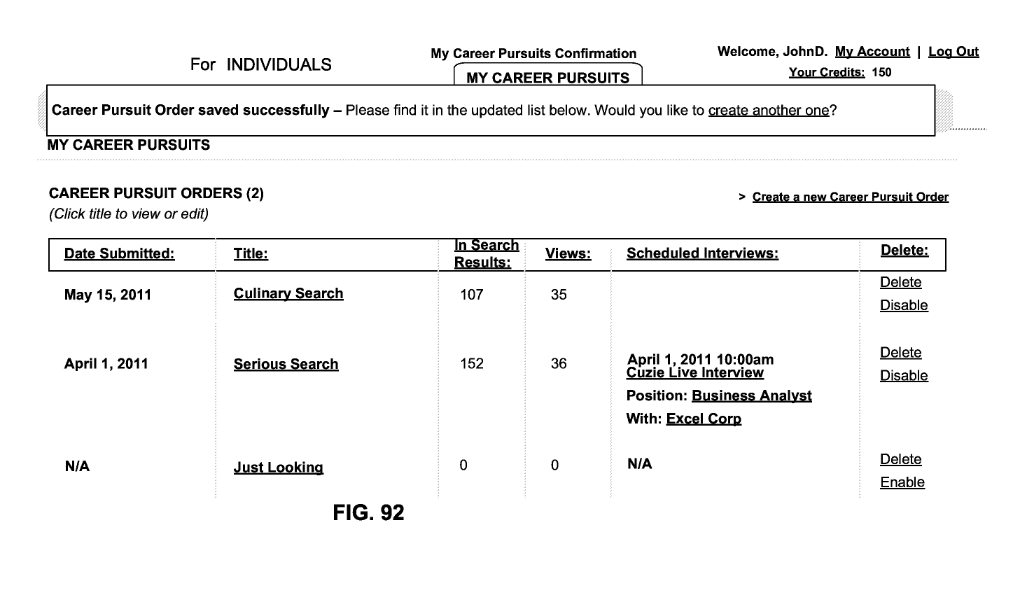

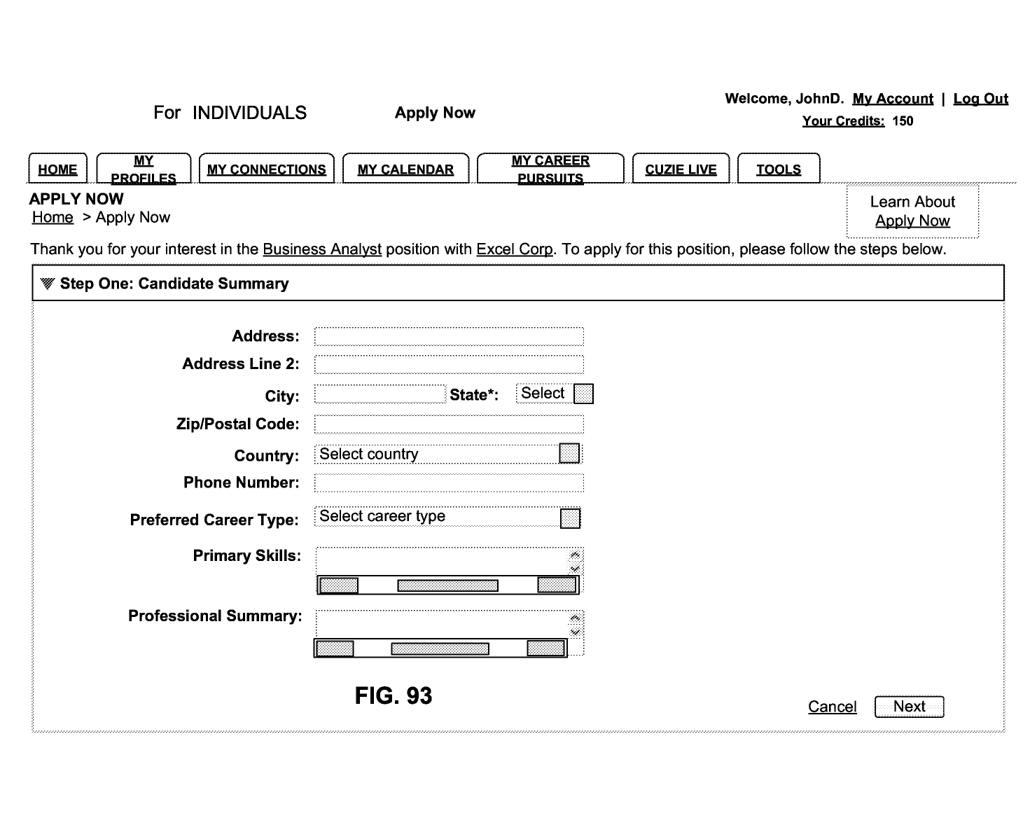

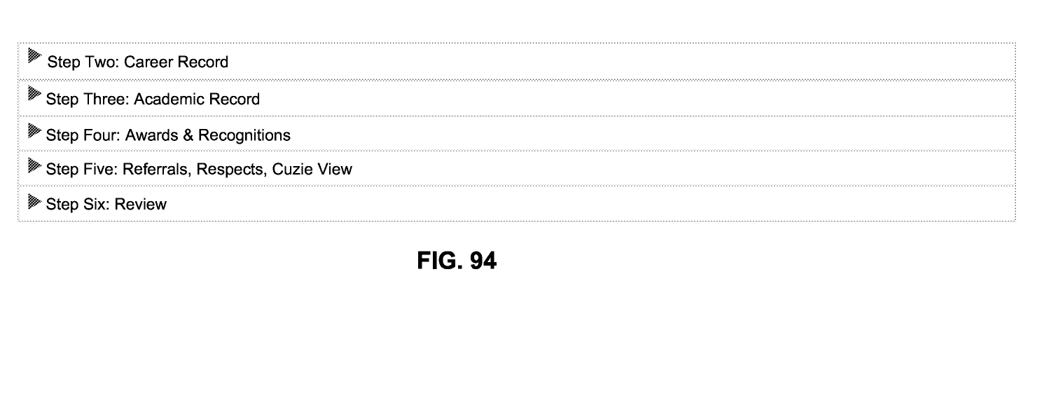

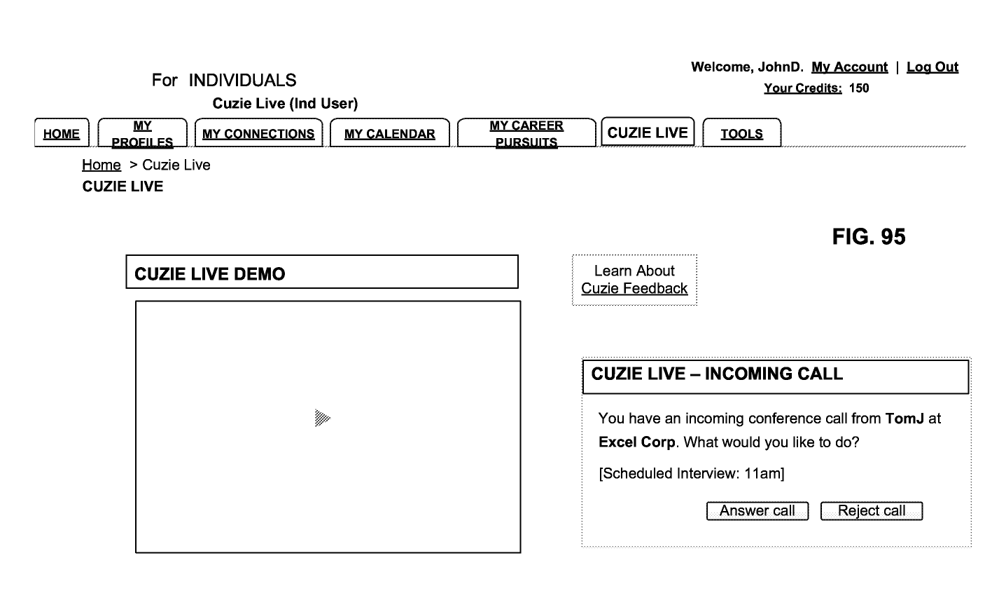

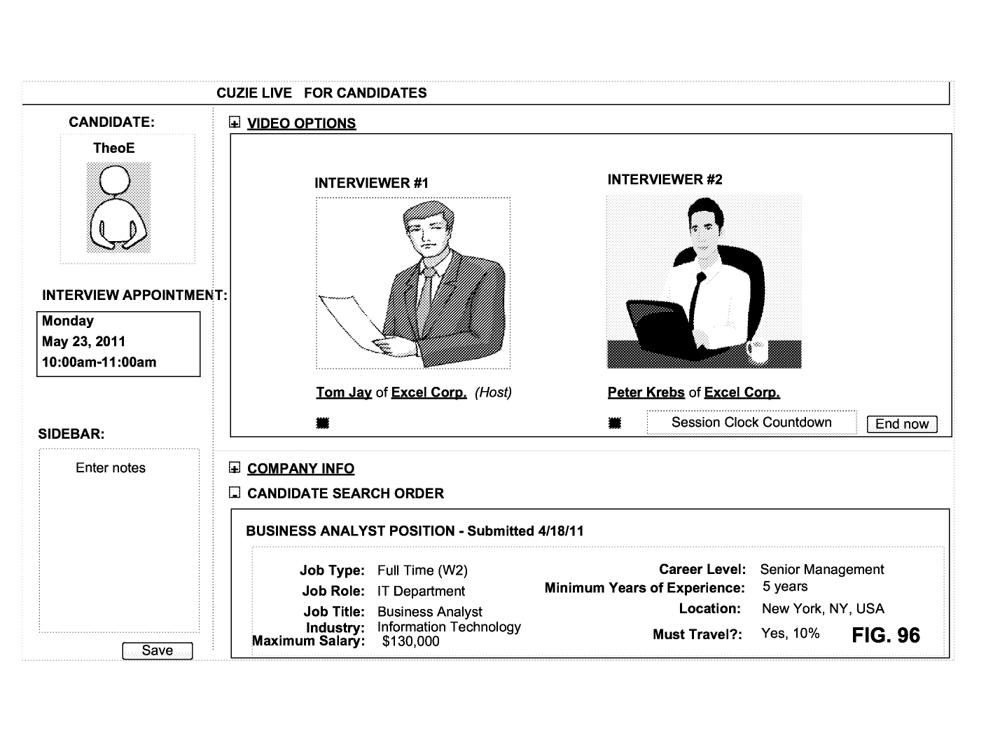

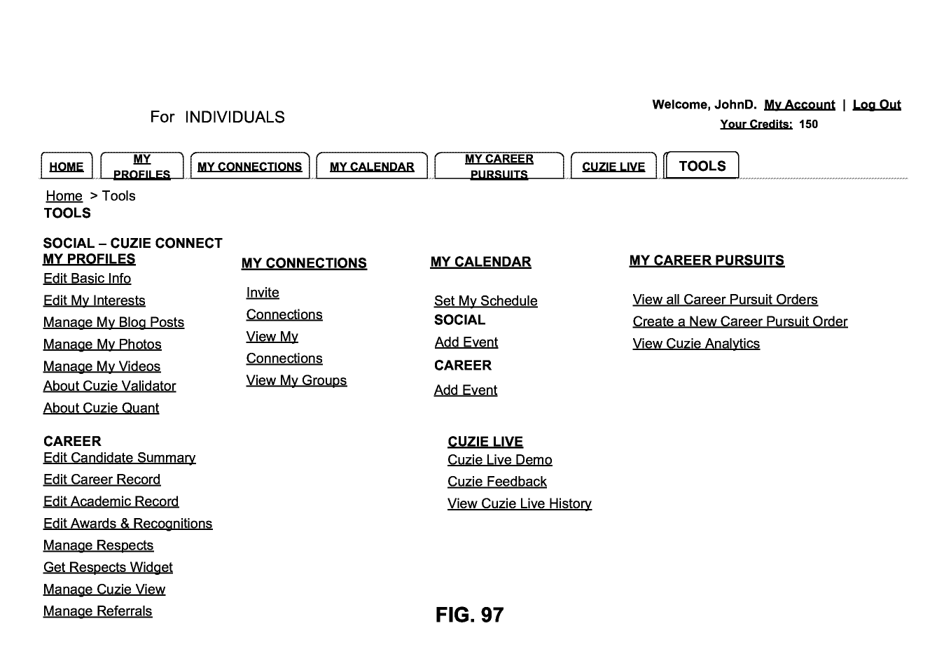

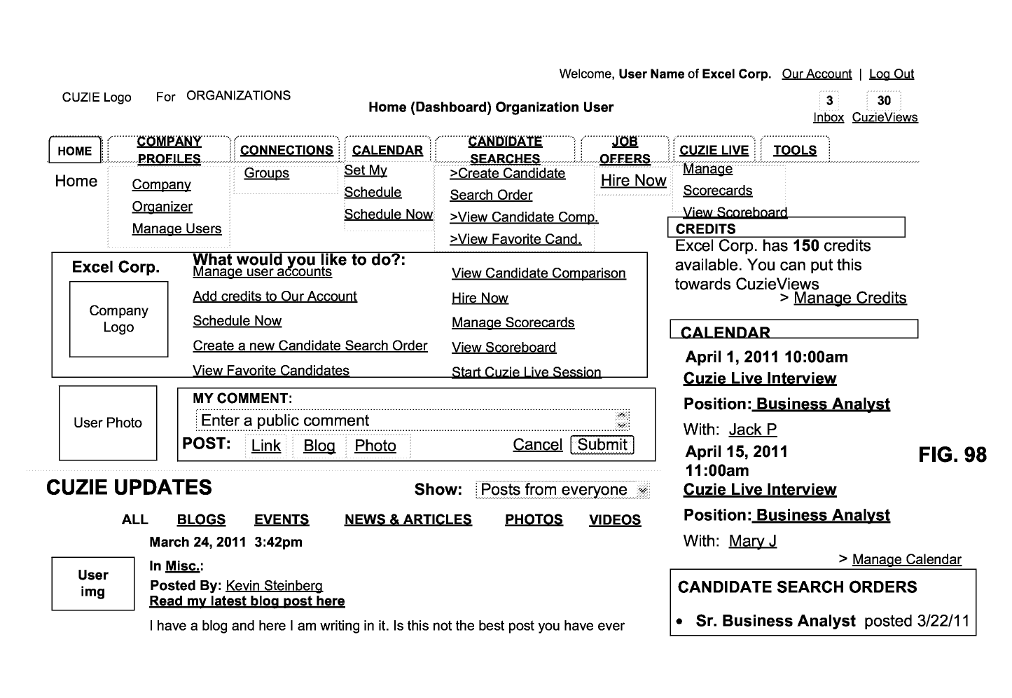

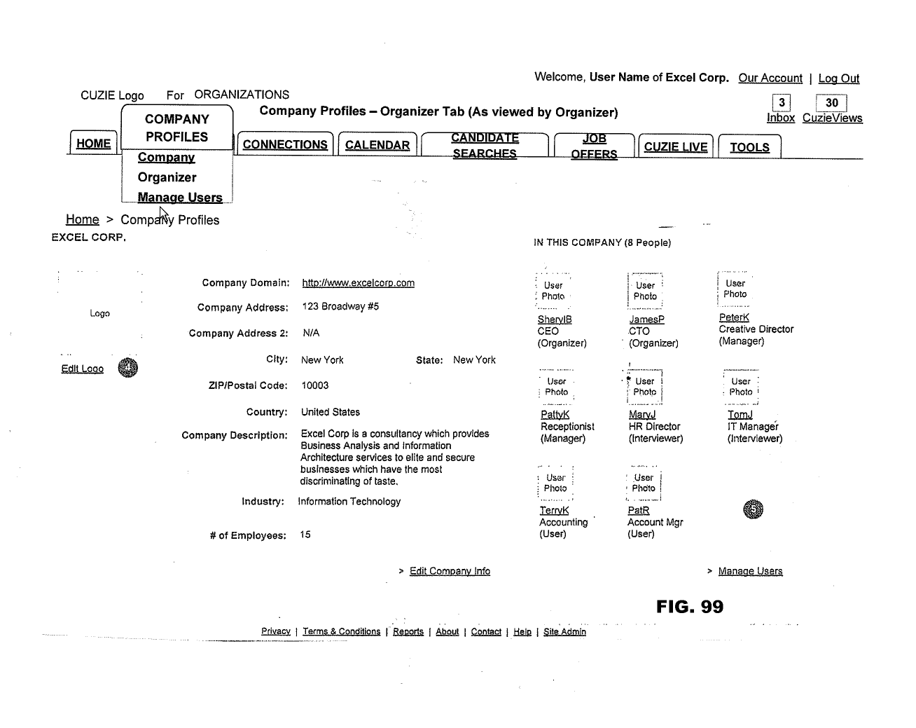

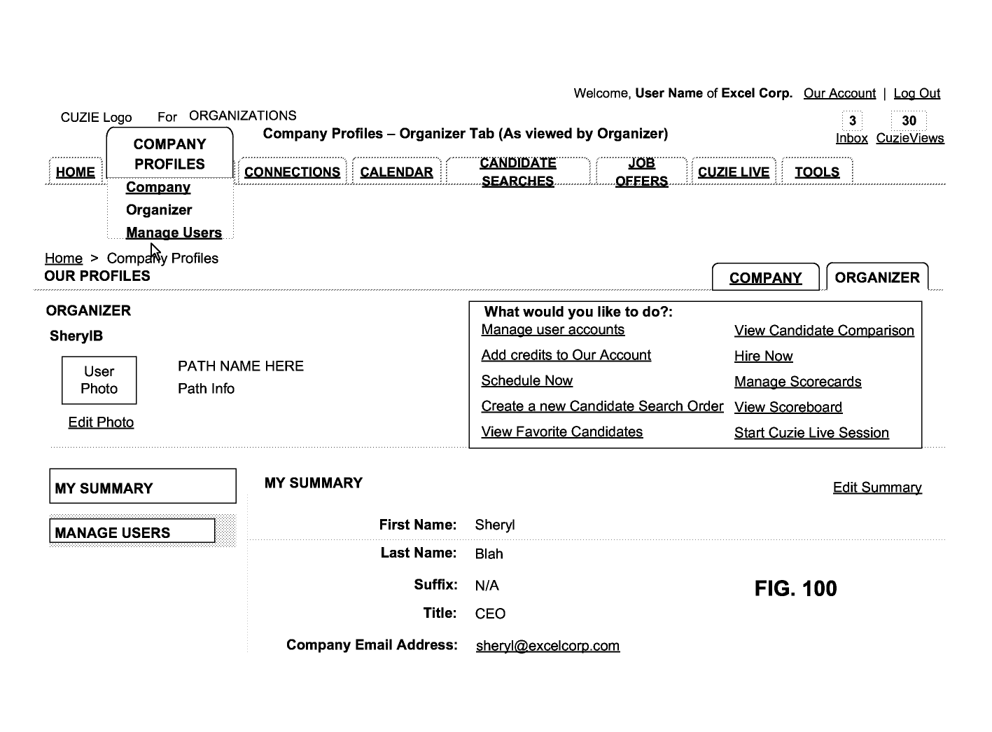

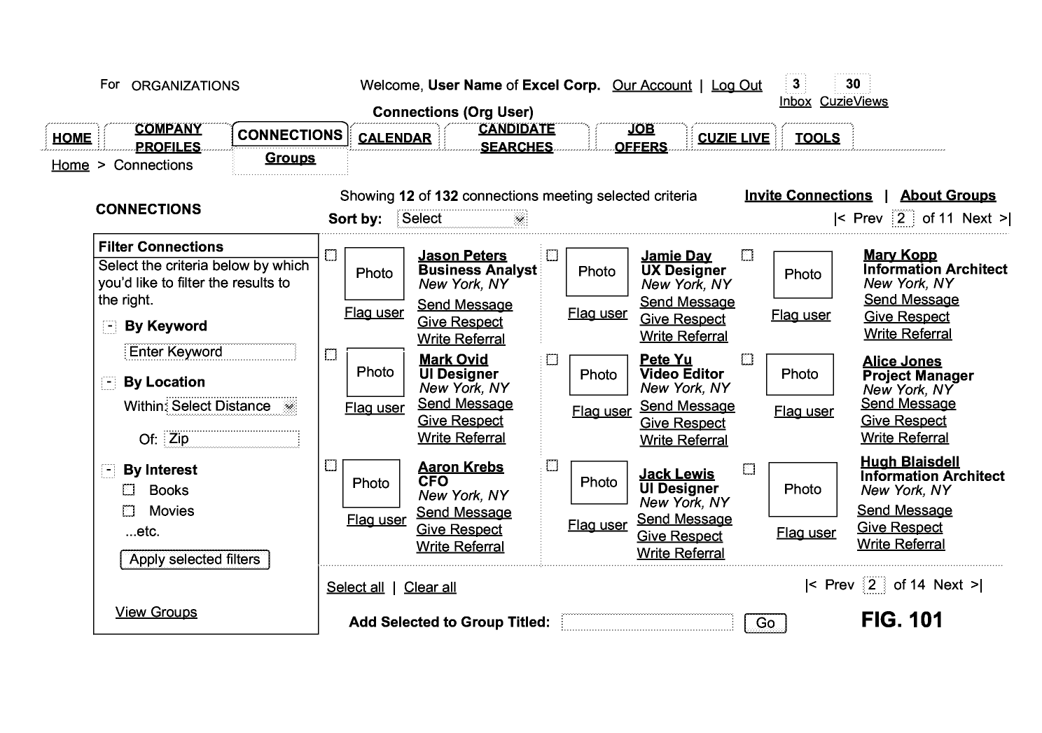

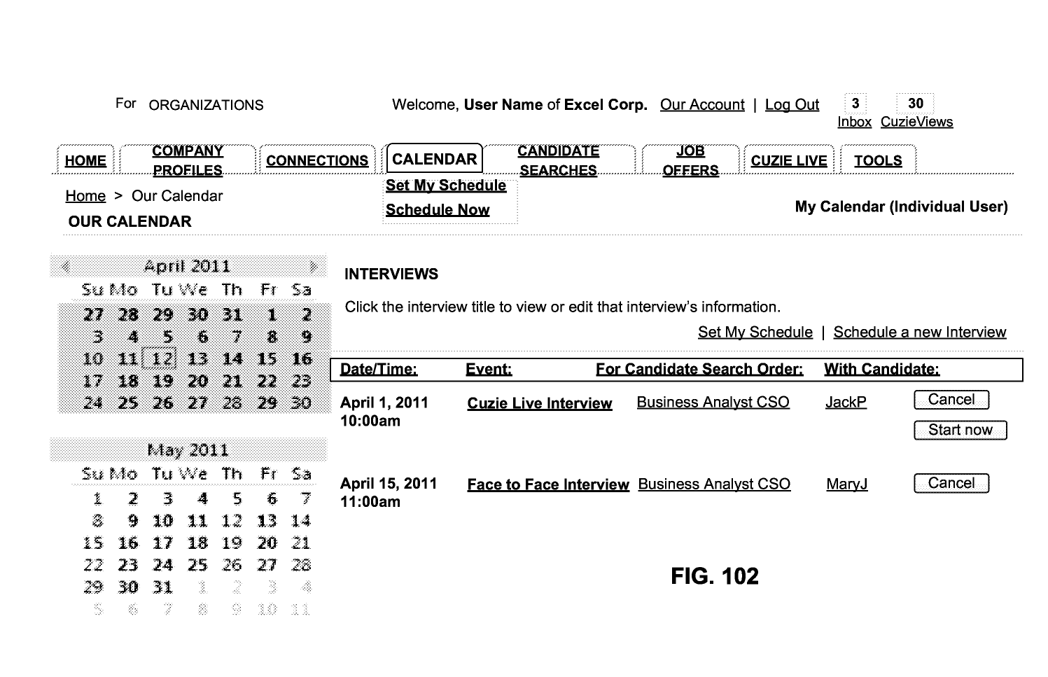

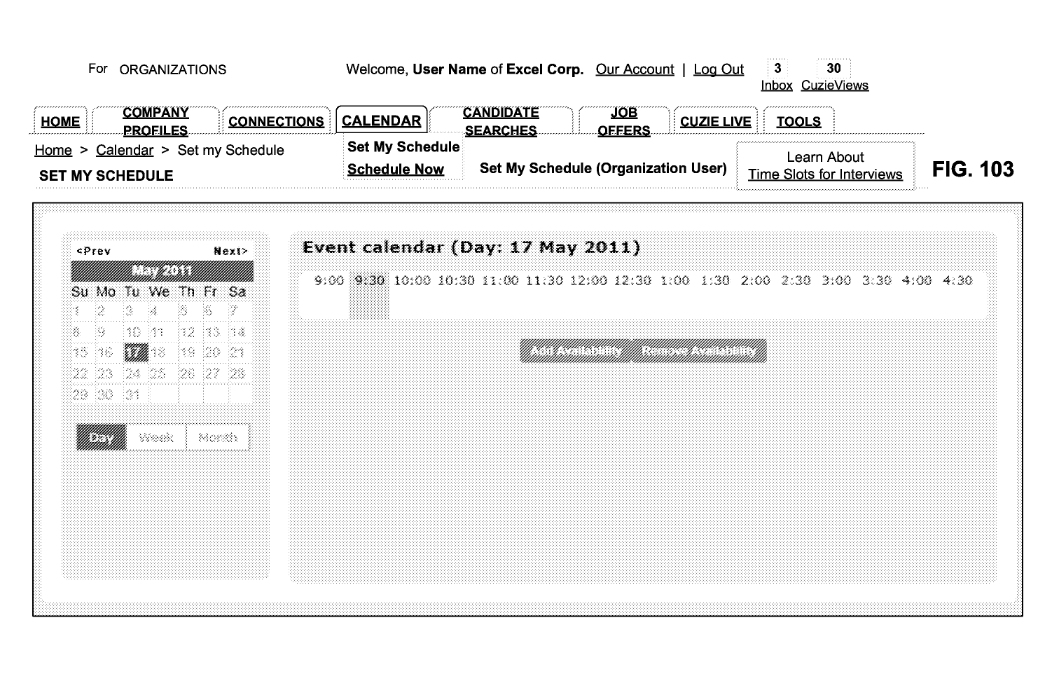

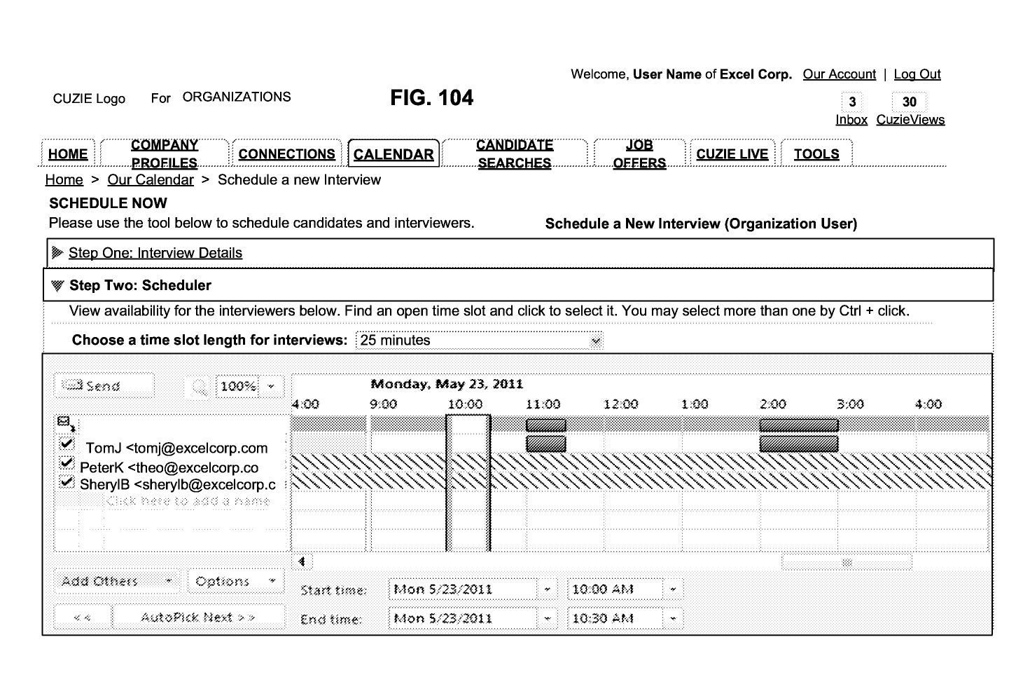

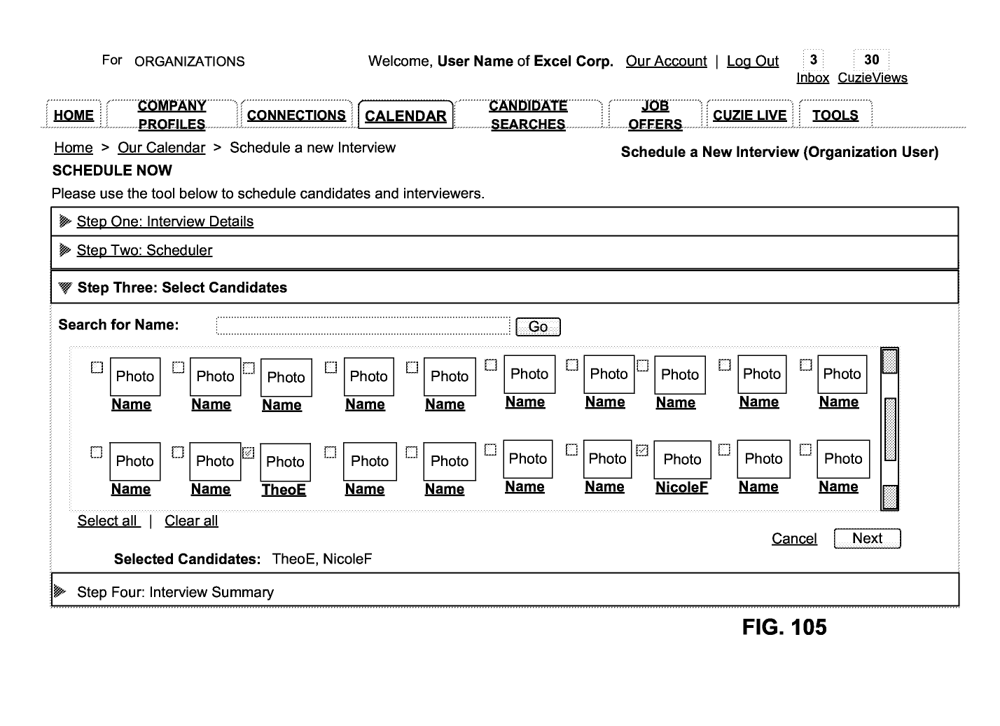

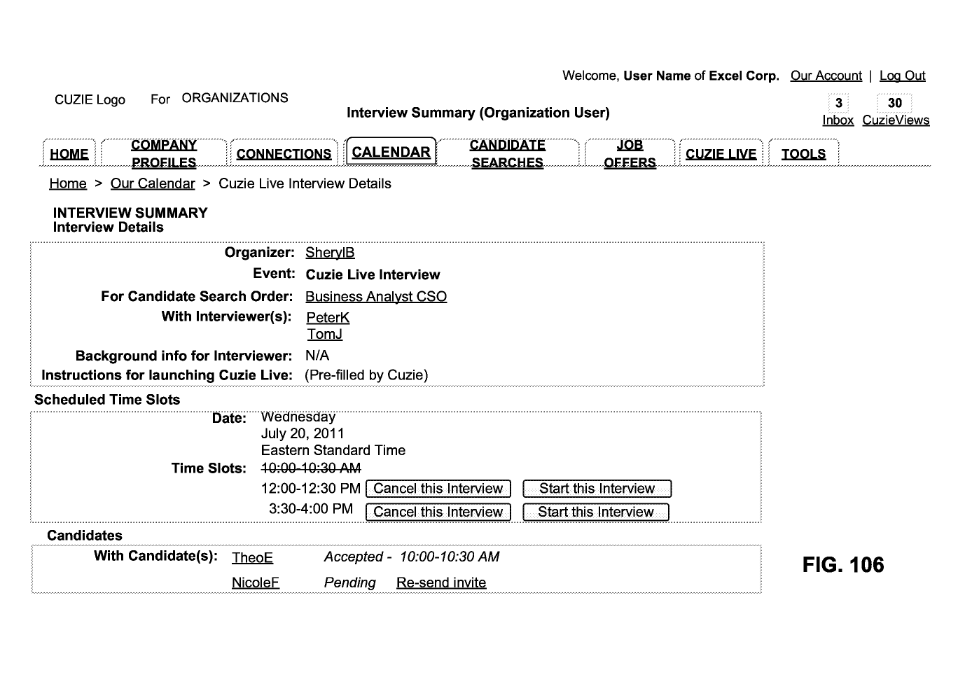

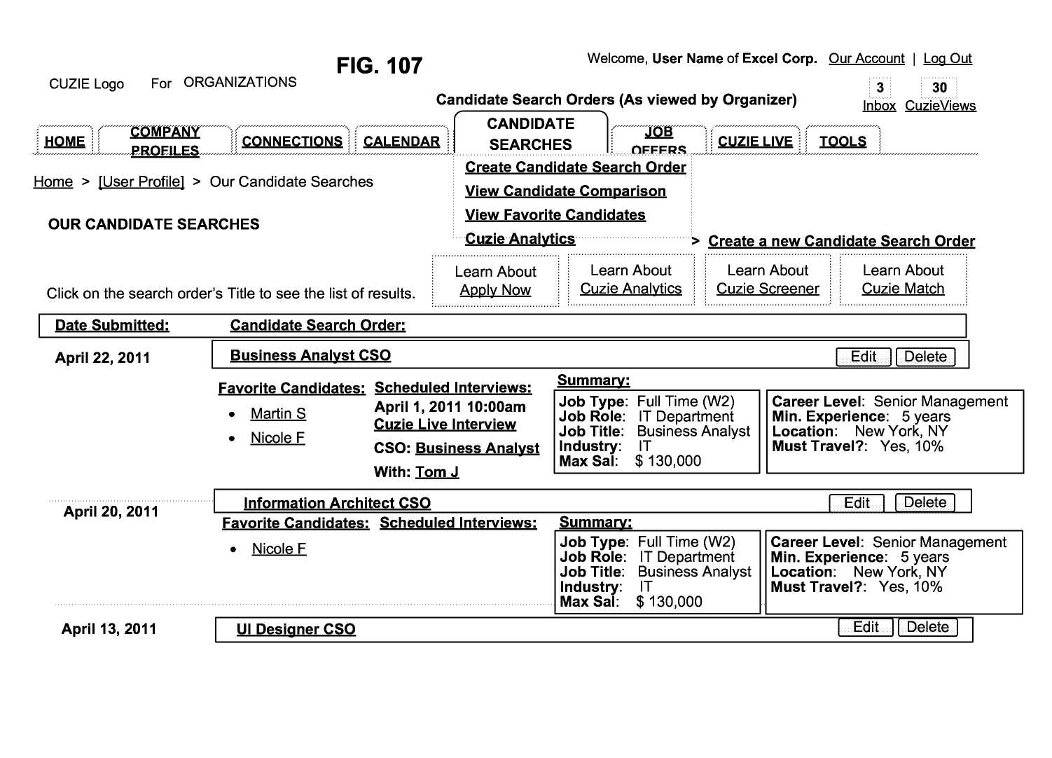

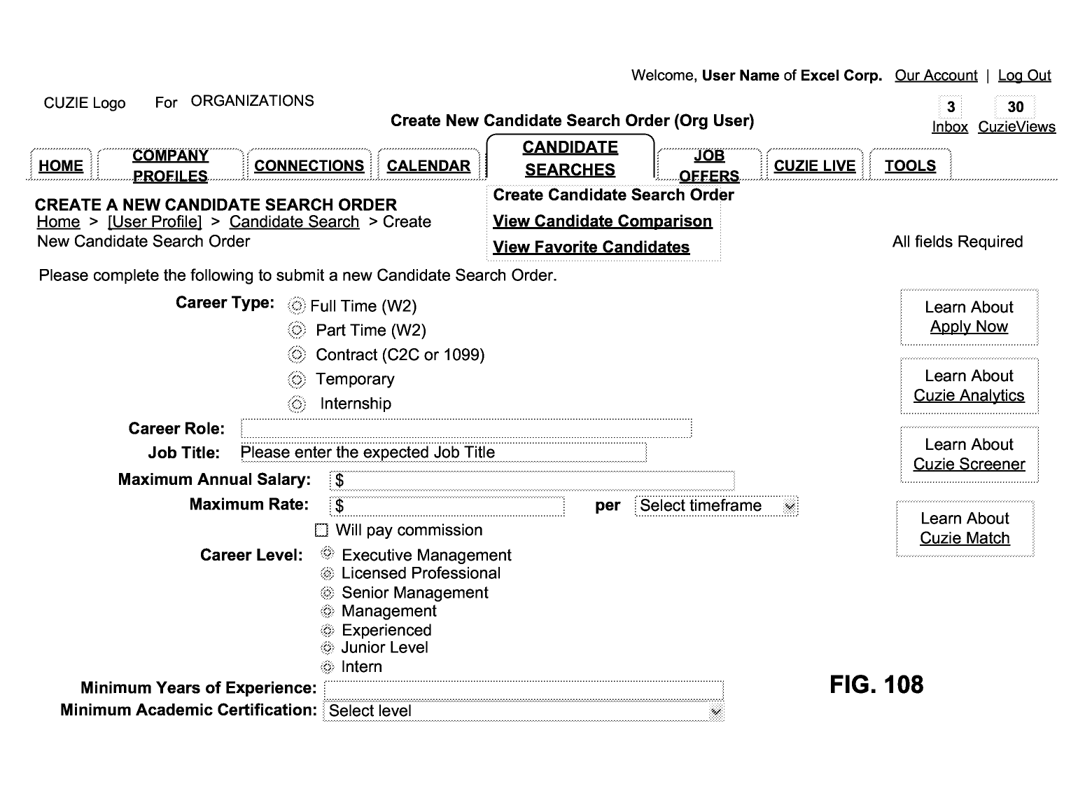

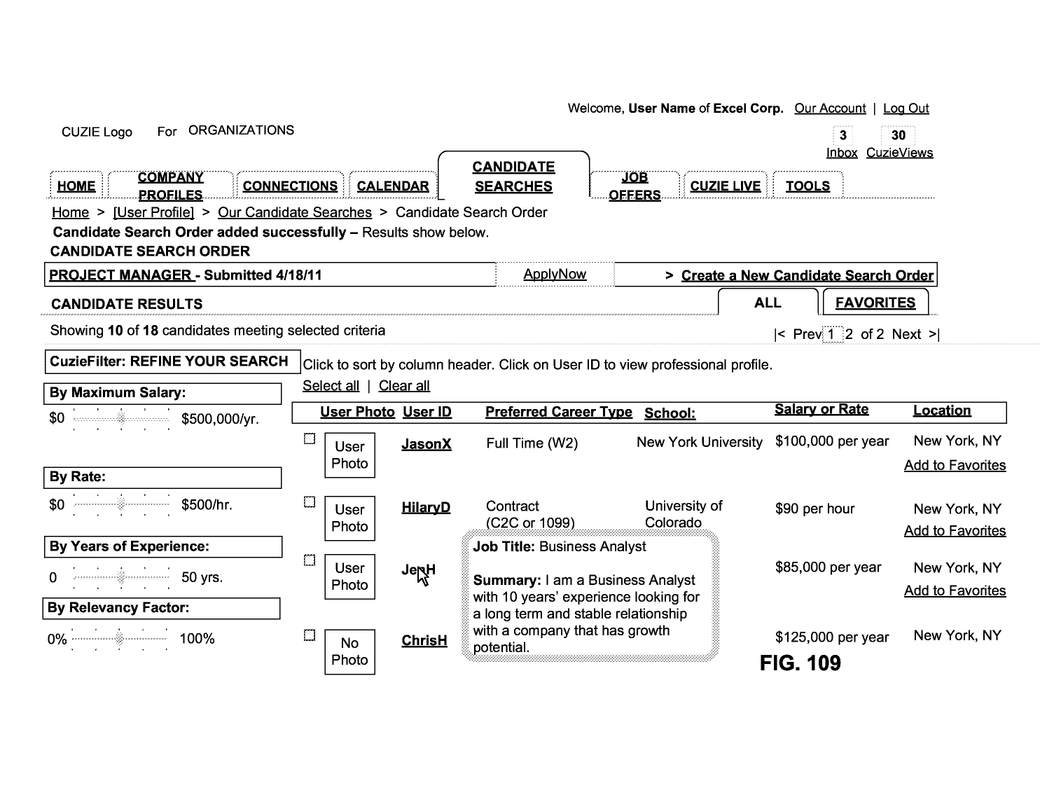

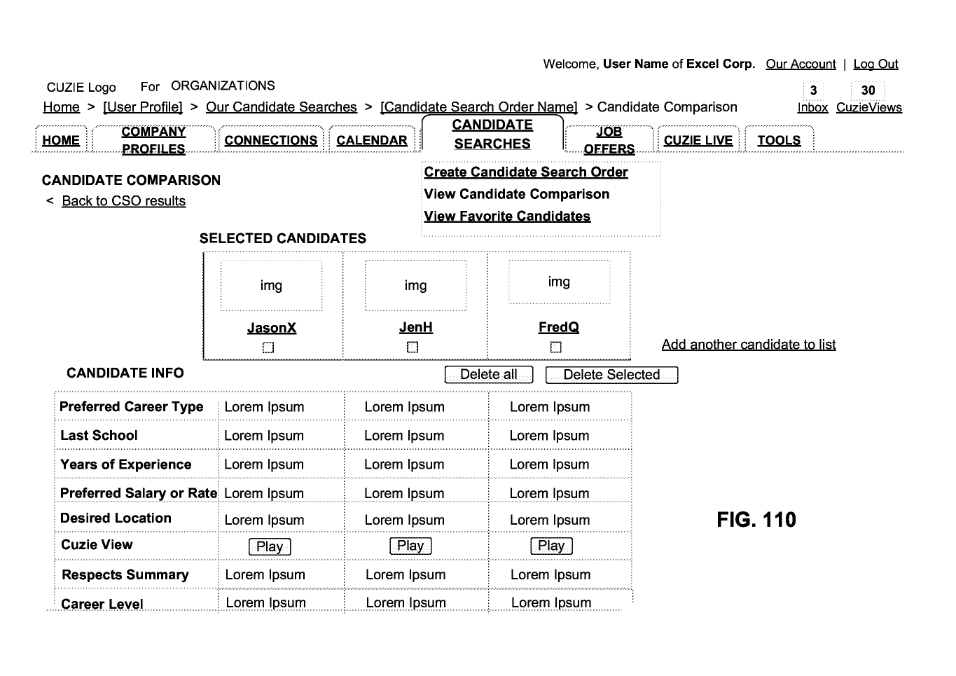

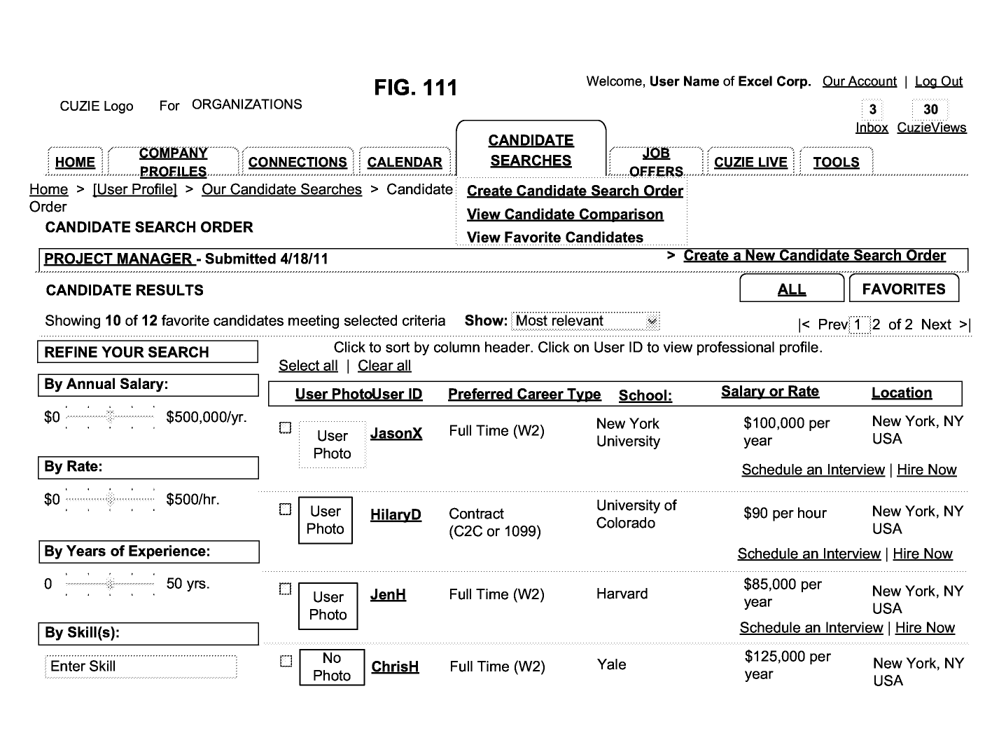

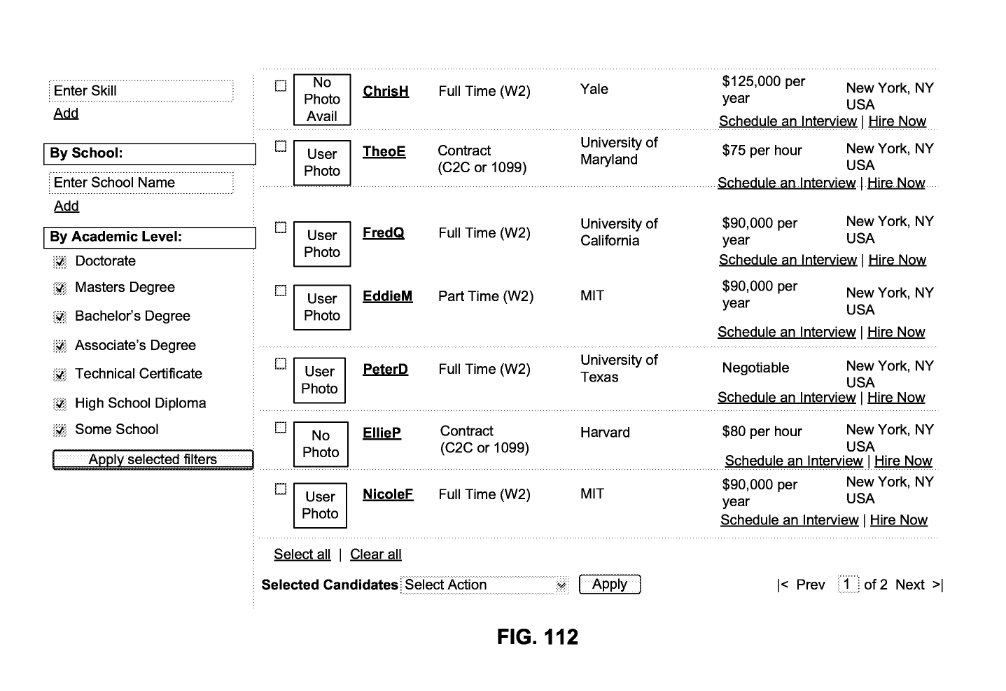

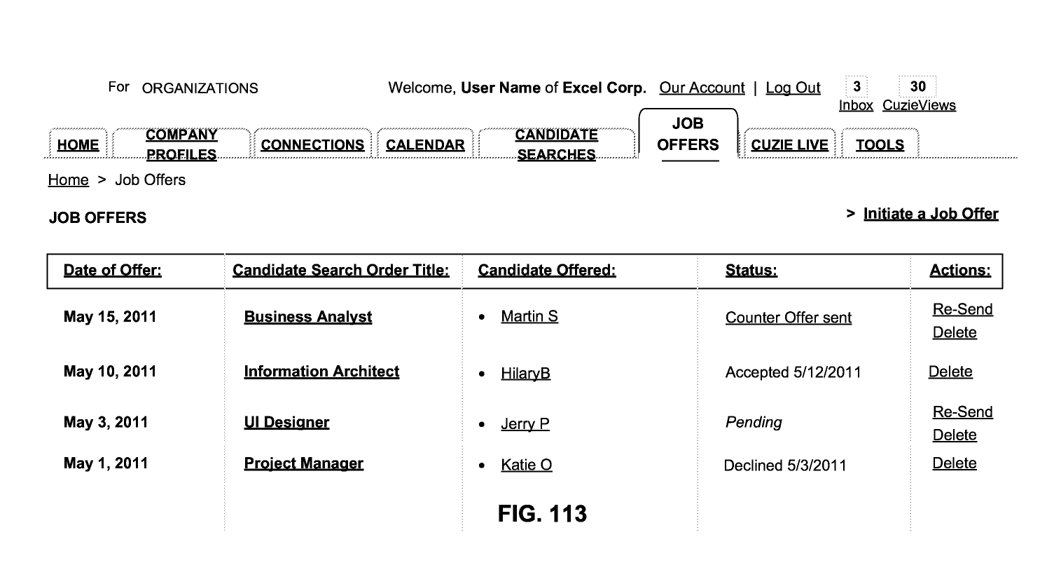

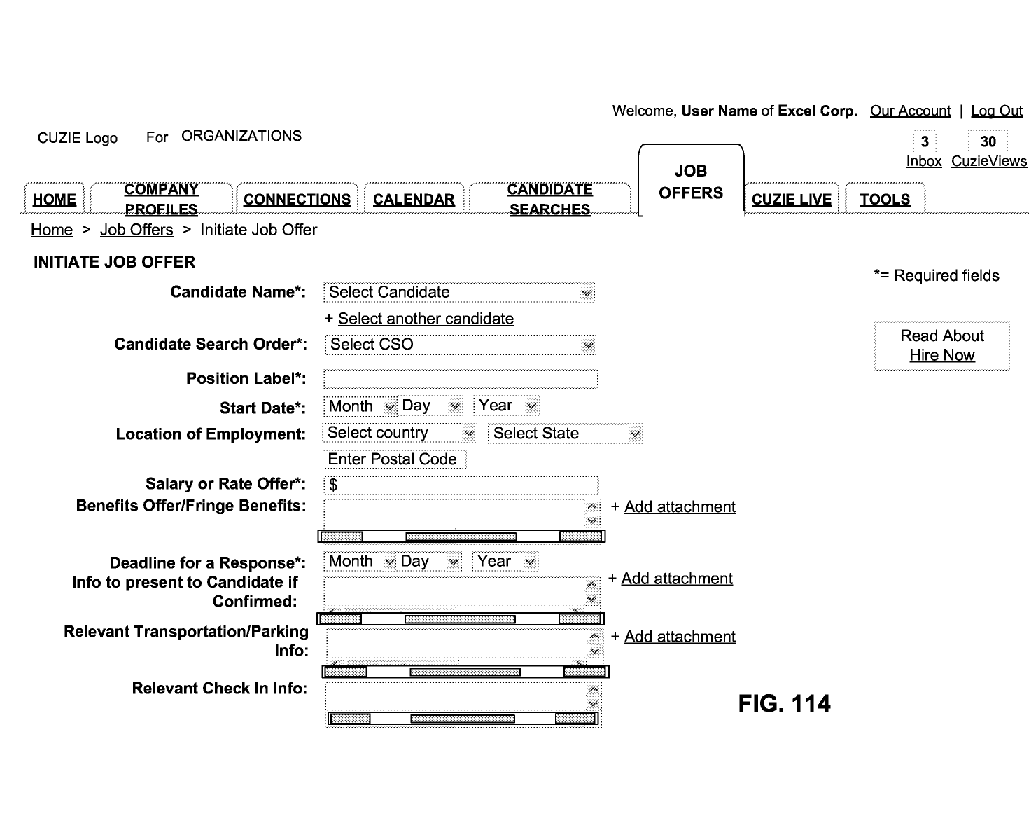

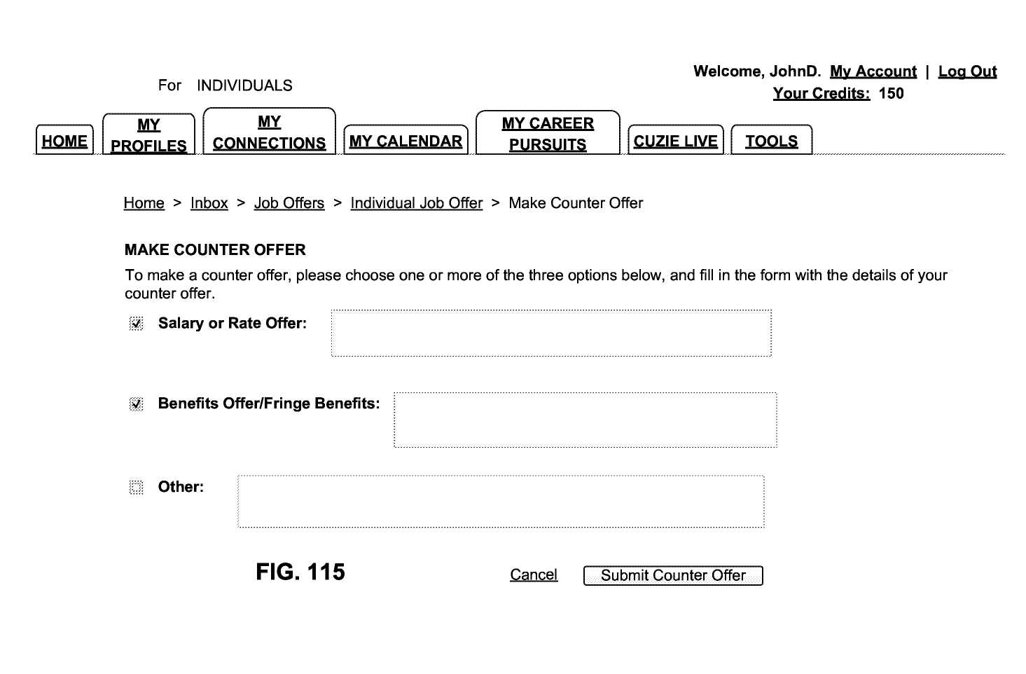

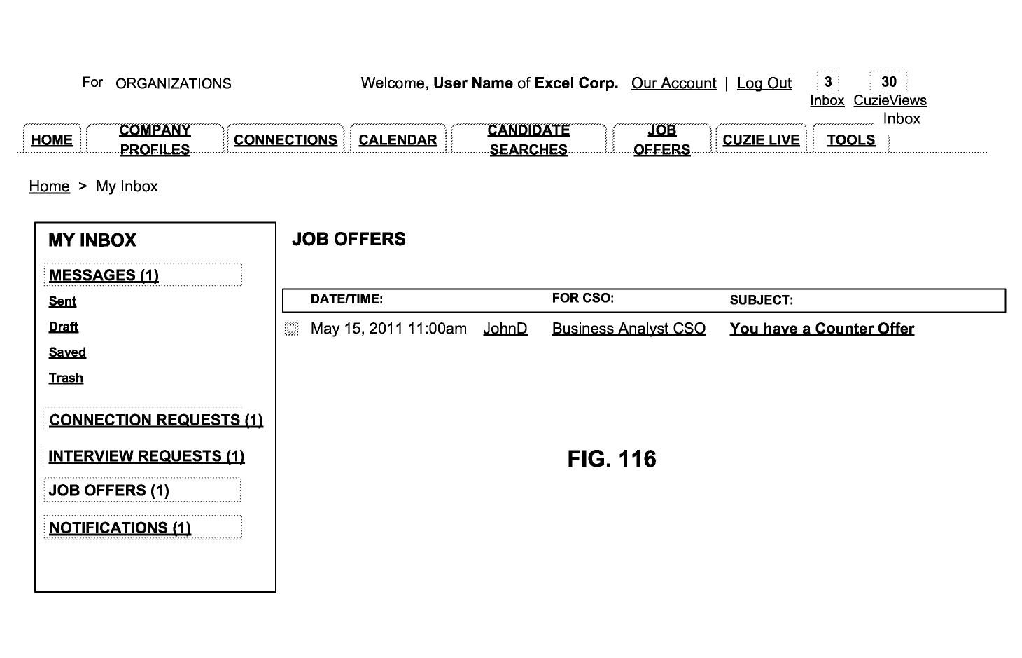

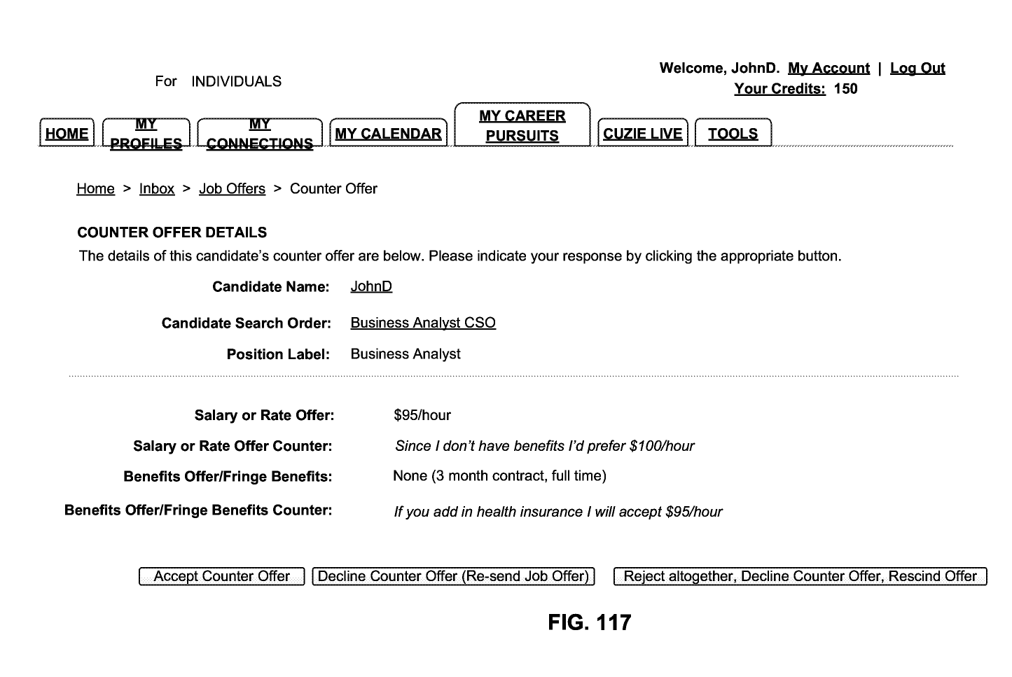

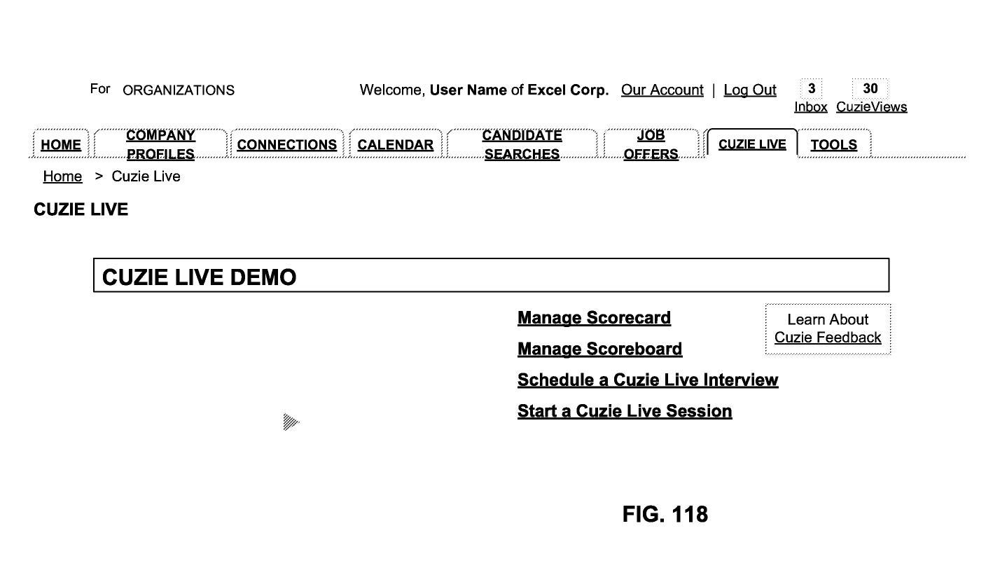

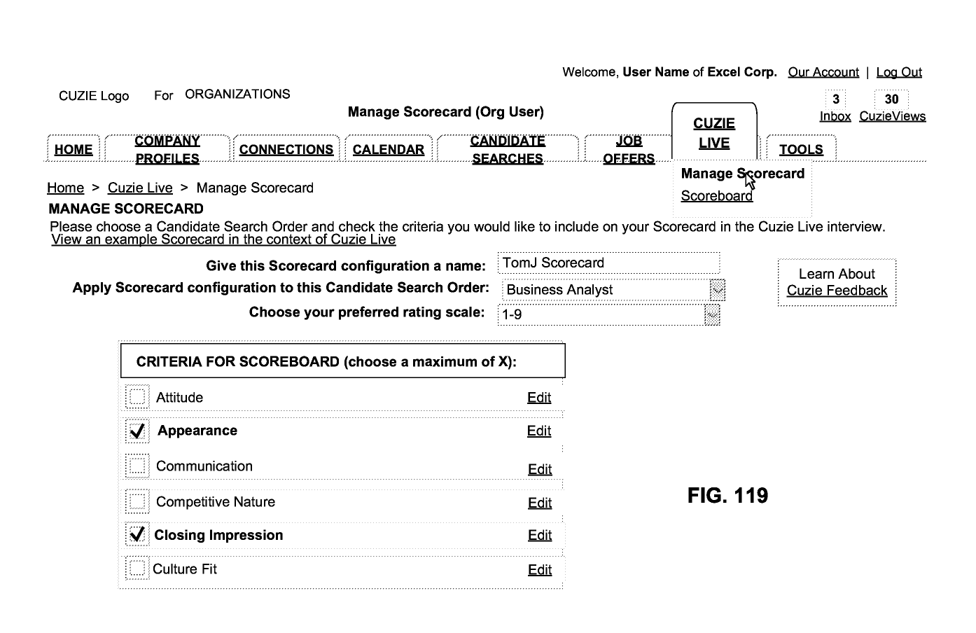

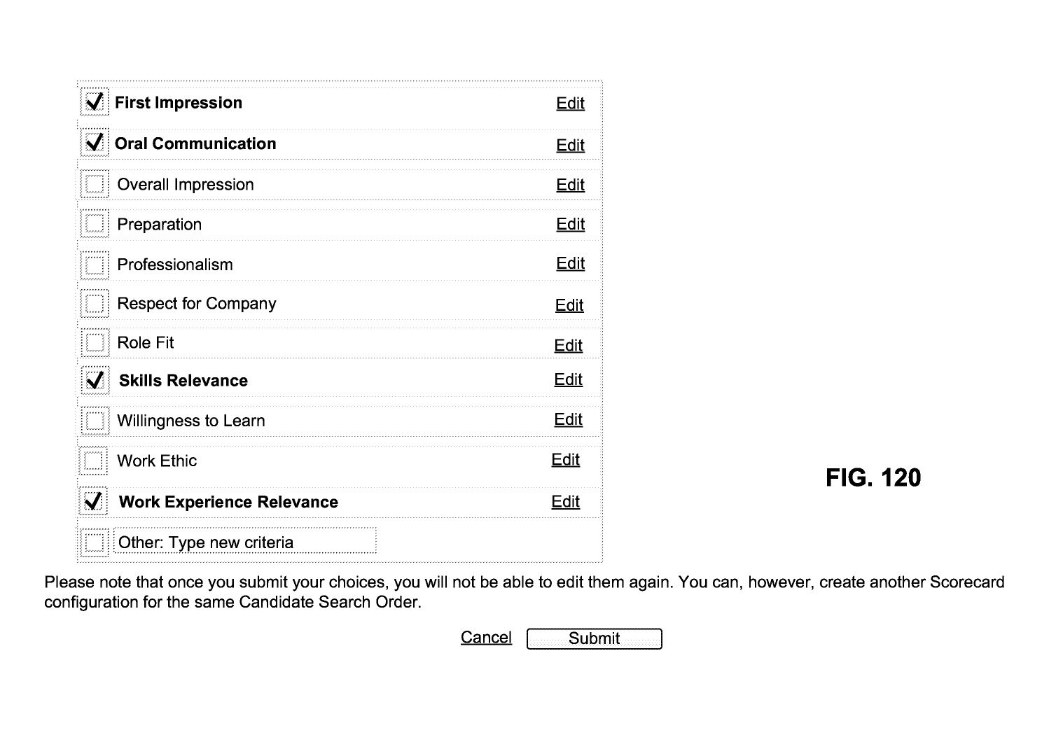

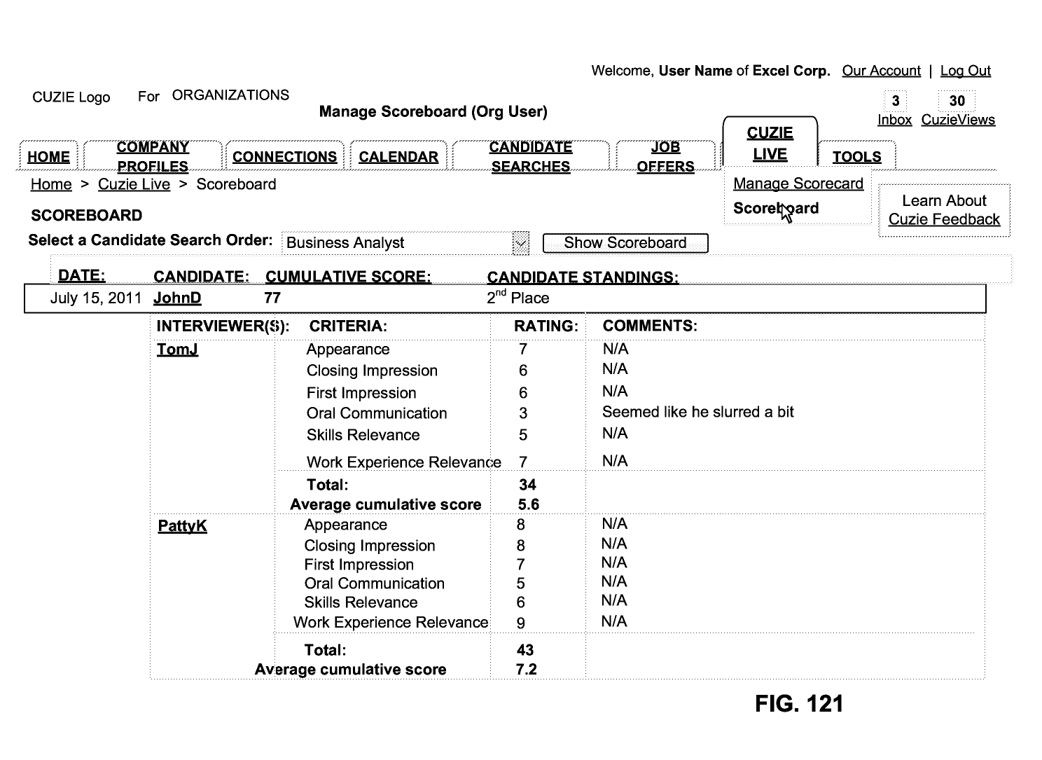

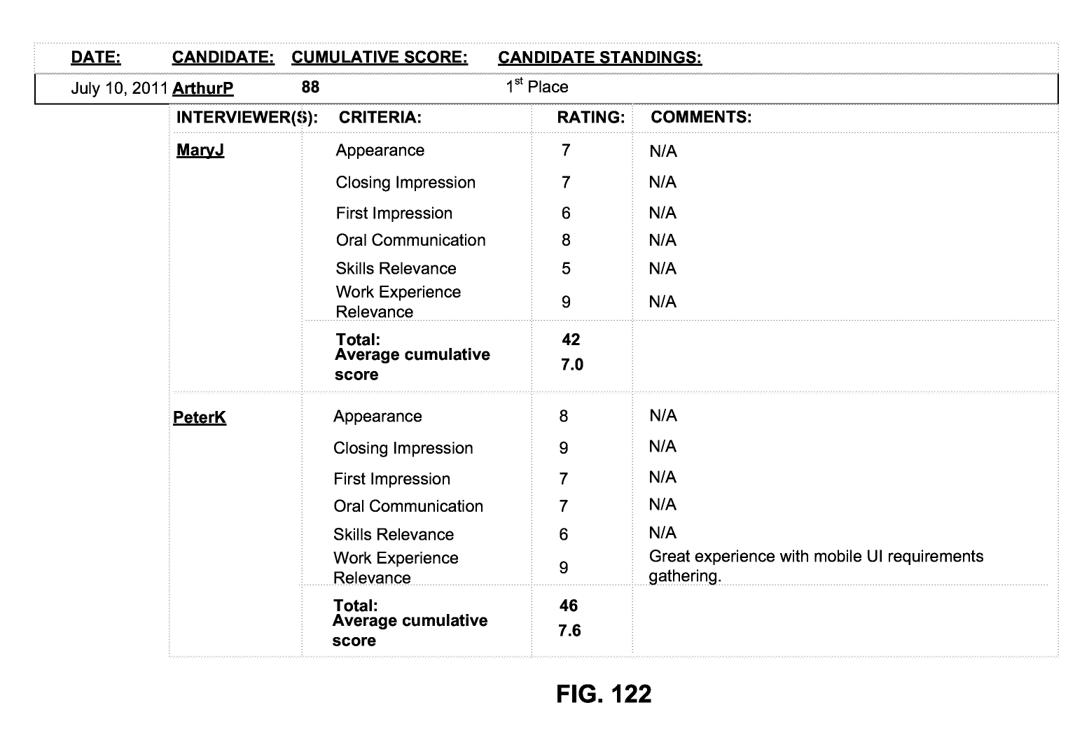

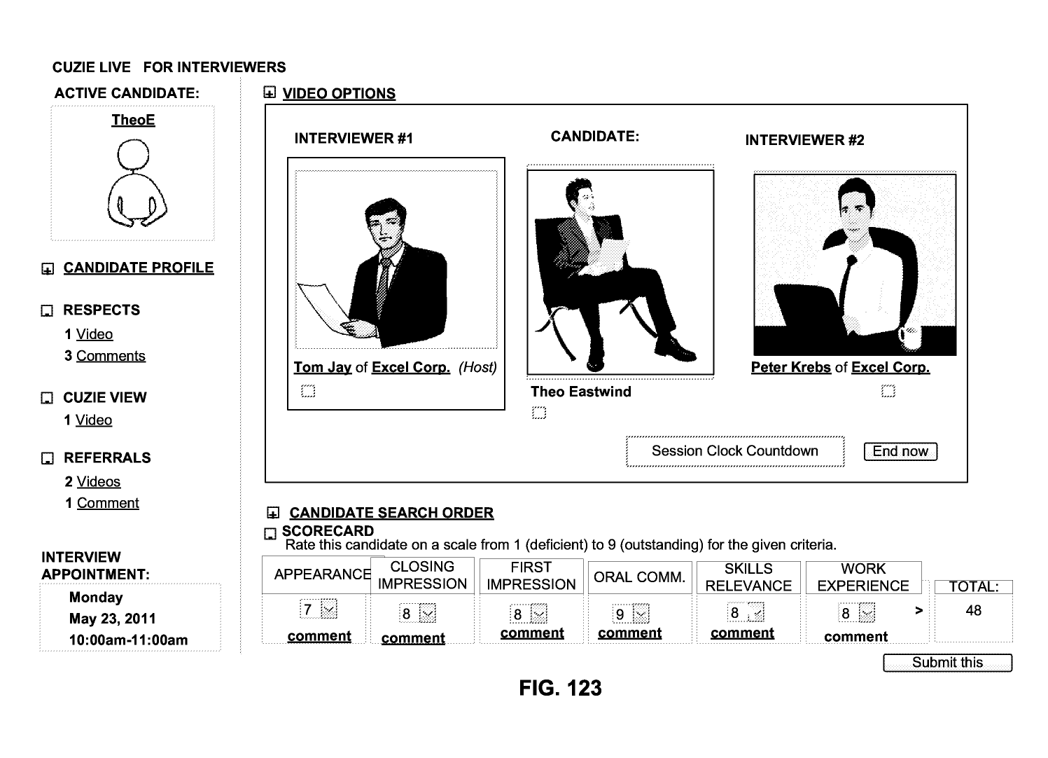

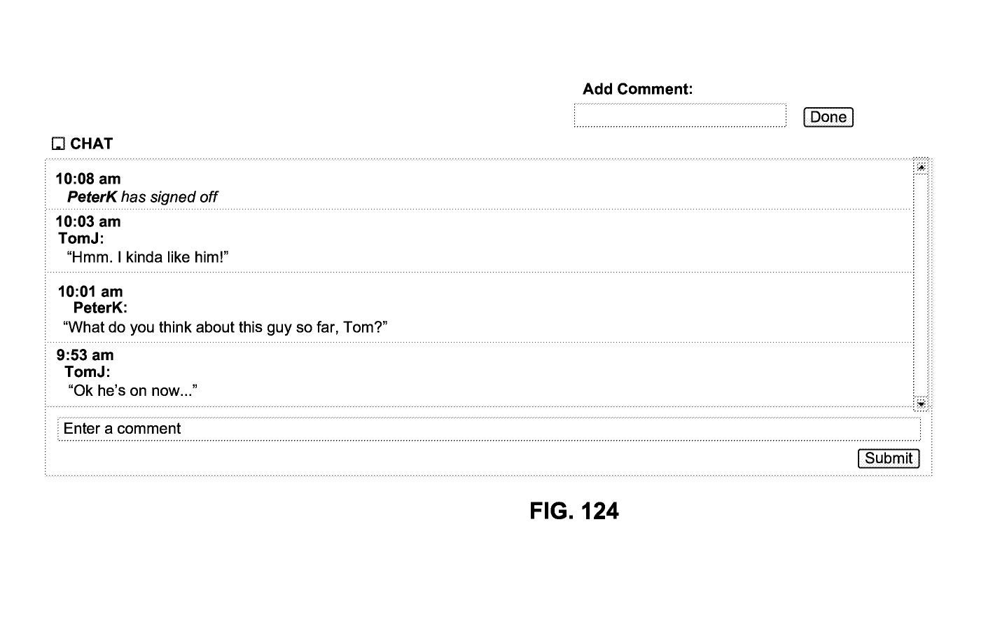

FIGS. 49 to 124 illustrate various further aspects of the present invention, including screen shots used by Candidates and by organizations to manage their careers and manpower needs. All of these diagrams are illustrative only. Other screen shots can be used in accordance with various aspects of the present invention.

FIG. 49 shows an initial screen displayed by the servers of FIG. 1 to a person that signs on from a remote terminal 4. The screen shot of FIG. 49 allows an existing user to log in with a user ID and a password that has been previously entered and stored by the servers of FIG. 1. It also allows those users that are new to the system to sign up as an Individual or as an Organization. The Individual is usually primarily concerned with managing his or her career. The Organization is usually concerned with managing its need for manpower.

Registration screen shots, not shown, request the entry of typical information. Thus, they will request name, birth date, address, email, current company information and password information. Similar but not necessarily the same information is requested for Individuals and Organizations.

FIGS. 50 and 51 show a screen shot for an Individual. It includes tabs for Home, My Profiles, My Connections, My Calendar, My Career Pursuits, CuzieLive and Tools. The screen of FIG. 50 shows a connection update space, where blogs, events, relevant news and articles, photos and videos can be displayed. It also shows a career status drop down list box at 7. The various status that can be selected include Looking, Not Looking and Satisfied But. The meaning of the first two status selections is obvious. The meaning of the third is that the Individual is happy where he or she is but would consider an opportunity that offers a significant advancement. This screen shot also shows a calendar section, which is split into a career calendar and a social calendar. The career calendar shows upcoming job interviews, if any. The social calendar shows upcoming events related to one or more career interests that the Individual has expressed.

As shown in FIG. 51, the screen shot also shows an Individual a CuzieView section. Initially, this shows a demo video that explains, among other things, how to use the videos available on the system of FIG. 1 to the Individual's advantage. Once the Individual establishes his or her video, the servers in FIG. 1 track how many times they are viewed for each career opportunity the Individual is interested in. In FIG. 51, the Individual is interests in Business Administration opportunities and in Culinary opportunities. When the Individual clicks on either link, then a request is sent to the servers in FIG. 1 which cause information related to the selected opportunity to be displayed. The information can include a number of views, the viewers identity and so on. The Individual's video, once established, can also be viewed in the CuzieLive section.

FIG. 52 illustrates information relating to a My Account page that an Individual can view as it relates to his or her account. It allows an Individual to control how their account is accessed and how the Individual is notified.

FIG. 53 shows an Inbox page available to every user. The Inbox page includes a messages section (shown in FIG. 53) in which a variety of different messages can be viewed. It also has a selectable Connection Requests section, a selectable Interview Requests section, a selectable Job Offers section and a selectable Notifications section. The Connection Requests section, when selected, shows the date of a request, the requester and a subject, which can be further viewed. The selectable Interview Requests section is shown in FIG. 54. When an organization selects the Individual for an interview based on information provided to the Organization by the system of FIG. 1, the Organization sends an Interview Request through the system of FIG. 1 which is displayed as illustrated in FIGS. 54 and 55. A command button entitled SEE AVAILABLE TIME SLOTS is provided in FIG. 55. Based on information provided by the Organization, when an Individual clicks on this command button, a window such as the one illustrated in FIG. 56 is displayed by the system of FIG. 1 on the Individual's remote terminal. Thus, the Individual is offered a number of time slots for an interview which can be selected by clicking the appropriate radial button and then selecting the command button ACCEPT SELECTED TIME SLOT. Alternatively, the Individual can indicate that none of the available time slots work by selecting the other command button on FIG. 56.

FIGS. 57 to 59 show the selectable Job Offers section from the Individual's inbox. FIG. 57 shows job offer messages from one or more Organizations. FIG. 58 shows the content of a job offer message, which allows the specific offer to be reviewed by selecting the REVIEW OFFER button. When that button is selected, the offer is shown as in FIG. 59. The information relating to the offer that is shown includes the candidate's name, search order, the start date, the location of employment, the salary, the benefits, the deadline for a response, other information such as a Non-Disclosure Agreement that should be signed, transportation information, training information, and administrative contact information. Also provided, but not shown, is manager information, negotiator's information and Human Resources Information.

FIG. 59A also allows the offer to be accepted by clicking the ACCEPT OFFER button. The offer can be rejected by clicking the REJECT OFFER button. Alternatively, a counter offer can be made by clicking the COUNTER OFFER button. In accordance with one aspect of the present invention, a single counter offer is allowed.

FIG. 60 shows an Individual's home page, which can allow Blogs, Discussion, Events, News and Articles, People connections, Photos and Videos to be selectively displayed by selecting a tab.

FIG. 61 illustrates an Individual's home page with the My Profiles tab selected. That allows Basic Info, My Interests, My Blog Posts, My Photos and My Videos to be selectively displayed. The Basic Info tab is shown in FIG. 61.

In addition to these categories, information relating to My Career Status can be shown as well, as in FIG. 62. This shows a Candidate Summary as shown in FIGS. 62 and 63. Also, a Career Record, Academic Record, Awards and Recognition, Respects, CuzieView and Referrals sections can be selectively displayed by the Individual. FIGS. 64 and 65 show the Career Record information which has been entered by the Individual on other windows. FIGS. 66 and 67 show the Academic Record information which has been entered by the Individual on other windows. FIGS. 68 and 69 show the Awards and Recognitions information which has been entered by the Individual on other windows. FIG. 70 shows the Respects information which has been entered by others respecting the Individual on other windows.

The Individual can manage the respects as shown in FIG. 71. Each respect can be selectively deleted or blocked by selecting the appropriate control shown in FIG. 71. FIG. 72 shows how an Individual can increase the number of respects provided over the system of FIG. 1. The Individual can search for a name by entering the name at 1. The request can be sent by completing the email, the subject and the message blocks and then clicking SUBMIT at 2. The person receiving the request can then complete a request and send it into the system of FIG. 1, where it is stored. FIGS. 73 and 74 show how an Individual can search for persons to make respects outside the system of FIG. 1. FIG. 75 shows how an Individual can create a widget to receive respects on the system of FIG. 1.

FIG. 76 shows how an Individual can manage videos, also referred to as CuzieViews. These videos are made by the Individual so that Organizations can view them to decide whether they are interested in the Individual as a candidate for employment. A different video can be displayed for different career interests. Thus, one video of the Individual is available for a business administration (BA) career. Another different video of the Individual is available for a different career, such as a culinary career (not shown). The First Try video may be a first attempt by the Individual to create a video. The videos can be selectively deleted. Also a button may be shown on FIG. 76 that allows an Individual to access a utility to create a video.

FIG. 77 illustrates a window that allows an Individual to create their own video. In this case, while sitting in front of a camera controlled by the remote terminal the Individual is sitting at, the Individual clicks on the RECORD button to record. The video is stored at the server in FIG. 1. When the Individual clicks the PLAY button, the video is retrieved from the server of FIG. 1 and played back in the Preview area of FIG. 77.

FIG. 78 illustrates referrals made for JohnD, an Individual. The referral is for a position and the relationship of the person making the referral is provided, as is a comment about the Individual. FIG. 79 illustrates a window that the server of FIG. 1 displays when an Individual wants to manage referrals. The window displays the identity of the person making the referral, the relationship, and the specific comment, including possibly a video. These are maintained by the server of FIG. 1. The referrals can be deleted or the user can be blocked by selecting the appropriate control on FIG. 79.

FIG. 80 illustrates a window on which someone can make a referral. When an Individual on a remote terminal who is a member of the system requests to give a referral, the server of FIG. 1 causes the window shown in FIG. 80 to appear on the remote terminal. The person making the referral identifies the Individual for whom the referral is being made at 1. The referral can be entered at 2 and can be submitted by clicking on the SUBMIT button. Additionally, the person making the referral can do so with a video. The person, while sitting in front of a remote terminal connected to the server of FIG. 1 selected RECORD VIDEO to record a video and the selects UPLOAD VIDEO when done to store the video on the server of FIG. 1. The server stores the Individual who is being referred, the person making the referral and the text or video of the referral for later usage.

FIG. 81 illustrates how an Individual can request a referral through the system of FIG. 1. The Individual first indicates that his is requesting a referral on one of his home pages and the server of FIG. 1 causes the window shown in FIG. 81 to appear on the Individual's remote terminal. The Individual can search for a name to give a referral at 1 on FIG. 81. The Individual can also send a request a referral at 2 by entering his or her name in the FROM USER(S) field, by entering email addresses of the person(s) the request is being made of, by entering a subject (i.e. a “Request for Referral” and by entering a message such as “I am writing to request a referral” and then clicking on the SUBMIT button. The request is submitted to the server of FIG. 1 and the server causes the emails to be transmitted. If the person the email is sent to is a member of the system, a window such as the one shown in FIG. 80 is displayed so the referral can be made. If the person is not a member of the system, then a different window that allows the referral to be made is presented.

FIGS. 82 and 83 illustrate a summary of an Individual's career profile. An Individual can view their summary by accessing their home page via the server of FIG. 1.

An Individual's connections are shown when the Individual clicks on the My Connections tab of his or her home page. See, for example, FIG. 52.

An Individual's calendar can be viewed when the Individual selects the MyCalendar tab on their home page, as shown in FIG. 84. Other windows provide means for an Individual to enter dates in the calendar. A special Interview Appointment window can be provided so that an Individual can view their employment interview schedule.

FIG. 85 shows an Individual's career pursuit orders. This window is accessed when the Individual selects the MyCareerPursuits tab on the Individual's home page. The career pursuit order is created by the Individual to pursue an opportunity. An Individual can create more than one Career Pursuit Order.

FIGS. 86 and 87 show how an Individual can create a Career Pursuit Order (CPO). In the MyCareer Pursuit tab of the Individual's home page, the Individual indicates a desire to create a CPO. When the Individual does so, the server of FIG. 1 causes the window of FIG. 86 to be displayed also the Individual's remote terminal. The Individual enters the career type being pursued. The Individual enters the career role being pursued. The career level is also entered by the Individual. The Individual also enters the industry he or she wants to work in. Referring to FIG. 87, the Individual also enters a minimum annual salary and/or a minimum rate per time period. The years of experience and the skill set are also entered by the Individual. The Individual can also enter a summary statement regarding himself or herself.

The Individual also indicates whether he or she is willing to relocate and a preferred location to work. The Individual also indicates whether they are willing to travel.

In step 2 of the creation of a CPO, shown in FIGS. 88 and 89, the Individual selects the profile elements to show. The Individual can select work experience from the MyCareerRecord. The Individual can also select which academic activities to show, which awards and recognitions, which referrals, which respects and what videos (CuzieView) to show. The selections are made by selecting check boxes or radial boxes, as indicated.

In the next step of creating a CPO, the user reviews a summary of the CPO, as shown in FIGS. 90 and 91. The summary includes the topics described above and as shown in FIGS. 90 and 91.

FIG. 92 shows a listing of CPO's for an Individual. This window is selected by an Individual when he or she selects the MyCareerPursuits tab on their home page. The server of FIG. 1 saves the CPO information and displays in on the remote terminal of the Individual when the Individual selects the appropriate controls. Again, more than one CPO, directed at different jobs, can be created by each Individual.

When an Individual wants to apply for a job, the Individual accesses the Apply Now window, shown in FIG. 93. The Individual selects a job to be applied for, including the company offering the job. This information is shown on FIG. 93 so the Individual knows which job is being applied for. The information in the Apply Now windows is pre-populated by the server of FIG. 1 but can be edited. In step 1, the candidate summary is completed. As shown, this includes an address of the Individual, the phone number, the career type, the skills and a professional summary.

In step 2 of the Apply Now process, the career record information is edited, as shown in FIG. 94. The information displayed and potentially edited includes a time span, a job title, a company name, an industry and a description.

In step 3 of the Apply Now process, the academic record is shown and potentially edited. The information includes, for each education item, the institution, the degree, the field of study, the GPA, the year of graduation, activities and societies and other notes.

In step 4 of the Apply Now process, the Individual's awards and recognitions are shown and potentially edited. The information includes the award, the year of the award, the entity granting the award, the type of award and a description of the award.

In step 5 of the Apply Now process, referrals, respects and video views (CuzieView) are reviewed and potentially edited. In the last step, the information is reviewed.

In accordance with an aspect of the present invention, the system of FIG. 1 provides video conferencing for interviews. When an Individual is ready for an interview, the Individual selects the CuzieLive tab. When the interview starts, a call is placed through the server of FIG. 1. The server responds by generating a window the indicates there is an incoming call, as illustrated in FIG. 95. The Individual can either answer the call or reject the call by selecting the appropriate button. If the call is accepted, the interviewer, who is in front of a camera connected to the system of FIG. 1, is displayed in the CuzieLive box and the interview is conducted. The Individual's video, assuming the Individual is in front of a camera connected to the system of FIG. 1, is also shown to the interviewer.

FIG. 96 illustrates an alternative video interview for a candidate in accordance with an aspect of the present invention. On the left side of the window, a photo of the candidate is shown, as is the appointment information. Also, an area where the candidate/Individual can enter notes is provided. On the right hand, upper portion of FIG. 96, video links of each interviewer are shown. In the case of FIG. 96, two interviewers are shown to the candidate as the interview is ongoing. On the bottom of the window of FIG. 96, information concerning the business position that the candidate is applying to is displayed.

When the interview is over, feedback information can be provided to the candidate. The candidate's strongest attributes according to the interviewers can be shown to the candidate. Also, the candidate's weakest attributes according to the interviewers can be shown to the candidate. Also, suggestions can be provided to the candidate.

FIG. 97 illustrates a set of tools provided to the candidate.

FIG. 98 illustrates a home page for an organization provided by the system of FIG. 1 when an authorized member of the organization logs in. Information about the organization is shown. System updates are shown. Available credits and a calendar are shown. Candidate Search Orders are shown.

Information about the organization is shown when the user selects the Company Profiles tab on the organization home page, as shown in FIG. 99. Information about organizers for the organization can be shown when selected, as shown in FIG. 100. Organization connections are shown when the Connections tab on the organizations home page is selected, as shown in FIG. 101. An organization calendar, showing the interviews scheduled for the organization, is shown when the Calendar tab on the organization's home page is selected, as shown in FIG. 102. FIGS. 103 and 104 show scheduling tools that are used by an organizer at an Organization to arrange for a time for an interview with a candidate. They are provided to a remote terminal where the organizer is sitting when the organizer indicates they want to schedule an interview.

After scheduling a time, the organizer can select from a number of potential candidates, as shown in FIG. 105. The potential candidates are indicated in FIG. 105 by NAME. Photos of the candidates can be provided. The server of FIG. 1 accesses its databases to retrieve the information for each potential candidate to display this information.

When the organizer for the Organization is ready to schedule an interview, they complete the interview details illustrated in FIG. 106. The information includes available time slots. In the case of FIG. 106, there are three available time slots, 10:00-10:30 AM, 12:00-12:30 AM and 3:30-4:00 AM.

The server of FIG. 1 keeps track of the candidate searches that each Organization is conducting. Each search is called a Candidate Search Order (CSO). A CSO is created by the organization. When an organizer at an Organization wants to see each CSO the organization wants to pursue, it selects an appropriate command at a remote terminal which is sent to the server. The server collects each CSO for the Organization and the relevant information associated with each CSO and displays that information in a window such as FIG. 107 on the remote terminal that made the request.

The creation of a new CSO is illustrated in FIG. 108. When an organizer at an Organization has a new job opening and wants to create a new CSO, the organizer selects an appropriate command at a remote terminal which is sent to the server. The server causes the window of FIG. 108 to be displayed. The organizer completes the form of FIG. 108, including the type of the job, the career role, the job title, the annual salary, a minimum salary, the level of the job, the minimum years of experience, and the minimum academic level. When done, the organizer submits this information to the server of FIG. 1 where it is stored in a database.

The server of FIG. 1 searches its database of Individuals for matches of the information entered above in FIG. 108. The server of FIG. 1 runs its quantifying process, explained before, rate each Individual that matches the minimum requirements set forth by the Organizer. Those with the highest score are shown to the Organizer in FIG. 109.

If the Organizer is not satisfied with the results, then the Organizer can refine the search as shown in FIG. 109. The Organizer can adjust the salary, for example, with a sliding scale as indicated. The Organizer can adjust the rate, for example with a sliding scale as indicated. The Organizer can adjust the years of experience, for example with a sliding scale as indicated. The Organizer can adjust a relevancy factor, for example, with a sliding scale as indicated. All of the parameters used by the Organizer to create the CSO can be adjusted, for example, with a sliding scale.

Once a CSO has been created and the server of FIG. 1 has run a matching process on a processor, the Organization that created the CSO can compare the candidates that the server generates. The Organization selects the proper command to the server and the server causes a window such as the one illustrated in FIG. 110 to be generated. FIG. 110 shows photos of the candidates and their information side by side to allow for a comparison of their capabilities.

The organizer can select their favorite candidates on FIG. 109. These are stored by the server of FIG. 1. When the organizer wants to review the search, the organizer can click on the favorites tab shown in FIG. 109 to see the favorite candidates, as shown in FIGS. 111 and 112. The organizer can further search among the favorite candidates by applying a variety of filters, shown in FIGS. 111 and 112. The filters include salary, years of experience, academics and all of the parameters set forth above.

Once a job offer is made by the Organization, the server of FIG. 1 keeps track of the offer, assuming it was made through the server. When desired, a list of pending job offers by the organization can be viewed upon command to the server. When the server receives such a command, it collects the information concerning job offers by the Organization from its database and causes that information to be displayed in a window as shown in FIG. 113.

FIG. 114 illustrates the process of initiating a job offer. When the Organization has settled on a candidate and desires to make an offer, it issues an appropriate command to the server of FIG. 1 from a remote terminal. The server responds by causing the window of FIG. 114 to be displayed at the remote terminal. The Organization fills in the information on FIG. 114. Once the information is completed, it is submitted to the server of FIG. 1 which stores the information and submits the offer to the Individual. The offer can be submitted by email to the Individual in the manner described earlier.

When the Individual receives the offer, he or she can accept, reject or make a counteroffer, as described earlier. When the Individual elects making a counteroffer (FIG. 59A), a command is sent to the server of FIG. 1 and the server causes the window shown in FIG. 115 to be displayed on the Individual's remote terminal. The Individual completes the information in FIG. 115 and clicks the SUBMIT COUNTER OFFER button. The information of FIG. 115 is sent to the server where it is stored. The server submits the information related to the counteroffer to the Organization over the network of FIG. 1. The counteroffer information can be submitted via email, as shown in FIG. 116. When the Organization wants to review the counteroffer, the email is clicked on and the details of the counteroffer are displayed in a window such as the one shown in FIG. 117. The Organization can accept the counteroffer by clicking the ACCEPT COUNTER OFFER button which is transmitted to the server and then sent to the Individual, for example by email. The Organization can reject the counteroffer but keep the offer open by clicking the DECLINE COUNTER OFFER (RE-SEND JOB OFFER) button which is transmitted to the server and then sent to the Individual, for example by email. The Organization can reject the counteroffer and withdraw the offer by clicking the REJECT ALTOGETHER button which is transmitted to the server and then sent to the Individual, for example by email.

In accordance with an aspect of the present invention, the server of FIG. 1 only allows an Individual to make a single counteroffer. Thus, the server tracks each counteroffer made by the Individual and once a counteroffer is made, it disables the ability of the Individual to make a counteroffer. Of course, the server can also permit a series of counteroffers to be made. This feature can be selected by the Organization depending on the importance of the job search. The more important the job, the more likely there is room for significant negotiations and more than one counteroffer.

FIG. 118 shows a window displayed to an organizer when the organizer selects the CuzieLive tab on the home page. This allows an organizer to manage the video interview process of the present invention. The organizer can manage the scorecard, the scoreboard, schedule a live video interview and start such an interview from this window.

FIGS. 119 and 120 illustrate windows the server provides to an organizer at a remote terminal when the organizer desires to manage the scorecard used during the interview process. As shown in FIGS. 119 and 120, the criteria for the scoreboard can be displayed. The selectable information includes attitude, appearance, communication, competitive nature, closing impression, culture fit, first impression, oral communication, overall impression, preparation, professionalism, respect for company, role fit, skills relevance, willingness to learn, work ethic, work experience relevance and other specified by the Organizer. These factors can be selected for individual CSOs or for types of CSOs (for example if a position should be frequently filled, a type of CSO can be created). Once the information is selected, it is sent to the server of FIG. 1 which stores the information.

FIGS. 121 and 122 show scoreboard and scorecard information for an interview. The ratings for a candidate that was interviewed on a certain date by each interviewer are displayed. Recall that the parameters in the scorecard are selectable and therefore may be different depending on the CSO. An average of the scorecard rating is calculated by a processor in the server and shown. The cumulative score of the ratings of each interviewer is shown in the scoreboard section. An average of the ratings of each interviewer can also be used. The standing of the candidate in terms of the ratings is also displayed.

FIGS. 123 and 124 illustrate another embodiment of the video shown to interviewers in accordance with another aspect of the present invention. Again, a photo of the candidate is displayed. The candidate's profile, explained earlier, can be selectably displayed by selecting the control shown in the left column in FIG. 123. Also, the candidates, respects, referrals and video can be selectably displayed by selecting the control shown in the left column in FIG. 123. The appointment date is also shown.

The video options are selectable by clicking on the video options control shown in FIG. 123.

In FIG. 123, a video of two interviewers and the candidate are shown by a processor. The videos are generated by the remote terminal that the interviewers and candidate are working from and sent to the server of FIG. 1 and then sent to the interviewer's remote terminal for display. The processor can also store this video information.

In accordance with another aspect of the present invention, a session clock countdown can be implemented. The interviewers establish the length of the interview. Once the interview starts, the countdown button is selected and a processor counts the time down and displays this time to the interviewers.

The CSO can also be displayed by selecting the CANDIDATE SEARCH ORDER control on FIG. 123. Each interviewer has a scorecard on his or her display. The scorecard shows the selectable parameters being used for the interview. The interviewer rates the candidate as the interview is ongoing. The scores are reported to the server of FIG. 1 and a processor determines the average scores by the interviewer and an overall rating based on the ratings of each interviewer. As described above, cumulative scores of the interviewers or average scores can be used.

A chat able parameters being used for the interview. The interviewer rates the candidate as the interview is ongoing. The scores are reported to the server of FIG. 1 and a processor determines the average scores by the interviewer and an overall rating based on the ratings of each interviewer. As described above, cumulative scores of the interviewers or average scores can be used.

A chat capability is provide on the windows shown in FIGS. 123 and 124 to allow the interviewers to chat with each other during the interview. The chat capability is provided and managed by the server of FIG. 1.

Thus, one aspect of the present invention is method and systems of interviewing a candidate for a position. The method includes a processor displaying a video of the candidate during the interview on a display, displaying a scorecard that shows a score of the candidate on the display, displaying a candidate profile on the display and one or more interviewers entering scoring and comment information on the display. The processor updates the scorecard based on the scoring information and displays an updated scorecard on the display. The processor can display a search order for the position and search order can include the requirements for position, such as a salary range. The processor can cause the recording and storing of a video or audio of the interviewer(s) and/or candidates during the interview. The scorecard includes selectable parameters. The parameters can be selected from the group consisting of appearance of the candidate, a first impression by the candidate, a last impression by the candidate, communication skills, work experience, work relevance, academic achievement, and combinations thereof. An interviewer can enter comments related to the interview in a note taking area displayed on the display and the processor can store the notes in a memory. The interview can include a number of interviewers and each can rate the candidate on a scorecard. A processor can accumulate scores from a plurality of scoreboards and update a scoreboard (which summarizes the scores on the scorecards as new information becomes available.

The processor can, in accordance with an aspect of the present invention, cause a video of one or more interviewers to be shown on the display of the interviewers and/or the candidate during the interview. The processor can also retrieve and display information from one or more social network sites during the interview and cause that information to be displayed to the interviewers during the display. The information can be gathered from Facebook, LinkedIn, Twitter, Google+, Yahoo and other sites. During the interview, a plurality of interviewers can participate in the interview and the plurality of interviewers can enter comments in a comment box the processor displays on the display and the comments are stored by the processor in memory. In this way, the interviewers can collaborate during the interview or they can simply store their impressions for later review. At the end of the interview, the processor can display an interview summary report to one or more interviewers which have been completed by the one or more interviewers after the interview and stored by the processor in memory. During the interview, the processor can access candidate endorsements (referrals and/or respects) by a third party that are stored in memory and displaying the candidate endorsements on the display.

In accordance with an aspect of the present invention, different interviewers can participate in the interview while being located at different locations.

The processor can also display a video of one or more interviewers to the candidate on a second display during the interview. The candidate can also take notes regarding the interview on the second remote terminal which are displayed on the second display. These notes can be stored in memory by the server of FIG. 1 for later review by the candidate. The system can also display information about the company, information about the available employment position and information about interviewer's company background to the candidate on the second display.

In accordance with another aspect of the present invention, the servers of FIG. 1 match Individuals seeking a job with Organizations seeking an employee using a Relevancy Factor. In accordance with one aspect of the present invention, the Relevancy Factor relates to eight matching criteria, including: Career Type, Career Role, Salary Requirement, Career Level, Years of Experience, Academic Level, Location of Employment and Travel Preference. The server of FIG, 1 identifies all criterion input matches between CPOs (from Individuals) and CSOs (from Organizations). As more criteria matches, the stronger the relevancy factor becomes for that match. The Relevancy Factor matching process is the initial step in sorting candidates against each other. Candidates with a 100% match are sorted together and then ranked according to their implied scores as calculated by CuzieQuant.

Candidates can be sorted by the following criteria in the following sequence:

Career Role—system identifies all Candidates that match the Career Role criterion in the CSO;

Criteria Relevancy—Of those Candidates vying for the same Job Role criterion, the Candidates are then sorted by the number of matches amongst the 8 criteria mentioned above in descending order; those with the most matches of the 8 appear at the top of the list;

Implied Scores—After Step A and B are conducted; the remaining Candidates are then sorted by the strength of their Implied Scores in descending order, highest scoring Candidates appearing at the top.

Here's a sample sequence of events for the matching process performed by the servers of FIG. 1 in accordance with an aspect of the present invention:

Sequence #1: Cuzie identifies all Candidates that chose the same Job Role criterion as per an Employer's CSO; Sequence #2: Of those vying for the same Job Role, Cuzie sorts those Candidates by the number of positively matched criteria between the Employer CSO requirements with that of the Candidate's CPO demands.

Candidates that match 8 out of 8 are in the top tier group, Candidates that match 7 out of 8 are in the 2nd tier group, Candidate that match 6 out of 8 are in the 3rd tier group, Candidates that match 5 out of 8 are in the 4^{th} tier group. No Candidates are considered if less than 5 criteria match; every Candidate in each tier group are then sorted by the value of their Implied Scores in descending order. The Organizer may want to alter this search results and realize the impact of those changes in real time to give him a better sense of the marketplace for a particular Job Role. That's where CuzieScreener comes in. In accordance with one embodiment of the present invention, CSOs cannot be edited. If for some reason, the Organizer wants to adjust the sorting of the search results, he can use post filtering applications for this purpose. CuzieScreener is provided for the purpose of adjusting CSO search results.

The matching requirements, in accordance with an aspect of the present invention, are selectable by the Organizer. Thus, the number of matches can be selected. So, for example, the Organizer can show lists of 4 out of 8 matches or even lower matches.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method of interviewing a candidate for a position, comprising:
a processor causing a video of the candidate to be displayed on a display during the interview;
the processor displaying a scorecard that shows a score of the candidate on the display, the score being related to a qualification of the candidate for the position;
the processor displaying a profile of the candidate on the display;
an interviewer entering scoring information related to the qualification of the candidate for the position and comment information on the display;
the processor updating the scorecard based on the scoring information entered by the interviewer and displaying an updated scorecard with an updated score on the display.

2. The method of claim 1, comprising the processor displaying a search order for the position on the display.

3. The method of claim 2, wherein the search order includes the requirements for position.

4. The method of claim 3, wherein the search order includes a salary range for the position.

5. The method of claim 1, comprising recording and storing the video of the candidate during the interview.

6. The method of claim 5, comprising recording and storing an audio stream of an interviewer during the interview.

7. The method of claim 1, wherein the scorecard includes entries related to information selected from the group consisting of: appearance of the candidate, a first impression by the candidate, a last impression by the candidate, communication skills, work experience, work relevance, academic achievement, and combinations thereof.

8. The method of claim 1, comprising an interviewer entering comments related to the interview in a note taking area displayed on the display and the processor storing the notes in a memory.

9. The method of claim 1 comprising the processor displaying a scoreboard that accumulates scores from a plurality of scorecards.

10. The method of claim 9, comprising the processor updating the scoreboard as new information becomes available.

11. The method of claim 1, comprising the processor displaying a video of one or more interviewers on the display.

12. The method of claim 1, comprising the processor retrieving and displaying information from one or more social network sites on the display.

13. The method of claim 11, wherein a plurality of interviewers participate in the interview and the plurality of interviewers enter comments in a comment box the processor displays on the display and the comments are stored by the processor in memory.

14. The method of claim 1, comprising the processor displaying an interview summary report to one or more interviewers at a conclusion of the interview which are completed by the one or more interviewers and stored by the processor in memory.

15. The method of claim 1, comprising the processor accessing candidate endorsements by a third party that are stored in memory and displaying the candidate endorsements on the display.

16. The method of claim 11 wherein there are two interviewers participating in the interview who are at different locations.

17. The method of claim 1, comprising displaying a video of an interviewer to the candidate on a second display.

18. The method of claim 17, comprising displaying a video of a second interviewer to the candidate on the second display.

19. The method of claim 17, comprising displaying the candidate's notes regarding the interview on the second display.

20. The method of claim 17, comprising displaying on the second display information about the company, information about the available employment position and information about interviewer's company background.
